(19) United States
(12) Patent Application Publication
(10) Pub. No.: US 2015/0046241 A1
(43) Pub. Date: Feb. 12, 2015

(54) Universal Value Exchange Multipoint Transactions Apparatuses, Methods and Systems

(71) Applicant: VISA INTERNATIONAL SERVICE ASSOCIATION, San Francisco, CA (US)

(72) Inventors: Diane Salmon, Lafayette, CA (US); Susan French, Foster City, CA (US); Victoria Graham, Centennial, CO (US); Amit Bhargava, San Jose, CA (US); Shipra Jha, Fremont, CA (US); Nancy Kim, San Francisco, CA (US)

(73) Assignee: VISA INTERNATIONAL SERVICE ASSOCIATION, San Francisco, CA (US)

(21) Appl. No.: 14/244,488

(22) Filed: Apr. 3, 2014

Related U.S. Application Data
(63) Continuation of application No. 13/842,969, filed on Mar. 15, 2013.
Application No. 13/842,969 is a continuation-in-part of application No. 13/348,634, filed on Jan. 11, 2012.
(60) Provisional application No. 61/808,180, filed on Apr. 3, 2013.
(60) Provisional application No. 61/431,775, filed on Jan. 11, 2011.

(51) Int. Cl. G06Q 30/02

(52) U.S. Cl. CPC G06Q 30/0228; G06Q 30/0215; G06Q 30/0216
USPC 705/14.18; 705/14.29; 705/14.17

(57) ABSTRACT

The UNIVERSAL VALUE EXCHANGE MULTIPOINT TRANSACTIONS APPARATUSES, METHODS AND SYSTEMS (“UVEMT”) transform cross-ecosystem currency exchange instructions via UVEMT components into cross-ecosystem currency exchanges. In one embodiment, the UVEMT may obtain a cross-ecosystem currency exchange instruction and determine one or more sources and destinations based on parsing the cross-ecosystem currency exchange instruction. The UVEMT may identify currency types associated with the sources and the destinations and determine exchange rates of the currency types relative to a standard currency. In one implementation, the UVEMT may obtain currency exchange restrictions and conditions associated with the sources and the destinations and generate a currency exchange flow path for currency transfer from the sources to the destinations. The UVEMT may also issue currency transfer requests to the sources and the destinations, determine that the cross-ecosystem currency exchange has been completed and provide a notification of completion of the cross-ecosystem currency exchange.

This application for letters patent disclosure document describes inventive aspects directed at various novel innovations (hereinafter “disclosure”) and contains material that is subject to copyright, mask work, and/or other intellectual property protection. The respective owners of such intellectual property have no objection to the facsimile reproduction of the disclosure by anyone as it appears in published Patent Office file/records, but otherwise reserve all rights.

### PRIORITY

Applicant hereby claims priority to and the benefit of U.S. provisional patent application Ser. No. 61/808,180, filed Apr. 3, 2013, entitled “Universal Value Exchange Multipoint Transactions Apparatuses, Methods and Systems.” Applicant also hereby claims benefit under 35 USC §120 of U.S. patent application Ser. No. 13/842,969, filed Mar. 15, 2013, entitled “UNIVERSAL VALUE EXCHANGE APPARATUSES, METHODS AND SYSTEMS,” attorney docket no. P-41948US02, which claims benefit under 35 USC §120 of U.S. patent application Ser. No. 13/348,634, filed Jan. 11, 2012, entitled “UNIVERSAL VALUE EXCHANGE APPARATUSES, METHODS AND SYSTEMS,” which claims priority under 35 USC §119 to U.S. provisional patent application Ser. No. 61/431,775 filed Jan. 11, 2011, entitled “UNIVERSAL VALUE EXCHANGE APPARATUSES, METHODS AND SYSTEMS,” attorney docket no. P-41948PRV. Applicant also claims priority under 35 USC §119 to U.S. provisional patent application Ser. No. 61/680,592, filed Aug. 7, 2012, entitled “VALUE CONVERSION AND SETTLEMENT SYSTEM.” The entire contents of the aforementioned applications are herein expressly incorporated by reference.

### FIELD

The present innovations are directed generally to apparatuses, methods and systems for rewards, points and currency exchange and more particularly, to UNIVERSAL VALUE EXCHANGE MULTIPOINT TRANSACTIONS APPARATUSES, METHODS AND SYSTEMS.

### BACKGROUND

Service providers such as banks and merchants run loyalty or rewards programs to reward their customers for being loyal to their business, encourage more spending, or entice new customers. These rewards may be in the form of points, cash back, gift cards, miles, etc.

### BRIEF DESCRIPTION OF THE DRAWINGS

The accompanying drawings illustrate various non-limiting, example, innovative aspects in accordance with the present descriptions:

FIGS. 1A-B show block diagrams illustrating various example embodiments of the UVEMT;

FIGS. 1C-D show data flow diagrams illustrating UVEMT program configuration embodiment of the UVEMT;

FIGS. 2A-C show data flow diagram illustrating closed/open loop gift card value exchange embodiments of the UVEMT;

FIGS. 2D-2E(a) show data flow diagrams illustrating gift card value exchange/transfer embodiments of the UVEMT including a broker option;

FIG. 2E(b) shows a data flow diagram illustrating broker interaction(s) of embodiments of the UVEMT;

FIG. 2F shows a data flow diagram illustrating charge processing embodiments of the UVEMT;

FIG. 2G shows a data flow diagram illustrating user purchase checkout embodiments of the UVEMT;

FIGS. 3A-D show logic flow diagrams illustrating closed/open loop gift card value exchange embodiments of the UVEMT;

FIGS. 3E-3F(a) show logic flow diagrams illustrating gift card value exchange/transfer embodiments of the UVEMT including a broker option;

FIG. 3F(b) shows a logic flow diagram illustrating broker interaction(s) of gift card value exchange/transfer embodiments of the UVEMT;

FIG. 3G shows a logic flow diagram illustrating example aspects of charge processing according to some embodiments of the UVEMT having a broker option.

FIG. 3H shows a logic flow diagram illustrating example aspects of a user purchase checkout in some embodiments of the UVEMT, e.g., a User Purchase Checkout (“UPC”) component 2241;

FIG. 4A shows a data flow diagram illustrating source/destination value exchange embodiment of the UVEMT;

FIGS. 5A-B show logic flow diagrams illustrating source/destination value exchange component embodiment of the UVEMT;

FIGS. 6A-B show logic flow diagrams illustrating equivalent value determination component embodiment of the UVEMT;

FIG. 7 shows a logic flow diagram illustrating cross-ecosystem exchange component embodiment of the UVEMT;

FIGS. 8A-D show screenshot diagrams illustrating exchange mode embodiments of the UVEMT;

FIG. 8E shows screenshot diagrams illustrating exchange rate mode embodiment of the UVEMT;

FIGS. 8F-I show screenshot diagrams illustrating management mode embodiment of the UVEMT;

FIGS. 8J-K show screenshot diagrams illustrating UVEMT point mode embodiment of the UVEMT;

FIGS. 8L-N show screenshot diagrams illustrating source/destination exchange mode embodiment of the UVEMT;

FIG. 8P shows a screenshot illustrating an example web checkout in an embodiment of the UVEMT;

FIG. 8Q shows a screenshot illustrating an example wallet view incorporating the multibroker exchange option in one embodiment of the UVEMT;

FIG. 8R shows a screenshot illustrating an example wallet view displaying UVEMT-exchanged value in one embodiment of the UVEMT;

FIG. 9 shows a user interface diagram illustrating an overview of example features of virtual wallet applications in some embodiments of the UVEMT;

FIGS. 10A-F show user interface diagrams illustrating example features of virtual wallet applications in a shopping mode, in some embodiments of the UVEMT;

FIGS. 11A-F show user interface diagrams illustrating example features of virtual wallet applications in a payment mode, in some embodiments of the UVEMT;

FIG. 12 shows a user interface diagram illustrating example features of virtual wallet applications, in a history mode, in some embodiments of the UVEMT;

FIGS. 13A-E show user interface diagrams illustrating example features of virtual wallet applications in a snap mode, in some embodiments of the UVEMT;

FIG. 14 shows a user interface diagram illustrating example features of virtual wallet applications, in an offers mode, in some embodiments of the UVEMT;

FIGS. 15A-B show user interface diagrams illustrating example features of virtual wallet applications, in a security and privacy mode, in some embodiments of the UVEMT;

FIG. 16 shows a data flow diagram illustrating an example user purchase checkout procedure in some embodiments of the UVEMT;

FIG. 17 shows a logic flow diagram illustrating example aspects of a user purchase checkout in some embodiments of the UVEMT, e.g., a User Purchase Checkout (“UPC”) component 1700;

FIGS. 18A-B show data flow diagrams illustrating an example purchase transaction authorization procedure in some embodiments of the UVEMT;

FIGS. 19A-B show logic flow diagrams illustrating example aspects of purchase transaction authorization in some embodiments of the UVEMT, e.g., a Purchase Transaction Authorization (“PTA”) component 1900;

FIGS. 20A-B show data flow diagrams illustrating an example purchase transaction clearance procedure in some embodiments of the UVEMT;

FIGS. 21A-B show logic flow diagrams illustrating example aspects of purchase transaction clearance in some embodiments of the UVEMT, e.g., a Purchase Transaction Clearance (“PTC”) component 2100; and

FIG. 22 shows a block diagram illustrating embodiments of a UVEMT controller;

APPENDICES 1-3 (provided in U.S. provisional patent application Ser. No. 61/808,180, filed Apr. 3, 2013, which is incorporated by reference for all purposes) illustrate various embodiments of the UVEMT.

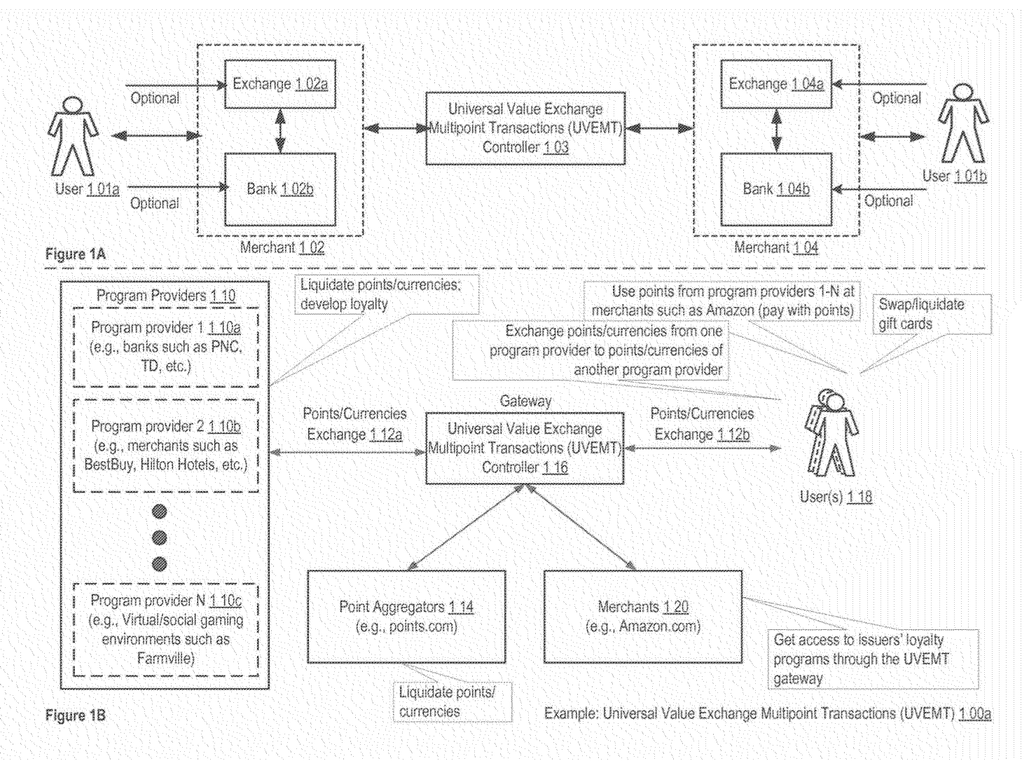

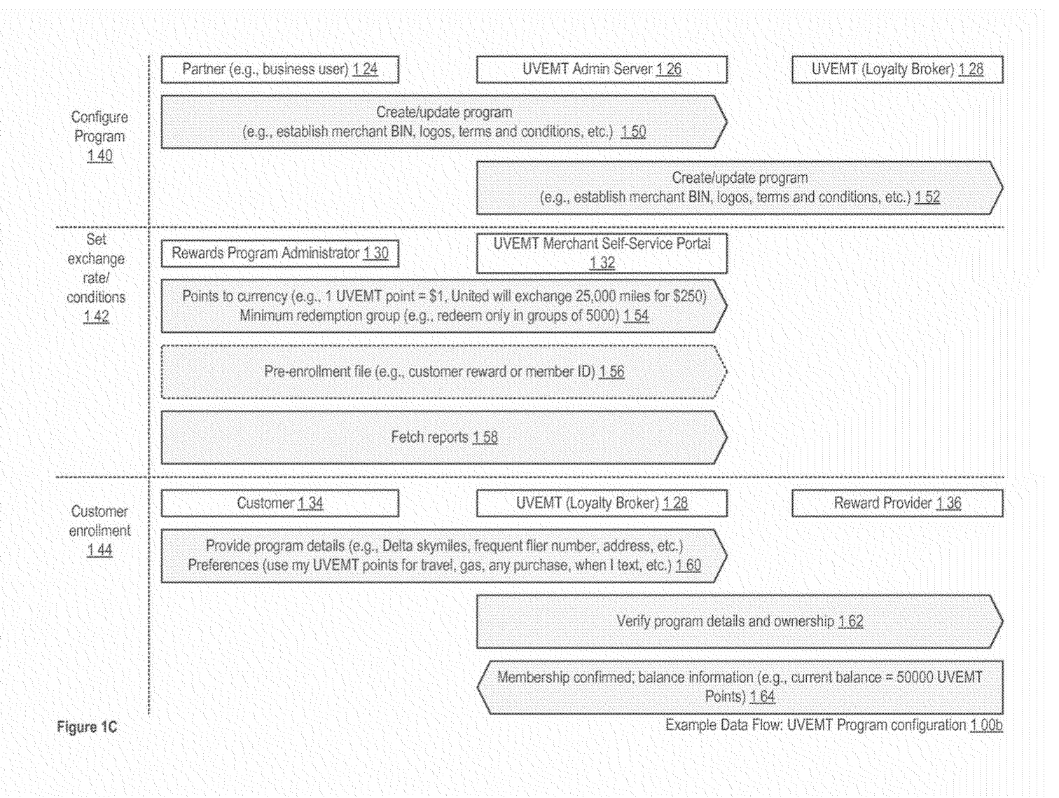

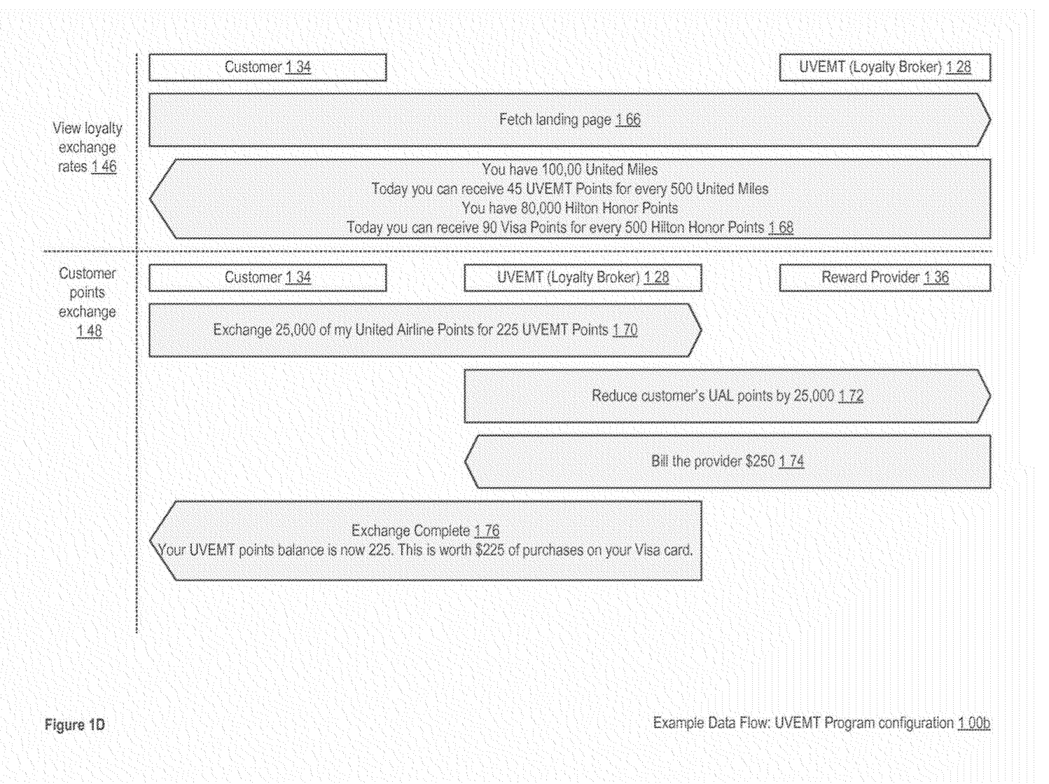

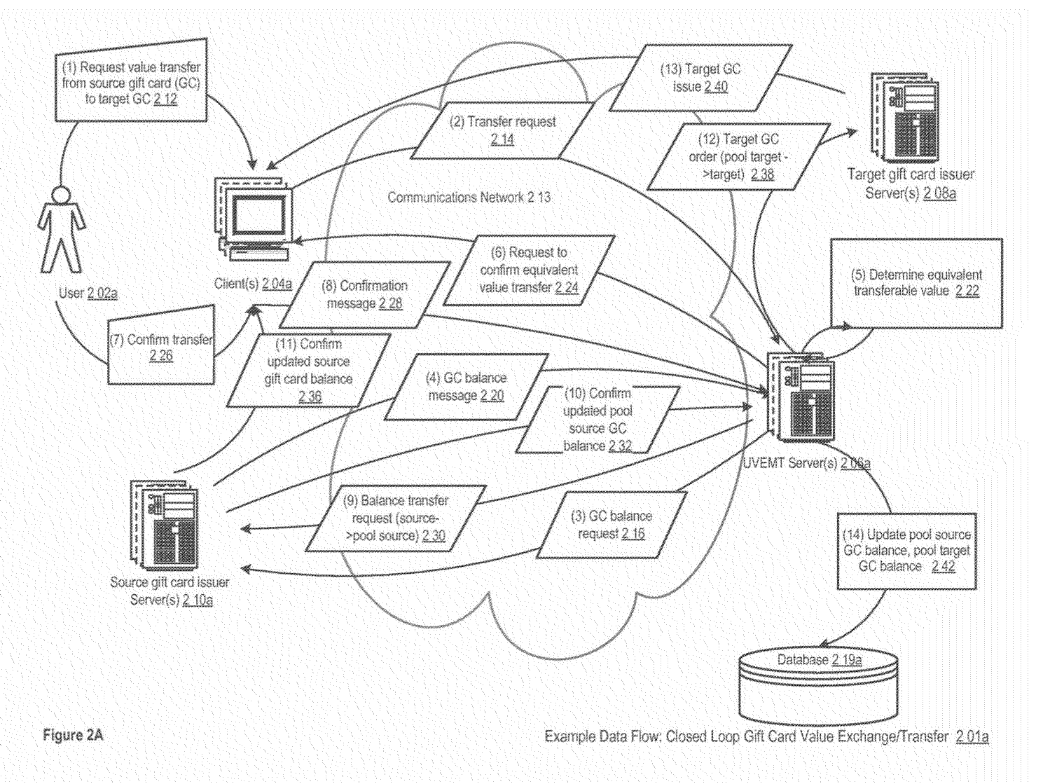

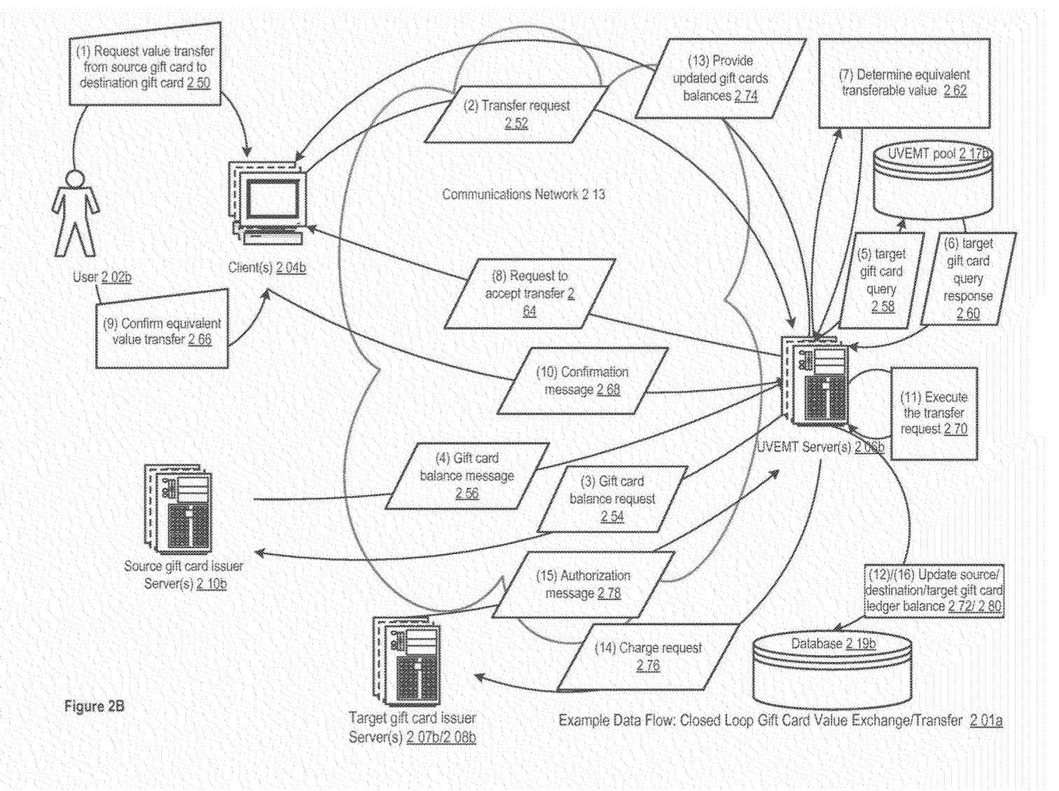

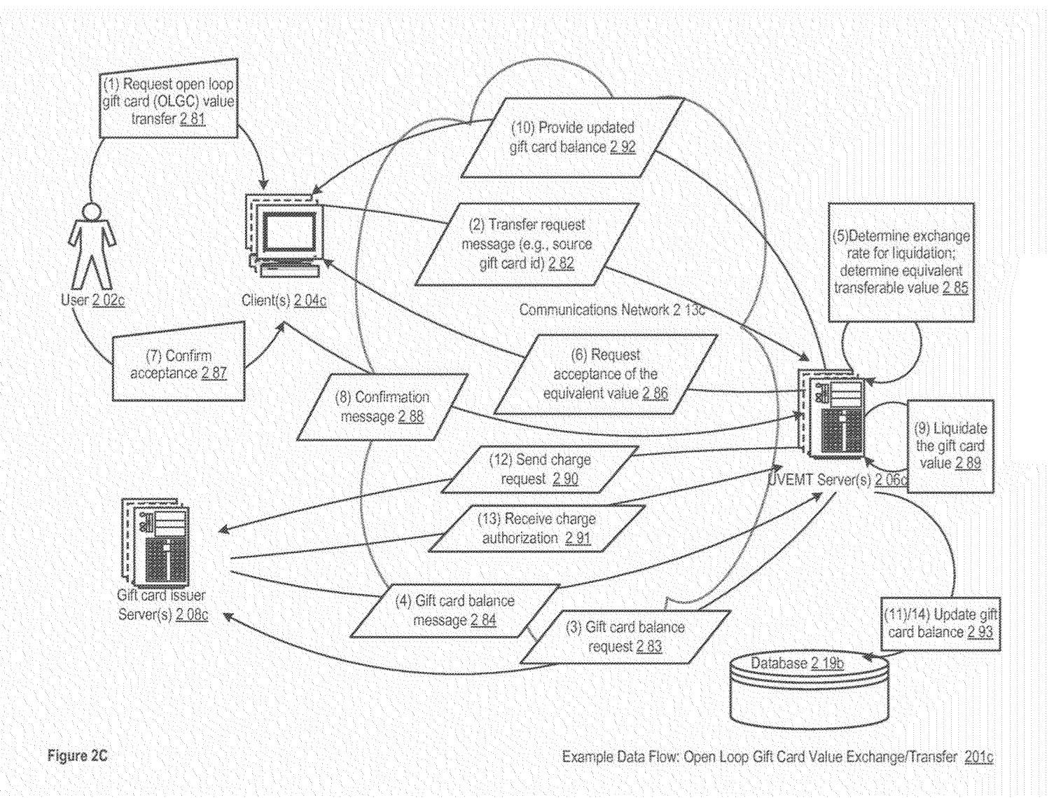

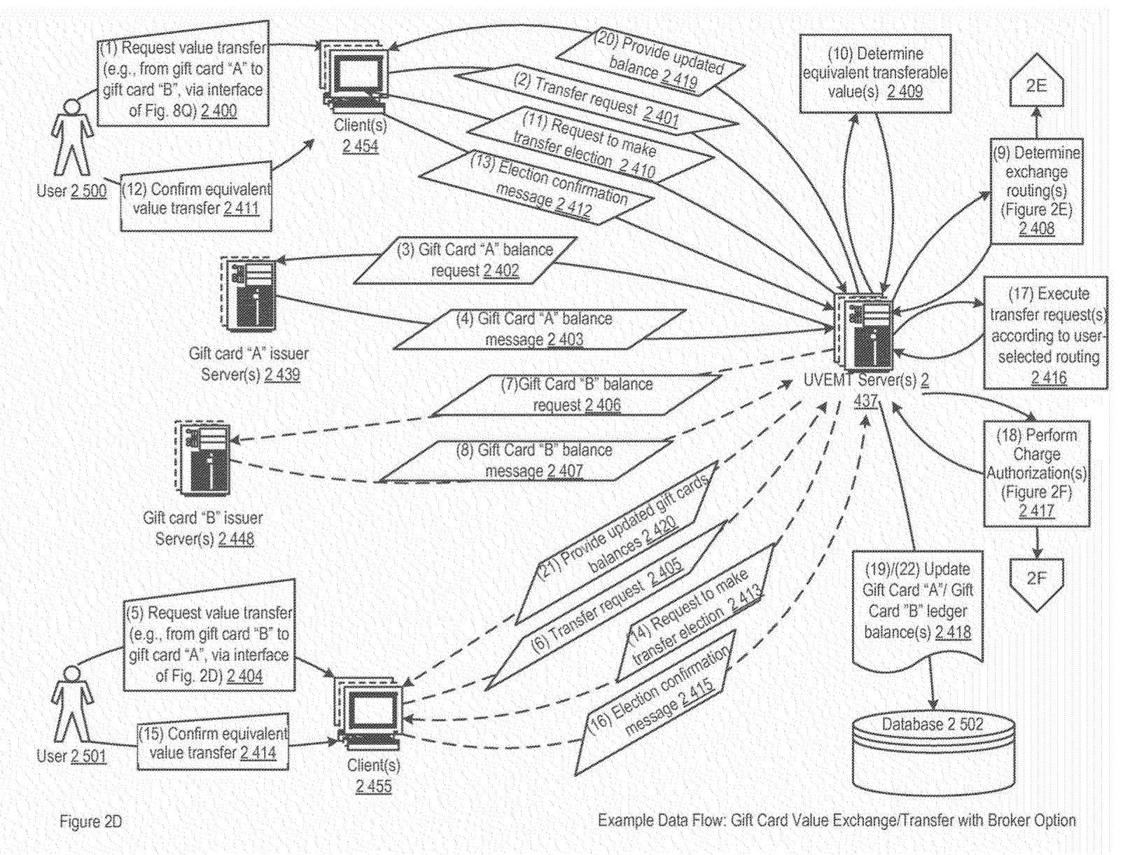

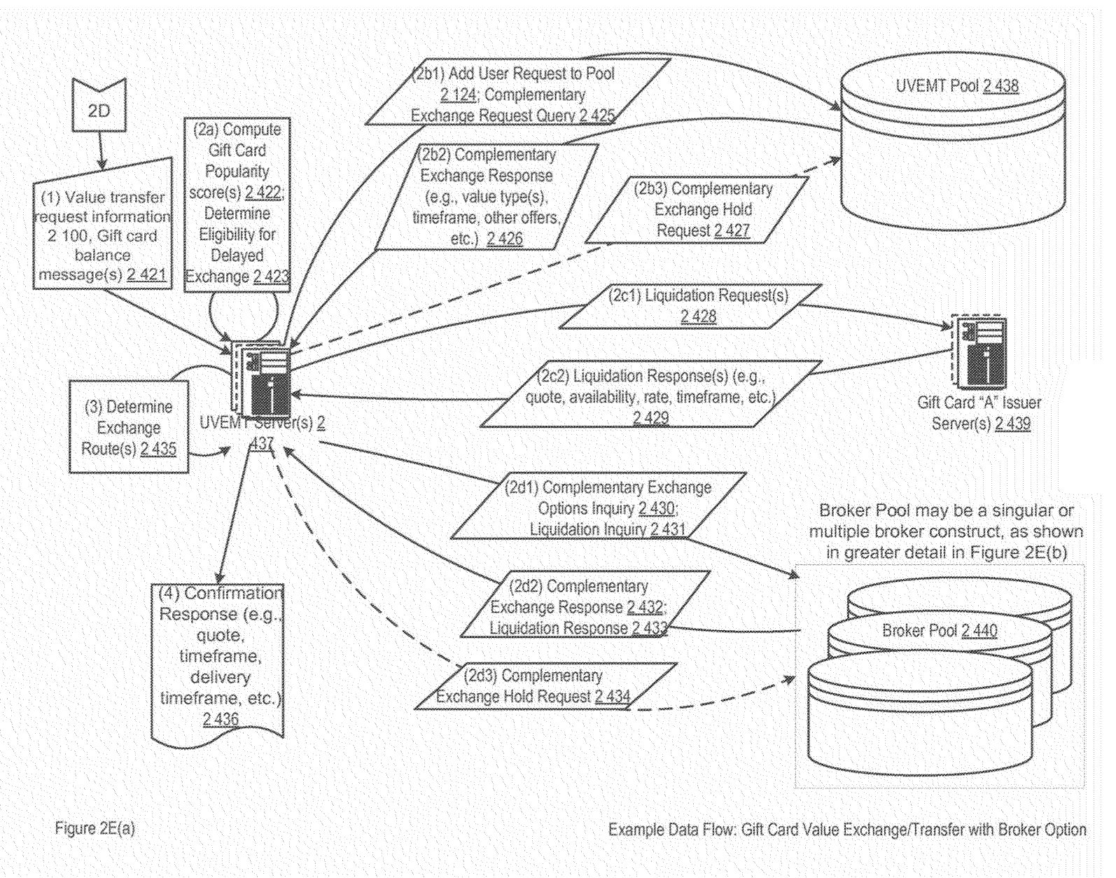

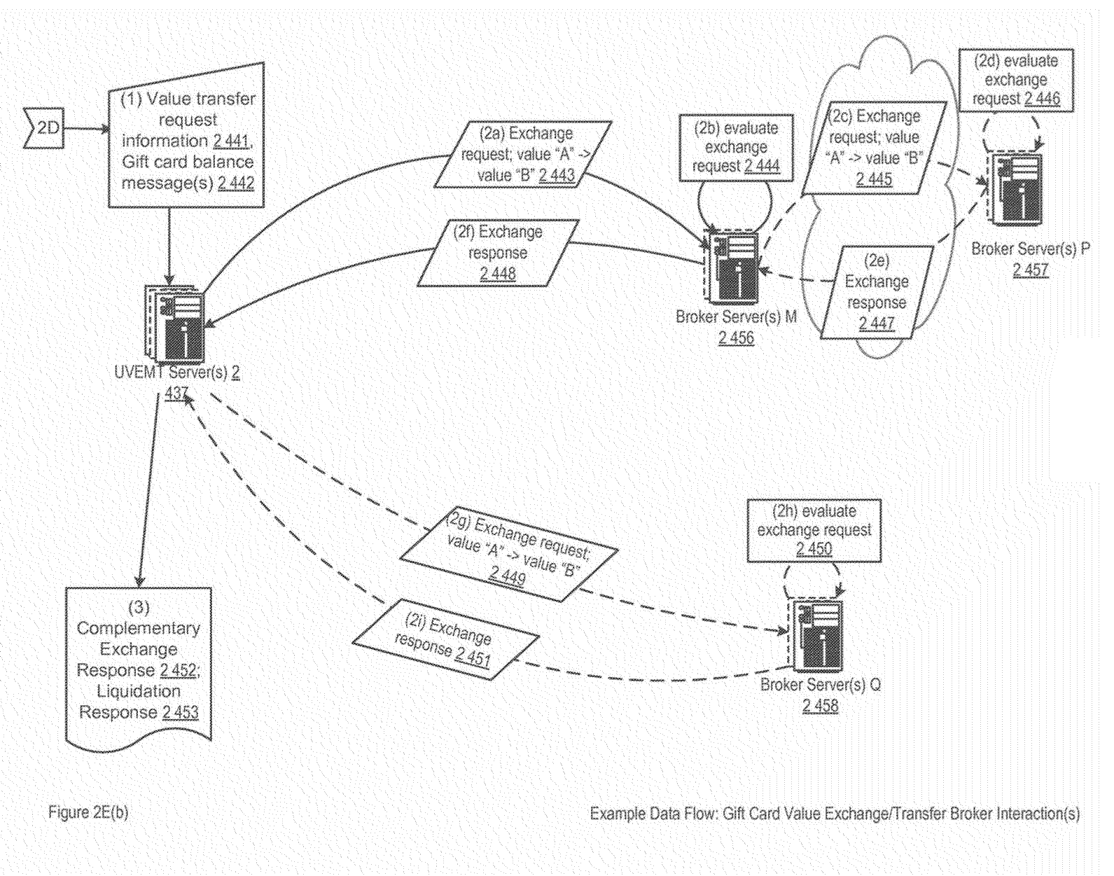

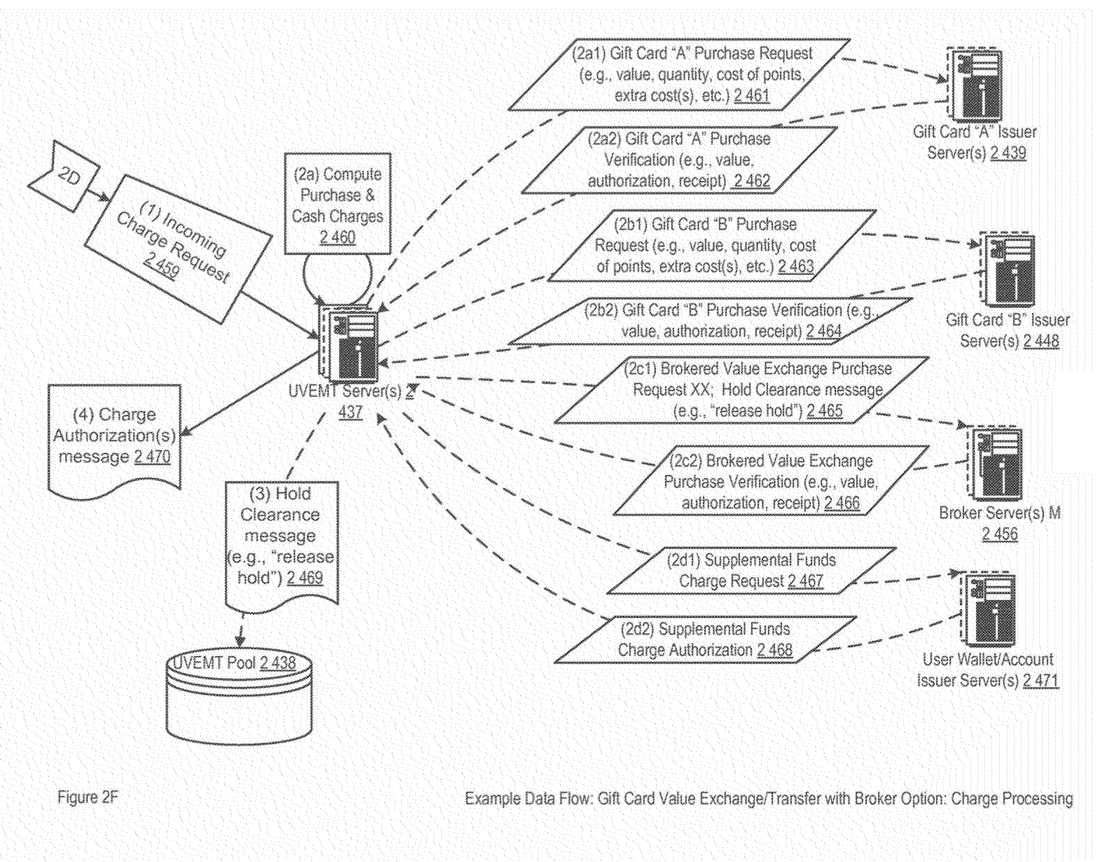

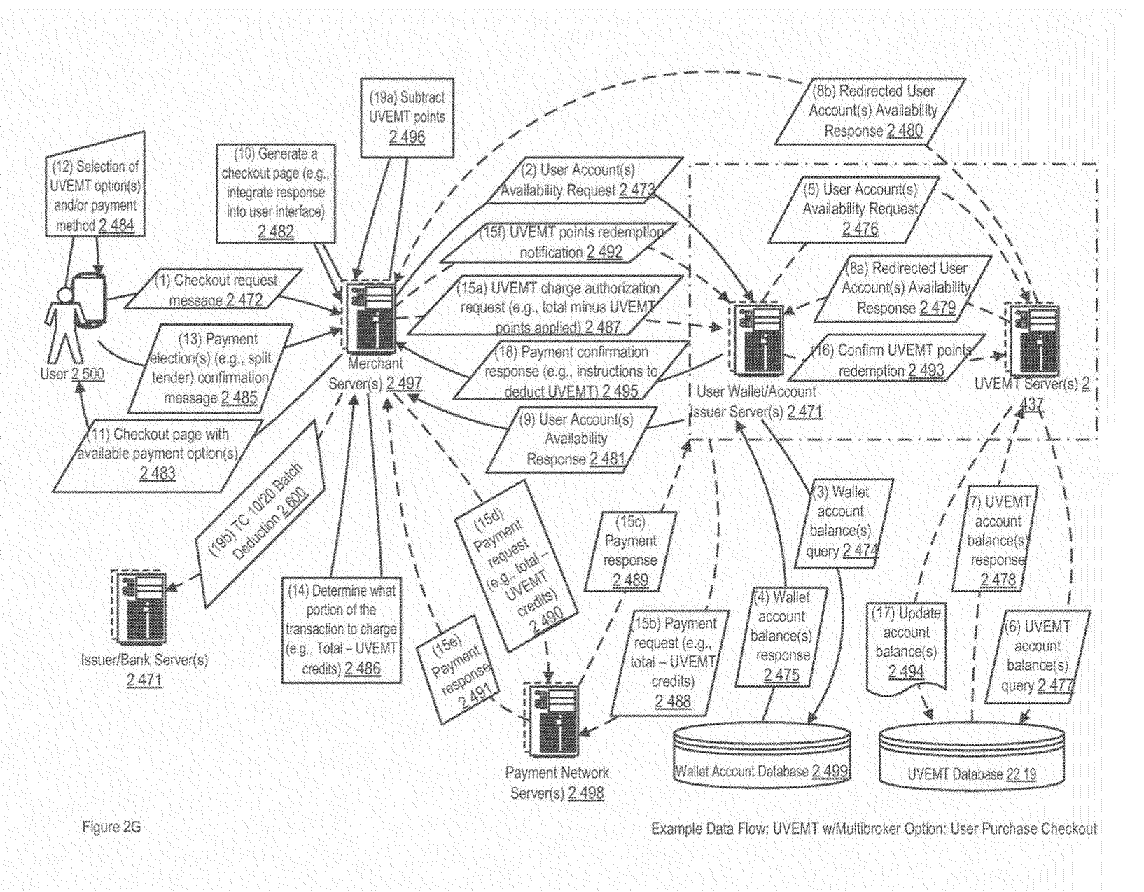

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION

### UVEMT

FIGS. 1A and 1B show block diagrams illustrating various example embodiments of the UVEMT. FIG. 1A shows a block diagram illustrating exemplary aspects of transforming value equivalent exchange instructions in some embodiments of the UVEMT. In some implementations, a user may desire to utilize purchasing power available to the user to obtain a desired product. For example, the user may be shopping online, playing a virtual online game (e.g., poker), trading on the stock market electronically, engaging in foreign exchange transactions, and/or other like transactions. In some implementations, the user may retain such purchasing power in various types of currency. In some implementations, the user may have retained purchasing power in various currency types across various ecosystems. For example, the user may have access to currencies such as, but not limited to: a financial account (checking, savings, debit card, credit card, open and closed loop gift cards, prepaid cards, current account, money market, etc.) storing currency of a real-world monetary system (e.g., U.S. dollar, Yen, Euro, etc.), an electronically tradable financial instrument (e.g., derivative financial products, securities, bonds, etc.), virtual currency (e.g., online poker chips, Farmville seeds, etc.), rewards program currency (e.g., rewards points, airline miles, hotel credits, rental car rewards, cruise line rewards, credit card rewards points, cashback rewards, etc.), and/or the like. In some implementations, the user may desire to convert purchasing power available in one currency ecosystem to another currency utilized in a completely different ecosystem. As one example, the user may desire to convert points from traditional rewards programs into cash withdrawn from an ATM-linked account. As another example, the user may desire to convert rewards points from an airline miles program into virtual currency that can be utilized in an online social networking game, e.g., Farmville. As another example, the user may desire to convert virtual currency into currency usable to purchase stock on an electronic trading system. As another example, the user may desire to convert a combination of currencies from financial accounts storing currency of a real-world monetary system, electronically tradable financial instruments, virtual currencies, rewards program points/miles/rewards, and/or the like into a different combination of such currencies.

In some implementations, a user may desire to aggregate purchasing power from a variety of sources, and apply the purchasing power towards executing a single transaction. For example, with reference to FIG. 1A, a user 101a may desire to execute a transaction with a user 101b. In some implementations, the user 101a may communicate with user 101b to execute the transaction via a universal value exchange multipoint transactions controller 103. In some implementations, the user may optionally communicate with intermediary merchants, exchanges, banks, and/or the like (e.g., 102, 104). For example, the user may communicate with an electronic trading system (e.g., 102a, 104a) to execute a transaction. As another example, the user may communicate with a bank (e.g., 102b, 104b) to conduct a transaction. As yet another example, the user may communicate with a merchant system (e.g., 102, 104) for purchasing goods and/or services. In some implementations, a user 101a may provide cross-ecosystem currency exchange instructions to the universal value exchange multipoint transactions controller 103. For example, the user 101a, in such instructions, may specify source details (of user 101a) such as, but not limited to: currency source types, currency account numbers, currency access usernames, currency access passwords, and/or the like, as well as destination details (of user 101b) such as, but not limited to: currency destination types, currency account numbers, currency access usernames, currency access passwords, and/or the like. In some implementations, the universal value exchange multipoint transactions controller 103 may obtain the cross-ecosystem currency exchange instructions from user 101a. The universal value exchange multipoint transactions controller may determine the sources of currency, and determine the types of currency available at the sources of the currencies. The universal value exchange multipoint transactions controller may determine exchange rates for each of the source currencies, for example, relative to a standard currency (e.g., U.S. dollar, Euro, Yen, privately created currency standard, and/or the like). The universal value exchange multipoint transactions controller may also determine whether there are any restrictions or conditions at each of the sources of the currencies, as well as the destinations of the currencies. For example, a rewards points program may have a restriction against converting its rewards points into rewards points of another rewards points program; a condition that conversion can only take place if fewer than a threshold amount of rewards points are utilized, and/or the like. Each of the source currencies may have various restrictions and/or conditions on use of the currency type of the source.

In some implementations, the universal value exchange multipoint transactions controller may obtain the restrictions and/or conditions of the sources and destinations of the currencies, and may determine a currency exchange flow path based on the restrictions and/or conditions at the currency sources and/or destinations. Upon determining a currency exchange flow path, the universal value exchange multipoint transactions controller 103 may provide request messages to the components in the currency exchange flow path, e.g., exchanges (e.g., 102a, 104a), banks (e.g., 102b, 104b), merchants (e.g., 102, 104) and/or the like, requesting the components to provide and/or accept currency value, based on the determined currency exchange flow path. Upon completing the currency withdrawal and/or deposits into each of the currency accounts involved in the cross-ecosystem currency exchange, the universal value exchange multipoint transactions controller may provide notifications to the users 101a, 101b notifying them of completion of the requested cross-ecosystem currency transaction. Various currency exchange flow paths of the UVEMT embodiments are discussed throughout the specification.

In some implementations, the UVEMT may allow merchants, hosts, exchanges, intermediaries, banks, and/or the like to take on different roles and/or relationships within an exchange network, for example allowing a supplier of rewards points to also operate, either in a separate transaction or simultaneously, as a purchaser and/or broker of rewards points. For example, a supplier of points may wish to sell off, rebalance, or acquire other point suppliers' value equivalence, and as such, may seek to sell and buy points akin to the process a consumer may use, as discussed throughout the specification. The UVEMT may also, in some embodiments, allow a user who has executed a cross-ecosystem currency exchange to perform a ‘refund’ transaction through which an exchanged currency type may be converted back into the original source currency type. In some instances, a user may provide information to the UVEMT which may include an account number, for example corresponding to a credit card, debit card, gift card, loyalty rewards card, and/or the like. The UVEMT may then determine, e.g. by referencing a lookup table, whether said account number(s) is in a predetermined range of account numbers for which payment using points is authorized, as described in greater detail in U.S. Provisional Patent Application No. 61/680,592, entitled “VALUE CONVERSION AND SETTLEMENT SYSTEM.” The UVEMT may utilize the entire account number in performing said lookup. Alternatively, during manual entry of said number(s) by a user (for example using a mobile device), the UVEMT may also, in some embodiments, execute said lookup using only a subset of the complete account number (e.g., a progressive lookup-as-you-type embodiment can provide interactive, on-the-go feedback to a user). By way of example, the UVEMT may use the first 4 digits of said account number in executing the lookup, and optionally perform additional subsequent lookups using additional digits if necessary in making a points redemption eligibility determination.

With reference to FIG. 1B, the UVEMT controller 116 may act as a gateway or a single point of access between program providers 110, point aggregators 114, merchants 120 and users 118. In some implementations, program providers 110 may enter into an agreement with the UVEMT to participate in the points/currency exchange 112a via the UVEMT gateway. The program providers may, via program configuration user interface (UI), identify one or more partner program providers with whom the program provider may enter into exchange transactions. For example, the program provider may select non-competing program providers and/or affiliated program providers as partners. For program providers, the facilities of the UVEMT platform may be an opportunity to unload the value of their promotions which are carried on their balance sheets as liability. For example, program providers may have customers who are holding on to their points because they do not have enough points to redeem an item, for example, a ticket or a room. However, at the aggregate level, there may be a significant liability for the program providers because of the unredeemed points. In such a situation, allowing the customers to participate in points/currency exchange may be an advantage to the program providers.

In some implementations, the program provider may also set an exchange rate with respect to each of the selected program provider partners. The exchange rate, in some implementations, may be established via bilateral agreement between the program provider and each partner. In such a situation, there may be no need for a base or intermediate currency. For example, United Airlines may enter into a bilateral agreement with Hilton and establish an exchange rate where 5 United Airline miles can be exchanged for 1 Hilton Honors point. In some other implementations, the exchange rate may be established using a base/intermediate currency. The intermediary may be, for example, a UVEMT currency (e.g., UVEMT point) or a non-denominational currency (e.g., a unit). In such a case, the program provider may need to negotiate with the UVEMT to set the exchange rate between the provider currency and the UVEMT currency. These bilateral agreements may be carried out electronically. As a part of the program provider enrollment, the program provider may need to expose API(s) to their rewards/loyalty program such that the UVEMT may obtain currency balance information and may credit/debit currency after an exchange transaction. Referring to FIG. 1B, the program providers 110 may include various types of entities or business users 110a-c such as issuers/banks, merchants, acquirers, virtual/social games, and/or the like. In some implementations, the UVEMT may also facilitate points/currency exchange between one or more program providers that are not enrolled as a program provider in the UVEMT platform.

In some implementations, the UVEMT may also act as a gateway to point aggregators 114. For example, UVEMT may transact with point aggregators to sell off or buy points when necessary. In some other implementations, various merchants 120 such as Amazon, may also utilize the facilities of the UVEMT gateway to access the points/currencies from various program providers, and allow customers to use the value of their points/currencies towards payment of purchases made via the merchant. In some implementations, at the back end standard settlement processes may be employed. In some implementations, such redemption may be for online purchases or brick and mortar purchases using an electronic or mobile wallet, a physical payment device or other methods. Further, redemption may occur prior to a transaction or dynamically at the time of transaction.

From the point of view of a user 118, the UVEMT provides a single place where points/currencies from various program providers 110 can be managed, redeemed, exchanged 112b, or linked to a wallet. Further, via the UVEMT, the user may have the flexibility to make a redemption dynamically at the time of purchase or prior to the purchase. The user may also have the option to combine points/currencies during the redemption. In some implementations, the user may also swap and liquidate points/currencies and open and closed loop gift cards.

FIGS. 1C and 1D show data flow diagrams illustrating UVEMT program configuration embodiment of the UVEMT. In one embodiment, the UVEMT may behave as a loyalty broker creating a marketplace or an exchange for converting points, rewards and virtual currencies to real world currencies. The loyalty broker embodiment may allow any point provider partner to establish their own price for points/currencies. The loyalty broker may, in some embodiments, allow a consumer to enroll and exchange points/currencies to a proprietary currency (e.g., Visa Points+) or even cash. The proprietary currency may then be used in inline or other purchases.

In one implementation, a partner 124 may configure an exchange program 140 with a loyalty broker 128. At 150, the partner may provide bank identification number (BIN), logos, accept any terms and conditions of the program, and/or the like to create and/or update the exchange program. If the partner does not have a BIN, one may be created. The BIN creation may be handled by an admin server 126 or the loyalty broker server. At 152, the information provided by the provider and/or confirmation of the exchange program creation may be provided to the loyalty broker 128.

Once the program has been configured, the partner or the partner's rewards program administrator 130 may set exchange rates and other conditions applicable to the exchange program 142. In some implementations, the configuration may be performed by the provider accessing a configuration UI in a merchant/provider self-service portal 132. In some implementations, at 154a, the provider may set the exchange rate for its points/currencies. The exchange rate may specify point/currency to UVEMT point ratio. For example, the program provider may set the exchange rate where the 25,000 miles (the provider's currency) is equivalent to 1 UVEMT point. In one implementation, the value of the UVEMT point may be with respect to a monetary currency such as US dollar, Canadian dollar, Yen, etc. For example, 1 UVEMT point may be equivalent to one US dollar. In one implementation the price for points may be changed as frequently as the partner wishes to change it. For example, it could be changed daily, weekly, monthly, yearly, etc. The exchange rate may be associated with a time period for which it is effective in some implementations.

In some implementations, the partners may set exchange rules/rates for various customer segments or even one customer segment. In some other implementations, partners may set up exchange rules at the product (e.g., Stock-Keeping Unit SKU) level. For example, some partners may wish to run a promotional type of exchange rules that may not apply across the partner's business overall, but may be applicable for a short period of time or a small or select group where it may not be applicable or convenient to set up a separate program. In one implementation, for example, a partner may set an exchange rule where customers who fall into Chase segment 82C would get a different exchange rate from customers who fall into other segments. In yet another implementation, for example, a partner may set an exchange rule where customers who enrolled in the partner program in the last 30 days would receive a special exchange rate on purchases of select items (e.g., SKU level data) at another merchant (e.g., Best Buy).

At 154b, the partner may specify rules and restrictions for any exchange of the program provider's points/currencies. In some implementations, the rules and restrictions may be negotiated between the provider and the loyalty broker. In other implementations, the rules and restrictions may be specified via the configuration UI. For example, the provider may set a minimum redemption group of 500 (e.g., redeem in groups of 500 miles). In some implementations, the partner may also provide or upload a pre-enrollment file at the self-service portal at 156. Such a pre-enrollment file may include information relating to customers of the program provider (e.g., customer reward ID or membership ID, name, address, etc.). The pre-enrollment file may be stored in one or more databases of the loyalty broker and may be used to validate users when they enroll in the loyalty broker. In one implementation, at 158 the partner may also access the self-service portal to fetch reports. Example of reports available to the partner provider may include report of exchange activities by customer and/or time period, report on customer enrollment, and/or the like.

Once the exchange program is configured and the exchange rate and conditions set up, the loyalty broker may accept customer enrollment 144. The customer may enroll in the exchange program with the loyalty broker by accessing a customer facing portal, a web or mobile application, a wallet having loyalty broker facilities. At 160, the customer 134 provide program details such as membership ID, password, and any other information necessary to verify the customer as the owner of the membership account. At 160, the customer may also provide usage and other preferences (e.g., use my UVEMT points for travel, gas, any purchase, when I send a text, exchange my miles as soon as they exceed 25,000, exchange my miles when the exchange rate is better than or equal to 100:1, etc.). At 162, the loyalty broker may receive the customer provided program details and may verify the details to confirm the customer ownership of the membership account with the reward provider. Alternatively, the loyalty broker may also utilize information in the pre-enrollment file to confirm some or all of the customer/program details. At 164, the program provider may confirm the membership of the customer to the loyalty broker. At 164, the program provider may also provide the customer in question's current points/currency balance information to the loyalty provider.

Referring to FIG. 1D, the customer may access and view loyalty exchange rates 146. At 166, the customer 134 may fetch a landing age or launch an application to view the program balance information and exchange rates. The loyalty broker, in response to the customer's request, may obtain from the loyalty provider the current exchange rates as well as points/currency balances and display the information to the customer at 168. In one implementation, the customer may initiate a points/currency exchange transaction 148. For example, at 170, the customer 134 may instruct the loyalty broker to exchange an amount of program points/currency (e.g., 25,000 miles) for an equivalent value (e.g., 225 UVEMT points) 170. At 172, the loyalty broker may process the instruction by requesting the program provider 136 to reduce the customer's program points/currency by the specified amount (e.g., reduce by 25,000 miles). The program provider may reduce the customer's points/currency and make payment of the agreed upon amount (e.g., $250) at 174. In one implementation, as a part of the agreement between the program provider and the loyalty broker, the loyalty broker may assess a transaction processing fee. In some implementations, the fee may be a percentage of the total amount the program provider has approved for billing. For example, when the program provider agrees to exchange 25,000 miles for $250, the loyalty broker may assess a 20% processing fee which is equivalent to $50. In some implementations, the loyalty broker may advertise the exchange rate using the adjusted amount that is actually payable to the customer. For example, the loyalty broker advertises to exchange 25,000 miles for $225. In some implementation, instead of assessing a processing fee on a per transaction basis, subscription type fees may be assessed to partners and/or users of the UVEMT. For example, the subscription fee amount may be tiered based on volume of UVEMT transactions. In some other implementations, there may be revenue share between the UVEMT and partners. In yet other implementations, UVEMT may add and/or retain a certain number of basis points to the exchange rate, assess subscription or per-use fees to the consumer or levy a percentage of the exchange value as fees to the consumer/partner in exchange for the services provided.

When the bill is paid, the customer portion is credited to the UVEMT points BIN or a Debit Processing Service (DPS) type BIN for each card. In some implementations, the customer may be issued a prepaid card having the value of the total UVEMT points obtained from the exchange. At 176, the exchange is complete. The customer's UVEMT points balance is incremented by the total UVEMT points gained (e.g., +225), his/her miles balance is decremented by the number of miles used in the exchange (e.g., 25,000 miles). The examples discussed herein assume that a unit UVEMT point is equivalent to $1. Other equivalency between the UVEMT point and currency are contemplated in some implementations of the loyalty broker.

Some embodiments of the UVEMT facilitate gift card exchanges and conversions. The facilities of the UVEMT may support open loop, closed loop and hybrid gift cards. Open loop gift cards can be redeemed in a variety of businesses, while closed loop gift cards can be redeemed at a specific business (e.g., Apple Store card, Best Buy card) or select businesses (e.g., Westfield mall gift card). For example, a user A may have a gift card for the Apple Store, but the user never shops in the Apple Store, and would instead prefer to exchange the Apple gift card for a Best Buy gift card. Similarly, another user B may have a Best Buy gift card, but would like to exchange for an Apple Store gift card. In such a situation, the UVEMT may facilitate the exchange of the Apple and Best Buy gift cards such that both users A and B can have their preferred gift cards. As another example, a user may have various gift cards in his or her hands or in the wallet. The user may prefer to combine the value of all the gift cards in one gift card or prepaid card, a bank account or obtain cash. In such as situation, the UVEMT may provide facilities to consolidate the gift card values and automatically apply them in a purchase transaction.

FIG. 2A shows a data flow diagram illustrating closed loop gift card value exchange embodiment of the UVEMT. The data flow diagram shows flow of data between a user 202a, a client 204a, a UVEMT server(s) 206a and gift card issuer servers 208a/210a, and target gift card issuer server(s) 207a over a communication network 213a. As shown in the figure, the user 202a may access the UVEMT web page or application using the client 204a to communicate with the UVEMT server. In some implementations, the user may wish to transfer the value from one gift card to another. The user may then input or select a source gift card and a target gift card and request value transfer from the source gift card to the target gift card at 212. In some implementations, the client may include, but is not limited to: a personal computer, mobile device, television, point-of-sale terminal, kiosk, ATM, and/or the like (e.g., 204a). In various implementations, the user input may include, but not be limited to: a single tap (e.g., a one-tap mobile app purchasing embodiment) of a touchscreen interface, keyboard entry, card swipe, activating a RFID/NFC enabled hardware device (e.g., electronic card having multiple accounts, smartphone, tablet, etc.) within the user device, mouse clicks, depressing buttons on a joystick/game console, voice commands, single/multi-touch gestures on a touch-sensitive interface, touching user interface elements on a touch-sensitive display, and/or the like.

In some implementations, using the user's input, the client may generate a transfer request, e.g., 214 and provide the transfer request to the UVEMT server. For example, the client may provide a (Secure) Hypertext Transfer Protocol (“HTTP(S)”) POST message including data formatted according to the eXtensible Markup Language (“XML”). An example transfer request 214, substantially in the form of a HTTP(S) POST message including XML-formatted data, is provided below:

```
POST /transferrequest.php HTTP/1.1
Host: www.visa.com/UVEMT
Content-Type: Application/XML
Content-Length: 484
<?XML version = “1.0” encoding = “UTF-8”?>
<transfer_request>
    <request_ID>45DSKFSWFG5</request_ID>
    <timestamp>yyyy-mm-dd hh:mm:ss</timestamp>
    <user_ID>JDoe@gmail.com</user_ID>
  <source_details>
    <giftcard_ID>4444566897978766</giftcard_ID>
    <issuer_ID>apple</issuer_ID>
    <card_value>100</card_value>
    <currency>usd</currency>
  </source_details>
  <destination_details>
    <giftcard_ID>5555566823457899</giftcard_ID>
    <issuer_ID>bestbuy</issuer_ID>
  </destination_details>
  <client_details>
    <client_IP>192.168.23.122</client_IP>
    <client_type>smartphone</client_type>
    <client_model>HTC Hero</client_model>
    <OS>Android 2.2</OS>
    <app_installed_flag>true</app_installed_flag>
  </client_details>
</transfer_request>
```

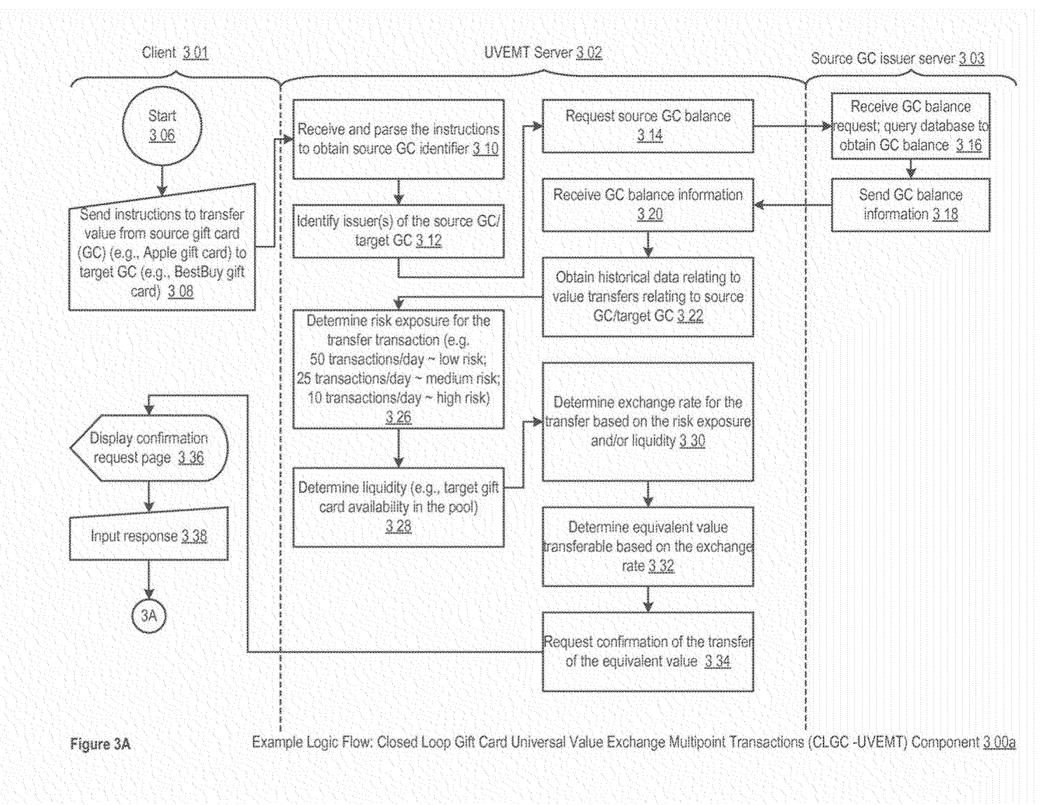

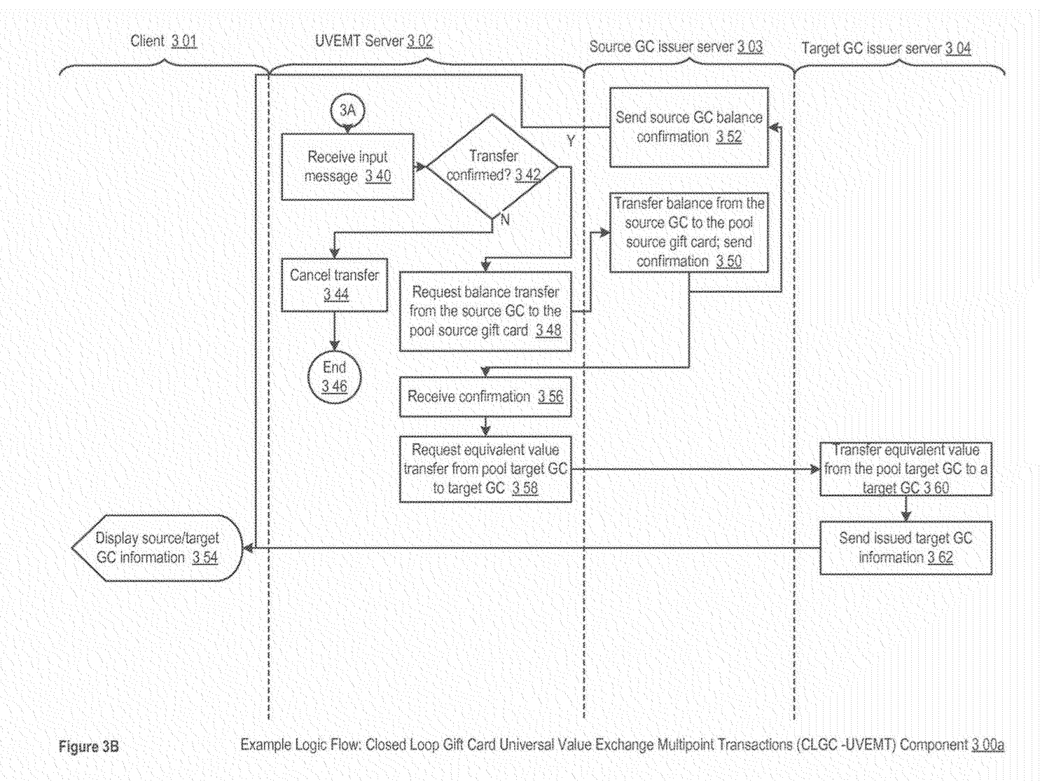

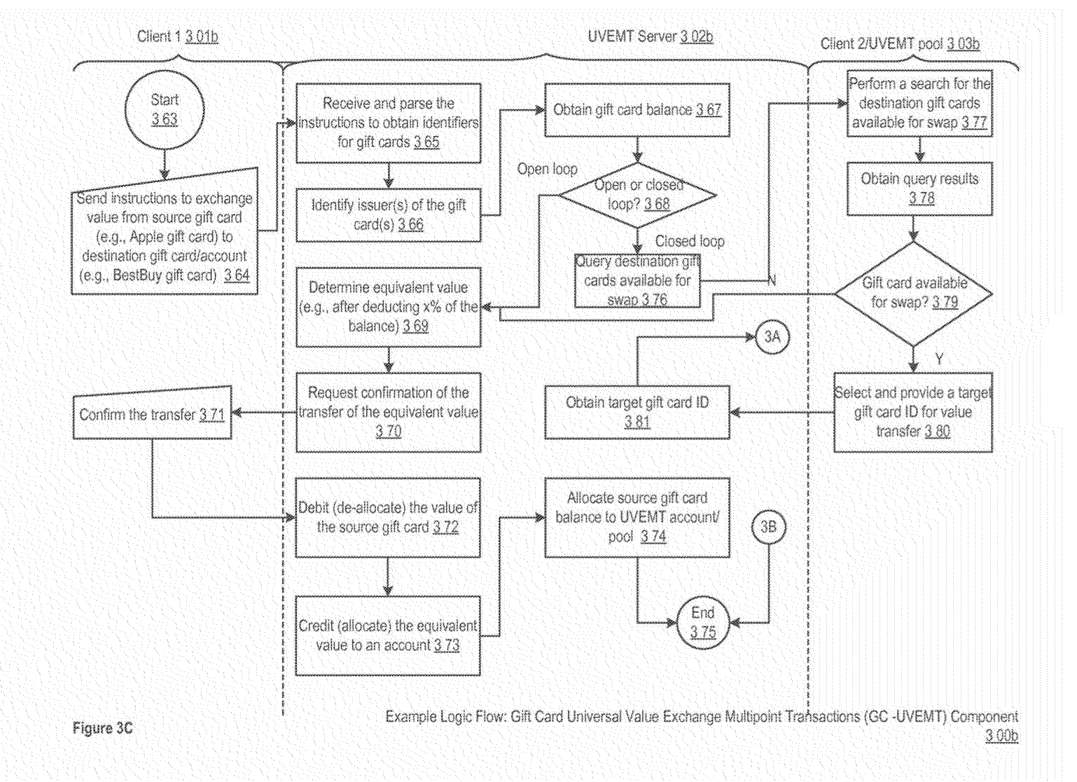

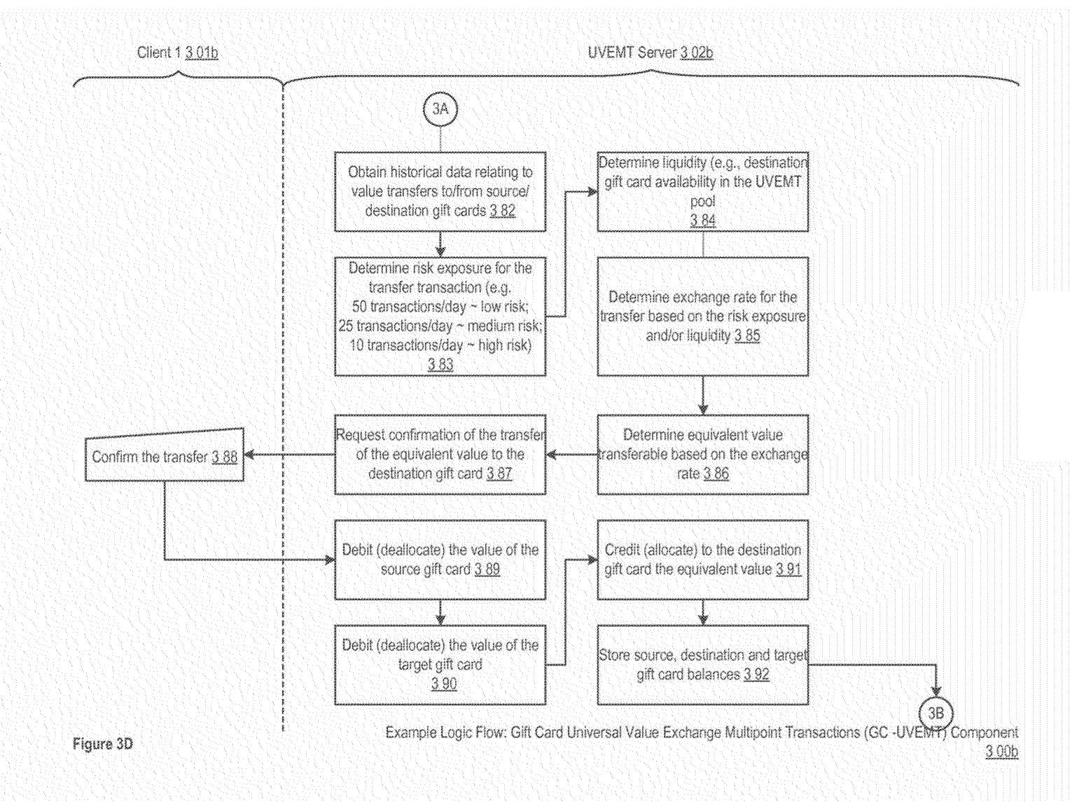

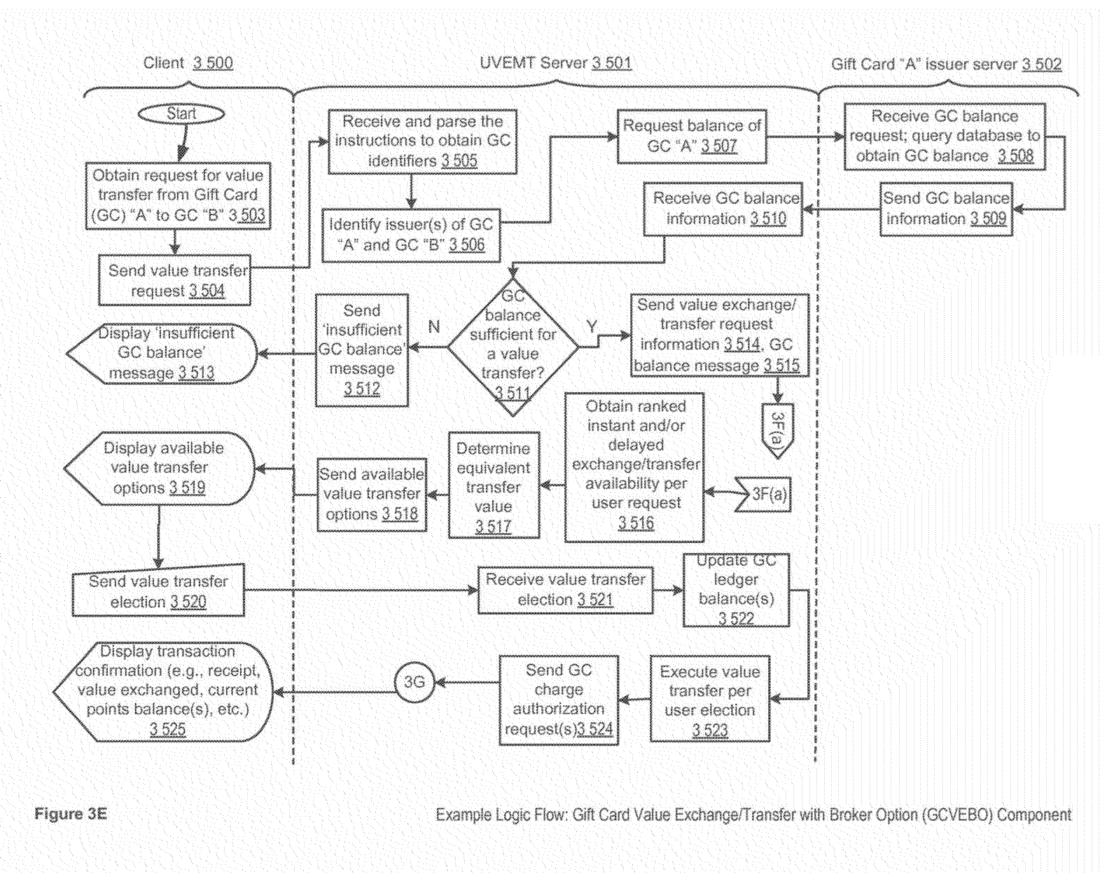

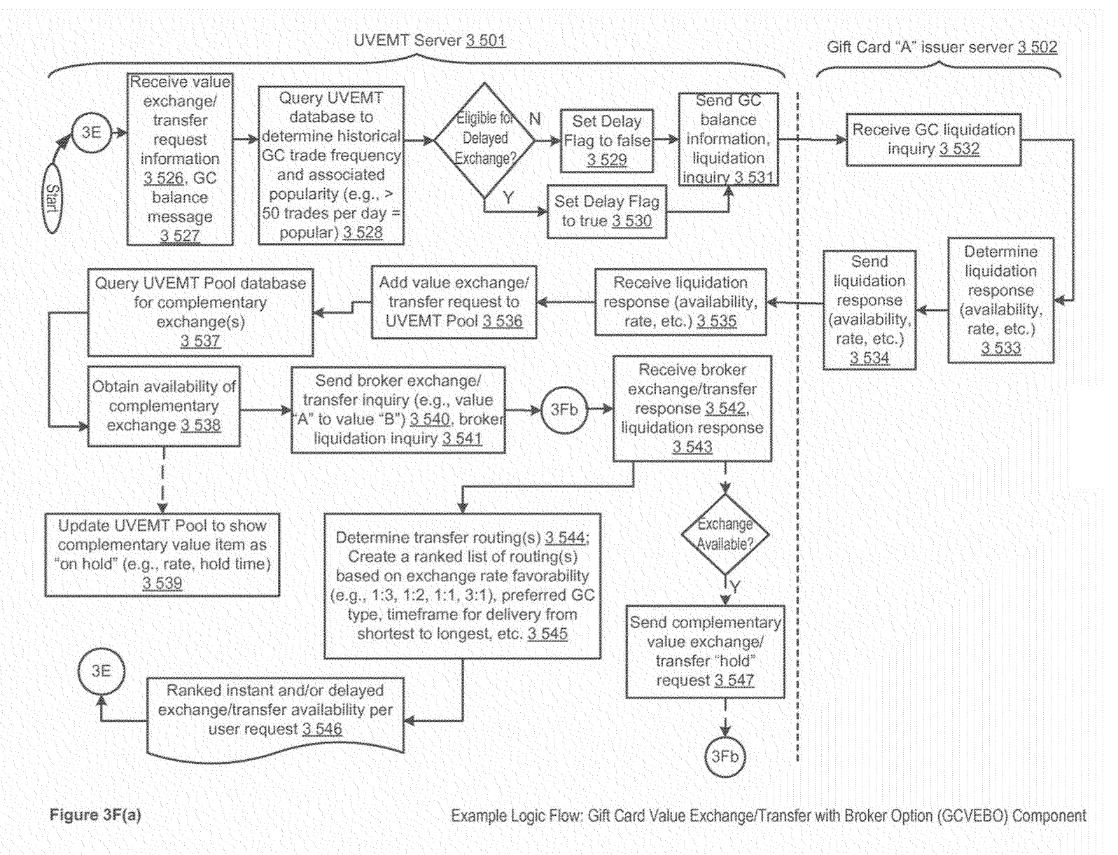

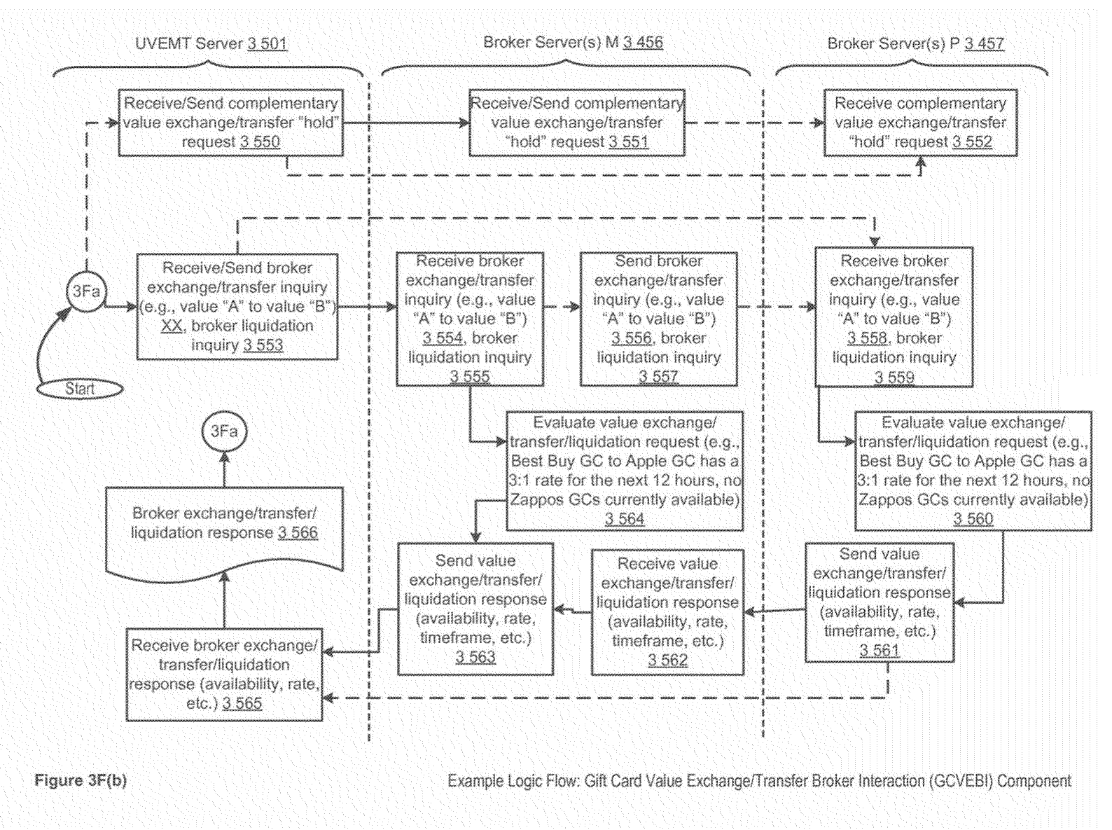

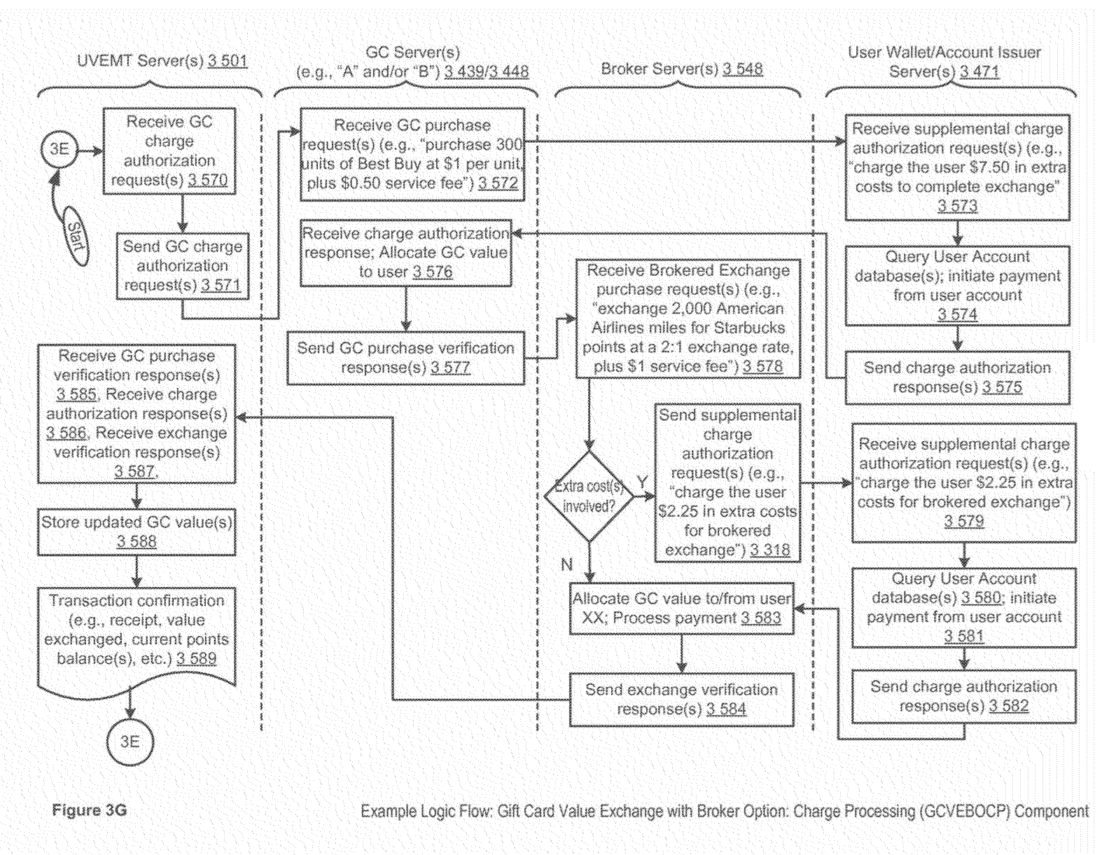

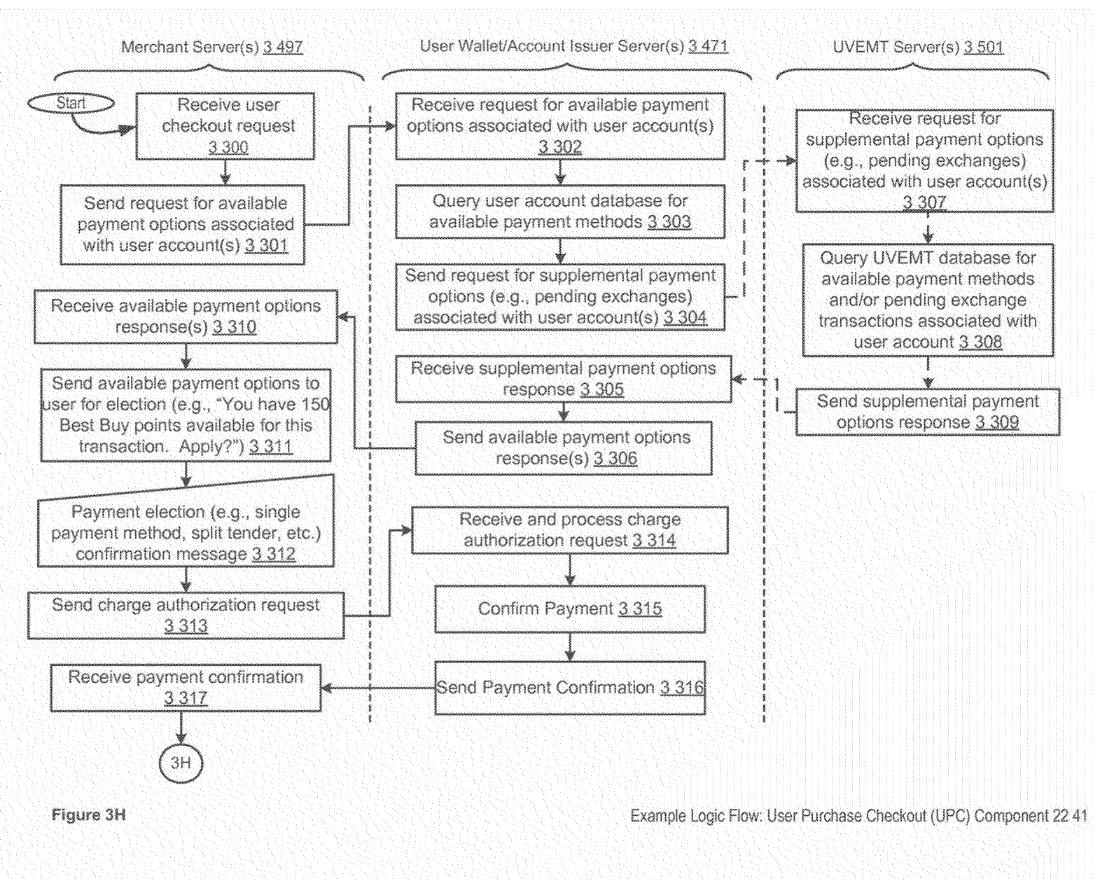

The UVEMT server may receive the transfer request 214 and may extract the details of the transfer request (e.g., XML data). In one implementation, the UVEMT server may identify the issuer of the source gift card 210a and may send a balance request 216 to the issuer of the source gift card 210a. In one implementation, the request 216 may be in the form of a web service/API call. The gift card issuer server may return the balance information message 220 to the UVEMT server. At 222, the UVEMT server may determine equivalent value that the user may obtain after the exchange. Determination of the equivalent value may be based on risk exposure, the details of which are discussed with respect to FIGS. 3A-B.

In one implementation, the UVEMT server may send to the client a request 224 that the user confirm acceptance of the equivalent value. For example, the UVEMT server may provide an HTML page to the client. The client may display, for example, a summary of the transfer request identifying the source and destination gift cards, the equivalent value of the destination gift card, terms and conditions, buttons to accept or cancel the exchange, and/or the like. At 226 the user may confirm acceptance of the equivalent value, which may then be passed on as the confirmation message 228 by the client to the UVEMT server.

In one implementation, the UVEMT may have a number of gift card accounts associated with a number of merchants. For example, the UVEMT may have a gift card account for Apple, Best Buy, Macys, Barneys, and/or the like. These gift card accounts may be referred to as pool gift card accounts. In one implementation, the UVEMT server may send a balance transfer request 230 to the source gift card issuer server 210a. The balance transfer request 230 may include information such as source gift card ID, pool source gift card ID, transfer amount, and/or the like. In one implementation, the pool source gift card ID may correspond to a gift card issued by the source gift card issuer and owned and maintained by the UVEMT (e.g., UVEMT's apple gift card). In one implementation, the source gift card issuer server may transfer the balance from the source gift card (e.g., the user's Apple gift card) to the pool source gift card (e.g., UVEMT's Apple gift card) and may send a confirmation message 232 including the updated pool source gift card balance to the UVEMT server. In one implementation, the source gift card issuer server may send the client the updated source gift card balance 236 confirming the transfer of the source gift card value. In one implementation, the UVEMT server may send a target gift card order 238 to the target gift card issuer. The target gift card order may include a request to transfer the determined equivalent value from the pool target gift card to a target gift card. An example target gift card order 238, substantially in the form of a HTTP(S) POST message including XML-formatted data, is provided below:

```
POST /targetorder.php HTTP/1.1
Host: www.merchant.com/order
Content-Type: Application/XML
Content-Length: 484
<?XML version = “1.0” encoding = “UTF-8”?>
<giftcard_order>
    <source_card_ID>2345678745674589</source_card_ID>
    <target_card_ID>3486549865445678</target_card_ID>
    <timestamp>yyyy-mm-dd hh:mm:ss</timestamp>
    <user_ID>UVEMT_order@visa.UVEMT.com</user_ID>
    <target_card_value>100</target_card_value>
    <password>UVEMTgiftcardpasssword</password>
    <delivery_email>jdoe@gmail.com</delivery_email>
    <delivery_message>standard</delivery_message>
</giftcard_order>
```

The target gift card issuer server may then issue a target gift card having the equivalent value to the user. The target gift card issuer server may send the client the target gift card issue message 240. In one implementation, the target gift card issue message 240 may include the target gift card ID which the user may obtain electronically and utilize for purchase with the merchant associated with the target gift card. An example target gift card issue message 240 formatted in XML is provided below:

```
<target_gift_card>
    <target_card_ID>3486549865</target_card_ID>
    <timestamp>yyyy-mm-dd hh:mm:ss</timestamp>
    <target_card_value>100</target_card_value>
    <activation_status>activated</activation_status>
    <delivery_email>jdoe@gmail.com</delivery_email>
    <delivery_message>Thank you for ... </delivery_message>
</target_gift_card>
```

At 242, the UVEMT server may store updated pool source gift card balance (e.g., previous balance incremented by the value of the source gift card) and the updated pool target gift card balance (e.g., previous value decremented by the equivalent amount). In some embodiments of the UVEMT, when the balance in any one of the pool gift cards exceeds a threshold, the UVEMT may initiate a sell off. In one implementation, the sell off may involve issuing gift cards and selling them at a discount. For example, the UVEMT may accumulate over time an excess balance of $10000 in one or more merchant gift card accounts. The UVEMT may then issue (e.g., via the gift card issuer) 100 gift cards each worth $100. The UVEMT may then sell each gift card at a discount to users to collect some revenue. The UVEMT may aggregate such excess balances over time by apportioning value from records in the UVEMT database, e.g., value card 2219u. For example, when source and destination field values in the value card table record reach $0 and yet there is residual value left on the card, that residual value may be used to generate such excess balances for the UVEMT. In one example, the UVEMT may observe consumers making purchases with merchants accepting such value; e.g., the UVEMT may be made part of a payment network which may parse PAN/account identifiers and compare such account identifiers embedded in transaction request/authentication with records in the UVEMT database, e.g., users 2219a, accounts 2219g, etc., tables. In those instances, the UVEMT may take a credit and use its points/value equivalence to pay for the consumer's purchase and take direct charge from the consumer's payment source for that value. In one embodiment the user would not be aware that the purchase was made using the pool points equivalence. In an alternative embodiment, the UVEMT would show up on the consumer's bills as the merchant taking the charge for the value of the item. In yet another embodiment, the user may be offered a discount on the item (e.g., the consumer would be charged 10% less from their payment source while the merchant would receive full value in point equivalence supplied by the UVEMT), thereby providing a liquidation method for the UVEMT to obtain currency exchange for its pool points/currency.

FIGS. 3A-B show logic flow diagrams illustrating closed loop gift card value exchange embodiments of the UVEMT. The closed loop gift card value exchange may begin at 306. At 308, client 301 may send instructions to transfer value from source gift card to a target gift card. The instructions may identify the source gift card and the target gift card. For example, the source/target gift card number may be included in the instructions. The instructions may be received by UVEMT server 302. The UVEMT server may parse the instructions to obtain identifiers of the gift cards at 310. The UVEMT server may further identify the issuers of the gift cards at 312. At 314, the UVEMT server may request the source gift card issuer server 303 to provide the balance in the source gift card. At 316, the source gift card server may receive the request and may query one or more tables and/or databases to obtain the source gift card balance. The source gift card issuer server may provide the requested balance summary to the UVEMT server at 318. The UVEMT server may receive the balance information at 320 and may obtain historical data relating to the source/target gift card value transfer at 322. In one implementation, the historical data may be obtained by querying one or more tables and/or databases using the source gift card ID and/or target gift card ID. At 326, the UVEMT server may use the historical data to determine risk exposure for the exchange transaction in question. In one implementation, for example, the risk exposure determination may be based on rate of source/target gift card transactions and predefined risk thresholds. Table 1 below shows example risk thresholds, risk exposure and risk exposure weights for gift card exchange transactions.

TABLE 1

| Thresholds | | Risk Exposure |
|---|---|---|
| [Transactions/Day] | Risk Exposure | Weight |
| 100 | Minimal risk | 0.9 |
| 50 | Low risk | 0.8 |
| 25 | Medium risk | 0.6 |
| 10 | High risk | 0.3 |
| 5 | Unacceptable risk | 0 |

In some implementations, at 328, the UVEMT server may determine liquidity of the source/target gift cards. For example, the UVEMT may query one or more databases and/or tables to determine the balance in the pool target gift card, and the approximate number of target gift cards the balance may support. In one implementation, the UVEMT may use the source/target transaction rate and the number of target gift cards in the UVEMT pool to calculate a liquidity ratio. In a further implementation, a liquidity ratio greater than 1 may be indicative of high liquidity, while a ratio less than 1 may indicate low liquidity. At 330, based on the risk exposure and/or the liquidity, the UVEMT may determine an exchange rate for the source/target gift card exchange. For example, when the liquidity ratio is greater than or equal to 1, the risk exposure weight may be equivalent to the exchange rate. When the liquidity ratio is less than 1, a product of the risk exposure weight and liquidity ratio may determine the exchange rate. In some implementations, the calculation of the liquidity ratio may be optional such that the risk exposure weight alone may determine the exchange rate.

Exchange−Rate=Weight_{RISK-EXPOSURE} when liquidity≧18 (1)

Exchange−Rate=Weight_{RISK-EXPOSURE}×liquidity when liquidity<1 (2)

Upon determining the exchange rate, the UVEMT may determine the equivalent value that client would receive in the form of a target gift card at 332. For example, with a source gift card valued at $100, and an exchange rate at 0.8, the target gift card may have an equivalent value of $80. At 334, the UVEMT server may send a request to the client to confirm the transfer of the source gift card value to the equivalent value of a target gift card. At 336, the client may receive and display the confirmation request. At 338, the client may receive an input from the user, and may send the input message to the UVEMT server. Referring to FIG. 3B, the UVEMT server may receive the input message from the client at 340, and parse the message to obtain the details. In one implementation, at 342, the UVEMT server may determine if the transfer is confirmed by the user. If the transfer is not confirmed by the user, the transfer is canceled at 344, concluding the process at 346. However, if the transfer is confirmed at 342, the UVEMT server may request the source gift card issuer to transfer balance of the source gift card to the pool source gift card at 348. The source gift card issuer server may receive the transfer request and may transfer the balance as requested at 350. In one embodiment, a web services request that initiates the transfer from one specified card account number to a destination account number may be issued. A web request that may otherwise have been initiated when a user wishes to move value from one account to another may be captured, but instead of using the same user card account as a parameter in the web services call, instead, a UVEMT value card (e.g., value equivalence held in a UVEMT pool) may be used as either a destination or a source account parameter in the web services call, e.g., to effect a transfer balance request 350 or a transfer request 360, respectively. Such web services may vary depending on the service/program.

In one implementation, the source gift card issuer server may also send a confirmation once the balance transfer has occurred. At 356, the UVEMT server may receive the confirmation of the balance transfer. At 358, the UVEMT server may request the target gift card issuer to transfer the equivalent value determined from the pool target gift card to a target gift card. The target gift card issuer may receive the transfer request at 360, and may execute the requested transfer. In one implementation, at 362, upon executing the transfer, the target gift card issuer server may send the issued target gift card having the equivalent value to the client. The client may receive and display the target gift card at 354. In one implementation, the target gift card issuer server may send an email or text message to notify and/or provide the user an electronic target gift card. In another implementation, the issued target gift card may be mailed to the user's physical address. In yet another implementation, the target gift card may pop up in the user's electronic wallet. In one implementation, the source gift card issuer server may also send a source gift card balance confirmation (e.g., $0 balance) to the client at 352.

In one implementation, in the instance where funds cannot be reassigned from a source gift card to a pool gift card, a deallocation of the source gift card in the user's wallet may be effected such that the user may no longer see it or use it or exchange it. The source gift card may be reallocated later to another user wanting a similar exchange as further described with respect to FIGS. 2B, 3A-B. In some embodiments, there may be instances of fraud where although the card is deallocated in the user's wallet, the user may still effect a purchase with the physical card. In one embodiment such fraud may be adjudicated upon discovery of that card no longer being available for a subsequent exchange by another user. In one implementation, a charge can be taken from the user's wallet (e.g., any of the funding accounts) and/or the user may be given warnings or prevented from participating in such exchange programs in future.

FIG. 2B shows a data flow diagram illustrating a second closed loop gift card value exchange embodiment of the UVEMT. Some of the gift cards that users may want to exchange may be of an open loop type. In one implementation, at 250, a user 202b may request value transfer from a source gift card to a destination gift card. The client 204b may receive the user input and may generate a transfer request 252. The transfer request 252 may have similar data structure to that of the transfer request 214 of FIG. 2B. The transfer request 252 may be sent to the UVEMT server 206b. The UVEMT server may receive and parse the request to obtain source gift card issuer ID and source gift card ID. The UVEMT server may send a source gift card balance request 254 to the source gift card issuer server 210b. The source gift card issuer server may look up the balance and may provide the information in a gift card balance message 256 to the UVEMT server. In one implementation, the UVEMT server may send a target gift card query 258 to the UVEMT pool database 217b. In one implementation, the query may return a target gift card response 260. At 262, the UVEMT may determine equivalent transferable value 262. In one implementation, the equivalent value may be the value that is ultimately made available to the user in a target gift card. The UVEMT server may send a request to accept transfer 264 to the client. The client may obtain the request and may render the contents of the request on the client display. The user may provide a response 266 confirming the acceptance. The client may take the user input and generate a confirmation message 268 for transfer to the UVEMT server. Upon receiving the confirmation message 268, the user may execute the transfer request at 270. In one implementation, at 272 the UVEMT server may update database 219b with updated balances of the source gift card, the target gift card and destination gift card. In one implementation, the UVEMT server may provide updated gift card balances 274 to the client such that the user may view the changes in the source and destination gift card balances after the transfer.

In one implementation, when the user 202b makes a purchase using the destination gift card, the UVEMT server may route the charge request 276 to the target gift card issuer server 207b. In addition to other example charge requests and authorizations provided throughout, the following is an example. An example charge request 276, substantially in the form of a HTTP(S) POST message including XML-formatted data, is provided below:

```
POST /chargerequest.php HTTP/1.1
Host: www.targetissuer.com/charge
Content-Type: Application/XML
Content-Length: 484
<?XML version = “1.0” encoding = “UTF-8”?>
<charge_request>
    <gift_card_ID>2345678745674589</gift_card_ID>
    <user_ID>theoriginalowner@gmail.com</user_ID>
  <checkout_request>
    <checkout_ID>4NFU4RG94</checkout_ID>
    <timestamp>2011-02-22 15:22:43</timestamp>
    <purchase_detail>
        <purchase_amount>100</purchase_amount>
        <num_products>5</num_products>
        <product_ID>AE95049324</product_ID>
        <product_ID>MD09808755</product_ID>
        <product_ID>OC12345764</product_ID>
        <product_ID>KE76549043</product_ID>
        <product_ID>SP27674509</product_ID>
    </purchase_detail>
    <PoS_client_detail>
        <client_IP>192.168.23.126</client_IP>
        <client_type>smartphone</client_type>
        <client_model>HTC Hero</client_model>
        <OS>Android 2.2</OS>
        <app_installed_flag>true</app_installed_flag>
    </PoS_client_detail>
  </checkout_request>
</charge_request>
```

The target gift card issuer 210b may receive the charge request and send a charge authorization message 278 to the UVEMT server. In addition to other example charge requests and authorizations provided throughout, the following is an example. An example authorization message 278, substantially in the form of a HTTP(S) POST message including XML-formatted data, is provided below:

```
POST /chargeauthorize.php HTTP/1.1
Host: www.visa.com/UVEMT/auth
Content-Type: Application/XML
Content-Length: 484
<?XML version = “1.0” encoding = “UTF-8”?>
<auth>
    <gift_card_ID>2345678745674589</gift_card_ID>
    <user_ID>theoriginalowner@gmail.com</user_ID>
    <status>approved</status>
    <balance>0</balance>
    <checkout_ID>4NFU4RG94</checkout_ID>
    <timestamp>2011-02-22 15:22:43</timestamp>
</auth>
```

The UVEMT server may then update the destination gift card balance at 280.

FIG. 2C shows a data flow diagram illustrating an open loop gift card value exchange embodiment of the UVEMT. In one implementation, a user 202c may request open loop gift card value transfer at 281. The client 204c may receive the input and may generate a transfer request 282 to the server 206c. An example transfer request 282, substantially in the form of a HTTP(S) POST message including XML-formatted data, is provided below:

```
POST /transferrequest.php HTTP/1.1
Host: www.visa.com/UVEMT
Content-Type: Application/XML
Content-Length: 484
<?XML version = “1.0” encoding = “UTF-8”?>
<transfer_request>
  <account_access_details>
    <user_details1>
        <user_ID>jdoe@gmail.com</user_ID>
        <password>password</password>
        <user_current_stake>100</user_current_stake>
    </user_details1>
    <user_details2>
        <user_ID>jdoe@gmail.com</user_ID>
        <password>password</password>
        <user_current_stake>50</user_current_stake>
    </UVEMT_details>
        <user_ID>UVEMT@UVEMT.com</user_ID>
        <user_current_stake>50</user_current_stake>
    </UVEMT_details>
  </account_access_details>
    <gift_card_ID>2345678745674589</gift_card_ID>
    <card_issuer>xyz</card_issuer>
    <balance>200</balance>
    <transfer_amount>200</transfer_amount>
    <destination_currency>UVEMT points</destination_currency>
    <timestamp>2011-02-22 15:22:43</timestamp>
  <client_details>
    <client_IP>192.168.23.122</client_IP>
    <client_type>smartphone</client_type>
    <client_model>HTC Hero</client_model>
    <OS>Android 2.2</OS>
    <app_installed_flag>true</app_installed_flag>
  </client_details>
</transfer_request>
```

The UVEMT server may then send a gift card balance request 283 to the gift card issuer server 208c to obtain the current gift card balance. The gift card issuer server may look up the gift card balance information using gift card ID in the request 283. The gift card issuer server may then provide the gift card balance message 284 to the UVEMT server. At 285, the UVEMT server may determine the equivalent transferable value (e.g., using process outlined in FIG. 3D). The UVEMT server may send a request 286 to the client to request acceptance of the equivalent value determined at 285. The client may receive and display the request to the user. At 287, the user may confirm acceptance of the equivalent value. The client may then generate a confirmation message 288 and send the message to the UVEMT server. At 289, the UVEMT server may liquidate the gift card to an equivalent value (e.g., cash, UVEMT points, etc.). In one implementation, the user may designate the currency into which the gift card may be converted. In another implementation, the UVEMT may allow conversion into only certain currencies (e.g. UVEMT points). In one implementation, the equivalent amount may be deposited in an account designated by the user, and may be used by the user when making purchases. In one implementation, the UVEMT server may update a value card table record (e.g., 2219u) to deallocate the user 202c from the gift card once it has been liquidated and an equivalent value has been provided. In one implementation, upon liquidation at 289, the user may be sent the updated gift card balance message 292 notifying that the gift card has been liquidated with no balance remaining in the gift card. In a further implementation, the user may also be notified of the deposit of the equivalent amount in a user designated account, statement credit, cash, and/or the like.

In one implementation, the liquidated gift card may be allocated to another user. In such a situation, the UVEMT server may send a charge request 290, corresponding to the user 202c's (liquidated) gift card on behalf of the new user (and not user 202c) to the gift card issuer 208c.

```
POST /chargerequest.php HTTP/1.1
Host: www.giftcardissuer.com/charge
Content-Type: Application/XML
Content-Length: 484
<?XML version = “1.0” encoding = “UTF-8”?>
<charge_request>
    <gift_card_ID>675678987654</gift_card_ID>
    <user_ID>theoriginalowner@gmail.com</user_ID>
  <checkout_request>
    <checkout_ID>4NFU4RG94</checkout_ID>
    <timestamp>2011-02-22 15:22:43</timestamp>
    <purchase_detail>
        <purchase_amount>100</purchase_amount>
        <num_products>5</num_products>
        <product_ID>AE95049324</product_ID>
        <product_ID>MD09808755</product_ID>
        <product_ID>OC12345764</product_ID>
        <product_ID>KE76549043</product_ID>
        <product_ID>SP27674509</product_ID>
    </purchase_detail>
    <PoS_client_detail>
        <client_IP>192.168.23.126</client_IP>
        <client_type>smartphone</client_type>
        <client_model>HTC Hero</client_model>
        <OS>Android 2.2</OS>
        <app_installed_flag>true</app_installed_flag>
    </PoS_client_detail>
  </checkout_request>
</charge_request>
```

The gift card issuer may receive the charge request. In one implementation, the gift card issuer may look up the balance in the gift card to ensure that the balance in the gift card covers the purchase amount. In a further implementation, the issuer may confirm that the user ID associated with the gift card number matches the user ID to whom the gift card was initially authorized. Upon making payment request validation, the gift card issuer may authorize the charge request and send an authorization message 291 to the UVEMT server. An example authorization message 291, substantially in the form of a HTTP(S) POST message including XML-formatted data, is provided below:

```
POST /chargeauthorize.php HTTP/1.1
Host: www.visa.com/UVEMT/auth
Content-Type: Application/XML
Content-Length: 484
<?XML version = “1.0” encoding = “UTF-8”?>
<auth>
    <gift_card_ID>675678987654</gift_card_ID>
    <user_ID>theoriginalowner@gmail.com</user_ID>
    <status>approved</status>
    <balance>0</balance>
    <checkout_ID>4NFU4RG94</checkout_ID>
    <timestamp>2011-02-22 15:22:43</timestamp>
</auth>
```

Once the purchase is authorized, the gift card balance may be exhausted or decremented. In one implementation, the UVEMT server may update the gift card balance at 293 (e.g., update value card table record 2219u) to indicate the new balance.

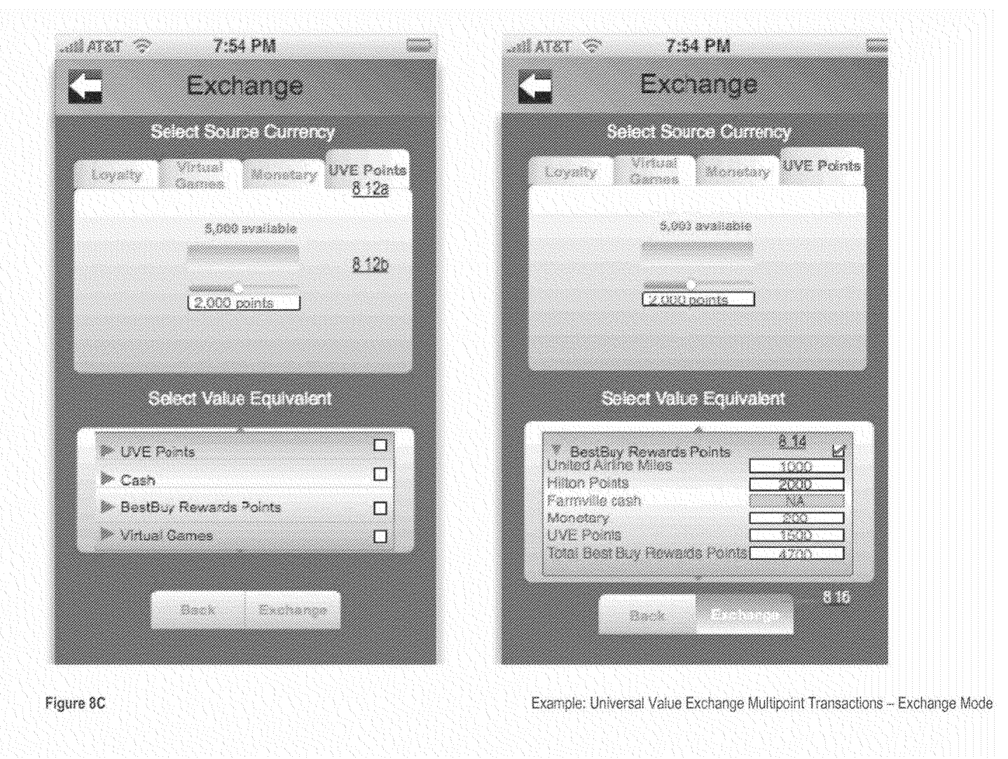

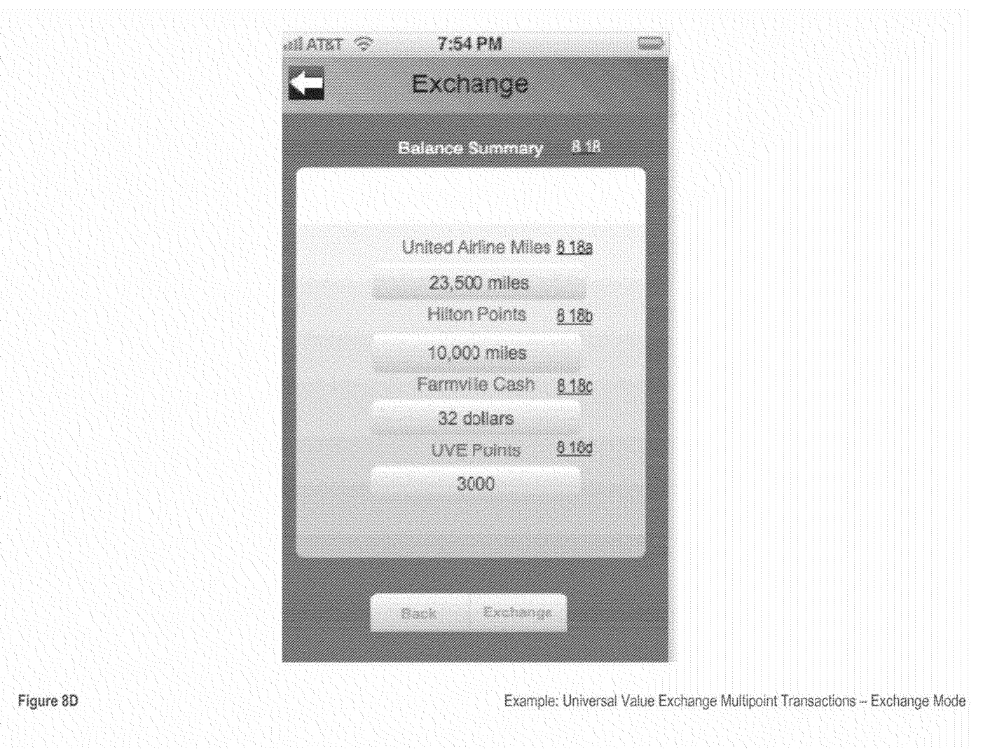

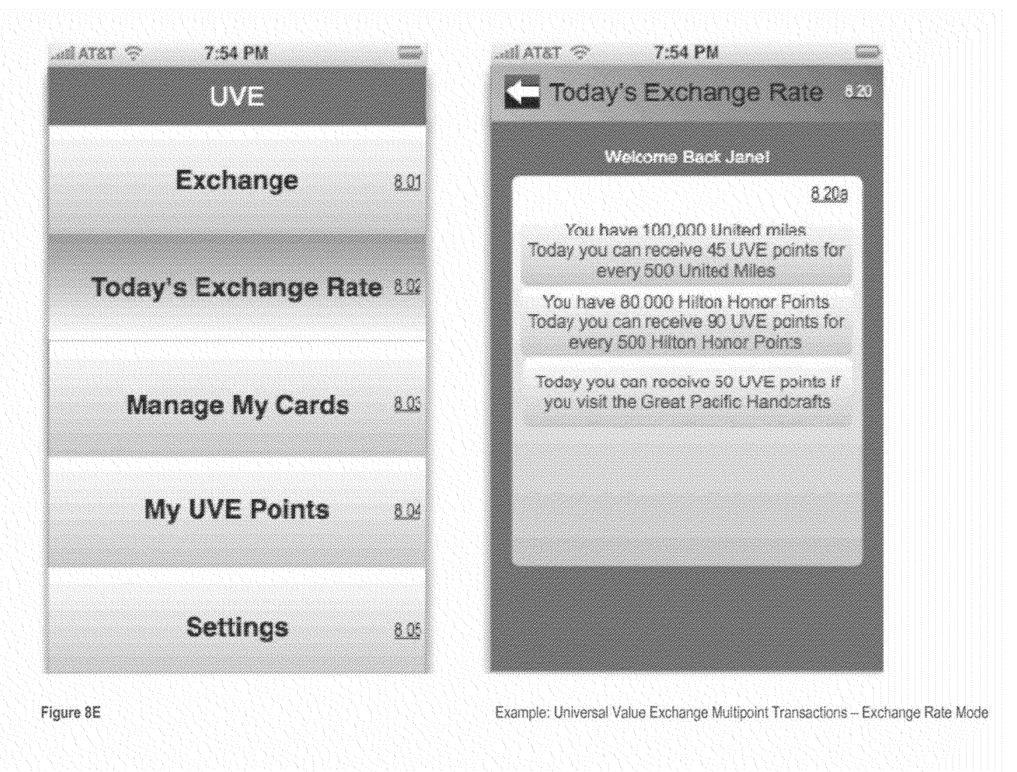

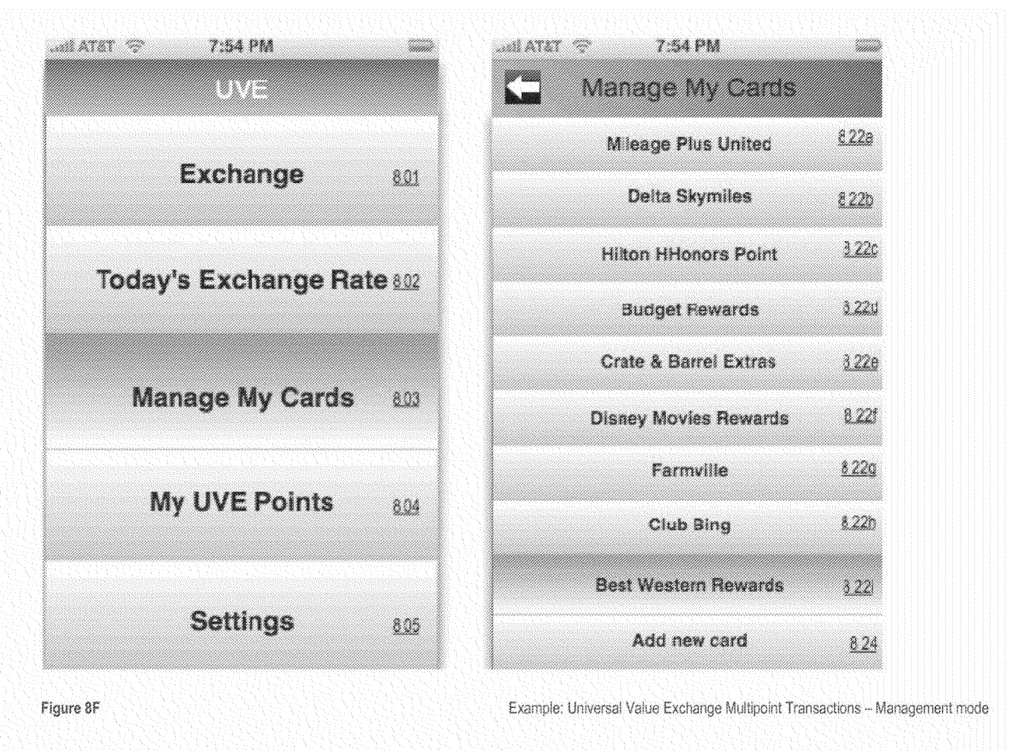

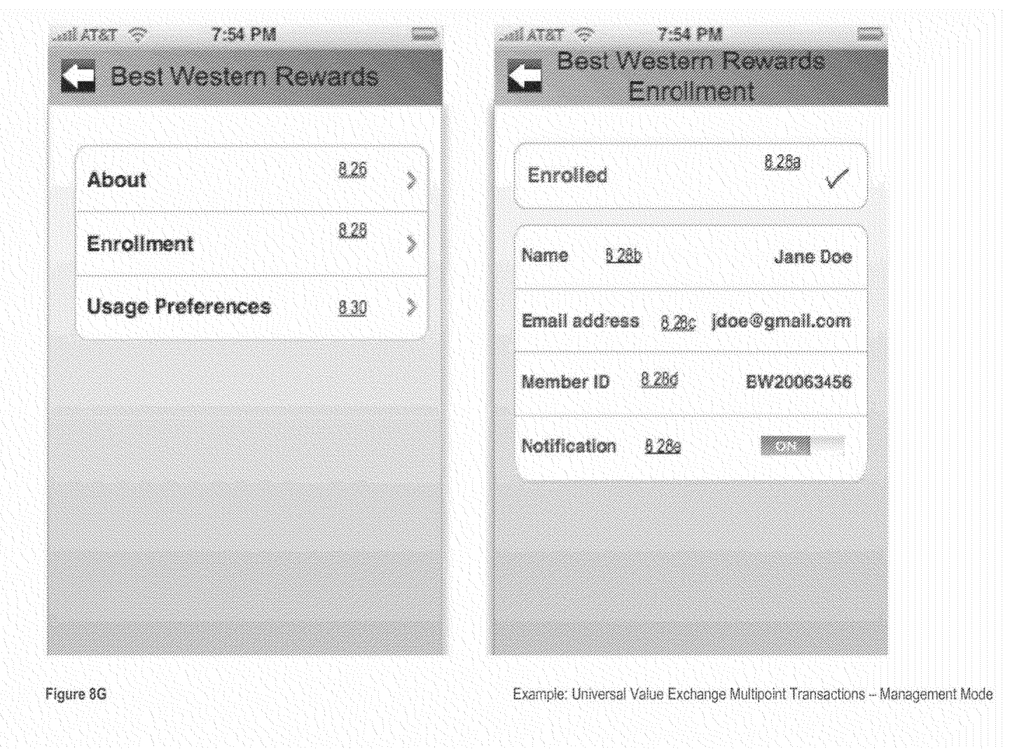

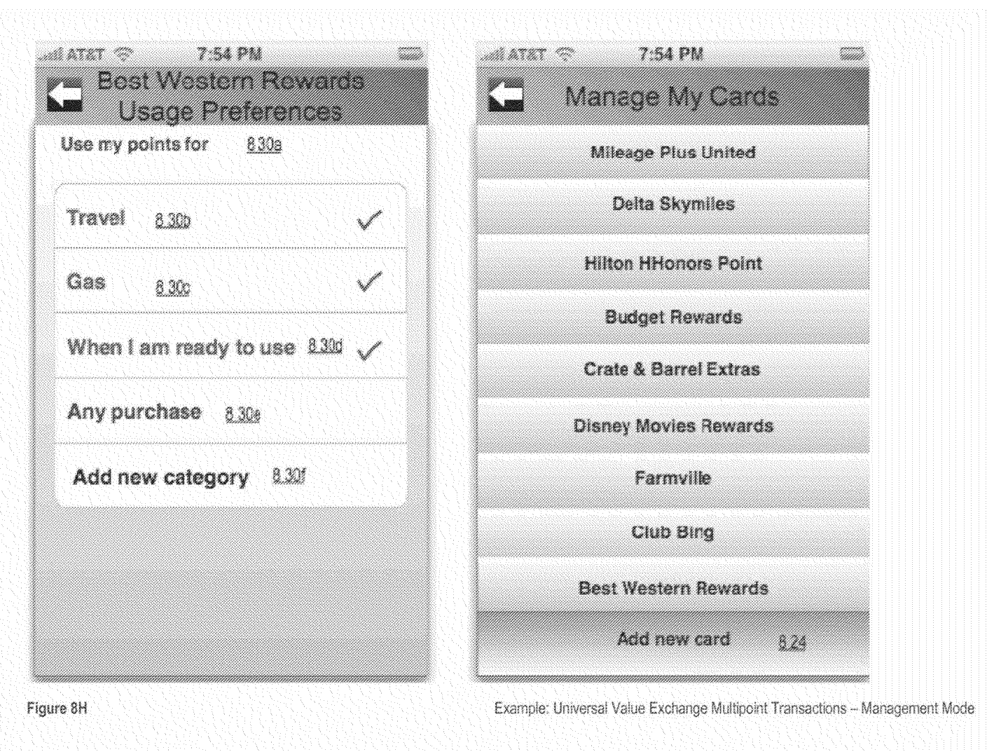

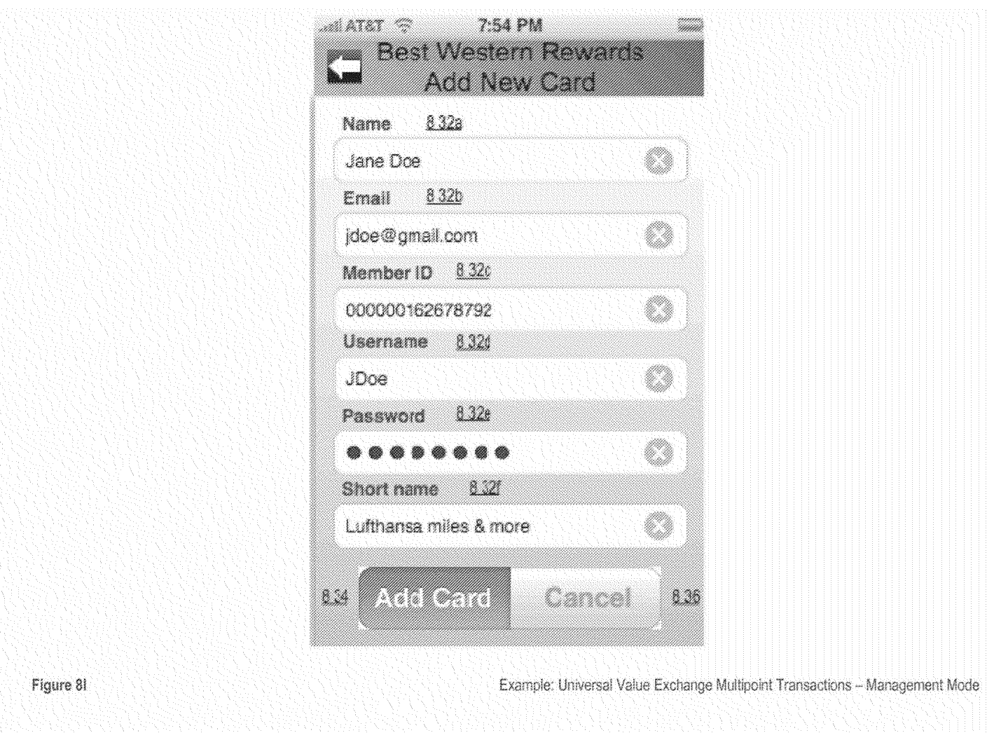

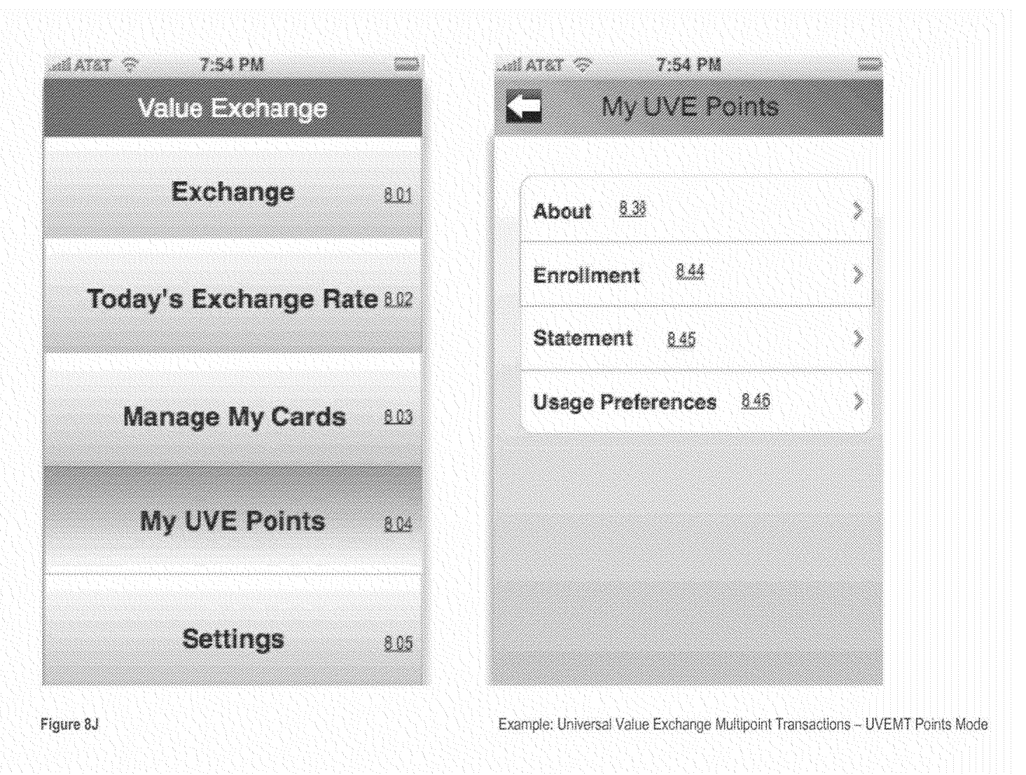

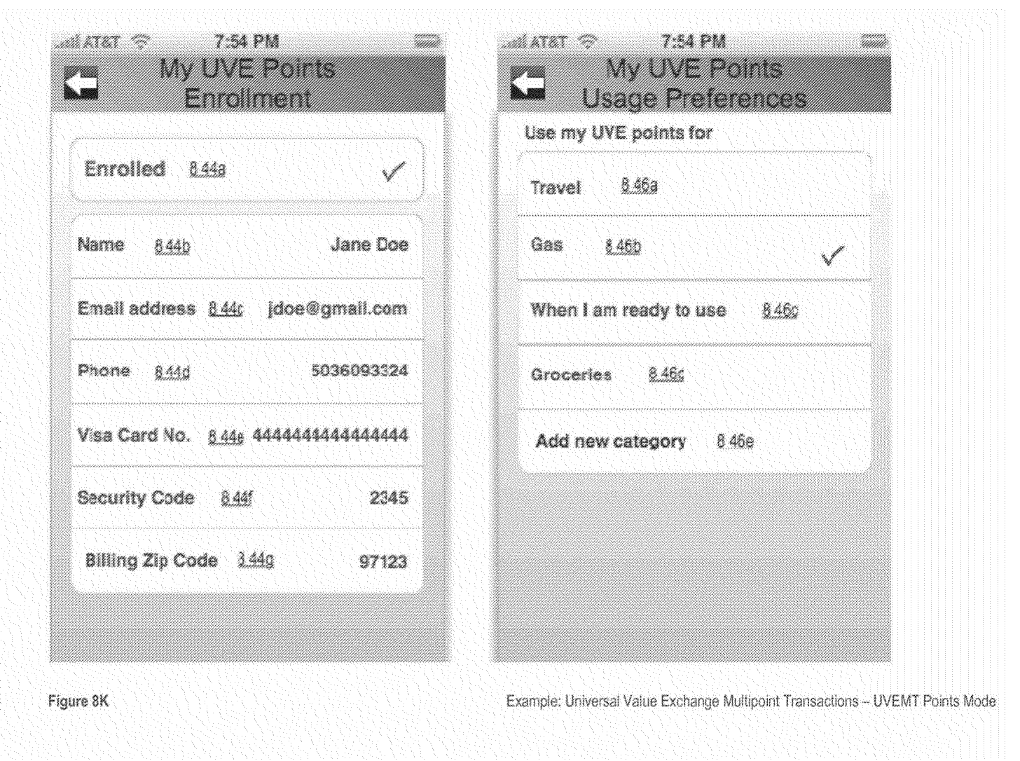

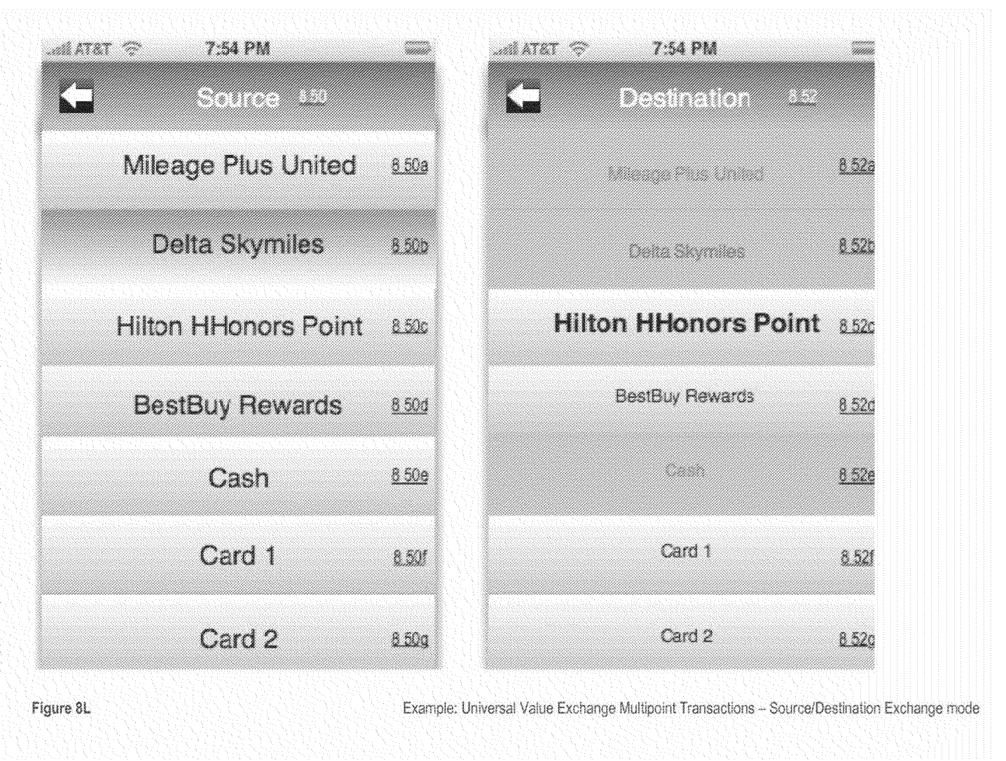

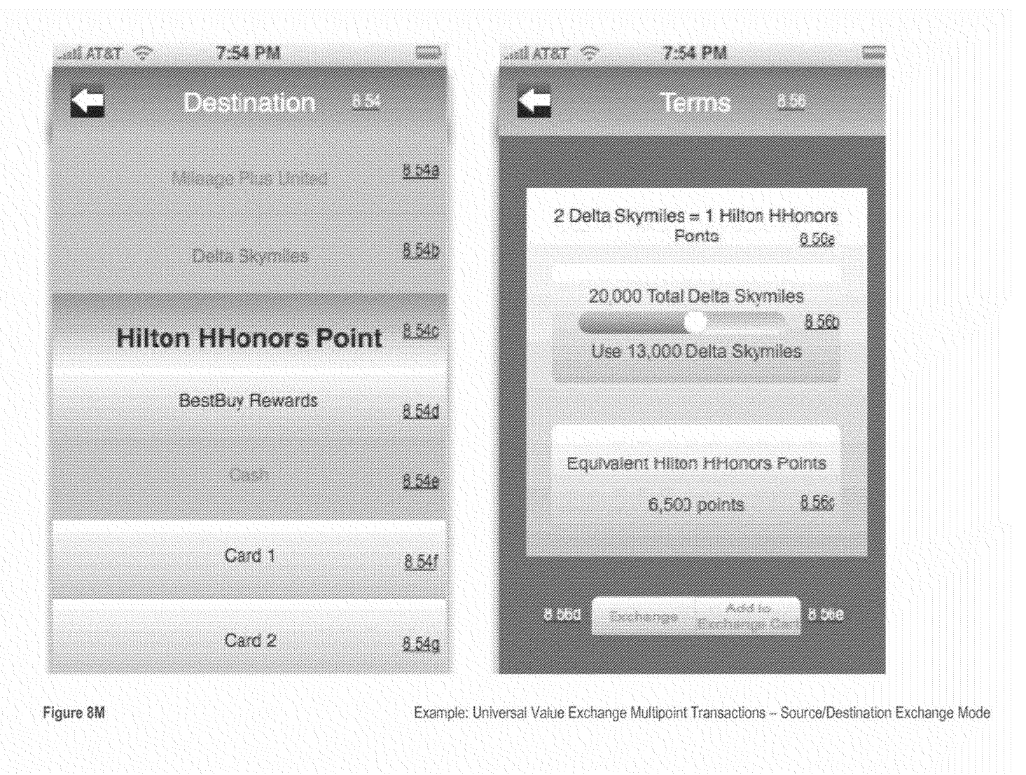

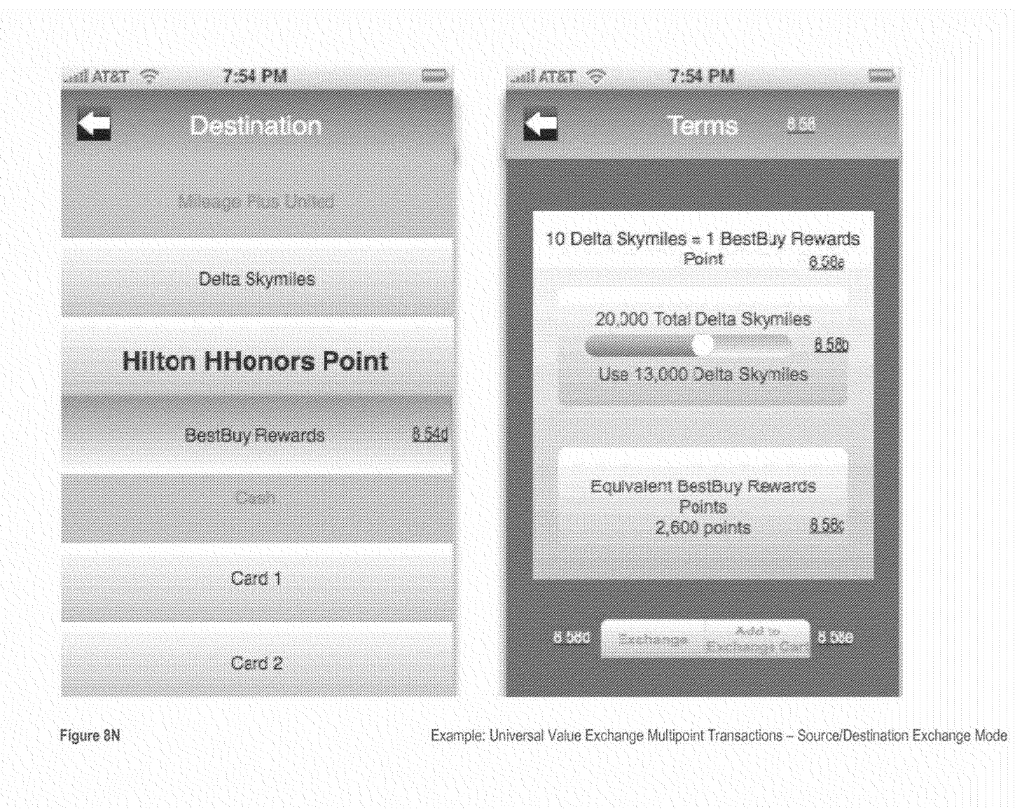

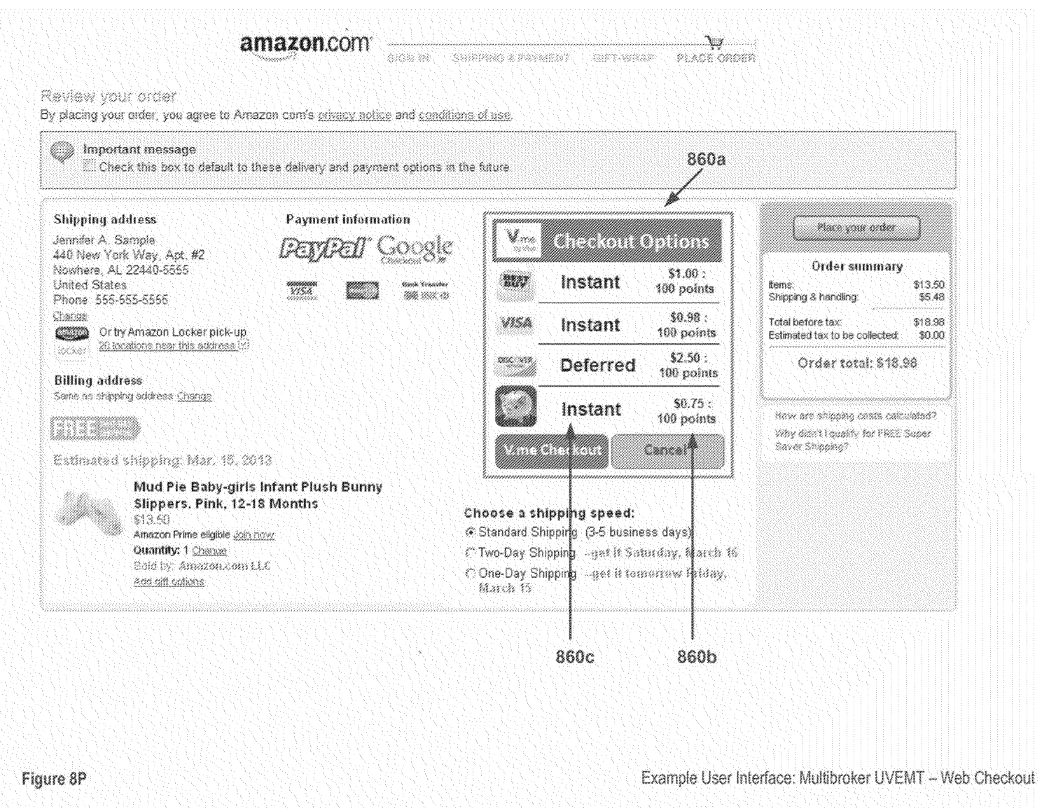

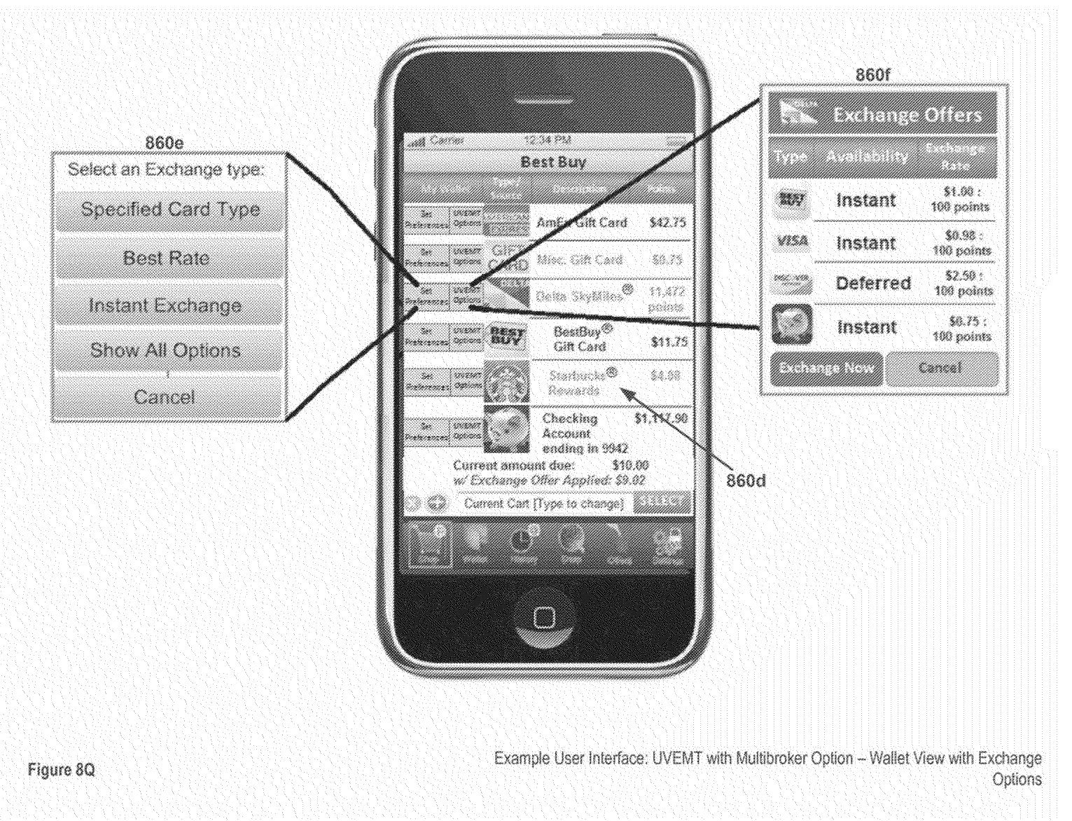

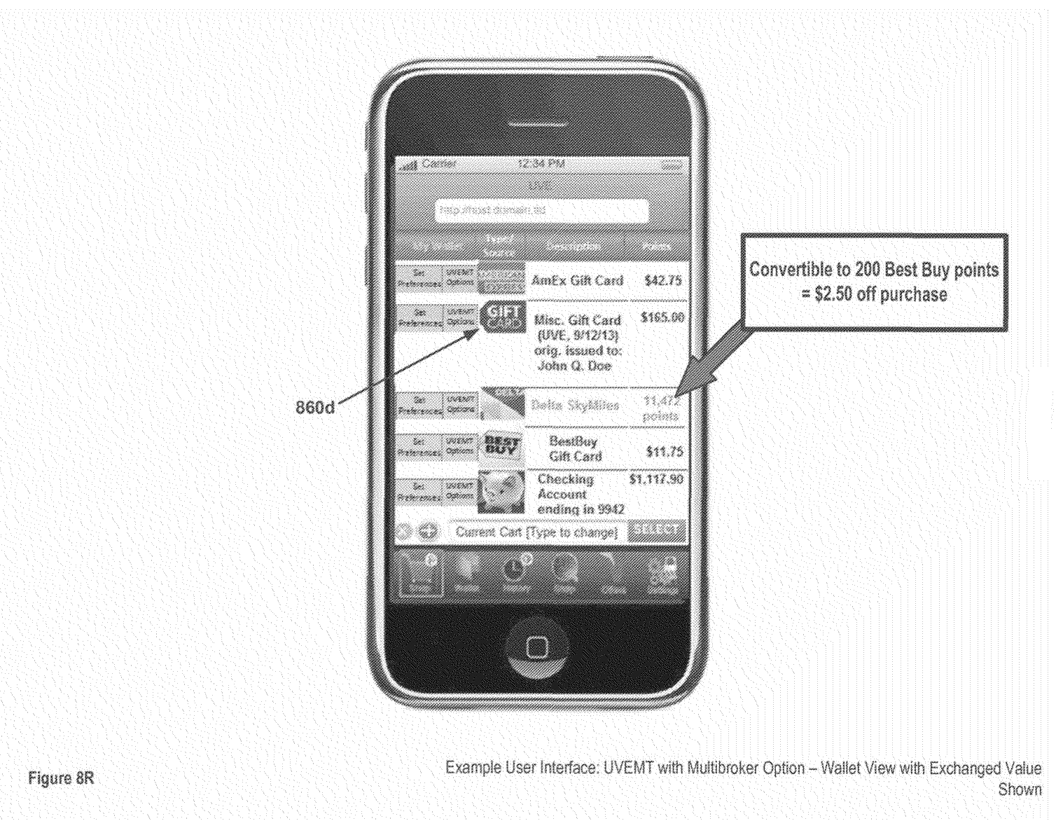

FIGS. 2D-2E(a) show data flow diagrams illustrating gift card value exchange/transfer embodiments of the UVEMT including a broker option. The gift card value exchange/transfer may begin at 2400 (e.g., see FIG. 8Q). At 2400, user 2500 may request value transfer, for example from gift card “A” to gift card “B,” using the interface shown in FIG. 8Q. The client 2454 may receive the input and may generate a transfer request 2401 to the UVEMT server 2437. Transfer request 2401, in some embodiments, may specify criteria for the exchange, for example that the UVEMT only return value types which qualify to be applied to a pending transaction. In some embodiments, gift card “B” may be automatically selected by the UVEMT according to its applicability to a pending transaction An example transfer request 2401, substantially in the form of a HTTP(S) POST message including XML-formatted data, is provided below:

```
POST /transferrequest.php HTTP/1.1
Host: www.visa.com/UVEMT
Content-Type: Application/XML
Content-Length: 484
<?XML version = “1.0” encoding = “UTF-8”?>
<transfer_request>
  <account_access_details>
    <user_details1>
        <user_ID>jdoe@gmail.com</user_ID>
        <password>password</password>
        <user_current_stake>100</user_current_stake>
    </user_details1>
    </UVEMT_details>
        <user_ID>UVEMT@UVEMT.com</user_ID>
        <user_current_stake>50</user_current_stake>
    </UVEMT_details>
  </account_access_details>
    <gift_card_ID>2345678745674589</gift_card_ID>
    <card_issuer>xyz</card_issuer>
    <balance>200</balance>
    <transfer_amount>200</transfer_amount>
    <merchant_ID>BestBuy</merchant_ID>
    <destination_currency>redeemable_at_merchant_checkout</
destination_currency>
    <timestamp>2013-02-22 15:22:43</timestamp>
  <client_details>
    <client_IP>192.168.23.122</client_IP>
    <client_type>smartphone</client_type>
    <client_model>HTC Hero</client_model>
    <OS>Android 2.2</OS>
    <app_installed_flag>true</app_installed_flag>
  </client_details>
</transfer_request>
```

The UVEMT server 2437 may then send a gift card balance request 2402 to gift card “A” issuer server 2439 in order to obtain the current balance of gift card “A.” In some implementations, an XML-encoded gift card balance request 2402 may take a form similar to the following:

```
POST /gift_card_balance_request.php HTTP/1.1
Host: www.UVEMTproccess.com
Content-Type: Application/XML
Content-Length: 788
<?XML version = “1.0” encoding = “UTF-8”?>
<gift_card_balance_request>
<timestamp>2016-01-01 12:30:00</timestamp>
    <user_details1>
        <user_ID>jdoe@gmail.com</user_ID>
        <password>password</password>
        <user_current_stake>100</user_current_stake>
    </user_details1>
  <gift_card>
    <gc_ID>2345678745674589</gc_ID>
    <action>balance</action>
  </gift_card>
</gift_card_balance_request>
```

Gift card issuer “A” may look up the gift card balance information using the gift card ID provided in transfer request 2401. The gift card issuer server may then provide the gift card balance message 2403 to the UVEMT server. In some implementations, an XML-encoded gift card balance message 2403 may take a form similar to the following:

```
POST /gift_card_balance_message.php HTTP/1.1
Host: www.UVEMTproccess.com
Content-Type: Application/XML
Content-Length: 788
<?XML version = “1.0” encoding = “UTF-8”?>
<gift_card_balance_message>
<timestamp>2016-01-01 12:30:00</timestamp>
  <user_details1>
    <user_ID>jdoe@gmail.com</user_ID>
    <password>password</password>
    <user_current_stake>100</user_current_stake>
  </user_details1>
  <gift_card>
    <gc_ID>2345678745674589</gc_ID>
    <balance>200</balance>
  </gift_card>
</gift_card_balance_message>
```

Another user (2501) may also request a value transfer, for example from gift card “B” to gift card “A” (e.g., via the interface of FIG. 8Q) using client 2455. The client 2455 may receive the input and may generate and send transfer request 2405 to the UVEMT server 2437. The transfer request may be substantially in the form of a HTTP(S) POST message including XML-formatted data as previously described. The UVEMT server 2437 may then send a gift card balance request 2406 to gift card “B” issuer server 2448 in order to obtain the current balance of gift card “B.” Gift card issuer “B” may look up the gift card balance information using the gift card ID provided in transfer request 2405. The gift card issuer server may then provide the gift card balance message 2407 to the UVEMT server.

At 2408, the UVEMT server may determine the available exchange routing(s) for the requested value exchange (e.g., using process outlined in FIG. 2E). At 2409, the UVEMT server may determine equivalent transferable value(s), for example using the process of FIG. 3D. The UVEMT server may send request 2410 to client 2454 requesting one or more elections from among the available exchange route(s) determined at 2408. An example request 2410 to make a transfer election, substantially in the form of a HTTP(S) POST message including XML-formatted data, is provided below (corresponding, by way of example, to FIG. 8Q):

```
POST /transferrequest.php HTTP/1.1
Host: www.visa.com/UVEMT
Content-Type: Application/XML
Content-Length: 484
<?XML version = “1.0” encoding = “UTF-8”?>
<transfer_election_request>
      <value_type_option1>BestBuy Rewards Points
      </value_type_option1>
      <exchange_rate>$1.00:100 points</exchange_rate>
      <availability_type>instant</availability_type>
      <value_type_option1>Visa Rewards points
      </value_type_option1>
      <exchange_rate>$0.98:100 points</exchange_rate>
      <availability_type>instant</availability_type>
      <value_type_option1>Discover Rewards points
      </value_type_option1>
      <exchange_rate>$2.50:100 points</exchange_rate>
      <availability_type>instant</availability_type>
      <value_type_option1>cash</value_type_option1>
      <exchange_rate>$0.75:100 points</exchange_rate>
      <availability_type>instant</availability_type>
      <expiration_period>20 minutes</expiration_period>
      <timestamp>2013-02-22 15:22:43</timestamp>
  <client_details>
      <client_IP>192.168.23.122</client_IP>
      <client_type>smartphone</client_type>
      <client_model>HTC Hero</client_model>
      <OS>Android 2.2</OS>
      <app_installed_flag>true</app_installed_flag>
  </client_details>
</transfer_election_request>
```

The client may receive and display the request for election to the user, for example as shown in FIG. 8Q. At 2411, the user may confirm the equivalent value transfer(s) selected. The client may then generate a confirmation message 2412 and send the message to the UVEMT server. An example confirmation message 2412, substantially in the form of a HTTP(S) POST message including XML-formatted data, is provided below:

```
POST /transferrequest.php HTTP/1.1
Host: www.visa.com/UVEMT
Content-Type: Application/XML
Content-Length: 484
<?XML version = “1.0” encoding = “UTF-8”?>
<confirmation_message>
      <value_type_election>BestBuy Rewards Points
      </value_type_election>
      <transfer_amount>200 points</transfer_amount>
      <timestamp>2013-02-22 15:24:00</timestamp>
  </UVEMT_details>
          <user_ID>UVEMT@UVEMT.com</user_ID>
          <user_current_stake>50</user_current_stake>
  </UVEMT_details>
</transfer_election_request>
```

Similarly, the UVEMT server may send request 2413 to client 2455 requesting one or more elections from among the available exchange route(s) determined at 2408. The client may receive and display the request to the user. At 2414, the user may confirm the equivalent value transfer(s) selected. The client may then generate a confirmation message 2415 and send the message to the UVEMT server.

At 2416, the UVEMT server may execute the transfer request(s) according to the routing(s) selected by user 2500 and/or user 2501. In one implementation, the UVEMT server may determine that complementary exchange requests are pending, for example as stored in UVEMT Pool 2438, and execute a direct swap between the two requesting users. In another implementation, the UVEMT may liquidate gift card “A” to an equivalent value (e.g., cash, UVEMT points, etc.) in order to facilitate the outright purchase of gift card “B.” In another implementation, the UVEMT may use a combination of liquidated value (e.g., cash, UVEMT points, etc.), points, closed-loop card value, and/or the like in the fulfillment of transfer requests (e.g., 2401, 2405). In another implementation, the UVEMT may utilize brokered transactions in the fulfillment of transfer requests (e.g., 2401, 2405), as will be described in greater detail below. In one implementation, the user may designate the currency into which the gift card may be converted. In another implementation, the UVEMT may allow conversion into only certain currencies (e.g. UVEMT points).

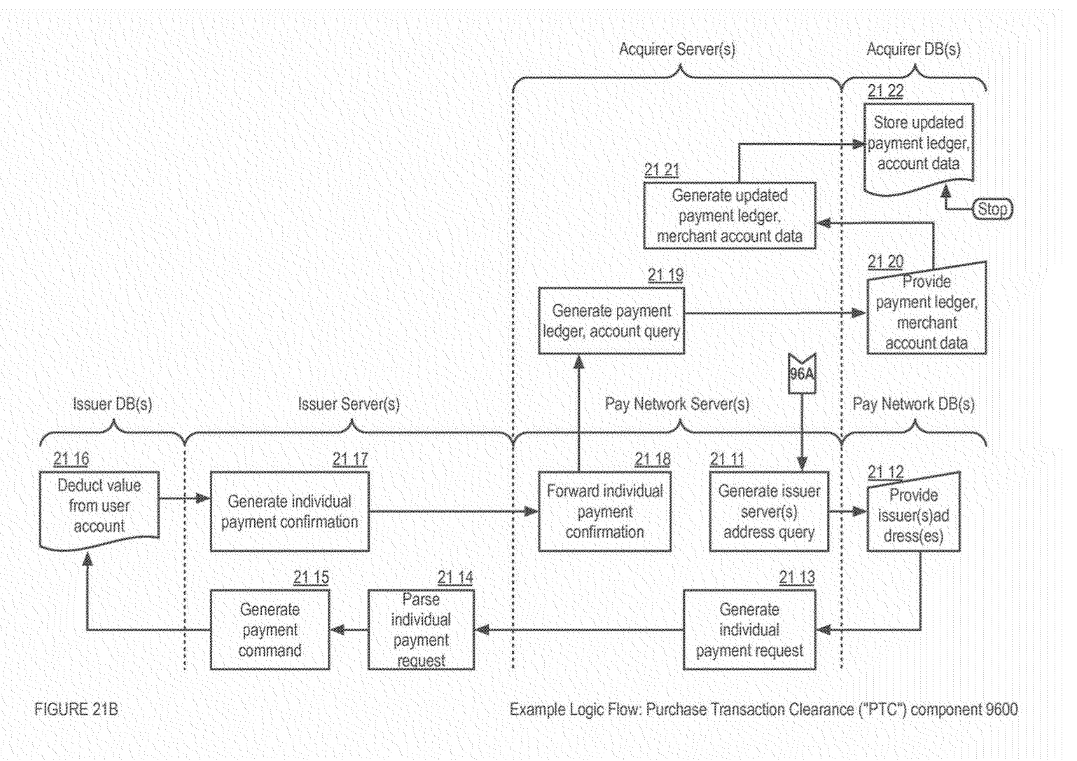

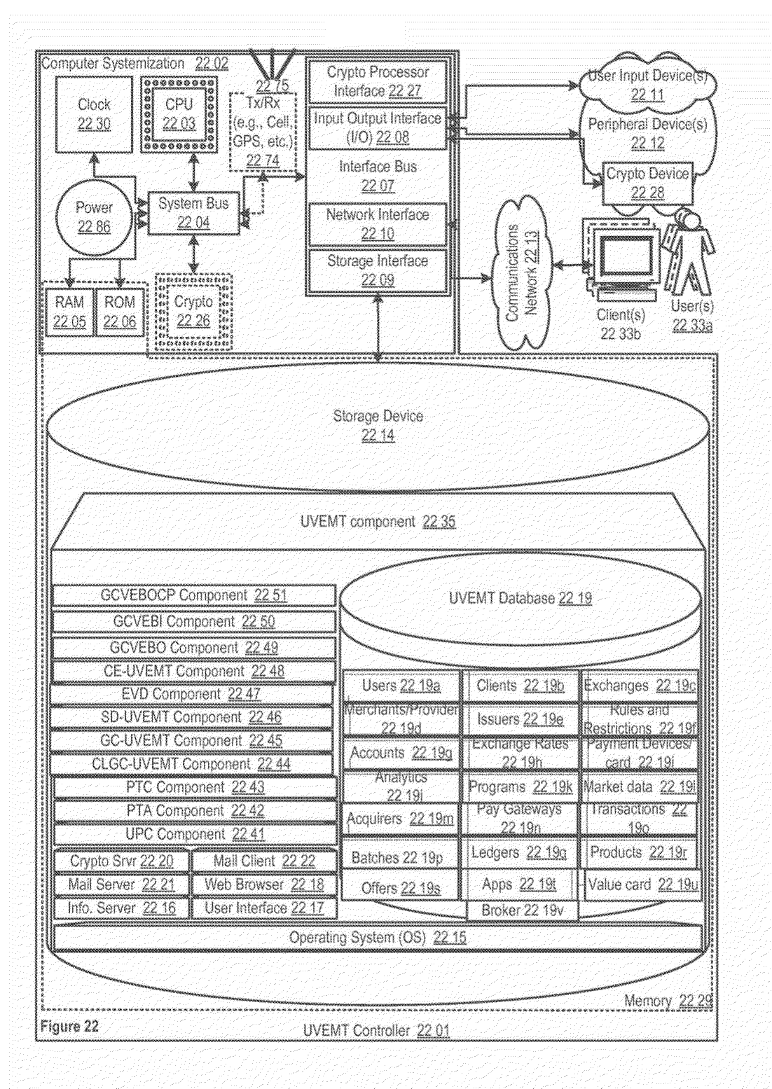

At 2417, the UVEMT server 2437 may perform charge authorizations according to the process illustrated in FIG. 2F, as described in greater detail below. In one implementation, upon authorization of required charge(s), if any, the UVEMT server may update, at 2418, the ledger balances for gift card(s) “A” and/or “B.” For example, the UVEMT server may issue PHP/SQL commands to update entries in a database table for balance data associated with a gift card (such as FIG. 22, Transactions 2219u). An example gift card value update command XXXXX, substantially in the form of PHP/SQL commands, is provided below:

<?PHP
header(‘Content-Type: text/plain’);
mysql_connect(″254.92.185.103”,$DBserver,$password); // access
database server
mysql_select(″UVEMT_DB.SQL″); // select database to append
mysql_query(“INSERT INTO TransactionsTable
(value_card_ID, value_amount, tracking_equivalent_amount,
source_user_ID, destination_user_ID,
current_user_ID)
VALUES ($value_card_ID, $value_amount,
$tracking_equivalent_amount, $source_user_ID,
$destination_user_ID, $current_user_ID)”); // add data to
table in database
mysql_close(″UVEMT_DB.SQL″); // close connection to database
?>

At 2419, the UVEMT server may provide an updated balance message 2419 to client 2454. In one implementation, the updated balance message 2419 may include the executed exchange rate, time/date information, current value of gift card “B,” and/or the like. Similarly, at 2415, the UVEMT server may provide an updated balance message 2420 to client 2455. In one implementation, the updated balance message 2420 may include the executed exchange rate, time/date information, current value of gift card “A,” and/or the like. Upon redemption of the value(s) stored on UVEMT-exchanged gift cards, the UVEMT server may issue PHP/SQL commands to update entries in a database table for balance data associated with said gift card (such as FIG. 22, Transactions 2219u), for example as described above.

FIG. 2E(a) shows a data flow diagram illustrating additional detail of the determination of exchange routing(s) in some embodiments of the UVEMT. In one embodiment, e.g. at 2421, the UVEMT server may receive value transfer request information 2100, gift card balance information 2421 (e.g., as contained within balance messages 2403 and 2407), and/or the like. In some implementations, an XML-encoded message containing the value transfer request at 2421 may take a form similar to the following:

```
POST /value_transfer_request_information.php HTTP/1.1
Host: www.UVEMTproccess.com
Content-Type: Application/XML
Content-Length: 788
<?XML version = “1.0” encoding = “UTF-8”?>
<value_transfer_request_information>
<timestamp>2016-01-01 12:30:00</timestamp>
      <user_details1>
          <user_ID>jdoe@gmail.com</user_ID>
          <password>password</password>
          <user_current_stake>100</user_current_stake>
      </user_details1>
      <exchange_request>
      <gift_card_ID>2642573289441672</gift_card_ID>
      <request_type>value_exchange</request_type>
      <incoming_value_type>Delta SkyMiles</incoming_value_type>
      <incoming_value_amount>11,472 points
      </incoming_value_amount>
      <desired_value_type>Best Buy</desired_value_type>
      <option_desired_value_amount>$100.00
      </option_desired_value_amount>
      <wait_time>30 seconds</wait time>
      <owner_ID>John Q. Doe</owner ID>
      <timestamp>2013-02-22 15:24:00</timestamp>
      <owner_verification>Sam Smith 2215</owner verification>
      </exchange_request>
      </gift_card_balance>
      <value_transfer_info>
      </value_transfer_info>
</value_transfer_request_information>
```

The UVEMT server may compute a popularity score 2422 for the gift card(s) associated with the request, and may also determine an eligibility for delayed exchange 2423 associated with the value exchange request. At 2124, the UVEMT server may add value transfer request information 2100 to the UVEMT Pool 2438 database, for example so that it can be made available for matching up with other incoming and/or pending UVEMT exchange requests. In one implementation, the UVEMT server or, optionally, an intermediary server, may send a complementary exchange request query 2425 to the UVEMT Pool database, for example to determine whether an instant swap is available from within the pool of pending exchange requests, stored value, and/or the like. For example, the UVEMT server may issue PHP/SQL commands to query a database table for pending UVEMT exchanges (such as FIG. 22, Accounts 2219g) associated with gift card “A” and/or gift card “B.” An example query, substantially in the form of PHP/SQL commands, is provided below:

<?PHP
header(‘Content-Type: text/plain’);
mysql_connect(“254.93.179.112”,$DBserver,$password); // access
database server
mysql_select_db(“UVEMT_DB.SQL”); // select database table to search
//create query
$swap_request = “SELECT value_type, stored_value_amount,
expiration_date_time,
owner_ID, hold_flag FROM AccountsTable WHERE owner_ID LIKE
‘%’ $ownerID”;
//optional set hold flag
$hold_state = “UPDATE AccountsTable SET hold_flag=
’true’WHERE value_type LIKE
‘%’ $value_type”;
$result = mysql_query($query); // perform the search query
mysql_close(“UVEMT_DB.SQL”); // close database access
?>

At 2426, the results of the 2425 query (e.g., available value type(s), timeframe, other available offers, etc.) may be returned to the UVEMT server in the form of a complementary exchange response, for example as illustrated in FIG. 8Q. In some embodiments the UVEMT may place a “hold” at 2427 on one or more available resources in the UVEMT Pool 2438, for example by updating a flag in an entry corresponding to the desired value. In some implementations, an exemplary XML-encoded UVEMT “hold” update message 2427 may take a form similar to the following:

```
POST /UVEMT_hold_message.php HTTP/1.1
Host: www.PSLMproccess.com
Content-Type: Application/XML
Content-Length: 788
<?XML version = “1.0” encoding = “UTF-8”?>
< UVEMT_hold_message >
<timestamp>2016-01-01 12:30:00</timestamp>
  <user_params>
      <user_ID>123456789</user_ID>
      <user_password>********</user_password>
      <wallet_ID>A2C4E6G8I</wallet_ID>
    </user_params>
    <UVEMT_hold_params>
      <UVEMT_value_ID>
            ...
      </UVEMT_value_ID>
      <set_delay_flag>true</set_delay_flag>
      <set_hold_time>15 minutes</set_hold_time>
  </UVEMT_hold_params>
</UVEMT_hold_message>
```

In one implementation, the UVEMT server may at 2428 send a liquidation request to the gift card “A” issuer server 2439. An example liquidation request message 2428, substantially in the form of a HTTP(S) POST message including XML-formatted data, is provided below:

```
POST /transferrequest.php HTTP/1.1
Host: www.visa.com/UVEMT
Content-Type: Application/XML
Content-Length: 484
<?XML version = “1.0” encoding = “UTF-8”?>
<liquidation_request>
      <gift_card_ID>2642573289441672</gift_card_ID>
      <request_type>liquidate to cash</request_type>
      <value_for_liquidation>11,472 Delta SkyMiles
</value_for_liquidation>
      <timestamp>2013-02-22 15:24:00</timestamp>
      <owner_verification>Sam Smith 2215</owner verification>
  <issuer_details>
      <issuer_IP>192.168.23.122</issuer_IP>
      <issuer_name>BestBuy</issuer_name>
      <digital_security_signature> signatureData
      </digital_security
_signature>
  </issuer_details>
</transfer_election_request>
```

In some embodiments, the gift card issuer 2439 may agree to pay a cash equivalent for the value of the gift card being exchanged, e.g. to allow for the purchase of a different type of gift card, direct payment of cash to user 2500, etc. The gift card issuer 2439 may send a liquidation response message 2429 including information such as an exchange quote, availability, rate, timeframe, and/or the like.

In some embodiments, e.g., at 2430 and 2431, the UVEMT server may send an inquiry about complementary exchange options and/or gift card liquidation to broker pool 2440, which may include of a single broker or a collection of multiple brokers, as discussed in greater detail below with respect to FIG. 2F(b). An example broker exchange request message 2430 and/or 2431, substantially in the form of a HTTP(S) POST message including XML-formatted data, is provided below:

```
POST /transferrequest.php HTTP/1.1
Host: www.visa.com/UVEMT
Content-Type: Application/XML
Content-Length: 484
<?XML version = “1.0” encoding = “UTF-8”?>
<exchange_liquidation_request>
    <exchange_request>
      <gift_card_ID>2642573289441672</gift_card_ID>
      <request_type>value_exchange</request_type>
      <incoming_value_type>Delta SkyMiles</incoming_value_type>
      <incoming_value_amount>11,472 points
      </incoming_value_amount>
      <desired_value_type>Best Buy</desired_value_type>
      <option_desired_value_amount>$100.00
      </option_desired_value_amount>
      <wait_time>30 seconds</wait time>
      <owner_ID>John Q. Doe</owner ID>
      <timestamp>2013-02-22 15:24:00</timestamp>
      <owner_verification>Sam Smith 2215</owner verification>
  </exchange_request>
  <liquidation_request>
      <request_type>liquidate to cash</request_type>
      <incoming_value_type>Delta SkyMiles</incoming_value_type>
      <incoming_value_amount>11,472 points
      </incoming_value_amount>
      <desired_value_type>checking acct 2242</desired_value_type>
  </liquidation_request>
  <broker_details>
      <broker_IP>192.168.23.122</broker_IP>
      <broker_name>BestBuy</broker_name>
      <broker_digital_certificate> certificateData </
broker_digital_certificate>
  </broker_details>
</exchange_liquidation_request>
```

The broker pool may provide a response to the inquiry, for example at 2432 and 2433, detailing available exchange rates, value types, liquidation offers, timeframes for deal execution, etc. In some embodiments, the UVEMT may place a “hold” (e.g., at 2434) on one or more available resources in the broker pool 2440. In some implementations, an exemplary XML-encoded UVEMT “hold” update message 2434 may take a form similar to the following:

```
POST /UVEMT_hold_message.php HTTP/1.1
Host: www.PSLMproccess.com
Content-Type: Application/XML
Content-Length: 788
<?XML version = “1.0” encoding = “UTF-8”?>
<broker_hold_message>
<timestamp>2016-01-01 12:30:00</timestamp>
    <user_params>
      <user_ID>123456789</user_ID>
      <user_password>********</user_password>
      <wallet_ID>A2C4E6G8I</wallet_ID>
    </user_params>
    <broker_hold_params>
      <broker_value_ID>
          ...
      </broker_value_ID>
      <set_delay_flag>true</set_delay_flag>
      <set_hold_time>15 minutes</set_hold_time>
  </broker_hold_params>
</broker_hold_message>
```

The UVEMT may, in some embodiments, determine the various available exchange routes made known through querying the UVEMT Pool 2438 and communicating with the gift card “A” issuer server 2439 and broker pool(s) 2440. For example, the UVEMT may rank the available exchange deals according to the favorability of their rate(s), the expected time to execution, the number of intermediate transactions required to execute the deal, extra costs, risk exposure considerations, ability of a single deal to combine with other exchanges in order to facilitate more complex deal transactions, and/or the like. The UVEMT may generate an exchange availability confirmation response (exchange rate quotes, deal execution timeframe, delivery timeframe, etc.), which may be taken into account when determining equivalent transferable value(s) at 2409.

FIG. 2E(b) shows a data flow diagram illustrating broker interaction(s) of embodiments of the UVEMT. At 2441, the UVEMT server may receive a value transfer request, and at 2442 may receive one or more gift card balance messages 2442. In some implementations, an XML-encoded message containing the transfer request at 2441 may take a form similar to the following:

```
POST /value_transfer_request_information.php HTTP/1.1
Host: www.UVEMTproccess.com
Content-Type: Application/XML
Content-Length: 788
<?XML version = “1.0” encoding = “UTF-8”?>
<value_transfer_request_information>
<timestamp>2016-01-01 12:30:00</timestamp>
      <user_details1>
          <user_ID>jdoe@gmail.com</user_ID>
          <password>password</password>
          <user_current_stake>100</user_current_stake>
      </user_details1>
      <exchange_request>
      <gift_card_ID>2642573289441672</gift_card_ID>
      <request_type>value_exchange</request_type>
      <incoming_value_type>Delta SkyMiles</incoming_value_type>
      <incoming_value_amount>11,472 points
      </incoming_value_amount>
      <desired_value_type>Best Buy</desired_value_type>
      <option_desired_value_amount>$100.00
      </option_desired_value_amount>
      <wait_time>30 seconds</wait time>
      <owner_ID>John Q. Doe</owner ID>
      <timestamp>2013-02-22 15:24:00</timestamp>
      <owner_verification>Sam Smith 2215</owner verification>
      </exchange_request>
      </gift_card_balance>
      <value_transfer_info>
      </value_transfer_info>
</value_transfer_request_information>
```

In some implementations, e.g. at 2443, the UVEMT server may send a request to broker server(s) M (2456) for a value exchange from gift card “A” to gift card “B.” An example value exchange request message 2443, substantially in the form of a HTTP(S) POST message including XML-formatted data, may take a form similar to the following:

```
POST /value_transfer_request_information.php HTTP/1.1
Host: www.UVEMTproccess.com
Content-Type: Application/XML
Content-Length: 788
<?XML version = “1.0” encoding = “UTF-8”?>
<value_transfer_request_information>
<timestamp>2016-01-01 12:30:00</timestamp>
      <user_details1>
          <user_ID>jdoe@gmail.com</user_ID>
          <password>password</password>
          <user_current_stake>100</user_current_stake>
      </user_details1>
      <exchange_request>
      <gift_card_ID>2642573289441672</gift_card_ID>
      <request_type>value_exchange</request_type>
      <incoming_value_type>Delta SkyMiles</incoming_value_type>
      <incoming_value_amount>11,472 points
      </incoming_value_amount>
      <desired_value_type>Best Buy</desired_value_type>
      <option_desired_value_amount>$100.00
      </option_desired_value_amount>
      <wait_time>30 seconds</wait time>
      <owner_ID>John Q. Doe</owner ID>
      <timestamp>2013-02-22 15:24:00</timestamp>
      <owner_verification>Sam Smith 2215</owner verification>
      </exchange_request>
      </gift_card_balance>
      <value_transfer_info>
      </value_transfer_info>
</value_transfer_request_information>
```

The broker server(s) M at 2456 may evaluate the exchange request to determine whether the request may be immediately fulfilled, or in some embodiments, whether a delayed exchange may be available. In some embodiments, broker server(s) M (2456) may send a request similar to exchange request 2443 to broker server(s) P (2457), for example to determine whether they may obtain all or part of the transaction from broker server(s) P (2457). Broker server(s) M (2456) may make the secondary inquiry to broker server(s) P (2457) regardless of whether broker server(s) M (2456) is able to fulfill exchange request 2443 on its own (for example, for purposes of rate comparison, securing a more profitable deal, etc.). Broker server(s) P (2457) may send an exchange response message back to broker server(s) M (2456) (e.g., exchange rate quotes, deal execution timeframe, delivery timeframe, etc.) at 2447, and broker server(s) M (2456) may incorporate the contents of response 2447 into exchange response 2448 which it returns to the UVEMT server. In some implementations, an XML-encoded message containing the exchange response at 2448 may take a form similar to the following:

```
POST /value_transfer_request_information.php HTTP/1.1
Host: www.UVEMTproccess.com
Content-Type: Application/XML
Content-Length: 788
<?XML version = “1.0” encoding = “UTF-8”?>
<value_transfer_response_information>
<timestamp>2016-01-01 12:30:00</timestamp>
      <broker_details>
          <broker_ID>AcmeValueExchangers</user_ID>
      <broker_digital_certificate> DigitalCertif
      </broker_digital
_certificate>
      </broker_details>
      <type_presented>Delta SkyMiles</type_presented>
      <value_presented>11,472 points</value_presented>
      <requested_value_type>Best Buy</requested_value_type>
      <exchange_response>
      <exchange_option_1>Smokey Joe's BBQ Grill
      </exchange_option_1>
      <option1_value>300 Baby Back Points</option1_value>
      <option1_incoming_value_redeemed>4,250 Delta SkyMiles
points</option1_incoming_value_redeemed>
      <option1_availability>immediate</option1_availability>
      <option1_expiration>Expires in 24 hours</option1_expiration>
      <exchange_option_2>Bed, Bath & Beyond
      </exchange_option_2>
      <option2_value>50 BBB Points</option2_value>
      <option2_incoming_value_redeemed>11,472 Delta SkyMiles
points</option2_incoming_value_redeemed>
      <option2_availability>immediate</option2_availability>
      <option2_expiration>Expires in 24 hours</option2_expiration>
      <exchange_option_3>Bed, Bath & Beyond
      </exchange_option_3>
      <option3_value>500 BBB Points</option3_value>
      <option3_incoming_value_redeemed>11,472 Delta SkyMiles
points</option3_incoming_value_redeemed>
      <option3_availability>not available until Monday, March 18^{th},
2013</option1_availability>
      <option3_expiration>Expires 24 hours from time of
availability</option3_expiration>
      </exchange_response>
</value_transfer_response_information>
```

In some embodiments, the UVEMT server may at send a request to more than one broker, e.g. exchange request 2449, shown as being sent to additional broker server(s) Q (2458), for a value exchange from gift card “A” to gift card “B.” The broker server(s) Q at 2458 may evaluate the exchange request to determine whether the request may be immediately fulfilled, or in some embodiments, whether a delayed exchange may be available. Broker server(s) Q (2458) may send an exchange response message back to the UVEMT server at 2451 (e.g., exchange rate quotes, deal execution timeframe, delivery timeframe, etc.), and the UVEMT server(s) may incorporate the contents of responses 2448 and/or 2451 into complementary exchange response 2452 and/or liquidation response 2453 which may be used in determining exchange route(s) 2435.

FIG. 2F shows a data flow diagram illustrating charge processing in some embodiments of the UVEMT. At 2459, the UVEMT server may receive an incoming charge request 2459. An example charge request 2459, substantially in the form of a HTTP(S) POST message including XML-formatted data, is provided below:

```
POST /chargerequest.php HTTP/1.1
Host: www.targetissuer.com/charge
Content-Type: Application/XML
Content-Length: 484
<?XML version = “1.0” encoding = “UTF-8”?>
<charge_request>
      <gift_card_ID>2345678745674589</gift_card_ID>
      <user_ID>theoriginalowner@gmail.com</user_ID>
  <checkout_request>
      <checkout_ID>4NFU4RG94</checkout_ID>
      <timestamp>2011-02-22 15:22:43</timestamp>
      <purchase_detail>
          <purchase_amount>100</purchase_amount>
      </purchase_detail>
      <PoS_client_detail>
          <client_IP>192.168.23.126</client_IP>
          <client_type>smartphone</client_type>
          <client_model>HTC Hero</client_model>
          <OS>Android 2.2</OS>
          <app_installed_flag>true</app_installed_flag>
      </PoS_client_detail>
  </checkout_request>
</charge_request>
```

The UVEMT server may, at 2460, compute purchase and cash charges using contents of charge request 2459, for example by summing the total cost of gift card “A” value being purchased, the total cost of any gift card “B” value being purchased, the total cost due to broker server(s) M (2456), and/or the total amount of supplemental funds which might be required to be paid, for example by user 2500, in executing the value exchange deal. By way of example, charges may be due to issuer 2448 of gift card “B” in circumstances involving the outright purchase of gift card “B” value after liquidation of gift card “A” value, or in the absence of any other available exchange route. Also by way of example, charges may be due to issuer 2439 of gift card “A” when the UVEMT determined that a favorable exchange route would be to increase the value of gift card “A” prior to executing the exchange for gift card “B” value, in order to take advantage of a more favorable value exchange deal. In one embodiment, the UVEMT server may send a purchase request (e.g., value, quantity, cost of points, extra cost(s), etc., for example in a manner similar to that of charge request 2459) at 2461 to gift card “A” issuer server(s) 2439, which may return purchase verification 2462, for example including the amount of value purchased, an authorization of the transaction, a receipt, etc.). In some embodiments, the UVEMT server may send a purchase request (e.g., value, quantity, cost of points, extra cost(s), etc.) at 2463 to gift card “B” issuer server(s) 2448, for example in a manner similar to that of charge request 2459, which may return purchase verification 2464, for example including the amount of value purchased, an authorization of the transaction, a receipt, etc.). In some embodiments, the UVEMT server may, at 2465, send a request to purchase a brokered exchange deal to broker server(s) M (2456), for example in a manner similar to that of charge request 2459, which may return a verification message 2466, for example including the amount and type of value purchased, an authorization of the transaction, a receipt, etc.). In some embodiments, the UVEMT server may send a hold clearance message 2465 to broker server(s) M (2456) so that any exchange deals that the broker has ‘reserved,’ or placed on ‘hold,’ if any, may be released from their respective holds and either purchased or released and made available for other potential value consumers. In some embodiments, the UVEMT server may send a supplemental funds charge request (e.g., for extra cost(s) incurred during the UVEMT exchange, etc.) at 2467 to user wallet/account issuer server(s) 2471, for example in a manner similar to that of charge request 2459, which may return a supplemental funds charge verification 2468, for example including the amount charged, transaction authorization ID, receipt, etc. Some of the charges shown in FIG. 2F may be fully or partially subsidized by the UVEMT, for example to take advantage of a favorable exchange rate when purchasing in bulk. At 2469, the UVEMT may issue a hold clearance message, e.g. an update removing holds placed on resources, if any, to the UVEMT Pool 2438. The UVEMT server may generate one or more charge authorization messages 2470 in response to one or more authorization messages (e.g., 2462, 2464, 2466, 2468), and no required sequence is intended by FIG. 2F.

FIG. 2G shows a data flow diagram illustrating user purchase checkout embodiments of the UVEMT. At 2472, the Merchant Server(s) 2497 may receive a checkout request message from a user 2500, e.g. user 2500 wishes to purchase the contents of his/her electronic ‘shopping cart’. Merchant Server(s) 2497 may, at 2473, send a user account(s) availability request 2473 to the User Wallet/Account Issuer Server(s) 2471, for example to determine what methods of payment, if any, are available to the user. An example account availability response 2473, substantially in the form of a HTTP(S) POST message including XML-formatted data, is provided below:

```
POST /authreqyest.php HTTP/1.1
Host: www.visa.com/UVEMT
Content-Type: Application/XML
Content-Length: 484
<?XML version = “1.0” encoding = “UTF-8”?>
<auth_request>
      <request_ID>45DSKFSWGG9</request_ID>
      <timestamp>yyyy-mm-dd hh:mm:ss</timestamp>
      <user_ID>JQDoe@gmail.com</user_ID>
      <password>kingoftheworls1982</password>
      <wallet_account_ID>6785456789763434</wallet_account_ID>
      <request_type>balance_inquiry</request_type>
  <client_details>
      <client_IP>192.168.23.122</client_IP>
      <client_type>smartphone</client_type>
      <client_model>HTC Hero</client_model>
      <OS>Android 2.2</OS>
      <app_installed_flag>true</app_installed_flag>
  </client_details>
</auth_request>
```

User Wallet/Account Issuer Server(s) 2471 may, at 2474, issue a query of point balances in a user wallet account at 2474 to Wallet Account Database 2499, which may return wallet account balance response 2475 containing, for example, a list of payment sources (e.g., credit cards, debit cards, cash equivalents, UVEMT points, loyalty points, rewards points, gift cards and/or the like) and their associated values. In some embodiments, User Wallet/Account Issuer Server(s) 2471 may, at 2476, send a user account(s) availability request 2476 to UVEMT Server 2437. UVEMT Server 2437 may, in turn, issue a UVEMT account balance query 2477 to UVEMT Database 2219. An example UVEMT account balance query 2477, substantially in the form of PHP/SQL commands, is provided below:

<?PHP
header(‘Content-Type: text/plain’);
mysql_connect(“254.93.179.112”,$DBserver,$password); // access
database server
mysql_select_db(“UVEMT_DB.SQL”); // select database table to search
//create query
$query = “SELECT current_ownerID, swapped_owner_ID,
pending_exchange_value_type, transaction_amount FROM
AccountsTable WHERE
current_owner_ID LIKE ‘%’ $current_ownerID”;
$result = mysql_query($query); // perform the search query
mysql_close(“UVEMT_DB.SQL”); // close database access
?>

Query 2477 on UVEMT Database 2219 may return UVEMT account balance response 2478 containing, for example, a list of “redirected” payment sources (e.g., sources previously reassigned to user 2500 from user 2501 through a value exchange transaction) and their associated values. In some embodiments, the availability of redirected funds identified by the UVEMT Server may be returned at 2479 to User Wallet/Account Issuer Server(s) 2471, which may send a related user account availability response 2481 to Merchant Server(s) 2471. An example account availability response 2481, substantially in the form of a HTTP(S) POST message including XML-formatted data, is provided below:

```
POST /authreqyest.php HTTP/1.1
Host: www.visa.com/UVEMT
Content-Type: Application/XML
Content-Length: 484
<?XML version = “1.0” encoding = “UTF-8”?>
<auth_request>
          <request_ID>45DSKFSWGG9</request_ID>
          <timestamp>yyyy-mm-dd hh:mm:ss</timestamp>
          <user_ID>JQDoe@gmail.com</user_ID>
          <password>kingoftheworls1982</password>
          <wallet_account_ID>6785456789763434</wallet_account_ID>
          <available_value_type1>AmEx Gift Card</available_value_type1>
          <available_amount_type1>$42.75</available_amount_type1>
          <available_value_type2>Misc. Gift Card</available_value_type2>
          <available_amount_type2>$0.75</available_amount_type2>
          <available_value_type3>Delta SkyMiles</available_value_type3>
          <available_amount_type3>11,472 points</available_amount_type3>
          <available_value_type4>Best Buy Gift Card</available_value_type4>
          <available_amount_type4>$11.75</available_amount_type4>
          <available_value_type5>Starbucks Rewards</available_value_type5>
          <available_amount_type5>$4.08</available_amount_type5>
          <available_value_type6>Checking Account ending in
9942</available_value_type6>
          <available_amount_type6>$1,117.90</available_amount_type6>
    <client_details>
          <client_IP>192.168.23.122</client_IP>
          <client_type>smartphone</client_type>
          <client_model>HTC Hero</client_model>
          <OS>Android 2.2</OS>
          <app_installed_flag>true</app_installed_flag>
    </client_details>
</auth_request>
```

In some embodiments, the availability of redirected funds identified by the UVEMT Server may be sent directly from the UVEMT Server to Merchant Server(s) 2471 at 2497. In some implementations, the UVEMT Server may generate a checkout page at 2482, for example integrating response(s) 2480 and/or 2481 into a user interface. User 2500 may receive a checkout page, for example at 2483, displaying available payment option(s) on his/her mobile device, laptop, netbook, tablet, desktop computer, etc. At 2484, the user may make a selection (e.g., via the checkout page) of his/her desired payment method(s) and return a payment election confirmation message at 2485 to Merchant Server(s) 2497. The selection may, in some embodiments, invoke a split tender form of payment (e.g., apply 500 Acme Rewards points; remainder charged to American Express account number ending in 4472). The Merchant Server(s) 2497 may in some embodiments determine what portion of the transaction to charge to a credit/debit card (e.g., transaction total−dollar equivalent of UVEMT credits applied=balance outstanding) at 2486. The Merchant Server 2497 may send a charge authorization request 2487 to User Wallet/Account Issuer Server(s) 2471, which may request payment at 2488 from Payment Network Server(s) 2498. An example charge authorization request 2487, substantially in the form of a HTTP(S) POST message including XML-formatted data, is provided below:

```
POST /authorizationrequests.php HTTP/1.1
Host: www.acquirer.com
Content-Type: Application/XML
Content-Length: 1306
<?XML version = “1.0” encoding = “UTF-8”?>
<card_authorization_request>
          <session_ID>4NFU4RG94</order_ID>
          <timestamp>2011-02-22 15:22:43</timestamp>
          <expiry>00:00:30</expiry>
          <alerts_URL>www.merchant.com/shopcarts.php?sessionID=
AEBB4356</alerts_URL>
          <!--optional data-->
          <user_ID>john.q.public@gmail.com</user_ID>
          <PoS_details>
              <PoS_IP>192.168.23.126</client_IP>
              <PoS_type>smartphone</client_type>
              <PoS_model>HTC Hero</client_model>
              <OS>Android 2.2</OS>
              <app_installed_flag>true</app_installed_flag>
          </PoS_details>
          <purchase_details>
              <num_products>1</num_products>
              <value_exchange>
                    <exchange_type>swap</exchange_type>
                    <exchange_info>
                          <outgoing_type>Delta SkyMiles</outgoing_type>
                          <purchase_type>Best Buy gift card</purchase_type>
                    <seller>Acme Value Exchange</seller>
                    </exchange_info>
                    <quantity>1</quantity>
              </product>
          </purchase_details>
          <merchant_params>
              <merchant_id>3FBCR4INC</merchant_id>
              <merchant_name>Acme Value Exchange</merchant_name>
              <merchant_auth_key>1NNF484MCP59CHB27365</merchant_auth_key>
          </merchant_params>
          <account_params>
              <account_name>John Q. Public</account_name>
              <account_type>credit</account_type>
              <account_num>123456789012345</account_num>
              <billing_address>123 Green St., Norman, OK
98765</billing_address>
              <phone>123-456-7809</phone>
              <sign>/jqp/</sign>
              <confirm_type>email</confirm_type>
              <contact_info>john.q.public@gmail.com</contact_info>
          </account_params>
          <shipping_info>
              <shipping_adress>same as billing</shipping_address>
              <ship_type>expedited</ship_type>
              <ship_carrier>FedEx</ship_carrier>
              <ship_account>123-45-678</ship_account>
              <tracking_flag>true</tracking_flag>
              <sign_flag>false</sign_flag>
          </shipping_info>
</card_authorization_request>
```

Payment Network Server(s) 2498 may in turn issue payment response 2489 back to User Wallet/Account Issuer Server(s) 2471, which may send payment confirmation response 2495 to Merchant Server(s) 2497. In some embodiments, Merchant Server(s) 2497 may request payment at 2490 directly from Payment Network Server(s) 2498, which in turn may issue payment response 2491 back to Merchant Server(s) 2497. In some embodiments, Merchant Server(s) 2497 may send UVEMT points redemption notification 2492 to User Wallet/Account Issuer Server(s) 2471, which may in turn confirm the redemption of UVEMT points at 2493 in a message sent to, and received by, the UVEMT Server. The UVEMT Server may update account balance information (e.g., decrement points redeemed in the most recent transaction(s)) in UVEMT Database 2219 at 2494. In some implementations, an exemplary XML-encoded account balance information update message 2494 may take a form similar to the following:

```
POST /account_balance_message.php HTTP/1.1
Host: www.UVEMTprocess.com
Content-Type: Application/XML
Content-Length: 788
<?XML version = “1.0” encoding = “UTF-8”?>
<account_balance_message>
<timestamp>2016-01-01 12:30:00</timestamp>
    <user_params>
          <user_ID>123456789</user_ID>
          <user_password>********</user_password>
          <wallet_ID>A2C4E6G8I</wallet_ID>
    </user_params>
    <redeemed_points_params>
          <value_type1_redeemed>Best Buy gift
          card</value_type1_redeemed>
          <value_type1_ID>4468213</value_type1_ID>
          <amount_type1_redeemed>$10.00-
          </amount_type1_redeemed>
          <on_list>true</on_list>
          <action>check_off</action>
    </account_balance_params>
</account_balance_message>
```

An example account balance information update command, substantially in the form of PHP/SQL commands, is provided below:

<?PHP
header(‘Content-Type: text/plain’);
mysql_connect(″254.92.185.103”,$DBserver,$password); // access
database server
mysql_select(″UVEMT_DB.SQL″); // select database to append
mysql_query(“INSERT INTO LedgersTable (value_card_ID,
updated_value_amount, source_user_ID, current_user_ID)
VALUES ($value_card_ID, $updated_value_amount,
$source_user_ID,
$current_user_ID)”); // add data to table in database
mysql_close(″UVEMT_DB.SQL″); // close connection to database
?>

At 2495, User Wallet/Account Issuer Server(s) 2471 may send payment confirmation response (e.g., instructions to deduct UVEMT points) at 2495 to Merchant Server(s) 2497. Further, Merchant Server(s) 2497 may deduct the corresponding UVEMT points at 2496 from the associated account. In some embodiments, Merchant Server(s) 2497 may not subtract points at 2496. Instead, Merchant Server(s) 2497 may collect full payment on a transaction involving points, and as shown by way of example at 2600, may send a TC 10/20 batch deduction message, containing for example bundled deduction requests for similar point types, to User Wallet/Account Issuer Server(s) 2471, on which the processing of points credits (e.g., the deduction of points from a user account) may occur.

FIGS. 3E-3F(a) show logic flow diagrams illustrating gift card value exchange/transfer embodiments of the UVEMT. The gift card value exchange/transfer may begin at 3503, where client 3500 may obtain a request for value transfer from gift card “A” to gift card “B.” At 3504, client 3500 may send a value transfer request to UVEMT Server 3501. The value transfer request may received and parsed (e.g., to obtain gift card identifiers) at 3505 by UVEMT Server 3501, which may identify issuer(s) of gift card “A” and gift card “B” (e.g., using gift card identifiers) at 3506 and, at 3507, send a message requesting the balance of gift card “A.” The gift card “A” issuer server 3502 may receive a gift card balance request (e.g., at 2508) and issue a database query to obtain said gift card balance (also at 2508). Gift card “A” issuer server 3502 may send gift card “A” balance information to UVEMT Server 3501 (e.g., at 2509). The UVEMT Server may receive gift card “A” balance information at 3510, and at 3511 determine where the balance on the gift card is sufficient for a value transfer (e.g., an amount greater than zero, or an amount greater than a minimum lower threshold of exchangeable gift card value). In some embodiments, UVEMT Server 3501 may, in the event of insufficient gift card balance, send an ‘insufficient GC balance’ message at 3512 to client 3500, which may in turn display an ‘insufficient GC balance’ mesasge at 3513, for example via a user interface. In the event that the gift card is determined at 3511 to contain sufficient value for a value exchange/transfer, UVEMT Server 3501 may further utilize value exchange/transfer request information at 3514, and/or gift card balance information at 3515, as described below in the description on FIG. 3F(a).

Turning now to FIG. 3F(a), UVEMT Server 3501 may receive exchange/transfer request information at 3526, and/or gift card balance information at 3527. In some embodiments, UVEMT Server 3501 may query UVEMT database at 3528 to determine a historical gift card trade and may further determine an associated popularity (e.g., more than 50 trades per day may indicate popularity). This popularity may, in some embodiments, correspond to an eligibility for a delayed exchange (i.e., if no trades are immediately available, but given the level of popularity, one may be believed to be imminent). In some implementations, UVEMT Server 3501 may set a delay flag to true at 3530 if delayed exchange is deemed available, and at 3529 set a delay flag to false if delayed exchange is not deemed available. UVEMT Server 3501 may send gift card balance information and a liquidation inquiry at 3531 to gift card “A” issuer server 3502, which in turn may receive said liquidation inquiry at 3532. Gift card “A” issuer server 3502 may, in some embodiments, determine a liquidation response (e.g., availability, rate, etc.) at 3533 and send said liquidation response at 3534 to UVEMT Server 3501, which in turn receives said liquidation response at 3535. UVEMT Server 3501 may, in some embodiments, add a value exchange/transfer request to UVEMT Pool 3536. Further, UVEMT Server 3501 may in some embodiments query the UVEMT Pool database (e.g., 3438) for complementary exchanges at 3537, for example to effectuate an ‘instant swap.’ UVEMT Server 3501 may obtain availability of a complementary exchange at 3538, and in some embodiments may (e.g., at 3539) further update the UVEMT Pool (e.g., 3438) to show a complementary value item as being ‘on hold’ (e.g., rate, hold time). UVEMT Server 3501 may utilize a broker exchange/transfer inquiry (e.g., value “A” to value “B”) at 3540, as well as a broker liquidation inquiry at 3541, as described in the description of FIG. 3F(b) below.

FIG. 3F(b) shows a logic flow diagram illustrating broker interaction(s) of gift card value exchange/transfer embodiments of the UVEMT. UVEMT Server 3501 may, at 3553, receive a broker exchange/transfer inquiry (e.g., value “A” to value “B”) and/or a broker liquidation inquiry, and send said inquiry or inquiries to Broker Server(s) M 3456. At 3555, Broker Server(s) M 3456 may receive broker exchange/transfer 3554 and liquidation inquiry 3555, and may in some implementations evaluate the request, e.g. at 3564 (e.g., Best Buy gift cards are currently trading at an exchange rate of 3:1 for Apple gift cards; this rate is valid for the next 12 hours; there are currently no Zappos gift cards available). In some embodiments, Broker Server(s) M 3456 may send a broker exchange/transfer inquiry (e.g., value “A” to value “B”) at 3556 and/or a broker liquidation inquiry at 3557 to Broker Server(s) P 3457, which in turn receives the inquiries (e.g., at 3558 and/or 3559). Broker Server(s) P 3457 may in some implementations evaluate the request, e.g. at 3560 (e.g., 10,000 Delta SkyMiles can currently be liquidated for $120; this rate is valid for the next 15 minutes). Broker Server(s) P 3457 may, in some embodiments, send a value exchange/transfer/liquidation response (e.g., availability, rate, timeframe, etc.) to Broker Server(s) M 3456 at 3561, which receives it at 3562. Broker Server(s) M 3456 may further send at 3563 a value exchange/transfer/liquidation response (e.g., availability, rate, timeframe, etc.), for example based on the evaluation at 3564 and/or the response at 3562, to UVEMT Server 3501. UVEMT Server 3501 may receive a broker exchange/transfer/liquidation response (availability, rate, etc.) at 3565, and at 3566 may generate a broker exchange/transfer/liquidation response. UVEMT Server 3501 may, in one embodiment, receive and send a complementary value exchange/transfer ‘hold’ request at 3550 to Broker Server(s) M 3456, which may receive and optionally forward said request at 3551. Broker Server(s) P 3457 may in turn receive a complementary value exchange/transfer ‘hold’ request at 3252. In some embodiments, UVEMT Server 3501 may send a complementary value exchange/transfer ‘hold’ request at 3550 directly to Broker Server(s) P 3457.

Turning again to FIG. 3F(a), UVEMT Server(s) 3501 may receive a broker exchange/transfer response 3542 and/or liquidation response 3543, and in some embodiments may determine whether an exchange is available (e.g, in view of response(s) 3542 and/or 3543). By way of example, UVEMT Server 3501 may, in the event that an exchange is available, generate a complementary value exchange/transfer ‘hold’ request at 3547, which may for example be used at 3550, 3551, and/or 3552. UVEMT Server 3501 may in some embodiments determine transfer routing(s) 3544 (e.g., based on responses 3542, 3543). Further, UVEMT Server 3501 may at 3545 create a ranked list of routing(s) based on exchange rate favorability (e.g., 1:3, 1:2, 1:1, 3:1), preferred gift card type, timeframe for delivery from shortest to longest, etc. UVEMT Server 3501 of one embodiment may generate, at 3546, a ranked list of instant and/or delayed exchange/transfer availability according to a user request.

Turning again to FIG. 3E, UVEMT Server 3501 may obtain ranked instant and/or delayed exchange/transfer availability per user request at 3516. UVEMT Server 3501 may further determine, at 3517, an equivalent transfer value associated with the exchange transaction. In some embodiments, UVEMT Server 3501 may send (e.g., at 3518) available value transfer options to client 3500, which may in turn, by way of example, display said available transfer options at 3519, e.g., via a mobile wallet user interface. Client 3500 may make a transfer election and send it at 3520, e.g. via a mobile wallet user interface, to UVEMT Server 3501, which may in turn receive said election at 3521 and accordingly update the associated gift card ledger balance(s) at 3522. UVEMT Server 3501 may in some implementations execute a value transfer according to a user's election at 3523 (e.g., purchase gift card “B” outright, liquidate gift card “A,” utilize a broker to swap gift card “A” for gift card “B,” execute a swap using the UVEMT Pool, and/or the like), and may further send gift card charge authorization request(s) at 3524, which may be handled according to FIG. 3G, as explained in greater detail below. In some embodiments, UVEMT Server 3501 may generate a transaction confirmation (e.g., receipt, value exchanged, current points balance(s), etc.), e.g., at 3589, which may be displayed on client 3500 at 3525.

FIG. 3G shows a logic flow diagram illustrating example aspects of charge processing according to some embodiments of the UVEMT having a broker option. UVEMT Server 3501 may, in some embodiments, receive gift card authorization request(s) at 3570. UVEMT Server 3501 may send gift card authorization request(s) to gift card server(s) “A” and/or “B” (e.g., 3439 and/or 3448) at 3571. In some embodiments, gift card server(s) “A” and/or “B” (e.g., 3439 and/or 3448) may receive gift card purchase request(s) (e.g., purchase 300 units of Best Buy at $1 per unit plus a $0.50 service fee) at 3572, which it may in turn send to User Wallet/Account Issuer Server(s) 3471. User Wallet/Account Issuer Server(s) 3471 may in some embodiments receive supplemental charge authorization request(s) (e.g., charge the user $7.50 in extra costs to complete the requested exchange) at 3573. Further, User Wallet/Account Issuer Server(s) 3471 may, at 3574, issue a query to a user account database and/or initiate payment from a user account. In some embodiments, User Wallet/Account Issuer Server(s) 3471 may send a charge authorization response 3575 to gift card server(s) “A” and/or “B” (e.g., 3439 and/or 3448), which may receive said authorization response at 3576, and further may allocate gift card value to a user. Gift card server(s) “A” and/or “B” (e.g., 3439 and/or 3448) may in one embodiment send a gift card purchase verification response 3577 to Broker Server(s) 3548, which may in turn receive at 3578 said brokered exchange purchase request(s) (e.g., to exchange 2,000 American Airlines miles for Starbucks points at a 2:1 Exchange rate, plus a $1 service fee). In some embodiments, Broker Server(s) 3548 may determine whether extra costs are involved in a given value exchange transaction. By way of example, should Broker Server(s) 3548 determine that extra costs are needed, Broker Server(s) 3548 may send, at 3318, a supplemental charge authorization request (e.g., charge the user $2.35 in extra costs/fees for a brokered exchange) to User Wallet/Account Issuer Server(s) 3471 at 3579. User Wallet/Account Issuer Server(s) 3471 may issue a query to a user account database at 3580 and/or initiate payment from a user account 3581, and may in turn send charge authorization response(s) at 3582 to Broker Server(s) 3548. Regardless of whether Broker Server(s) 3548 determines that extra costs are needed, Broker Server(s) 3548 may, at 3583, allocate gift card value to/from a user, and further may process payment. Broker Server(s) 3548 may send exchange verification response(s) at 3584 to UVEMT Server 3501, which may in turn receive gift card purchase verification response(s) 3585, charge authorization response(s) 3586, and/or exchange verification response(s) 3587. In some embodiments, UVEMT Server(s) 3501 may store updated gift card value(s) 3588, and at 3589, may generate a transaction confirmation (e.g., receipt, value exchanged, current points balance(s), etc.).

FIG. 3H shows a logic flow diagram illustrating example aspects of a user purchase checkout in some embodiments of the UVEMT, e.g. a User Purchase Checkout (“UPC”) component 3241. In some embodiments Merchant Server(s) 3497 may receive a user checkout request 3300, and further may send, at 3301, a request for available payment options associated with user account(s) to User Wallet/Account Issuer Server(s) 3471, which may in turn receive said request at 3302. In one embodiment, User Wallet/Account Issuer Server(s) 3471 may query a user account database (e.g., at 3303) for available payment methods (e.g., credit card liquidity, checking account balance, gift card amounts, rewards points, loyalty points, UVEMT points, and/or the like), and further may send a request at 3304 for supplemental payment options (e.g., pending exchanges) associated with user accounts. In some embodiments, UVEMT Server 3501 may receive a request (e.g., at 3307) for supplemental payment options (e.g. pending exchanges) associated with user account(s). UVEMT Server 3501 may additionally query the UVEMT database (e.g., 3219) at 3308 to determine available payment methods and/or pending exchange transactions associated with a user account. UVEMT Server 3501 may send supplemental payment options response 3309 to User Wallet/Account Issuer Server(s) 3471, which may receive the response at 3305. User Wallet/Account Issuer Server(s) 3471 may send supplemental payment options response 3306 to Merchant Server(s) 3497, where it may be received at 3310. Merchant Server(s) 3497 may send, at 3311, available payment options to a user for election (e.g., “You have 150 Best Buy points available for this transaction. Apply?”). Merchant Server(s) 3497 may then receive, at 3312, a payment election (e.g., single payment method, split tender, etc.) confirmation message, for example from a user. In some embodiments, Merchant Server(s) 3497 may send a charge authorization request at 3313 to User Wallet/Account Issuer Server(s) 3471, which may receive and process said request at 3314, confirm payment at 3315, and/or send payment confirmation at 3316 to Merchant Server(s) 3497, where said confirmation may be received in Merchant Server(s) 3497 at 3317.

FIGS. 3C-D show logic flow diagrams illustrating closed loop gift card value exchange second embodiment of the UVEMT. The open/closed loop gift card value exchange may begin at 363. At 364, client 1 301b may send instructions to transfer value from source gift card to a destination gift card. The instructions may identify the source gift card and the destination gift card. The instructions may be received by UVEMT server 365. The UVEMT server may parse the instructions to obtain identifiers for the gift cards at 365. The UVEMT server may further identify the issuers of the gift cards at 366, and obtain balance in the source gift card account at 367. At 368, the UVEMT server may determine whether the source gift card is an open or a closed loop gift card. If the source gift card is a closed loop gift card, the UVEMT server may, at 376, query one or more databases and/or tables to look up a target gift card exchange request (e.g., from client 2 303b) or a target gift card that available in the UVEMT pool 303b for exchange. If a target gift card is determined to be available at 379 based on query results obtained at 378, the UVEMT server may, in one implementation, request confirmation from client 2/pool that the target gift card may be used for exchange. In another implementation, the exchange may be preapproved. In one implementation, at 380, the client2/pool may select and/or provide a target gift card (e.g., gift card number) to the UVEMT server. The UVEMT server may obtain the target gift card information at 381 and may determine the exchange rate and equivalent value (e.g., 382-386) in a manner similar to that described with respect to FIGS. 3A-B. At 387, the UVEMT server may send a request to client 1 asking to confirm that the equivalent value and/or exchange rate is acceptable. At 388, client 1 may confirm the exchange. At 389, upon receiving the confirmation, the UVEMT may deallocate (or debit) the value of the source gift card such that the balance of the source gift card is not available to the user. In one embodiment, the original value of the gift card will be set to an allocated value card that is associated with the original card. In essence this will be the value used by UVEMT participants. If a card is to have a value deallocated, this value card will have the appropriate amount deducted from it based on value exchange calculations, while the amount on the original card is as of yet unaffected. For example, the transfer request data structure 282 shows the underlying card value of 200 points is unaffected while participating user 1 will see only 100 points of that value and participating user 2 will see 50 points and the UVEMT in this example has allocated 50 points to itself for various transaction fees. As such, the UVEMT may generate a new value card record in value card table 2219u having the original identifier of the card, the original owner ID of the card, the target owner ID, the tracking equivalent amount that deducts the appropriate value equivalent off of the original amount and the transferred amount. This tracking equivalent amount is what will be visible to the original owner. The target user will see the transferred value field associated with the gift card. Similarly, credit/allocate may affect the field values of the value card record appropriately.

At 390, the UVEMT server may deallocate the value of the target gift card such that the value of the target gift card is not available for the target gift card for anyone else. At 391, the destination gift card is allocated the equivalent value. In one implementation, the destination gift card is linked to the target gift card. When the user makes a purchase using his or her destination gift card, a charge request is sent to the issuer of the target gift card to charge the value of the purchase (up to the equivalent amount) to the target gift card. As such, the allocation and deallocation are ledger entries made to track the exchange of the gift cards between users without actually moving funds from one account to another. In some implementations, the payment gateway may assist in the routing of the charge requests to the appropriate issuer or issuer bank. At 392, the UVEMT server may update the ledger entry balances for the source, destination and target gift card, concluding the process at 375.

Referring to FIG. 3C, when there is no target gift card available for a swap at 379, or when the source gift card is determined to be an open loop card at 368, the UVEMT server may determine the equivalent value of the source gift card at 369. In one implementation, the equivalent value may be 50% of the source gift card value. In another implementation, the equivalent value may be determined using similar method outlined in 382-386 (FIG. 3D). At 370, the UVEMT server may provide the equivalent value to client 1 and request acceptance of the transfer. At 371, the user may input acceptance of the transfer and the client may provide the acceptance message to the UVEMT server. In response, the UVEMT server may deallocate the value of the source gift card at 372, and may allocate the equivalent value to an account at 373. In one implementation, the user may select an account where the equivalent value may be deposited. In an alternate implementation, the equivalent amount be converted into UVEMT currency and the user's UVEMT currency balance may be updated. At 374, the value of the source gift card account may be allocated to a UVEMT account or a UVEMT pool, concluding the gift card exchange process. Examples on how to allocate and deallocate are discussed with respect to processes e.g., 389, 391.

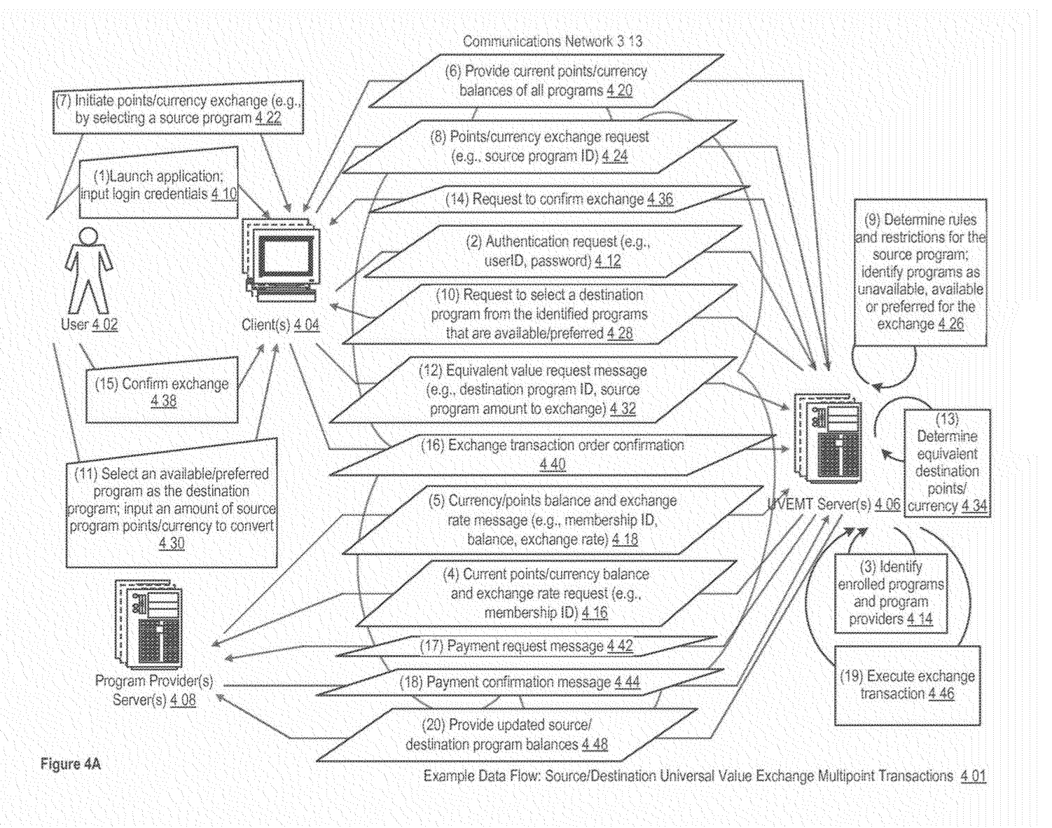

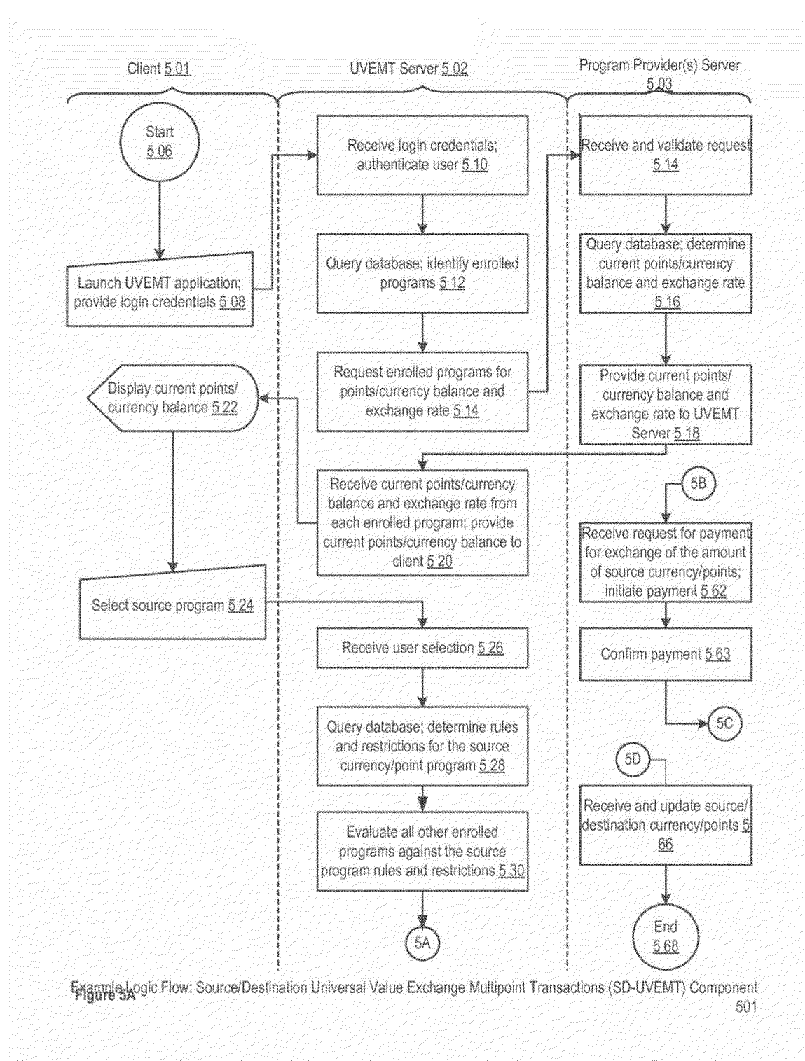

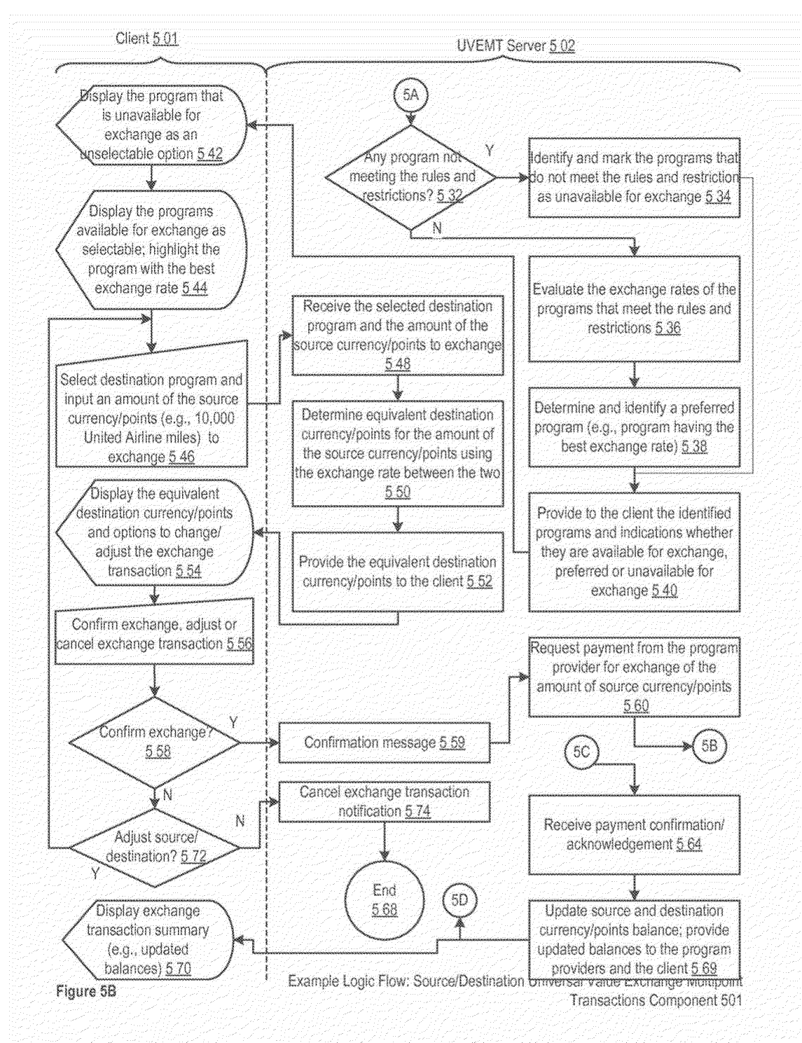

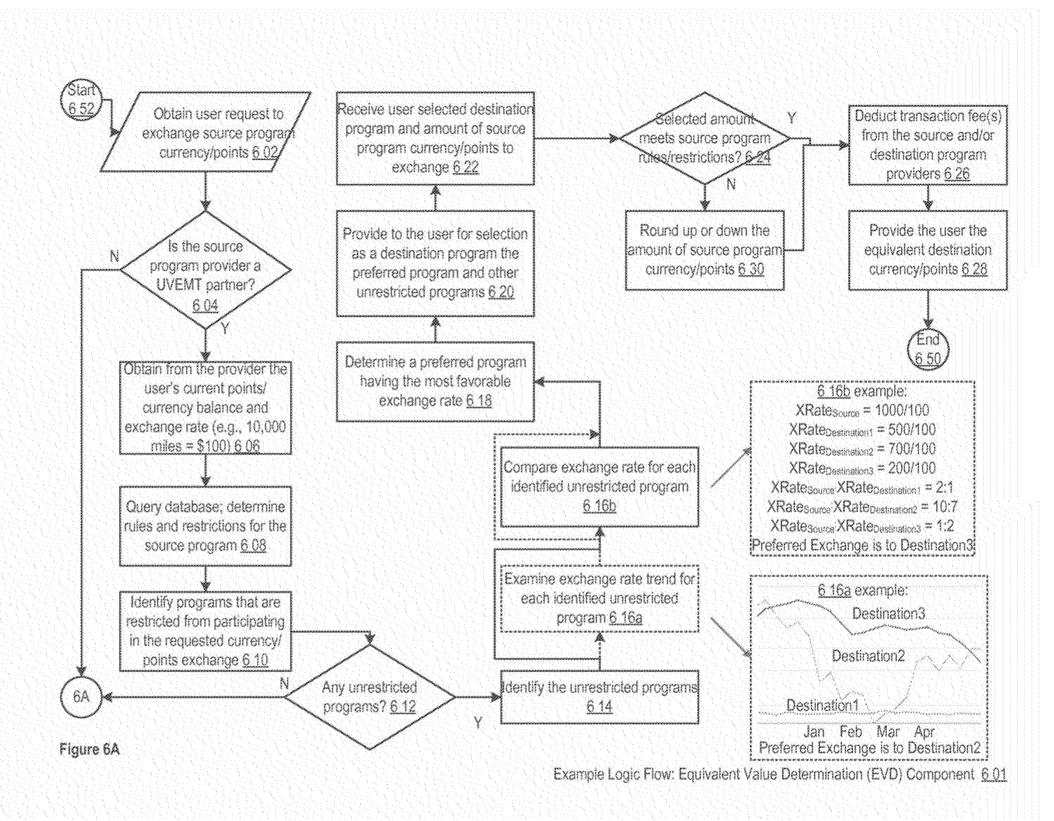

FIG. 4 shows a data flow diagram illustrating source/destination value exchange embodiment of the UVEMT. A user 402 may launch a UVEMT application or access a UVEMT web page and input login credentials into a client 404 at 410. The client may generate and send an authentication request 412 to the UVEMT server 406. An example authentication request 412, substantially in the form of a HTTP(S) POST message including XML-formatted data, is provided below:

```
POST /authreqyest.php HTTP/1.1
Host: www.visa.com/UVEMT
Content-Type: Application/XML
Content-Length: 484
<?XML version = “1.0” encoding = “UTF-8”?>
<auth_request>
          <request_ID>45DSKFSWGG9</request_ID>
          <timestamp>yyyy-mm-dd hh:mm:ss</timestamp>
          <user_ID>JDoe@gmail.com</user_ID>
          <password>kingoftheworls1982</password>
          <wallet_account_ID>6785456789763434-
          </wallet_account_ID>
    <client_details>
          <client_IP>192.168.23.122</client_IP>
          <client_type>smartphone</client_type>
          <client_model>HTC Hero</client_model>
          <OS>Android 2.2</OS>
          <app_installed_flag>true</app_installed_flag>
    </client_details>
</auth_request>
```

The UVEMT server may extract details from the authentication request 412 (e.g., XML data) to validate the authentication request. If the authentication request cannot be verified, the user may be asked to re-enter login credentials. The UVEMT server may identify all the loyalty programs that the user is currently enrolled in at 414. The UVEMT server may also identify the program providers of the enrolled programs. In one implementation, the UVEMT may query its user database to obtain a list of the user's enrolled programs. For example, the UVEMT server may issue PHP/SQL commands to query a database table for enrolled program data associated with the user. An example query, substantially in the form of PHP/SQL commands, is provided below:

<?PHP
header(‘Content-Type: text/plain’);
mysql_connect(“254.93.179.112”,$DBserver,$password); // access
database server
mysql_select_db(“UVEMT_DB.SQL”); // select database table to search
//create query
$query = “SELECT enrolled_program_list program_issuer
FROM UserTable WHERE user LIKE ‘%’ $user_id”;
$result = mysql_query($query); // perform the search query
mysql_close(“UVEMT_DB.SQL”); // close database access
?>

In one implementation, the UVEMT server may query an issuer database to obtain issuer balance/exchange rate request template to process the exchange. The issuer template may include instructions, data, login URL, login API call template, rules and restrictions file, exchange rate file and/or the like for facilitating data exchange between the UVEMT server and the program issuer server. An example PHP/SQL command listing, illustrating substantive aspects of querying the database, is provided below:

<?PHP
header(‘Content-Type: text/plain’);
mysql_connect(“254.93.179.112”,$DBserver,$password); // access
database server
mysql_select_db(“UVEMT.SQL”); // select database table to search
//create query
$query = “SELECT template FROM ProgramTable WHERE issuer
LIKE ‘%’
$program_issuer”;
$result = mysql_query($query); // perform the search query
mysql_close(“UVEMT.SQL”); // close database access
?>

In one implementation, the UVEMT may create and send a current points/currency balance and exchange rate request 416 to the identified program provider servers 408. The request 416 may be in the form of an API/web service call in some implementations. The program provider servers may respond to the UVEMT server's request with the requested points/currency balance. For example, the program provider server may provide an HTTP(S) POST message, e.g., 418, similar to the example below:

```
POST /balanceinfo.php HTTP/1.1
Host: www.UVEMT.com
Content-Type: Application/XML
Content-Length: 1306
<?XML version = “1.0” encoding = “UTF-8”?>
<balance_notification>
          <request_ID>4NFU5GG94</request_ID>
          <timestamp>20xx-02-22 15:22:43</timestamp>
          <member_ID>5645789643452367</member_ID>
          <balance>100</balance>
          <rate>10</rate>
          <base_currency>dollars</base_currency>
</balance_notification>
```

The UVEMT server may then provide program points/currency balance message 420 to the user's client 404. In one implementation, the client may display the contents of the message 420 to the user. The user may initiate a points/currency exchange transaction at 422. In one implementation, the user may select a source program to initiate an exchange transaction. The client may generate and send a points/currency exchange request 424 to the UVEMT server. In one implementation, the request 424 may include user ID, source program ID, and/or the like. An example exchange request 412, substantially in the form of a HTTP(S) POST request including XML-formatted data, is provided below:

```
POST /exchangerequest.php HTTP/1.1
Host: www.visa.com/UVEMT
Content-Type: Application/XML
Content-Length: 484
<?XML version = “1.0” encoding = “UTF-8”?>
<exchange_request>
          <request_ID>45DSKFTGGG9</request_ID>
          <timestamp>yyyy-mm-dd hh:mm:ss</timestamp>
          <user_ID>JDoe@gmail.com</user_ID>
    <source_details>
          <member_ID>4444566897978766</member_ID>
          <program_ID>MER675656</program_ID>
          <issuer_ID>apple</issuer_ID>
          <card_value>100</card_value>
          <currency>usd</currency>
    </source_details>
    <client_details>
          <client_IP>192.168.23.122</client_IP>
          <client_type>smartphone</client_type>
          <client_model>HTC Hero</client_model>
          <OS>Android 2.2</OS>
          <app_installed_flag>true</app_installed_flag>
    </client_details>
</exchange_request>
```

The UVEMT server may receive the exchange request and parse the request to obtain details (e.g., XML data). For example, the UVEMT server may identify the source program, and using the user ID, identify destination programs to which the source program points/currencies could be transferred. At 426, the UVEMT server may query one or more databases and/or tables to determine rules and restrictions for the source program. Further, in some implementations, the UVEMT server may examine the rules and restrictions to determine potential destinations programs that are available for exchange, unavailable for exchange and preferred for exchange. FIGS. 5A-B provide additional detail on these determinations. Upon identifying the potential destination programs, the UVEMT server may send the client a request 428 to select a destination program. The request 428 may include the list of the potential destination programs and indications of whether they are unavailable, available or preferred destination program. For example, the request 428 may include XML formatted data similar to the example below:

```
<selectdestination_request>
          <request_ID>45DSJKTGGG9</request_ID>
          <timestamp>yyyy-mm-dd hh:mm:ss</timestamp>
  <source_details>
          <member_ID>4444566897978766</member_ID>
          <program_ID>MER675656</program_ID>
          <issuer_ID>apple</issuer_ID>
          <card_value>100</card_value>
          <currency>usd</currency>
  </source_details>
  <destination_details>
          <destination1>
                <program_ID>MER567855</program_ID>
                <issuer_ID>Hilton</issuer_ID>
                <designation>available</designation>
          </destination1>
          <destination2>
                <program_ID>MER598755</program_ID>
                <issuer_ID>BestBuy</issuer_ID>
                <designation>available</designation>
          </destination2>
          <destination3>
                <program_ID>MER232855</program_ID>
                <issuer_ID>Microsoft</issuer_ID>
                <designation>unavailable</designation>
          </destination3>
          <destination4>
                <program_ID>MER765555</program_ID>
                <issuer_ID>Macworld</issuer_ID>
                <designation>preferred</designation>
          </destination4>
          .
          .
          .
</selectdestination_request>
```

The potential destination programs and their corresponding indications may be displayed by the client. The client may specifically grey out unavailable destination programs to indicate that the unavailable program cannot be selected by the user for the exchange transaction. Further the client may highlight the preferred options to draw the user's attention to the most optimal option for the exchange transaction. In one implementation, potential destination programs that are neither unavailable nor preferred may be displayed normally and may be available to the user for selection even though the option may not be the most optimal.

At 430 the user may select an available or preferred destination program. Upon selection of the source program, the client may display an option for the user to select or input an amount of the source program points/currency to exchange. In some implementations, a default amount (e.g., available balance) may be pre-populated. The client may package the user's input of the selected destination program and the amount of the source program points/currency into an equivalent value request 432 and send the request to the UVEMT server. In one implementation, the equivalent value request 432 may include user ID, destination program ID, source program ID, source program amount, and/or the like. The UVEMT server may receive the request 432 and parse the request to identify the source program, destination program as well as the amount to be exchanged. The UVEMT server may query one or more databases and/or tables to determine the exchange rate between source program and the destination program. The UVEMT server may then utilize the exchange rate to calculate the equivalent value in destination points/currency at 434. The UVEMT server may send a request 436 to the client to confirm exchange for the equivalent destination points/currency. In one implementation, the request 436 may include user ID, source program ID, destination program ID, equivalent value, exchange rate, validity time period, and/or the like. The user may view the equivalent value and exchange rate and may agree to proceed with the exchange transaction at 438. The confirmation message 440 may then be generated by the client and sent to the UVEMT server. Upon receiving confirmation from the user, the UVEMT server may send a payment request 442 to the program provider to request payment for the exchange transaction. In one implementation, the payment request 442 may include provider ID, source program ID, destination program ID, user ID, exchange rate, equivalent value, points/currency amount for exchange, bill amount and/or the like. An example payment request 442, substantially in the form of a HTTP(S) POST request including XML-formatted data, is provided below:

```
POST /paymentrequest.php HTTP/1.1
Host: www.programprovider.com/miles
Content-Type: Application/XML
Content-Length: 484
<?XML version = “1.0” encoding = “UTF-8”?>
<payment_request>
          <request_ID>45KGKFTGGG9</request_ID>
          <timestamp>yyyy-mm-dd hh:mm:ss</timestamp>
          <member_ID>4444566897978766</member_ID>
          <program_ID>MER675656</program_ID>
          <exchange_rate>10</exchange_rate>
          <exchange_rate_startdate>yyyy-mm-
          dd</exchange_rate_startdate>
          <exchange_rate_enddate>yyyy-mm-
          dd</exchange_rate_enddate>
          <destination_program>BestBuy</destination_program>
          <currency_amt>10000</currency_amt>
          <currency>miles</currency>
          <equivalent_amt>225</equivalent_amt>
          <bill_owed>250</bill_owed>
</payment_request>
```

The program provider may authorize payment and may send a payment confirmation message 444 to the UVEMT server. The payment confirmation message may include provider ID, source program ID, destination program ID, user ID, exchange rate, equivalent value, points/currency amount for exchange, payment ID, bill amount and/or the like. In one implementation, both the source and destination program providers may be billed for the services provided. Upon receiving the payment confirmation message 444, the UVEMT server may execute the exchange transaction at 446. In one implementation, executing the exchange transaction may include decrementing the user's source program points/currency and incrementing the destination program points/currency. Upon execution of the exchange transaction, the source/destination gift card balances may be updated and the updated balance information may be provided to the program providers via a balance message 448.

FIGS. 5A and 5B show logic flow diagrams illustrating source/destination value exchange component embodiment of the UVEMT. Starting at 506, a user may launch a UVEMT application on a client 501 and may provide login credentials at 508. The login credentials are sent by the client to the UVEMT server 502. The UVEMT server may receive the login credentials at 510 and may authenticate the user. Once the user is authenticated, at 512 the UVEMT server may query one or more user databases and/or tables using for example the user ID to identify loyalty programs in which the user is currently enrolled. At 514, the UVEMT server may communicate with the enrolled programs to ascertain current points/balance and any exchange rate that they may have established. In one implementation, the UVEMT server may communicate with the program service provider servers 503 using API/web service calls. The program provider servers may receive the request from the UVEMT server, and at 514, may validate that the request is authentic. For example, the program provider may check the UVEMT server credentials, user ID and/or the like to validate the request. At 517, the program service provider server may use the user ID in the received request to query their databases and/or tables to determine the user's current points/currency balance. In a further implementation, the program service provider may also look up the exchange rate for the source program points/currency. At 518, the program service providers may return the obtained balance and exchange rate information to the UVEMT server. At 520, the UVEMT server may obtain the balance and exchange rate information from each enrolled program. The UVEMT may also provide the balance information, and in some implementations, the exchange rate for each of the enrolled program to the client. In some implementations, the balance information may be directly communicated to the client by the program service provider. Upon receiving the points/currency balance, the client may display the balance at 522 and inquire if the user wishes to select a source program for an exchange transaction.

At 524, the user may select a source currency/point program to initiate an exchange transaction. The client may communicate the selected source program to the UVEMT server which may receive the selection at 526. At 528, the UVEMT server may parse the message received and may query the rules and restrictions database to determine any rules and restrictions associated with the source program.

In some implementations, each program may have rules and restrictions associated therewith that allow certain exchanges to proceed while forbidding others. Example rules and restrictions include: a minimum redemption group (e.g., redeem in groups of 500 miles), minimum redemption amount (e.g., users with 10,000 miles or more can redeem), non-refundable exchange, exchange amount limit, number of transactions per period limit, and/or the like.

At 530, the UVEMT server may obtain the associated rules and restrictions file and may evaluate each of the other enrolled programs against the source program rules and restrictions. Referring to FIG. 5B, at 532, any program not meeting the rules and restrictions may be identified. At 534, one or more programs that do not meet the source program rules and restrictions may be identified and marked as unavailable for exchange, and the processing moves to 540. If at 532, all programs are found to meet source program rules and restrictions, the processing moves to 536. At 536, the UVEMT server may evaluate the exchange rates of the programs that meet the rules and restrictions, and at 538, based on the evaluation, the UVEMT may determine and identify a preferred program for the exchange transaction. In one implementation, for example, a preferred program may be a program that has the most favorable exchange rate with the source program. With regard to identifying, highlighting, marking, etc., value exchange program at e.g., 534, 536, 538, 540, the UVEMT may make entries as being preferred, not allowed or restricted, allowed, etc., by updating a programs record 2219k appropriately. For example, program record entry for, e.g., Delta SkyMiles 850b of FIG. 8L may appear as follows:

```
<program1>
          <program_name>Mileage Plus United</program_name>
          <status>restricted</status>
          <exchange_rate>NA</exchange_rate>
</program1>
<program2>
          <program_name>Hilton HHnoros Point</program_name>
          <status>Preferred</status>
          <exchange_rate>2:1</exchange_rate>
</program2>
<program3>
          <program_name>BestBuy Rewards</program_name>
          <status>allowed</status>
          <exchange_rate>10:1</exchange_rate>
</program3>
.
.
.
```

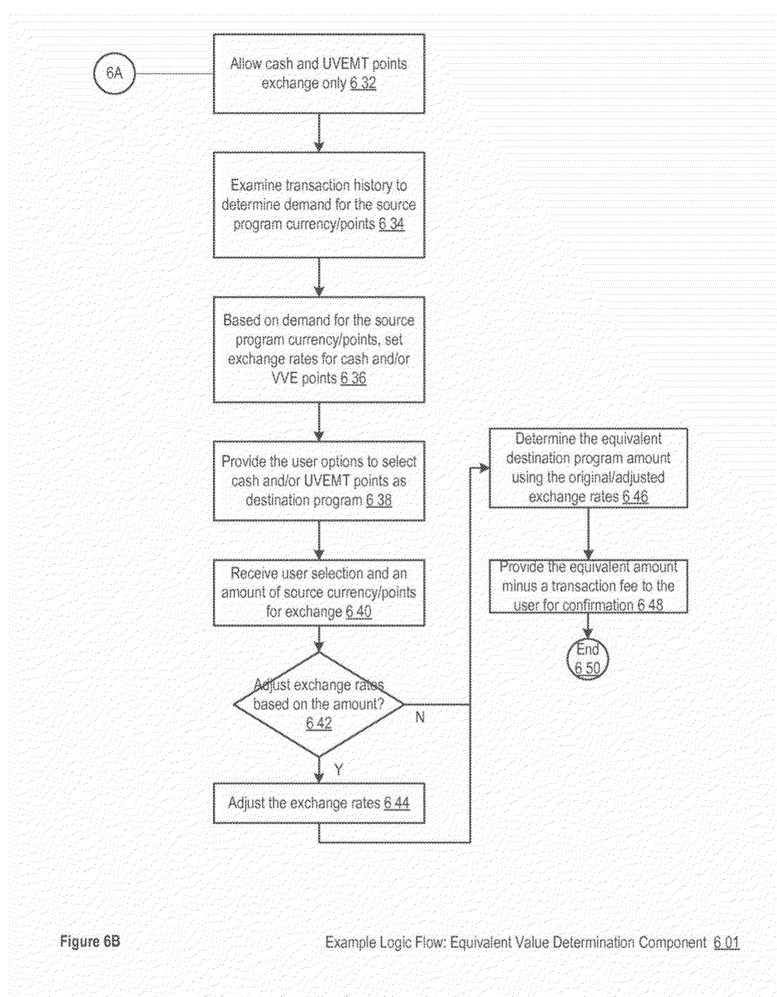

In other implementations, the preferred program may have additional rewards/points that may be obtained after the completion of the exchange. In yet other implementations, preferred programs may be selected based upon other factors such as acceptance, transaction history, and/or the like. Exchange rate evaluation and preferred program determination are discussed in detail with respect to FIGS. 6A-B.

At 540, the UVEMT server may provide to the client the identified programs and indications whether each program is unavailable, available or preferred for exchange with the source program. The client may receive the identified program information and may display the unavailable program as an unselectable option at 542. In one implementation, the unavailable program may be grayed out to clearly identify that the source program rules and restrictions forbid conversion of the source program to the unavailable program. At 544, the client may display the available programs as options that can be selected. In a further implementation, the client may highlight the preferred program so as to clearly identify that the highlighted program is the preferred program to which the source program points/currency should be converted to.

The user may select a destination program from the available list of programs and may input an amount of the source/currency points at 546. The client receives the input and sends the information to the UVEMT server which receives the selected destination program and the amount of the source program points/currency for exchange at 548. At 550, the UVEMT may determine equivalent amount of destination currency/points for the selected amount of source program currency points. In one implementation, the equivalent amount may be calculated based on the exchange rate between the source and destination program points/currency. In some implementations, the exchange rate of each program may be with respect to a base currency/unit such as the UVEMT point, from which the exchange rate between the two program points/currency may be determined. At 552, the UVEMT may provide the equivalent destination currency/points to the client which may display the information at 554. The client may also display controls for the user to adjust or change the transaction. For example, the user may go back and change the destination program or may adjust the source program points/currency amount. At 556, the user may confirm the exchange, adjust or cancel the exchange transaction. At 558, if the user does not confirm the transaction, the client may inquire if the user may want to adjust the transaction. At 572, if the user wants to adjust the transaction, the process may move to 546, where the user is provided an option to select another destination program or adjust the amount for conversion. If at 572, the user does not wish to adjust the transaction, the client may notify the UVEMT server to cancel the exchange transaction at 574. The exchange transaction may then come to its conclusion at 568. On the other hand, if the user confirms the exchange at 558, the client sends a confirmation message 559 to the UVEMT server. At 560, the UVEMT server may request payment from the program provider for exchange of the amount of source points/currency. Referring to FIG. 5A, the request may be received by the program service providers at 562. At 563, the program service providers may confirm payment or acknowledge the exchange transaction. Referring To FIG. 5B, the payment confirmation/acknowledgement may be received by the UVEMT server at 564. The UVEMT server may then update the source/destination points/currency balance in one or more databases and/or tables. At 569, the UVEMT server may provide the updated points/currency balances and/or confirmation of the exchange transaction to the client and the program providers. The client may receive the updated balances and confirmation and may display a transaction summary at 570. Referring to FIG. 5A, the program providers may receive the updated balance information and confirmation of the transaction and may update their own records at 566. The transaction processing may then conclude at 568.

FIGS. 6A and 6B show logic flow diagrams illustrating equivalent value determination component embodiment of the UVEMT. Starting at 652, the component 601 may receive as input a user request to exchange a source program points/currency at 602. At 604, a determination may be made as to whether the source program provider is a UVEMT partner. In one implementation, a UVEMT partner is a program provider having an agreement with and enrolled in the UVEMT. If the source program provider is a UVEMT partner, the user's current program points/currency and exchange rate may be obtained from the provider at 606. At 608, rules and restrictions tables and/or databases may be queries using the provider's program ID to obtain rules and restrictions for the source program. At 610, programs that are restricted from participating in the requested currency/points exchange are identified. A determination may be made at 612 whether there are any unrestricted programs. If there are any unrestricted programs, such programs are identified at 614. In one implementation, the exchange rates for each of the identified unrestricted programs points/currency are obtained and compared at 616b. For example, as shown in 616b, the exchange rate (e.g., points/dollars) of source, destination 1, destination 2 and destination 3 are obtained. Using the same common denominator (e.g., dollars), the exchange rate of the source with respect to each of the destination programs may be calculated. By comparing the calculated exchange rate ratios, the most favorable ratio may be selected. In the example shown, destination 3 has the most favorable ratio, and as such destination 3 may be selected as the preferred program at 618. In another implementation, the component 601 may obtain exchange rate data relating to the source/destination programs for at least the last three consecutive time periods. As shown in 616a example, the exchange rate trend for each of the destination programs may be evaluated and a preferred exchange rate determined based on the trend analysis. In the example shown, destination 2 may be determined to be a preferred program for exchange. Upon determining a preferred program at 618, the user may be requested to select a destination program from the list of preferred and other unrestricted programs at 620. In one implementation, the restricted programs may also be displayed along with the preferred and/or unrestricted destination programs. In a further implementation, the restricted programs may be de-highlighted or grayed out to indicate that these programs may not be selected as destination programs. In one implementation, the preferred program(s) may be highlighted to clearly distinguish it from other options. In some implementations, the highlighting and de-highlighting may be mandated by exchange rate analyses (e.g., 616a, 616b). In a further implementation, one or more destination programs may be given preferential treatment based on user preferences. For example, the user may specify a ranking of his or her rewards programs. In such a case, the UVEMT server may present as preferred a destination program that the user prefers provided that the destination program is not restricted by the rules and conditions. In yet another implementation, bilateral relationship or affiliation between the source and a destination program may be taken into account while determining a preferred destination program.

The user selection of a destination program and an amount of the points/currency may be obtained at 622. In one implementation, a determination may be made whether the user selected amount meets the source program rules/restrictions at 624. For example, the source program rules and restrictions may require the source amount to be selected in groups of 500. As another example, a user may have to have select a minimum amount of points/currency or may not select more than a maximum amount of points/currency. If the user selected amount does not meet the rules and restrictions, the amount may be automatically adjusted at 530 by rounding up or down. If the user selected amount meets the rules and restrictions, or once the user selected amount has been adjusted to meet the rules and restrictions, transaction fees and/or payment for the points/currency may be billed to (or deducted from) the source/destination program providers at 626. At 628, the user may be provided the equivalent destination points/currency, completing the transaction at 650.

In one implementation, when the source program provider is not a UVEMT partner (as determined at 604) or when there are no unrestricted programs (as determined at 612), referring to FIG. 6B, the exchange may be limited to UVEMT points/currency and/or cash at 632. At 634, the component may examine transaction history to assess the demand for the source program points/currency. In one implementation, a method similar to the risk exposure thresholds and weights shown in Table 1 may be utilized to determine demand or risk exposure. At 636, the exchange rate may be set based on the weighted demand/risk exposure. At 638, the user may be provided an option to select cash and/or UVEMT points as a destination program. At 640, the component may obtain the user selected destination program and an amount of source points/currency for conversion. At 642, a determination may be made whether to adjust the exchange rates based on the amount. For example, the amount selected by the user may be too high, increasing the risk exposure and therefore may require adjustment of the exchange rate. If an adjustment is required, at 644, the exchange rate may be adjusted and the process moves on to 646. At 646, equivalent destination program amount may be determined using the original or adjusted exchange rates. At 648, the equivalent amount may be provided to the user for confirmation. In some implementations a transaction fee may be levied for the exchange transaction. The process may conclude at 650.

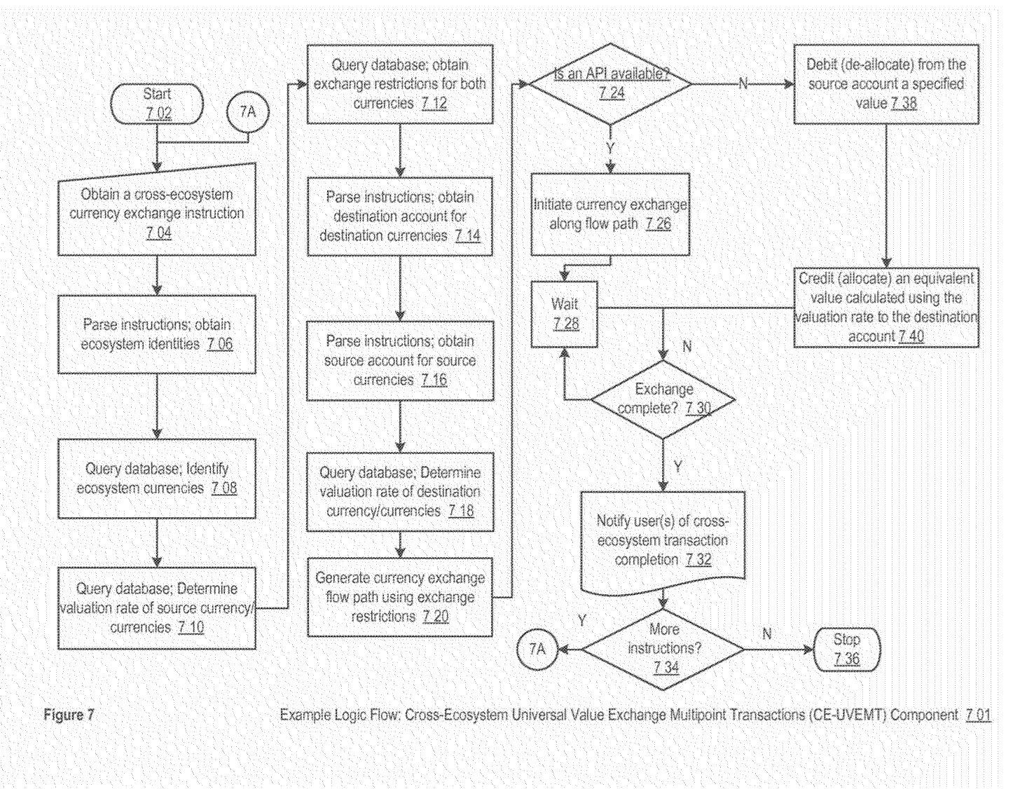

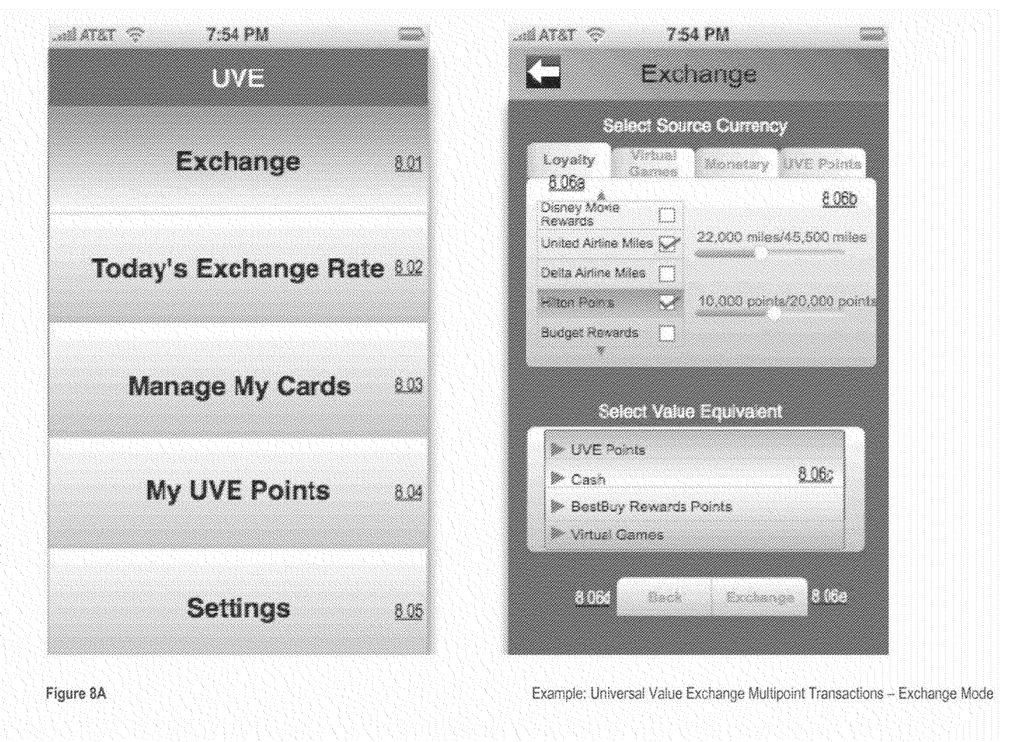

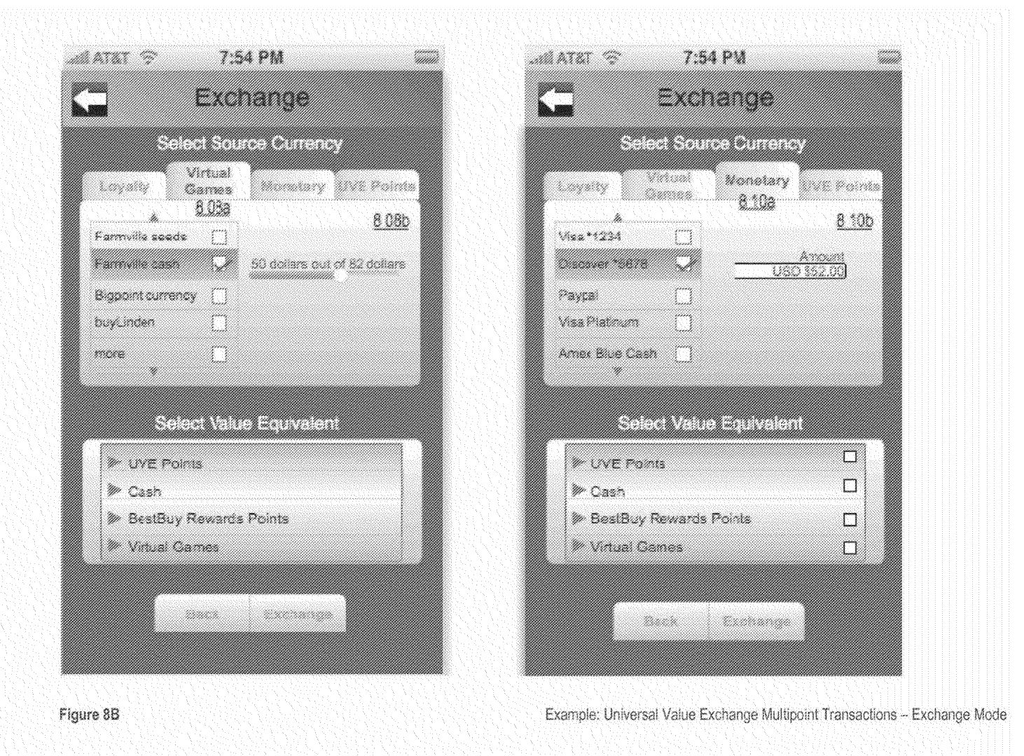

FIG. 7 shows a logic flow diagram illustrating cross-ecosystem exchange component embodiment of the UVEMT. Exemplary aspects of transforming value equivalent exchange instructions into cross-ecosystem currency exchanges in some embodiments of the UVEMT are discussed. In some implementations, a universal value exchange multipoint transactions controller may obtain one or more cross-ecosystem currency exchange instructions, e.g., 704. For example, such instructions may specify currency source details and currency destination details such as those discussed above. The universal value exchange multipoint transactions controller may parse the obtained instructions, and determine the identities of the ecosystems acting as sources and destinations of the currencies, e.g., 706. The universal value exchange multipoint transactions controller may utilize the identities of the source and destination ecosystems to determine the currency types associated with each of the source and destination currency ecosystems, e.g., 708. Using the currency types, the universal value exchange multipoint transactions controller may determine an exchange rate of each of the source and destination currencies relative to a standard currency, e.g., 710. For example, the universal value exchange multipoint transactions controller may look up the currency exchange rates of the currency types of the currency sources in a relational database using a hypertext preprocessor (PHP) script utilizing Structured Query Language (SQL) commands. In some implementations, the universal value exchange multipoint transactions controller may similarly determine the currency exchange rates of the currency types of the currency destinations, e.g., 718. In some implementations, the universal value exchange multipoint transactions controller may parse the cross-ecosystem currency exchange instructions, and obtain account information (e.g., account name, account number, routing number, password, security codes, CVV number, etc.) for the source currencies, e.g., 716. For example, the universal value exchange multipoint transactions controller may utilize such information to obtain access to the purchasing power retained in the currency sources. In some implementations, the universal value exchange multipoint transactions controller may parse the cross-ecosystem currency exchange instructions, and obtain account information for the destination currencies, e.g., 714. For example, the universal value exchange multipoint transactions controller may utilize such information to obtain access to the currency destinations for depositing purchasing power into the currency destinations.

In some implementations, the universal value exchange multipoint transactions controller may also determine whether there are any restrictions and/or conditions at each of the sources of the currencies, as well as the destinations of the currencies. For example, the universal value exchange multipoint transactions controller may query a database to obtain the restrictions and/or conditions for the sources and/or destinations. In some implementations, the universal value exchange multipoint transactions controller may generate, e.g., 720, a currency exchange flow path based on the restrictions and/or conditions at the currency sources and/or destinations. Upon generating the currency exchange flow path, the universal value exchange multipoint transactions controller may, n some implementations, if an API is available, e.g., 724, initiate currency exchange along the generated currency exchange flow path, for example, by providing request messages to the components in the currency exchange flow path to provide and/or accept currency value, based on the generated currency exchange flow path. The universal value exchange multipoint transactions controller may monitor the currency exchange flow among the components in the currency exchange flow path until the currency exchange is complete, e.g., 728-730. Alternatively if an API is not available, e.g., 724, the UVEMT controller may deallocate a specified value from the source account e.g., 738 and allocate an equivalent value calculated using the valuation rate to the destination account, e.g., 740. Upon completing the currency withdrawal and/or deposits into each of the currency accounts involved in the cross-ecosystem currency exchange, the universal value exchange controller may provide notifications, e.g., 732, for the users of the universal value exchange multipoint transactions controller notifying them of completion of the requested cross-ecosystem currency transaction. In some implementations, the universal value exchange multipoint transactions controller may determine whether there are more cross-ecosystem currency exchange instructions remaining to be processed (e.g., 734, option “Y”), and perform the cross-ecosystem currency exchanges until all the cross-ecosystem currency exchange instructions have been processed (e.g., 734, option “N”).

FIGS. 8A-D show screenshot diagrams illustrating exchange mode embodiments of the UVEMT. In some implementations, the exchange mode UIs may include various options for user selections. Referring to FIG. 8A for example, the left UI shows exchange 801, today's exchange rate 802, manage my cards 803, my UVEMT points 804 and settings 805 for user selection. Each of the options are discussed in further detail below.

When the exchange option 801 is selected from the left UI, the exchange UI (right) may be displayed. The exchange UI may display various options for selecting a source currency. For example, a user may select the loyalty tab 806a as a source currency. When the loyalty tab is selected a loyalty panel 806b may be displayed. As shown, the loyalty panel may include a listing of loyalty cards or accounts. The user may select one or more of these loyalty accounts as a source currency. Further for each selected account, the user may view the total available points/currency as well as select the amount of currency the user would like to exchange. Also shown in the right UI is a value equivalent selection panel 806c. The user may select any of the options as the destination into which the loyalty currencies may be converted to. The back button 806d allows the user to go back to the left UI, while the exchange button 806e allows the user to initiate the exchange.

Referring to FIG. 8B, when the virtual games tab 808a is selected, the virtual games panel 808b is displayed. As shown, a list of the user's virtual currencies are populated. The user may select one or more of these virtual currencies as source currencies and may specify for each currency the amount to be converted. Referring to the right UI, the monetary tab 810a is selected. The UI shows the monetary panel 810b and a list of monetary accounts. These accounts may be imported from the user's electronic wallet. Alternately, these monetary accounts may be added by the user to the UVEMT application/account. As shown, one or more of these monetary accounts may be selected, and the user may specify for each selected account, the amount to be converted (e.g., $52). Referring to FIG. 8C, when the UVEMT points tab 812a is selected, the UVEMT points panel 812b may be displayed. As shown, the UI may display the amount of points available (e.g., 5000) and allow the user to select the amount of points to be converted (e.g., 2000 points). As shown in the right UI, any of the options in the value equivalent panel may be selected. As shown the BestBuy rewards points option is selected. The panel 814 displays the user selected source currencies (e.g., United Airline Miles and Hilton points selected at panel 806b, Farmville cash selected at 808b, Discover *5678 account selected at 810b and UVEMT points selected at 812b), as well as equivalent of the selected source currencies in BestBuy rewards points. In one implementation, when a source currency cannot be converted into a selected currency, the conversion of that currency is skipped, and the rest of the currencies are converted. As shown in the right UI, the user may view the value equivalents, and if it is acceptable to the user, the user may confirm exchange by selecting the exchange button 816. Referring to FIG. 8D, once the exchange is performed, a summary 818 of the remaining points/currency balance in the programs may be displayed. For example, as shown, the UI may display the currencies that were converted 818a-d along with the remaining balance. In some other implementations, the display 818 may show the amount of currencies converted and the effective exchange rate.

FIG. 8E shows screenshot diagrams illustrating exchange rate mode embodiment of the UVEMT. As shown in the left UI, the user may select view today's exchange rate 802. The right UI 820 as shown displays a summary of the deals or exchanges available in the display panel 820a. In one implementation, these exchange messages may be provided by the program providers to encourage points/currency redemption. In other implementations, the messages may be provided as an offer to gain points/currency by performing an online or offline activity.

FIGS. 8F-I show screenshot diagrams illustrating management mode embodiment of the UVEMT. In one implementation, the selection of the option manage my cards 803 from the left UI may display the right UI. As shown, the right UI displays various cards or accounts 822a-i added to the UVEMT application or account. In one implementation, the user may select one of the card accounts, e.g., 822i. Referring to FIG. 8G, the left UI may be displayed to the user in response to his or her selection of a card account 822i. The user may have a number of options e.g., 826, 828 and 830 for selection. The about option 826 may provide a brief description about the program provider or card account. Selection of the enrollment option 828 may lead to the right UI which may display enrollment status 828a and enrollment information such as name 828b, email address 828c, member ID 828d, notification setting 828e, and/or the like. The enrollment information may be provided at the time the card is added to the UVEMT account. As shown, the user may uncheck or unselect the enrolled option 828a to unenroll from the selected program 822i. When the usage preferences option 830 is selected from the left UI, the left UI 830a of FIG. 8H may be displayed. In this UI, the user may specify how the program points/currency may be used. As shown, the user may select options 830b-e. The user may also add his or her own category for usage 630f. In some implementations, the user may also specify priority or order of usage. Referring to the right UI of FIG. 8H, the user may select option 824 to add a new card or program account. As shown in FIG. 8I, the user may enter information such as name 832a, email 832b, member ID 832c, username 832d, password 832e, short name 832f, and/or the like to add a program account to the UVEMT. The user may select the add card button 834 to add the program to the UVEMT or the cancel button 836 to cancel.

FIGS. 8J-K show screenshot diagrams illustrating UVEMT point mode embodiment of the UVEMT. When the user selects my UVEMT points option 804 from the left UI, the right UI may be displayed. As shown, various options e.g., 838, 844, 845, 846, etc., may be available. The user may select the about option 838 to read information about the UVEMT points. The enrollment option 844 may be selected to view the left UI as shown in FIG. 8K. The enrollment UI shows the enrolled status 844a, along with identifying information such as name 844b, email address 844c, phone 844d, payment device number, 844e, security code 844f, billing zip code 844g, and/or the like. The user may unenroll from the UVEMT points program by unchecking the enrolled option 844a. Referring back to FIG. 8J, when the user selects the statement option 845, a statement UI may be displayed. The statement UI (not shown) may allow the user to select a time period and obtain a statement summary of exchanges, UVEMT points balance, and/or the like. The usage preferences option 846 may be selected to view the right UI shown in FIG. 8K. As shown, the user may select usage preferences for specific purchases 846a-d for the UVEMT points. The user may also add his or her own category 646e.

FIGS. 8L-N show screenshot diagrams illustrating source/destination exchange mode embodiment of the UVEMT. In one embodiment of the UVEMT, a source UI 850 may display a list of selectable options 850a-g as possible sources for an exchange. When the source 850b (e.g., Delta SkyMiles) is selected, the destination UI 852 may be displayed. The destination UI may display a list of possible destination currencies 852a-852g into which the source currency 850b may be converted. The destination UI may also highlight or de-highlight certain options to indicate preference or restriction, For example, the destination UI shows “Mileage Plus United” 852a and “Cash” 852e as grayed out indicating that these two options cannot be selected as destination currencies. As a further example, “Hilton HHonors Point” 852c option is highlighted (e.g., bold, large font) to indicate that the exchange of the Delta SkyMiles 850b for Hilton HHonors Point is the most favorable or optimal exchange. Other options 852d-g that are selectable as destination programs may also be shown, but without any emphasis, to indicate that these options are neither preferred nor restricted.

Referring to FIG. 8M, the user may select the preferred destination program 854c. The terms UI 856 (right) may then be displayed showing the details of the exchange to be conducted. For example, the terms UI shows the exchange rate 856a that indicates that 2 Delta Skymiles is equivalent to 1 Hilton HHonors Points. The UI may also display a slide control 856b to allow the user to select the amount of Delta Skymiles that the user wishes to convert. In a further implementation, the UI may also display the equivalent Hilton HHonors Point 856c that the selected amount of Delta Skymiles would be converted to. Upon viewing the terms of the exchange, the user may select the transfer button 856d to initiate the exchange. In some implementations, the user may also select the add to exchange cart button 856e to add the exchange transaction to cart and execute at a later time. The user may also set up other exchanges and add those to the cart to simultaneously execute multiple exchanges.

Referring to FIG. 8N, the user may select a destination program 854d (e.g., BestBuy Rewards) that is not preferred, but is available for exchange. When such an option is selected, the terms UI 858 may display the terms of the exchange as shown. In contrast to the preferred exchange shown in FIG. 8M where the exchange rate ratio was 2:1, in this case the exchange rate ratio 858a may be worse (e.g., 10:1). The user may specify the amount of the source program points to use via the slider 858b. The equivalent value destination program points may be displayed at 858c. The user may execute the transfer by selecting the button 858d or may postpone it till later by selecting add to exchange cart button 858e.

Referring to FIG. 8P, showing an exemplary user checkout screenshot, a user may select from among payment options within an exemplary V.me overlay window 860a. Payment options are presented in a list, and each entry includes a row of corresponding exchange rates 860b (e.g., 100 Discover rewards points may be redeemed for $2.50 of value at Best Buy) and a row of availability timeframes 860c (e.g., instant, deferred).

Referring to FIG. 8Q, showing an exemplary mobile device user interface depicting an electronic ‘wallet’ (e.g., V.me) environment, a user is provided with a listing of various payment options and/or currency types which are resident in, and/or accessible via, his/her ‘wallet’. Payment options which may not be applied to a pending transaction are grayed out (e.g., 860d). To the left of each payment type listed are two buttons; one allowing a user to set his/her value exchange preferences, and one allowing a user to view UVEMT options associated with said pending transaction event. Upon clicking on the ‘Set Preferences’ option, a list of buttons appear, as shown in 860e. A user may elect to restrict exchanges to a specified card type, the best available rate (i.e., the most favorable exchange rate), or the fastest available option. The user may also specify that all options be displayed, such that he/she may choose a value exchange option only after viewing all available choices. Upon clicking on the ‘UVEMT Option’ option, a list of exchange offers appears, as shown in 860f. Options are presented in a list, and each entry includes a corresponding exchange rate (e.g., 100 Discover rewards points may be redeemed for $2.50 of value at Best Buy) and availability timeframe (e.g., instant, deferred), as may be applied to a pending transaction.

Referring to FIG. 8R, showing an exemplary mobile device user interface depicting an electronic ‘wallet’ (e.g., V.me) environment, a variety of value types are displayed (e.g., American Express gift card, Misc. Gift Card, Delta SkyMiles, BestBuy Gift Card, and a checking account). By way of example, assuming that a purchase was pending at Best Buy, all payment options would be shown as available 18 (i.e., ‘non-grayed’) except for Delta SkyMiles, which are not honored by Best Buy. An overlay box is presented to the user, explaining that the 11,472 Delta SkyMiles are convertible (e.g., via UVEMT) to 200 Best Buy Points, which may be further converted into $2.50 off a purchase. Also shown in FIG. 8R is an exemplary gift card (Misc. Gift Card 860g) which was previously reassigned through a value exchange (e.g., UVEMT) to the ‘wallet’ owner, but which was originally issued to John Q. Doe.

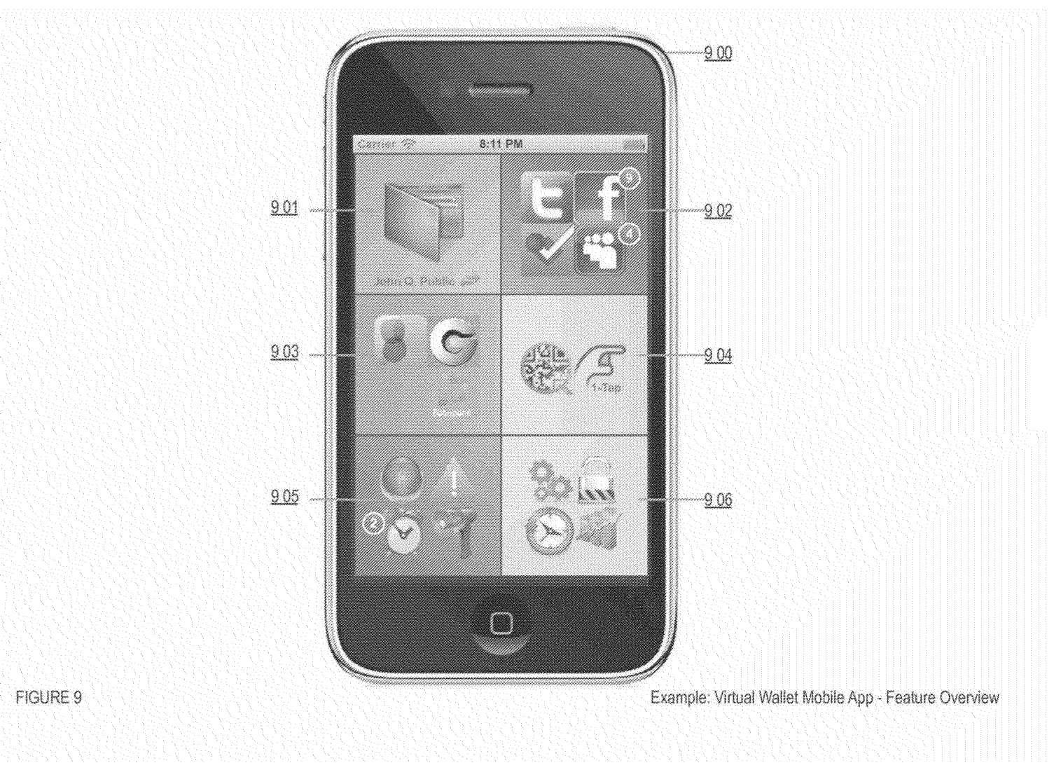

FIG. 9 shows a user interface diagram illustrating an overview of example features of virtual wallet applications in some embodiments of the UVEMT. FIG. 9 shows an illustration of various exemplary features of a virtual wallet mobile application 900. Some of the features displayed include a wallet 901, social integration via TWITTER, FACEBOOK, etc., offers and loyalty 903, snap mobile purchase 904, alerts 905 and security, setting and analytics 996. These features are explored in further detail below.

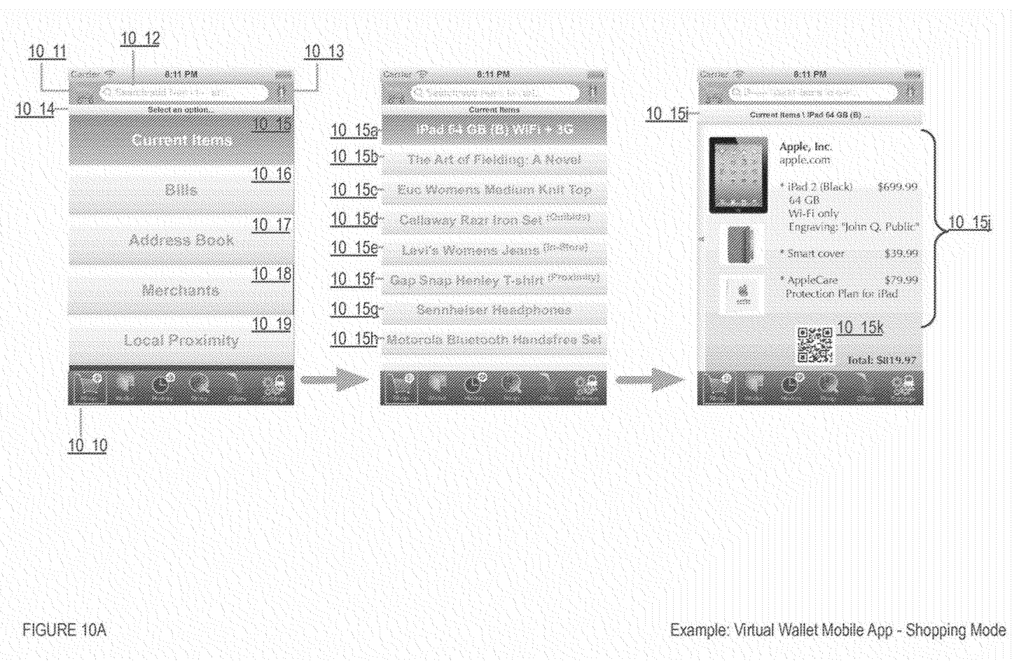

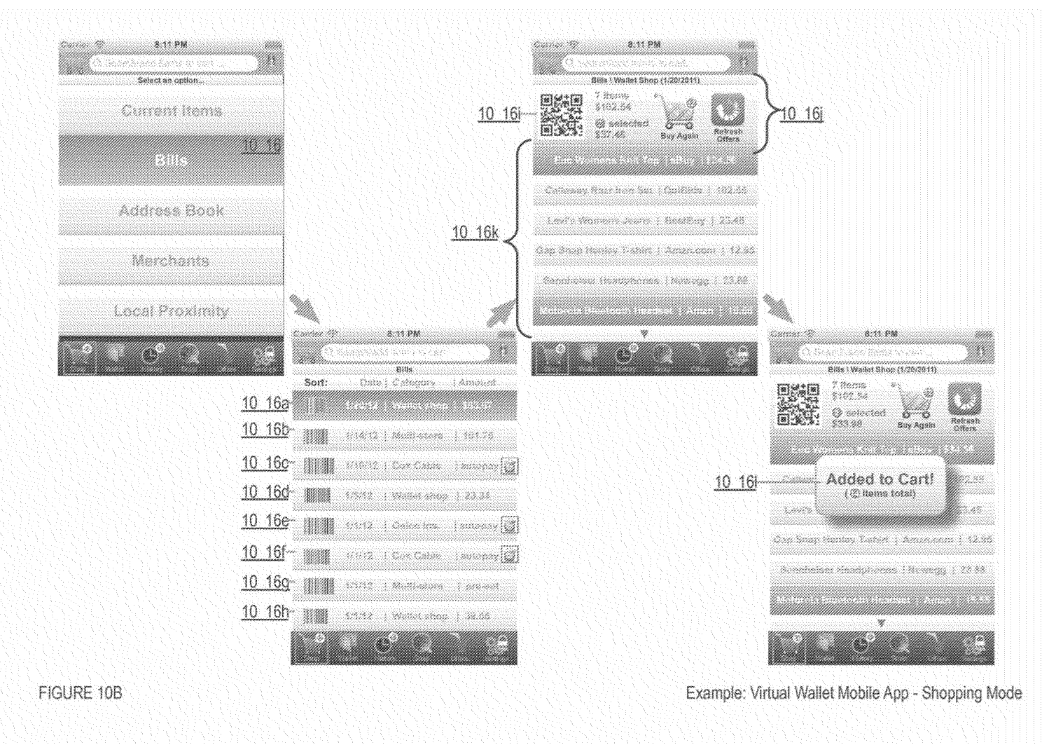

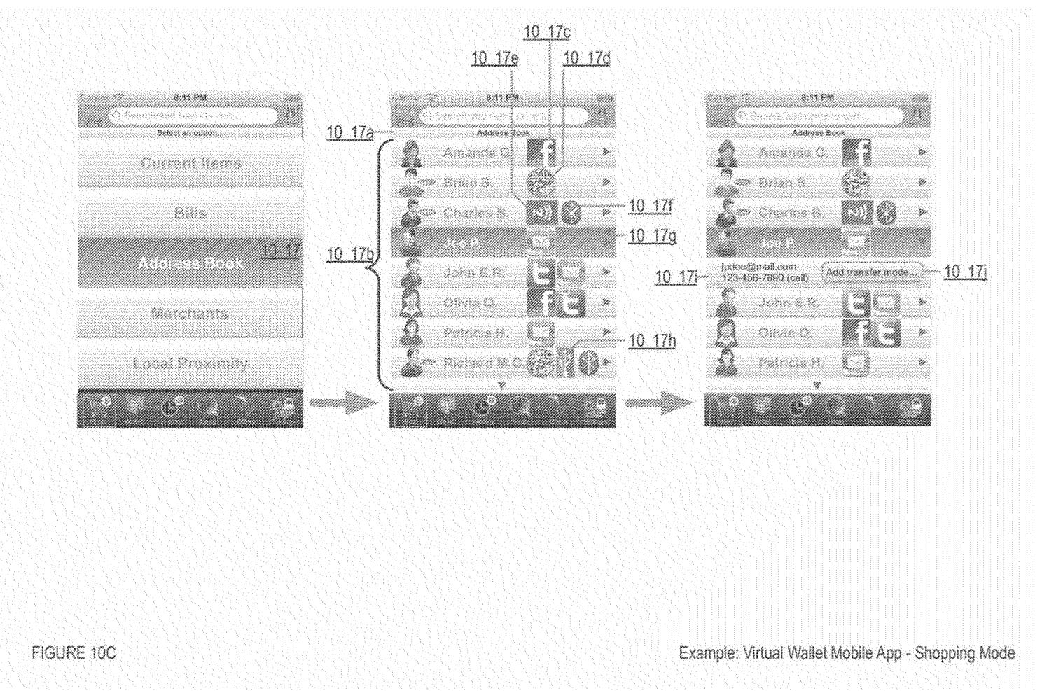

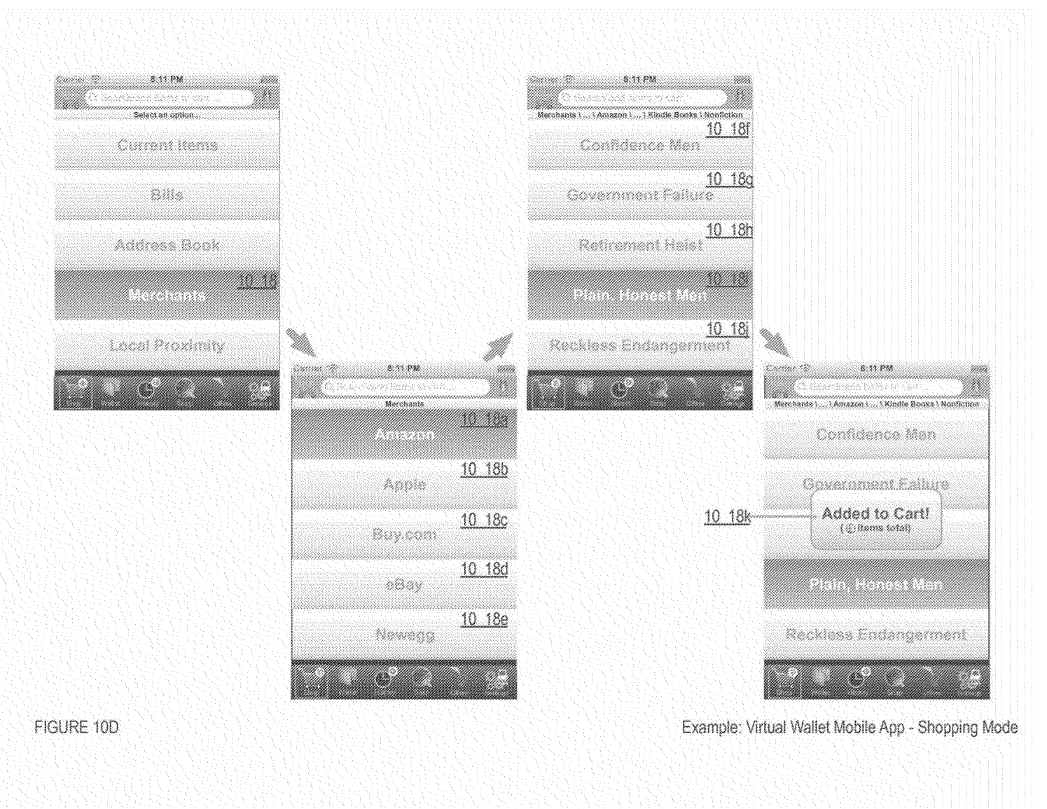

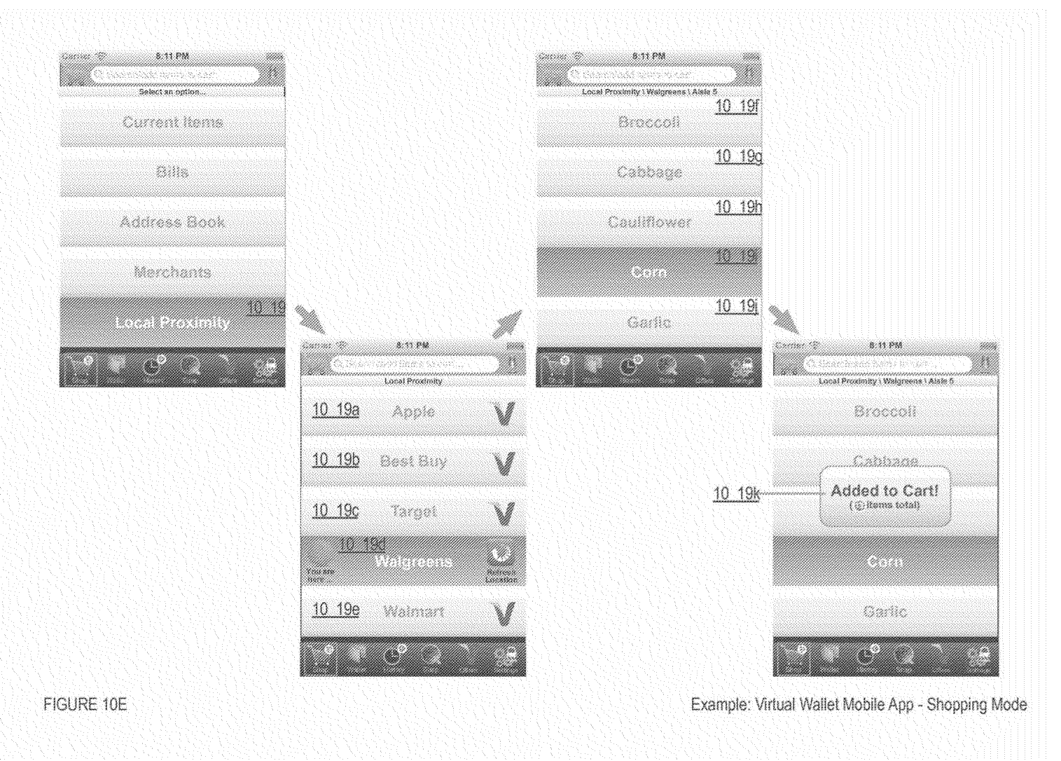

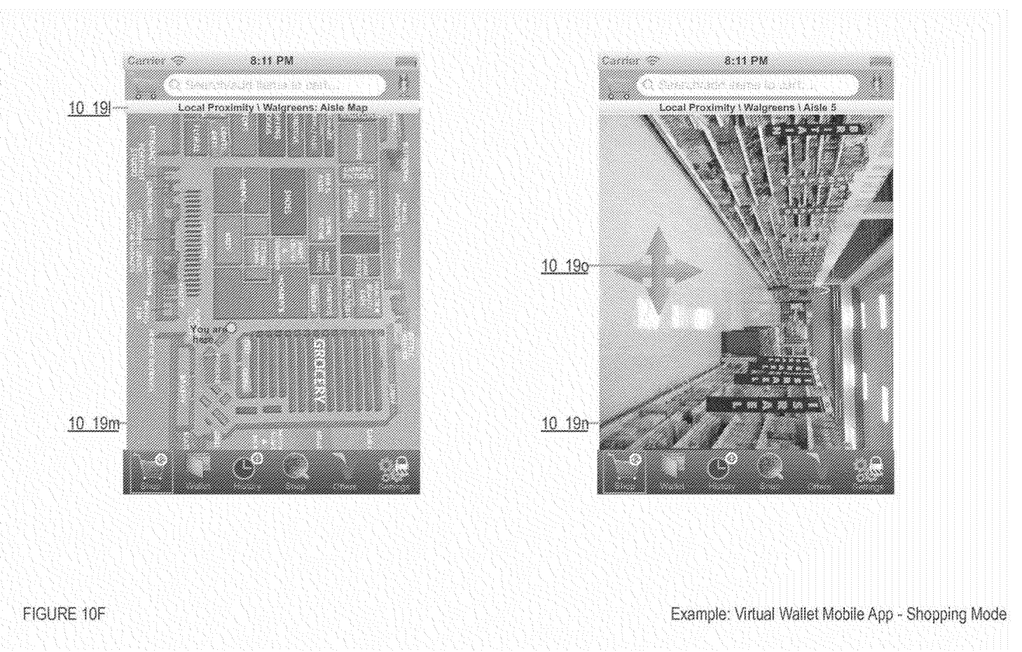

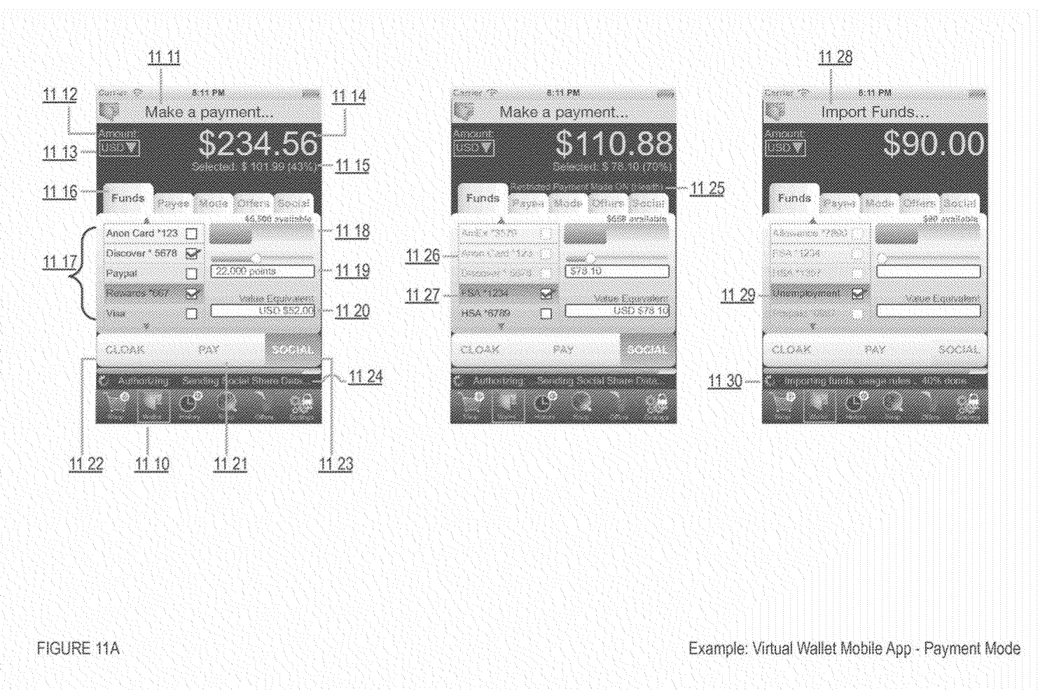

FIGS. 10A-G show user interface diagrams illustrating example features of virtual wallet applications in a shopping mode, in some embodiments of the UVEMT. With reference to FIG. 10A, some embodiments of the virtual wallet mobile app facilitate and greatly enhance the shopping experience of consumers. A variety of shopping modes, as shown in FIG. 10A, may be available for a consumer to peruse. In one implementation, for example, a user may launch the shopping mode by selecting the shop icon 1010 at the bottom of the user interface. A user may type in an item in the search field 1012 to search and/or add an item to a cart 1011. A user may also use a voice activated shopping mode by saying the name or description of an item to be searched and/or added to the cart into a microphone 1013. In a further implementation, a user may also select other shopping options 1014 such as current items 1015, bills 1016, address book 1017, merchants 1018 and local proximity 1019.

In one embodiment, for example, a user may select the option current items 1015, as shown in the left most user interface of FIG. 10A. When the current items 1015 option is selected, the middle user interface may be displayed. As shown, the middle user interface may provide a current list of items 1015a-h in a user's shopping cart 1011. A user may select an item, for example item 1015a, to view product description 1015j of the selected item and/or other items from the same merchant. The price and total payable information may also be displayed, along with a QR code 1015k that captures the information necessary to effect a snap mobile purchase transaction.

With reference to FIG. 10B, in another embodiment, a user may select the bills 1016 option. Upon selecting the bills 1016 option, the user interface may display a list of bills and/or receipts 1016a-h from one or more merchants. Next to each of the bills, additional information such as date of visit, whether items from multiple stores are present, last bill payment date, auto-payment, number of items, and/or the like may be displayed. In one example, the wallet shop bill 1016a dated Jan. 20, 2011 may be selected. The wallet shop bill selection may display a user interface that provides a variety of information regarding the selected bill. For example, the user interface may display a list of items 1016k purchased, <<1016i>>, a total number of items and the corresponding value. For example, 7 items worth $102.54 were in the selected wallet shop bill. A user may now select any of the items and select buy again to add purchase the items. The user may also refresh offers 1016j to clear any invalid offers from last time and/or search for new offers that may be applicable for the current purchase. As shown in FIG. 10B, a user may select two items for repeat purchase. Upon addition, a message 10161 may be displayed to confirm the addition of the two items, which makes the total number of items in the cart 14.

With reference to FIG. 10C, in yet another embodiment, a user may select the address book option 1017 to view the address book 107a which includes a list of contacts 1017b and make any money transfers or payments. In one embodiment, the address book may identify each contact using their names and available and/or preferred modes of payment. For example, a contact Amanda G. may be paid via social pay (e.g., via FACEBOOK) as indicated by the icon 1017c. In another example, money may be transferred to Brian S. via QR code as indicated by the QR code icon 1017d. In yet another example, Charles B. may accept payment via near field communication 1017e, Bluetooth 1017f and email 1017g. Payment may also be made via USB 1017h (e.g., by physically connecting two mobile devices) as well as other social channels such as TWITTER.

In one implementation, a user may select Joe P. for payment. Joe P., as shown in the user interface, has an email icon 1017g next to his name indicating that Joe P. accepts payment via email. When his name is selected, the user interface may display his contact information such as email, phone, etc. If a user wishes to make a payment to Joe P. by a method other than email, the user may add another transfer mode 1017j to his contact information and make a payment transfer.

With reference to FIG. 10D, in some other embodiments, a user may select merchants 1018 from the list of options in the shopping mode to view a select list of merchants 1018a-e. In one implementation, the merchants in the list may be affiliated to the wallet, or have affinity relationship with the wallet. In another implementation, the merchants may include a list of merchants meeting a user-defined or other criteria. For example, the list may be one that is curated by the user, merchants where the user most frequently shops or spends more than an x amount of sum or shopped for three consecutive months, and/or the like. In one implementation, the user may further select one of the merchants, Amazon 1018a for example. The user may then navigate through the merchant's listings to find items of interest such as 1018f-j. Directly through the wallet and without visiting the merchant site from a separate page, the user may make a selection of an item 1018j from the catalog of Amazon 1018a. As shown in the right most user interface of FIG. 10E, the selected item may then be added to cart. The message 1018k indicates that the selected item has been added to the cart, and updated number of items in the cart is now 13.

With reference to FIG. 10E, in one embodiment, there may be a local proximity option 1019 which may be selected by a user to view a list of merchants that are geographically in close proximity to the user. For example, the list of merchants 1019a-e may be the merchants that are located close to the user. In one implementation, the mobile application may further identify when the user in a store based on the user's location. For example, position icon 1019d may be displayed next to a store (e.g., Walgreens) when the user is in close proximity to the store. In one implementation, the mobile application may refresh its location periodically in case the user moved away from the store (e.g., Walgreens). In a further implementation, the user may navigate the offerings of the selected Walgreens store through the mobile application. For example, the user may navigate, using the mobile application, to items 1019f-j available on aisle 5 of Walgreens. In one implementation, the user may select corn 1019i from his or her mobile application to add to cart 1019k.

With reference to FIG. 10F, in another embodiment, the local proximity option 1019 may include a store map and a real time map features among others. For example, upon selecting the Walgreens store, the user may launch an aisle map 10191 which displays a map 1019m showing the organization of the store and the position of the user (indicated by a yellow circle). In one implementation, the user may easily configure the map to add one or more other users (e.g., user's kids) to share each other's location within the store. In another implementation, the user may have the option to launch a “store view” similar to street views in maps. The store view 1019n may display images/video of the user's surrounding. For example, if the user is about to enter aisle 5, the store view map may show the view of aisle 5. Further the user may manipulate the orientation of the map using the navigation tool 10190 to move the store view forwards, backwards, right, left as well clockwise and counterclockwise rotation

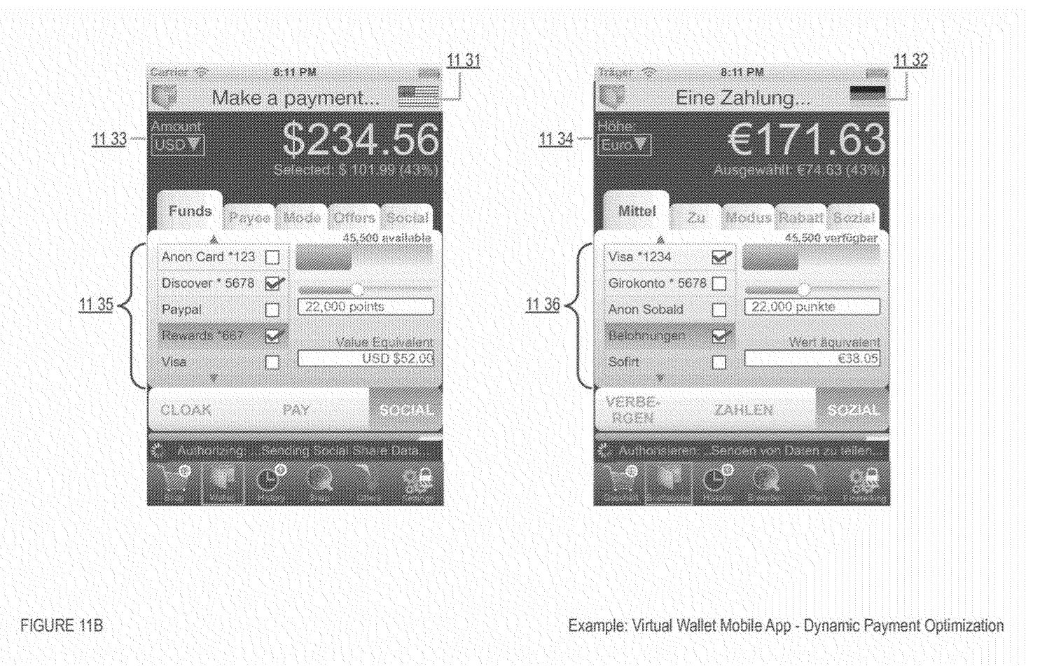

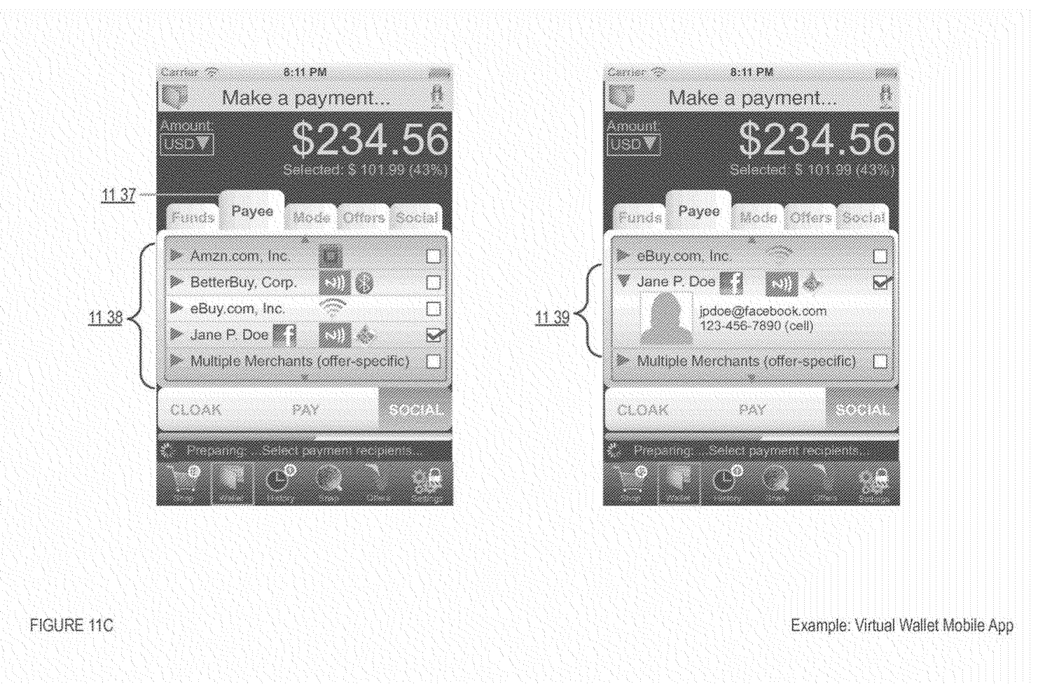

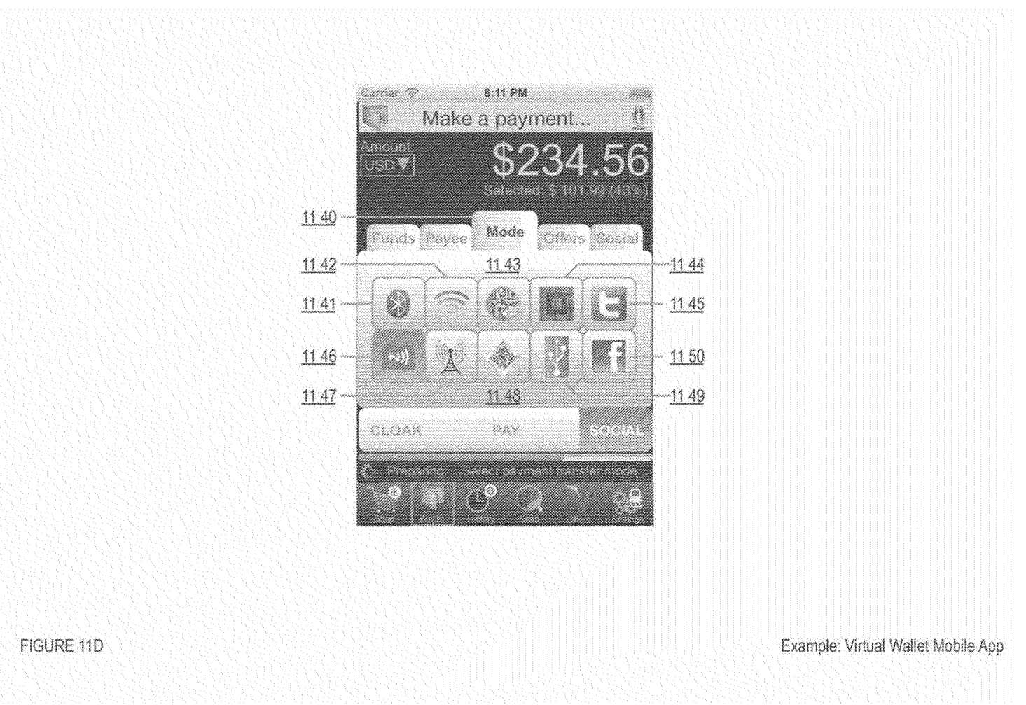

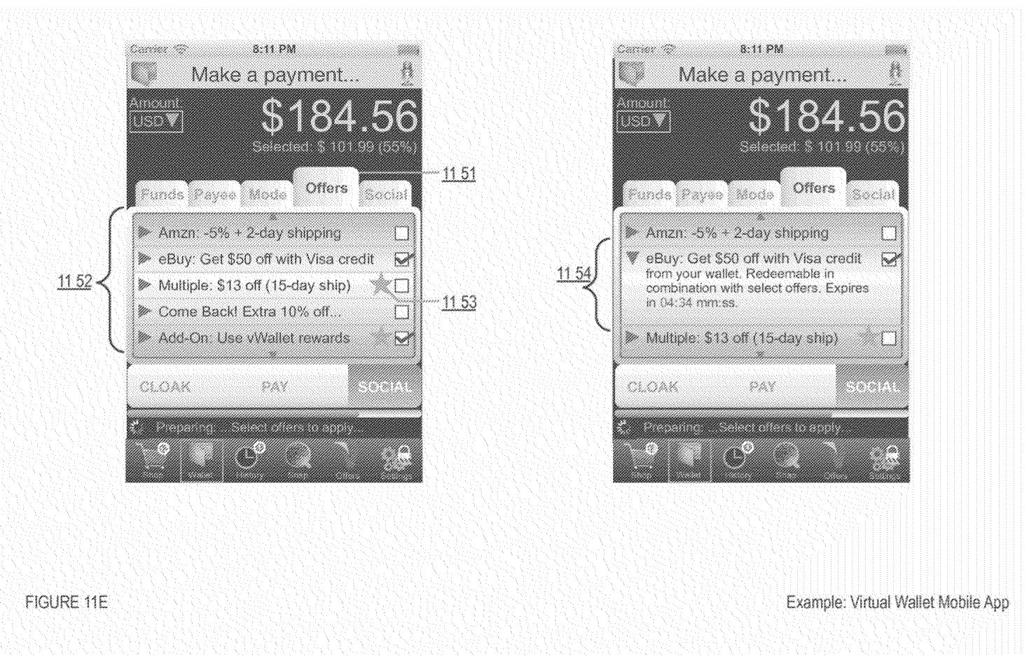

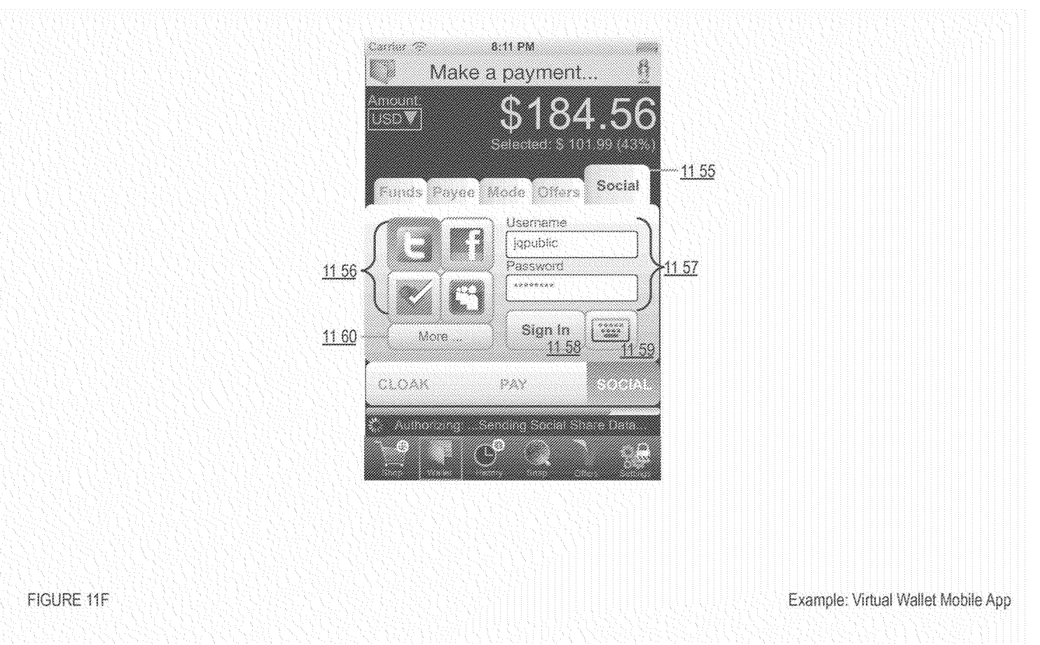

FIGS. 11A-F show user interface diagrams illustrating example features of virtual wallet applications in a payment mode, in some embodiments of the UVEMT. With reference to FIG. 1A, in one embodiment, the wallet mobile application may provide a user with a number of options for paying for a transaction via the wallet mode 1110. In one implementation, an example user interface 1111 for making a payment is shown. The user interface may clearly identify the amount 1112 and the currency 1113 for the transaction. The amount may be the amount payable and the currency may include real currencies such as dollars and Euros, as well as virtual currencies such as reward points. The amount of the transaction 1114 may also be prominently displayed on the user interface. The user may select the funds tab 1116 to select one or more forms of payment 1117, which may include various credit, debit, gift, rewards and/or prepaid cards. The user may also have the option of paying, wholly or in part, with reward points. For example, the graphical indicator 1118 on the user interface shows the number of points available, the graphical indicator 1119 shows the number of points to be used towards the amount due 234.56 and the equivalent 1120 of the number of points in a selected currency (USD, for example).

In one implementation, the user may combine funds from multiple sources to pay for the transaction. The amount 1115 displayed on the user interface may provide an indication of the amount of total funds covered so far by the selected forms of payment (e.g., Discover card and rewards points). The user may choose another form of payment or adjust the amount to be debited from one or more forms of payment until the amount 1115 matches the amount payable 1114. Once the amounts to be debited from one or more forms of payment are finalized by the user, payment authorization may begin.

In one implementation, the user may select a secure authorization of the transaction by selecting the cloak button 1122 to effectively cloak or anonymize some (e.g., pre-configured) or all identifying information such that when the user selects pay button 1121, the transaction authorization is conducted in a secure and anonymous manner. In another implementation, the user may select the pay button 1121 which may use standard authorization techniques for transaction processing. In yet another implementation, when the user selects the social button 1123, a message regarding the transaction may be communicated to one of more social networks (set up by the user) which may post or announce the purchase transaction in a social forum such as a wall post or a tweet. In one implementation, the user may select a social payment processing option 1123. The indicator 1124 may show the authorizing and sending social share data in progress.

In another implementation, a restricted payment mode 1125 may be activated for certain purchase activities such as prescription purchases. The mode may be activated in accordance with rules defined by issuers, insurers, merchants, payment processor and/or other entities to facilitate processing of specialized goods and services. In this mode, the user may scroll down the list of forms of payments 1126 under the funds tab to select specialized accounts such as a flexible spending account (FSA) 1127, health savings account (HAS), and/or the like and amounts to be debited to the selected accounts. In one implementation, such restricted payment mode 1925 processing may disable social sharing of purchase information.

In one embodiment, the wallet mobile application may facilitate importing of funds via the import funds user interface 1128. For example, a user who is unemployed may obtain unemployment benefit fund 1129 via the wallet mobile application. In one implementation, the entity providing the funds may also configure rules for using the fund as shown by the processing indicator message 1130. The wallet may read and apply the rules prior, and may reject any purchases with the unemployment funds that fail to meet the criteria set by the rules. Example criteria may include, for example, merchant category code (MCC), time of transaction, location of transaction, and/or the like. As an example, a transaction with a grocery merchant having MCC 5411 may be approved, while a transaction with a bar merchant having an MCC 5813 may be refused.

With reference to FIG. 11B, in one embodiment, the wallet mobile application may facilitate dynamic payment optimization based on factors such as user location, preferences and currency value preferences among others. For example, when a user is in the United States, the country indicator 1131 may display a flag of the United States and may set the currency 1133 to the United States. In a further implementation, the wallet mobile application may automatically rearrange the order in which the forms of payments 1135 are listed to reflect the popularity or acceptability of various forms of payment. In one implementation, the arrangement may reflect the user's preference, which may not be changed by the wallet mobile application.

Similarly, when a German user operates a wallet in Germany, the mobile wallet application user interface may be dynamically updated to reflect the country of operation 1132 and the currency 1134. In a further implementation, the wallet application may rearrange the order in which different forms of payment 1136 are listed based on their acceptance level in that country. Of course, the order of these forms of payments may be modified by the user to suit his or her own preferences.

With reference to FIG. 11C, in one embodiment, the payee tab 1137 in the wallet mobile application user interface may facilitate user selection of one or more payees receiving the funds selected in the funds tab. In one implementation, the user interface may show a list of all payees 1138 with whom the user has previously transacted or available to transact. The user may then select one or more payees. The payees 1138 may include larger merchants such as Amazon.com Inc., and individuals such as Jane P. Doe. Next to each payee name, a list of accepted payment modes for the payee may be displayed. In one implementation, the user may select the payee Jane P. Doe 1139 for receiving payment. Upon selection, the user interface may display additional identifying information relating to the payee.

With reference to FIG. 11D, in one embodiment, the mode tab 1940 may facilitate selection of a payment mode accepted by the payee. A number of payment modes may be available for selection. Example modes include, blue tooth 1141, wireless 1142, snap mobile by user-obtained QR code 1143, secure chip 1144, TWITTER 1145, near-field communication (NFC) 1146, cellular 1147, snap mobile by user-provided QR code 1148, USB 1149 and FACEBOOK 1150, among others. In one implementation, only the payment modes that are accepted by the payee may be selectable by the user. Other non-accepted payment modes may be disabled.

With reference to FIG. 11E, in one embodiment, the offers tab 1151 may provide real-time offers that are relevant to items in a user's cart for selection by the user. The user may select one or more offers from the list of applicable offers 1152 for redemption. In one implementation, some offers may be combined, while others may not. When the user selects an offer that may not be combined with another offer, the unselected offers may be disabled. In a further implementation, offers that are recommended by the wallet application's recommendation engine may be identified by an indicator, such as the one shown by 1153. In a further implementation, the user may read the details of the offer by expanding the offer row as shown by 1154 in the user interface.

With reference to FIG. 11F, in one embodiment, the social tab 1155 may facilitate integration of the wallet application with social channels 1156. In one implementation, a user may select one or more social channels 1156 and may sign in to the selected social channel from the wallet application by providing to the wallet application the social channel user name and password 1157 and signing in 1158. The user may then use the social button 1159 to send or receive money through the integrated social channels. In a further implementation, the user may send social share data such as purchase information or links through integrated social channels. In another embodiment, the user supplied login credentials may allow UVEMT to engage in interception parsing.

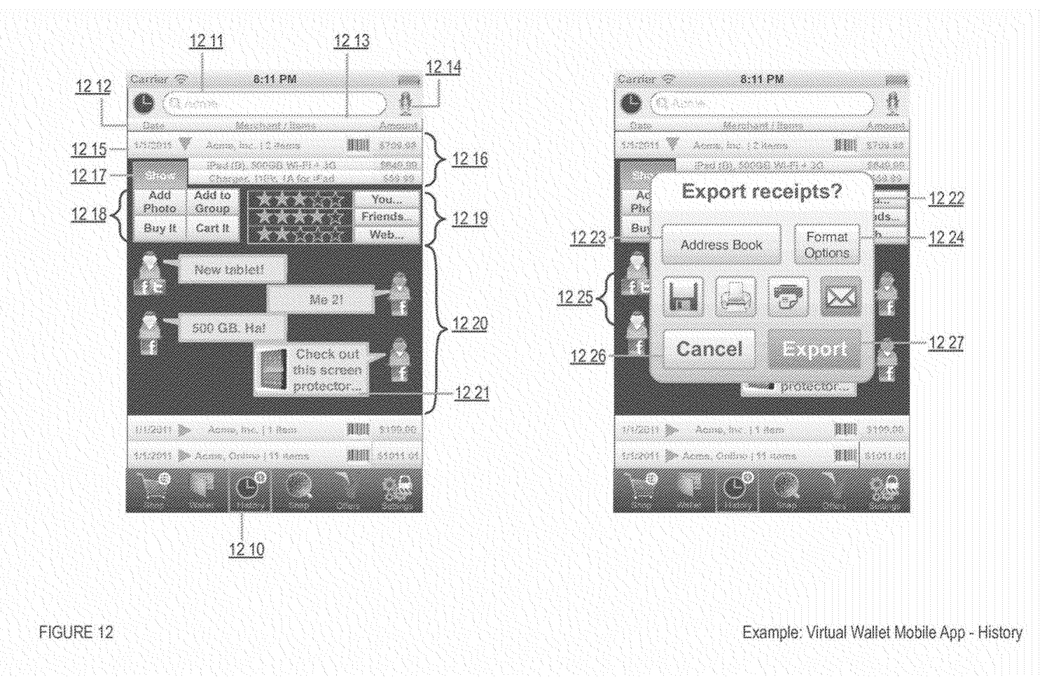

FIG. 12 shows a user interface diagram illustrating example features of virtual wallet applications, in a history mode, in some embodiments of the UVEMT. In one embodiment, a user may select the history mode 1210 to view a history of prior purchases and perform various actions on those prior purchases. For example, a user may enter a merchant identifying information such as name, product, MCC, and/or the like in the search bar 1211. In another implementation, the user may use voice activated search feature by clicking on the microphone icon 1214. The wallet application may query the storage areas in the mobile device or elsewhere (e.g., one or more databases and/or tables remote from the mobile device) for transactions matching the search keywords. The user interface may then display the results of the query such as transaction 1215. The user interface may also identify the date 1212 of the transaction, the merchants and items 1213 relating to the transaction, a barcode of the receipt confirming that a transaction was made, the amount of the transaction and any other relevant information.

In one implementation, the user may select a transaction, for example transaction 1215, to view the details of the transaction. For example, the user may view the details of the items associated with the transaction and the amounts 1216 of each item. In a further implementation, the user may select the show option 1217 to view actions 1218 that the user may take in regards to the transaction or the items in the transaction. For example, the user may add a photo to the transaction (e.g., a picture of the user and the iPad the user bought). In a further implementation, if the user previously shared the purchase via social channels, a post including the photo may be generated and sent to the social channels for publishing. In one implementation, any sharing may be optional, and the user, who did not share the purchase via social channels, may still share the photo through one or more social channels of his or her choice directly from the history mode of the wallet application. In another implementation, the user may add the transaction to a group such as company expense, home expense, travel expense or other categories set up by the user. Such grouping may facilitate year-end accounting of expenses, submission of work expense reports, submission for value added tax (VAT) refunds, personal expenses, and/or the like. In yet another implementation, the user may buy one or more items purchased in the transaction. The user may then execute a transaction without going to the merchant catalog or site to find the items. In a further implementation, the user may also cart one or more items in the transaction for later purchase.

The history mode, in another embodiment, may offer facilities for obtaining and displaying ratings 1219 of the items in the transaction. The source of the ratings may be the user, the user's friends (e.g., from social channels, contacts, etc.), reviews aggregated from the web, and/or the like. The user interface in some implementations may also allow the user to post messages to other users of social channels (e.g., TWITTER or FACEBOOK). For example, the display area 1220 shows FACEBOOK message exchanges between two users. In one implementation, a user may share a link via a message 1221. Selection of such a message having embedded link to a product may allow the user to view a description of the product and/or purchase the product directly from the history mode.

In one embodiment, the history mode may also include facilities for exporting receipts. The export receipts pop up 1222 may provide a number of options for exporting the receipts of transactions in the history. For example, a user may use one or more of the options 1225, which include save (to local mobile memory, to server, to a cloud account, and/or the like), print to a printer, fax, email, and/or the like. The user may utilize his or her address book 1223 to look up email or fax number for exporting. The user may also specify format options 1224 for exporting receipts. Example format options may include, without limitation, text files (.doc, .txt, .rtf, .iif, etc.), spreadsheet (.csv, .xls, etc.), image files (.jpg, .tff, .png, etc.), portable document format (.pdf), postscript (.ps), and/or the like. The user may then click or tap the export button 1227 to initiate export of receipts.

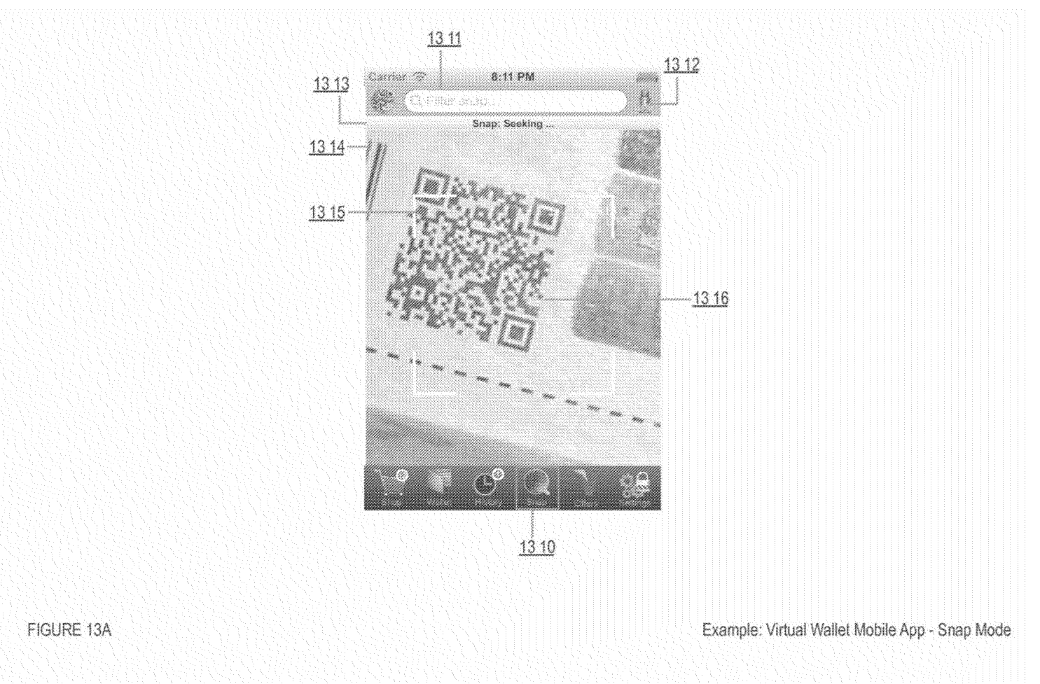

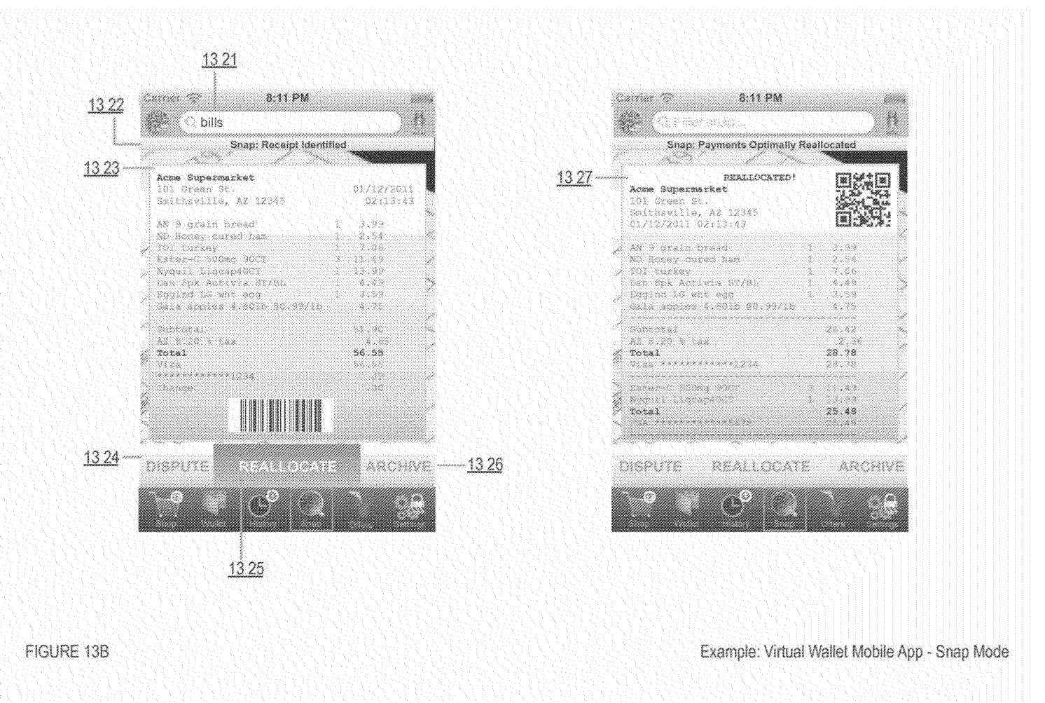

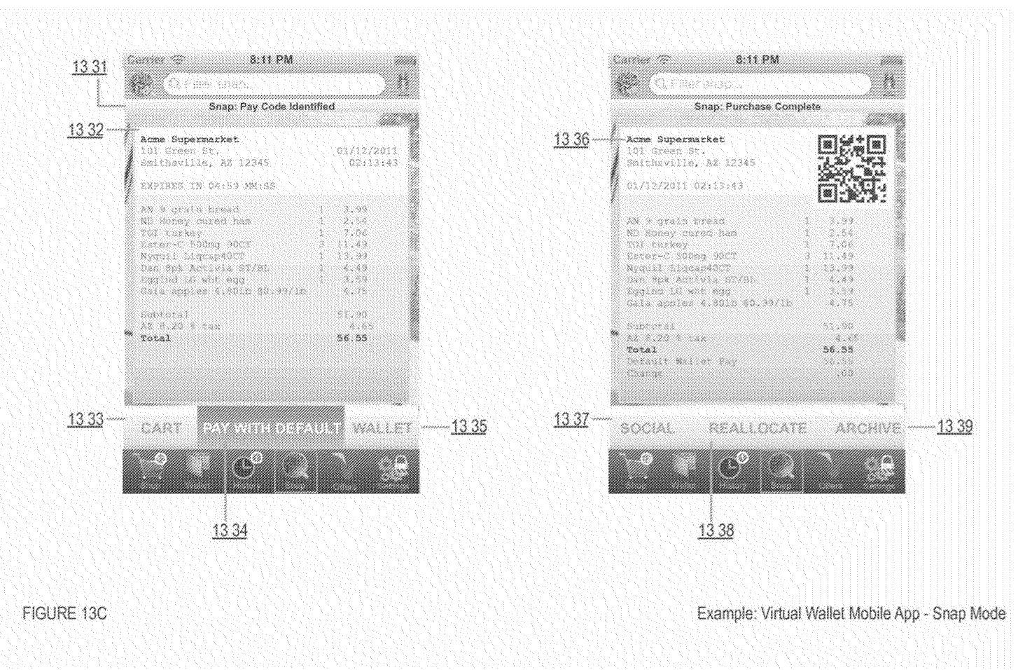

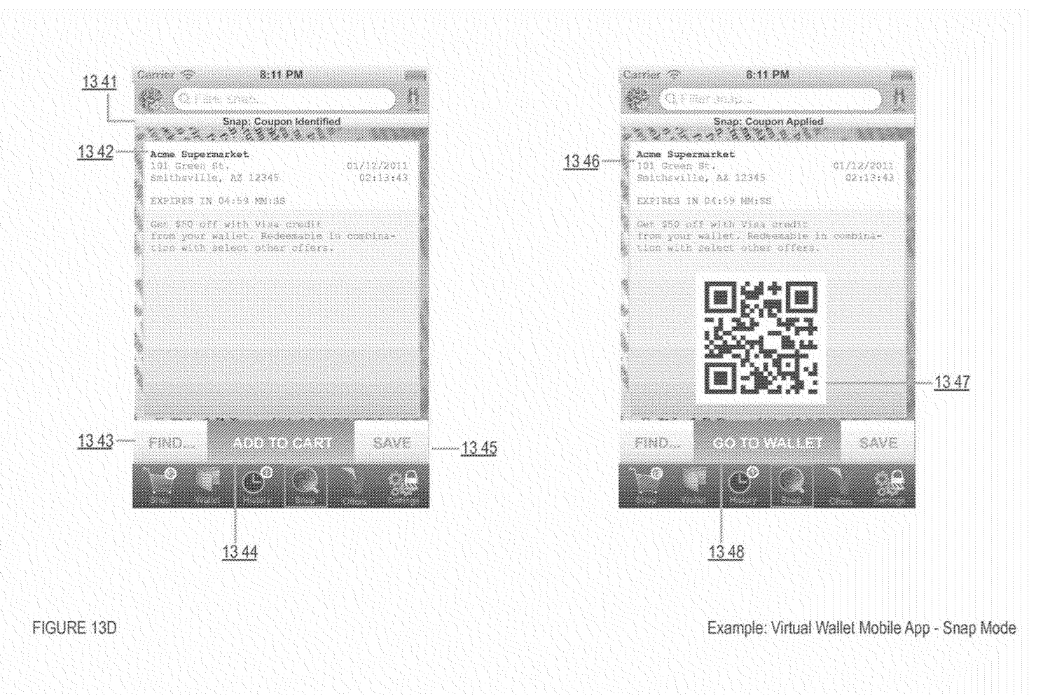

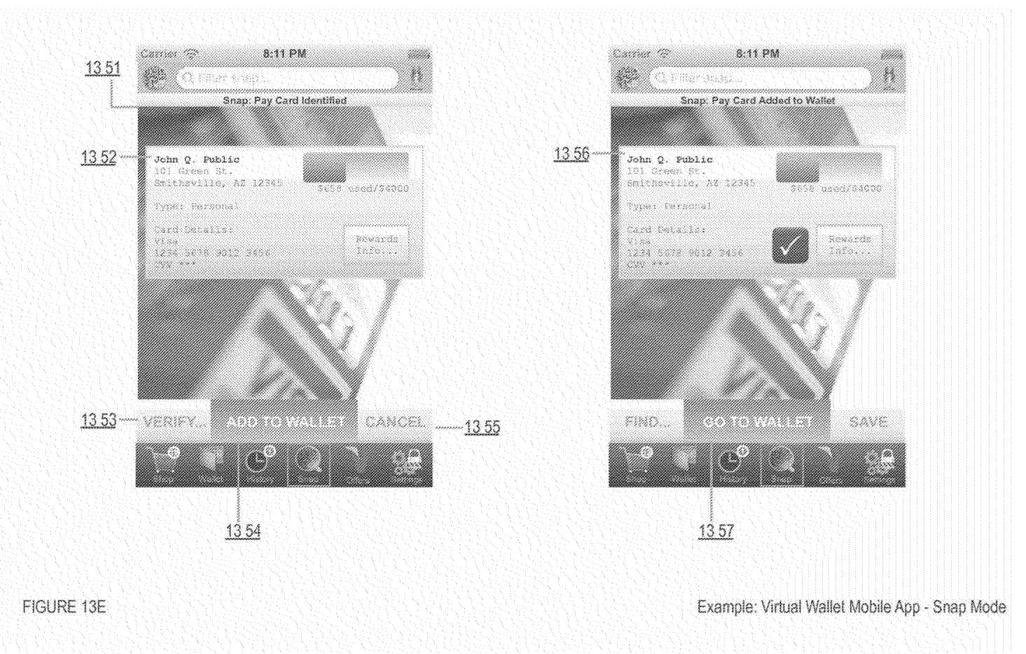

FIGS. 13A-E show user interface diagrams illustrating example features of virtual wallet applications in a snap mode, in some embodiments of the UVEMT. With reference to FIG. 13A, in one embodiment, a user may select the snap mode 2110 to access its snap features. The snap mode may handle any machine-readable representation of data. Examples of such data may include linear and 2D bar codes such as UPC code and QR codes. These codes may be found on receipts, product packaging, and/or the like. The snap mode may also process and handle pictures of receipts, products, offers, credit cards or other payment devices, and/or the like. An example user interface in snap mode is shown in FIG. 13A. A user may use his or her mobile phone to take a picture of a QR code 1315 and/or a barcode 1314. In one implementation, the bar 1313 and snap frame 1315 may assist the user in snapping codes properly. For example, the snap frame 1315, as shown, does not capture the entirety of the code 1316. As such, the code captured in this view may not be resolvable as information in the code may be incomplete. This is indicated by the message on the bar 1313 that indicates that the snap mode is still seeking the code. When the code 1316 is completely framed by the snap frame 1315, the bar message may be updated to, for example, “snap found.” Upon finding the code, in one implementation, the user may initiate code capture using the mobile device camera. In another implementation, the snap mode may automatically snap the code using the mobile device camera.

With reference to FIG. 13B, in one embodiment, the snap mode may facilitate payment reallocation post transaction. For example, a user may buy grocery and prescription items from a retailer Acme Supermarket. The user may, inadvertently or for ease of checkout for example, use his or her Visa card to pay for both grocery and prescription items. However, the user may have an FSA account that could be used to pay for prescription items, and which would provide the user tax benefits. In such a situation, the user may use the snap mode to initiate transaction reallocation.

As shown, the user may enter a search term (e.g., bills) in the search bar 2121. The user may then identify in the tab 1322 the receipt 1323 the user wants to reallocate. Alternatively, the user may directly snap a picture of a barcode on a receipt, and the snap mode may generate and display a receipt 1323 using information from the barcode. The user may now reallocate 1325. In some implementations, the user may also dispute the transaction 1324 or archive the receipt 1326.

In one implementation, when the reallocate button 1325 is selected, the wallet application may perform optical character recognition (OCR) of the receipt. Each of the items in the receipt may then be examined to identify one or more items which could be charged to which payment device or account for tax or other benefits such as cash back, reward points, etc. In this example, there is a tax benefit if the prescription medication charged to the user's Visa card is charged to the user's FSA. The wallet application may then perform the reallocation as the back end. The reallocation process may include the wallet contacting the payment processor to credit the amount of the prescription medication to the Visa card and debit the same amount to the user's FSA account. In an alternate implementation, the payment processor (e.g., Visa or MasterCard) may obtain and OCR the receipt, identify items and payment accounts for reallocation and perform the reallocation. In one implementation, the wallet application may request the user to confirm reallocation of charges for the selected items to another payment account. The receipt 1327 may be generated after the completion of the reallocation process. As discussed, the receipt shows that some charges have been moved from the Visa account to the FSA.

With reference to FIG. 13C, in one embodiment, the snap mode may facilitate payment via pay code such as barcodes or QR codes. For example, a user may snap a QR code of a transaction that is not yet complete. The QR code may be displayed at a merchant POS terminal, a web site, or a web application and may be encoded with information identifying items for purchase, merchant details and other relevant information. When the user snaps such as a QR code, the snap mode may decode the information in the QR code and may use the decoded information to generate a receipt 1332. Once the QR code is identified, the navigation bar 1331 may indicate that the pay code is identified. The user may now have an option to add to cart 1333, pay with a default payment account 1334 or pay with wallet 1335.

In one implementation, the user may decide to pay with default 1334. The wallet application may then use the user's default method of payment, in this example the wallet, to complete the purchase transaction. Upon completion of the transaction, a receipt may be automatically generated for proof of purchase. The user interface may also be updated to provide other options for handling a completed transaction. Example options include social 1337 to share purchase information with others, reallocate 1338 as discussed with regard to FIG. 13B, and archive 1339 to store the receipt.

With reference to FIG. 13D, in one embodiment, the snap mode may also facilitate offer identification, application and storage for future use. For example, in one implementation, a user may snap an offer code 1341 (e.g., a bar code, a QR code, and/or the like). The wallet application may then generate an offer text 1342 from the information encoded in the offer code. The user may perform a number of actions on the offer code. For example, the user use the find button 1343 to find all merchants who accept the offer code, merchants in the proximity who accept the offer code, products from merchants that qualify for the offer code, and/or the like. The user may also apply the offer code to items that are currently in the cart using the add to cart button 1344. Furthermore, the user may also save the offer for future use by selecting the save button 1345.

In one implementation, after the offer or coupon 1346 is applied, the user may have the option to find qualifying merchants and/or products using find, the user may go to the wallet using 1348, and the user may also save the offer or coupon 1346 for later use.

With reference to FIG. 13E, in one embodiment, the snap mode may also offer facilities for adding a funding source to the wallet application. In one implementation, a pay card such as a credit card, debit card, pre-paid card, smart card and other pay accounts may have an associated code such as a bar code or QR code. Such a code may have encoded therein pay card information including, but not limited to, name, address, pay card type, pay card account details, balance amount, spending limit, rewards balance, and/or the like. In one implementation, the code may be found on a face of the physical pay card. In another implementation, the code may be obtained by accessing an associated online account or another secure location. In yet another implementation, the code may be printed on a letter accompanying the pay card. A user, in one implementation, may snap a picture of the code. The wallet application may identify the pay card 1351 and may display the textual information 1352 encoded in the pay card. The user may then perform verification of the information 1352 by selecting the verify button 1353. In one implementation, the verification may include contacting the issuer of the pay card for confirmation of the decoded information 1352 and any other relevant information. In one implementation, the user may add the pay card to the wallet by selecting the ‘add to wallet’ button 1354. The instruction to add the pay card to the wallet may cause the pay card to appear as one of the forms of payment under the funds tab 1116 discussed in FIG. 11A. The user may also cancel importing of the pay card as a funding source by selecting the cancel button 1355. When the pay card has been added to the wallet, the user interface may be updated to indicate that the importing is complete via the notification display 1356. The user may then access the wallet 1357 to begin using the added pay card as a funding source.

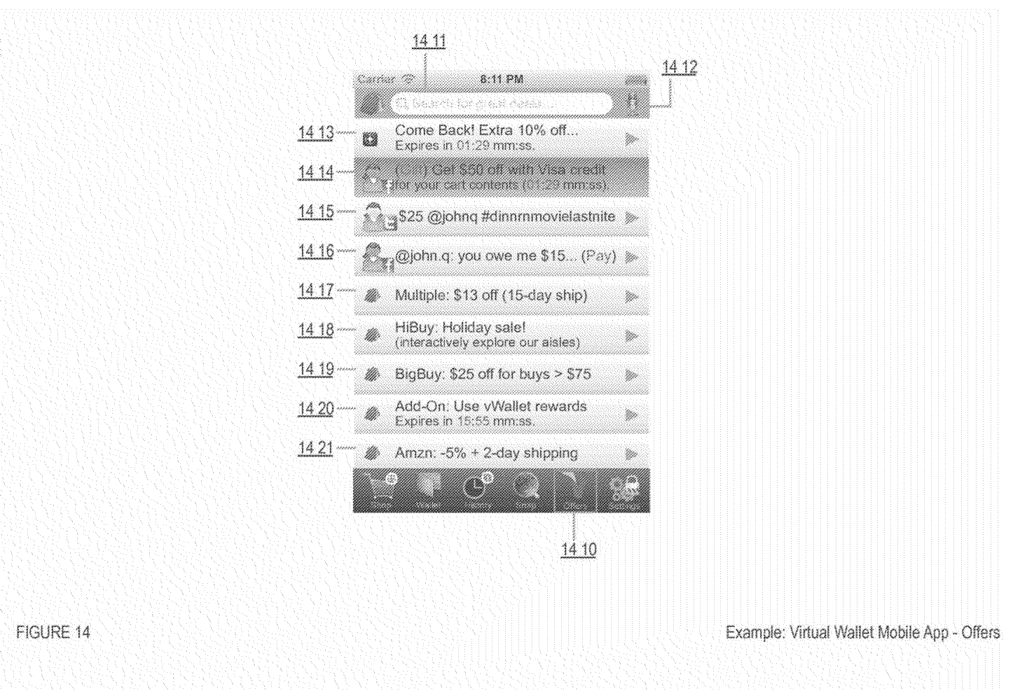

FIG. 14 shows a user interface diagram illustrating example features of virtual wallet applications, in an offers mode, in some embodiments of the UVEMT. In some implementations, the UVEMT may allow a user to search for offers for products and/or services from within the virtual wallet mobile application. For example, the user may enter text into a graphical user interface (“GUI”) element 1411, or issue voice commands by activating GUI element 1412 and speaking commands into the device. In some implementations, the UVEMT may provide offers based on the user's prior behavior, demographics, current location, current cart selection or purchase items, and/or the like. For example, if a user is in a brick-and-mortar store, or an online shopping website, and leaves the (virtual) store, then the merchant associated with the store may desire to provide a sweetener deal to entice the consumer back into the (virtual) store. The merchant may provide such an offer 1413. For example, the offer may provide a discount, and may include an expiry time. In some implementations, other users may provide gifts (e.g., 1414) to the user, which the user may redeem. In some implementations, the offers section may include alerts as to payment of funds outstanding to other users (e.g., 1415). In some implementations, the offers section may include alerts as to requesting receipt of funds from other users (e.g., 1416). For example, such a feature may identify funds receivable from other applications (e.g., mail, calendar, tasks, notes, reminder programs, alarm, etc.), or by a manual entry by the user into the virtual wallet application. In some implementations, the offers section may provide offers from participating merchants in the UVEMT, e.g., 1417-1419, 1420. These offers may sometimes be assembled using a combination of participating merchants, e.g., 1417. In some implementations, the UVEMT itself may provide offers for users contingent on the user utilizing particular payment forms from within the virtual wallet application, e.g., 1420.

FIGS. 15A-B show user interface diagrams illustrating example features of virtual wallet applications, in a security and privacy mode, in some embodiments of the UVEMT. With reference to FIG. 15A, in some implementations, the user may be able to view and/or modify the user profile and/or settings of the user, e.g., by activating a user interface element. For example, the user may be able to view/modify a user name (e.g., 1511a-b), account number (e.g., 1512a-b), user security access code (e.g., 1513-b), user pin (e.g., 1514-b), user address (e.g., 1515-b), social security number associated with the user (e.g., 1516-b), current device GPS location (e.g., 1517-b), user account of the merchant in whose store the user currently is (e.g., 1518-b), the user's rewards accounts (e.g., 1519-b), and/or the like. In some implementations, the user may be able to select which of the data fields and their associated values should be transmitted to facilitate the purchase transaction, thus providing enhanced data security for the user. For example, in the example illustration in FIG. 15A, the user has selected the name 1511a, account number 1512a, security code 1513a, merchant account ID 1518a and rewards account ID 1519a as the fields to be sent as part of the notification to process the purchase transaction. In some implementations, the user may toggle the fields and/or data values that are sent as part of the notification to process the purchase transactions. In some implementations, the app may provide multiple screens of data fields and/or associated values stored for the user to select as part of the purchase order transmission. In some implementations, the app may provide the UVEMT with the GPS location of the user. Based on the GPS location of the user, the UVEMT may determine the context of the user (e.g., whether the user is in a store, doctor's office, hospital, postal service office, etc.). Based on the context, the user app may present the appropriate fields to the user, from which the user may select fields and/or field values to send as part of the purchase order transmission.

For example, a user may go to doctor's office and desire to pay the co-pay for doctor's appointment. In addition to basic transactional information such as account number and name, the app may provide the user the ability to select to transfer medical records, health information, which may be provided to the medical provider, insurance company, as well as the transaction processor to reconcile payments between the parties. In some implementations, the records may be sent in a Health Insurance Portability and Accountability Act (HIPAA)-compliant data format and encrypted, and only the recipients who are authorized to view such records may have appropriate decryption keys to decrypt and view the private user information.

With reference to FIG. 15B, in some implementations, the app executing on the user's device may provide a “VerifyChat” feature for fraud prevention. For example, the UVEMT may detect an unusual and/or suspicious transaction. The UVEMT may utilize the VerifyChat feature to communicate with the user, and verify the authenticity of the originator of the purchase transaction. In various implementations, the UVEMT may send electronic mail message, text (SMS) messages, Facebook® messages, Twitter™ tweets, text chat, voice chat, video chat (e.g., Apple FaceTime), and/or the like to communicate with the user. For example, the UVEMT may initiate a video challenge for the user, e.g., 1521. For example, the user may need to present him/her-self via a video chat, e.g., 1522. In some implementations, a customer service representative, e.g., agent 1524, may manually determine the authenticity of the user using the video of the user. In some implementations, the UVEMT may utilize face, biometric and/or like recognition (e.g., using pattern classification techniques) to determine the identity of the user. In some implementations, the app may provide reference marker (e.g., cross-hairs, target box, etc.), e.g., 1523, so that the user may the video to facilitate the UVEMT's automated recognition of the user. In some implementations, the user may not have initiated the transaction, e.g., the transaction is fraudulent. In such implementations, the user may cancel the challenge. The UVEMT may then cancel the transaction, and/or initiate fraud investigation procedures on behalf of the user.

In some implementations, the UVEMT may utilize a text challenge procedure to verify the authenticity of the user, e.g., 1525. For example, the UVEMT may communicate with the user via text chat, SMS messages, electronic mail, Facebook® messages, Twitter™ tweets, and/or the like. The UVEMT may pose a challenge question, e.g., 1526, for the user. The app may provide a user input interface element(s) (e.g., virtual keyboard 1528) to answer the challenge question posed by the UVEMT. In some implementations, the challenge question may be randomly selected by the UVEMT automatically; in some implementations, a customer service representative may manually communicate with the user. In some implementations, the user may not have initiated the transaction, e.g., the transaction is fraudulent. In such implementations, the user may cancel the text challenge. The UVEMT may cancel the transaction, and/or initiate fraud investigation on behalf of the user.

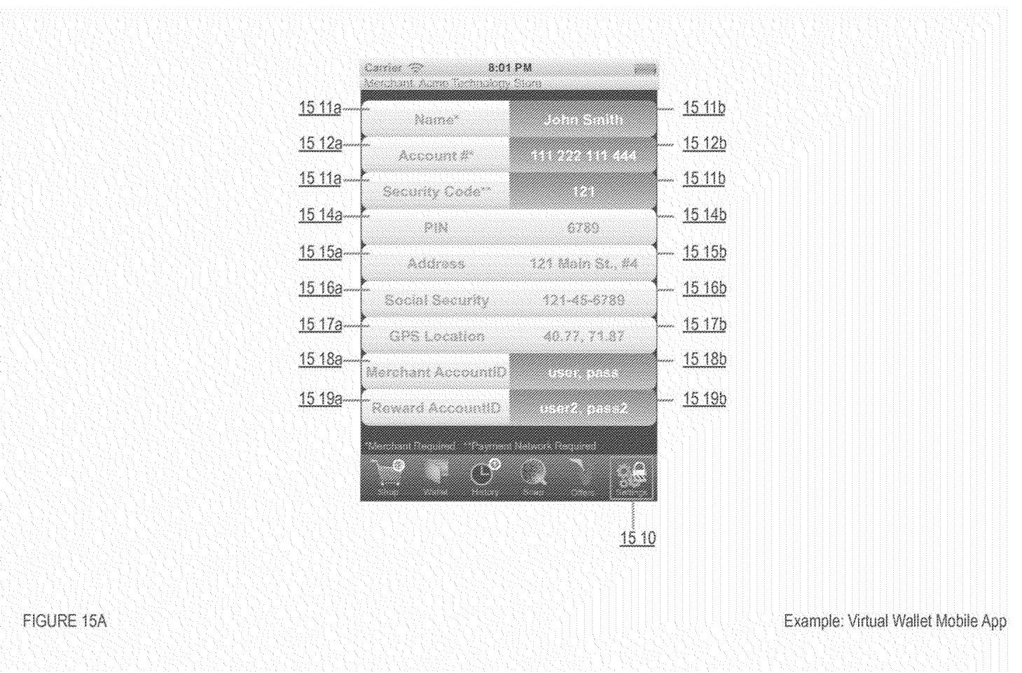

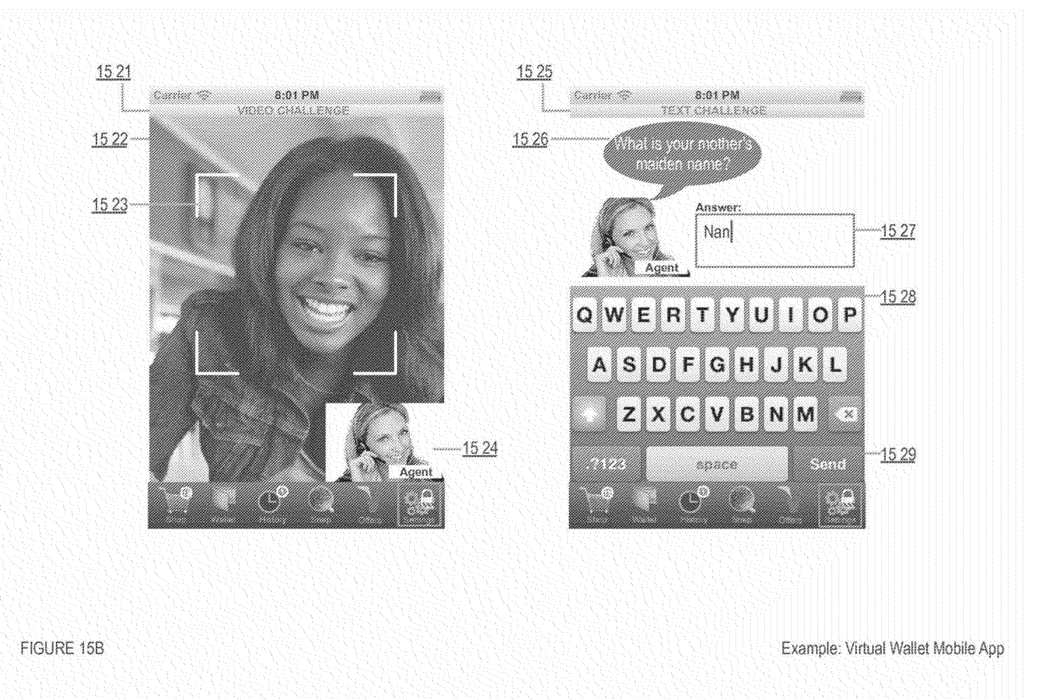

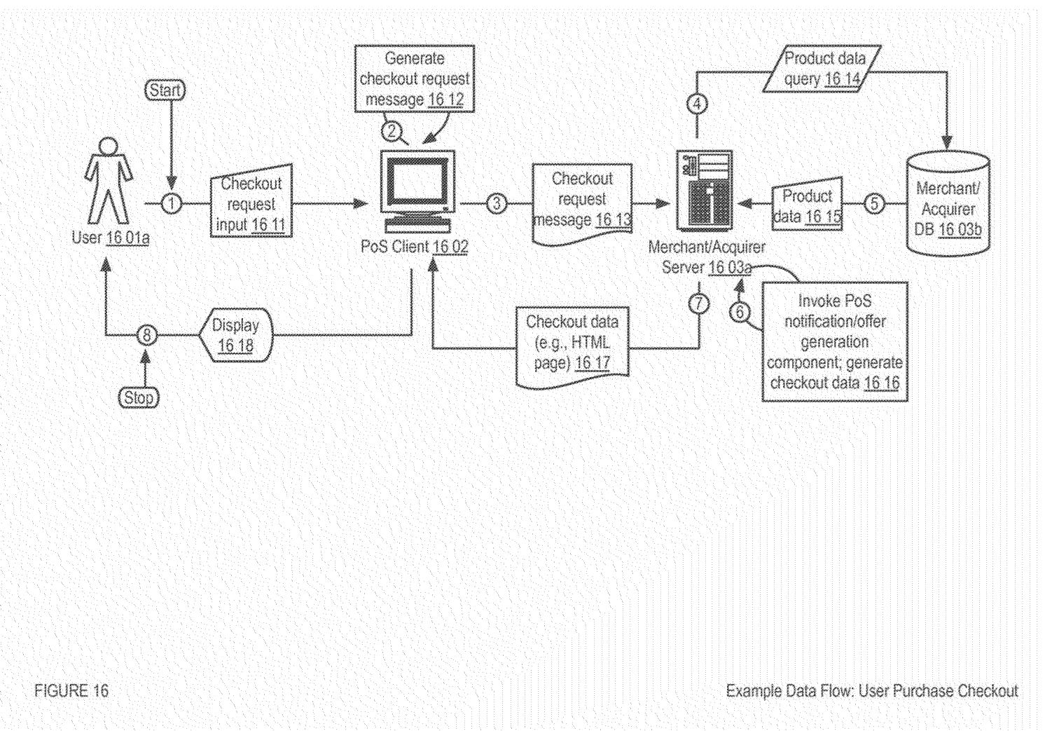

FIG. 16 shows a data flow diagram illustrating an example user purchase checkout procedure in some embodiments of the UVEMT. In some embodiments, a user, e.g., 1601a, may desire to purchase a product, service, offering, and/or the like (“product”), from a merchant via a merchant online site or in the merchant's store. The user may communicate with a merchant/acquirer (“merchant”) server, e.g., 1603a, via a client such as, but not limited to: a personal computer, mobile device, television, point-of-sale terminal, kiosk, ATM, and/or the like (e.g., 1602). For example, the user may provide user input, e.g., checkout input 1611, into the client indicating the user's desire to purchase the product. In various embodiments, the user input may include, but not be limited to: a single tap (e.g., a one-tap mobile app purchasing embodiment) of a touchscreen interface, keyboard entry, card swipe, activating a RFID/NFC enabled hardware device (e.g., electronic card having multiple accounts, smartphone, tablet, etc.) within the user device, mouse clicks, depressing buttons on a joystick/game console, voice commands, single/multi-touch gestures on a touch-sensitive interface, touching user interface elements on a touch-sensitive display, and/or the like. As an example, a user in a merchant store may scan a product barcode of the product via a barcode scanner at a point-of-sale terminal. As another example, the user may select a product from a webpage catalog on the merchant's website, and add the product to a virtual shopping cart on the merchant's website. The user may then indicate the user's desire to check out the items in the (virtual) shopping cart. For example, the user may activate a user interface element provided by the client to indicate the user's desire to complete the user purchase checkout. The client may generate a checkout request, e.g., 1612, and provide the checkout request, e.g., 1613, to the merchant server. For example, the client may provide a (Secure) Hypertext Transfer Protocol (“HTTP(S)”) POST message including the product details for the merchant server in the form of data formatted according to the eXtensible Markup Language (“XML”). An example listing of a checkout request 1612, substantially in the form of a HTTP(S) POST message including XML-formatted data, is provided below:

```
POST /checkoutrequest.php HTTP/1.1
Host: www.merchant.com
Content-Type: Application/XML
Content-Length: 667
<?XML version = “1.0” encoding = “UTF-8”?>
<checkout_request>
          <checkout_ID>4NFU4RG94</checkout_ID>
          <timestamp>2011-02-22 15:22:43</timestamp>
          <purchase_detail>
              <num_products>5</num_products>
              <product_ID>AE95049324</product_ID>
              <product_ID>MD09808755</product_ID>
              <product_ID>OC12345764</product_ID>
              <product_ID>KE76549043</product_ID>
              <product_ID>SP27674509</product_ID>
          </purchase_detail>
<!--optional parameters-->
          <user_ID>john.q.public@gmail.com</user_ID>
          <PoS_client_detail>
              <client_IP>192.168.23.126</client_IP>
              <client_type>smartphone</client_type>
              <client_model>HTC Hero</client_model>
              <OS>Android 2.2</OS>
              <app_installed_flag>true</app_installed_flag>
          </PoS_client_detail>
</checkout_request>
```

In some embodiments, the merchant server may obtain the checkout request from the client, and extract the checkout detail (e.g., XML data) from the checkout request. For example, the merchant server may utilize a parser such as the example parsers described below in the discussion with reference to FIG. 22. Based on parsing the checkout request 1612, the merchant server may extract product data (e.g., product identifiers), as well as available PoS client data, from the checkout request. In some embodiments, using the product data, the merchant server may query, e.g., 1614, a merchant/acquirer (“merchant”) database, e.g., 1603b, to obtain product data, e.g., 1615, such as product information, product pricing, sales tax, offers, discounts, rewards, and/or other information to process the purchase transaction and/or provide value-added services for the user. For example, the merchant database may be a relational database responsive to Structured Query Language (“SQL”) commands. The merchant server may execute a hypertext preprocessor (“PHP”) script including SQL commands to query a database table (such as FIG. 22, Products 22191) for product data. An example product data query 1614, substantially in the form of PHP/SQL commands, is provided below:

<?PHP
header(‘Content-Type: text/plain’);
mysql_connect(“254.93.179.112”,$DBserver,$password); // access
database server
mysql_select_db(“UVEMT_DB.SQL”); // select database table to search
//create query
$query = “SELECT product_title product_attributes_list product_price
tax_info_list related_products_list
offers_list discounts_list rewards_list merchants_list
merchant_availability_list FROM ProductsTable
WHERE product_ID LIKE ‘%’ $prodID”;
$result = mysql_query($query); // perform the search query
mysql_close(“UVEMT_DB.SQL”); // close database access
?>

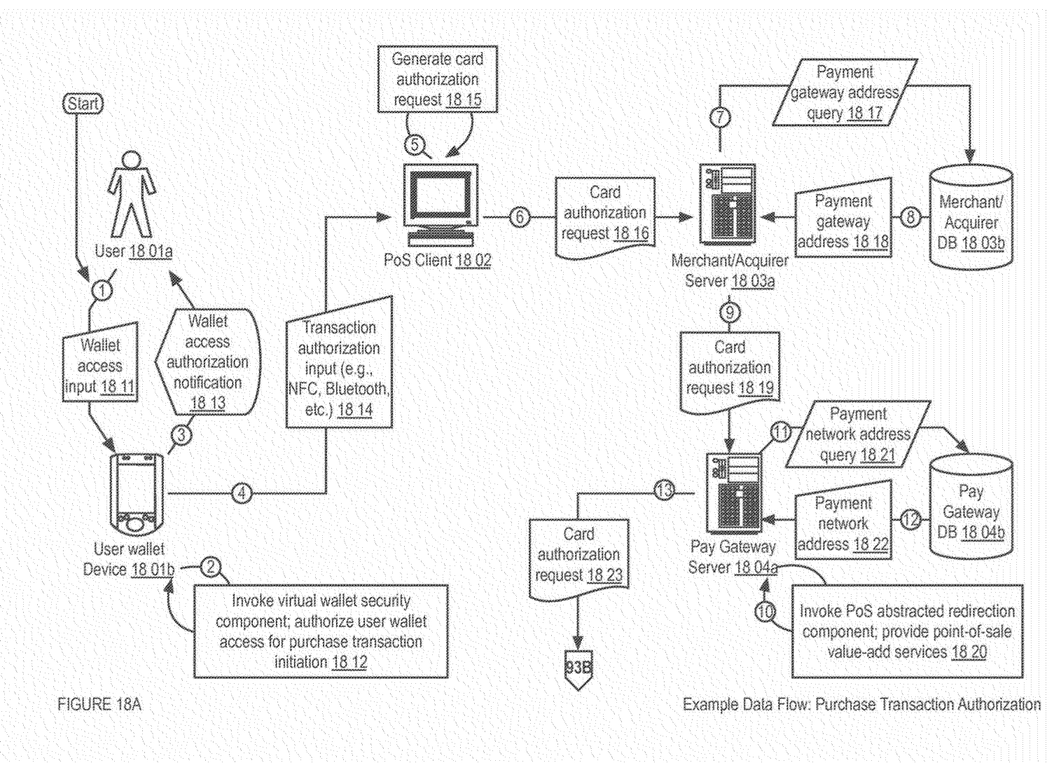

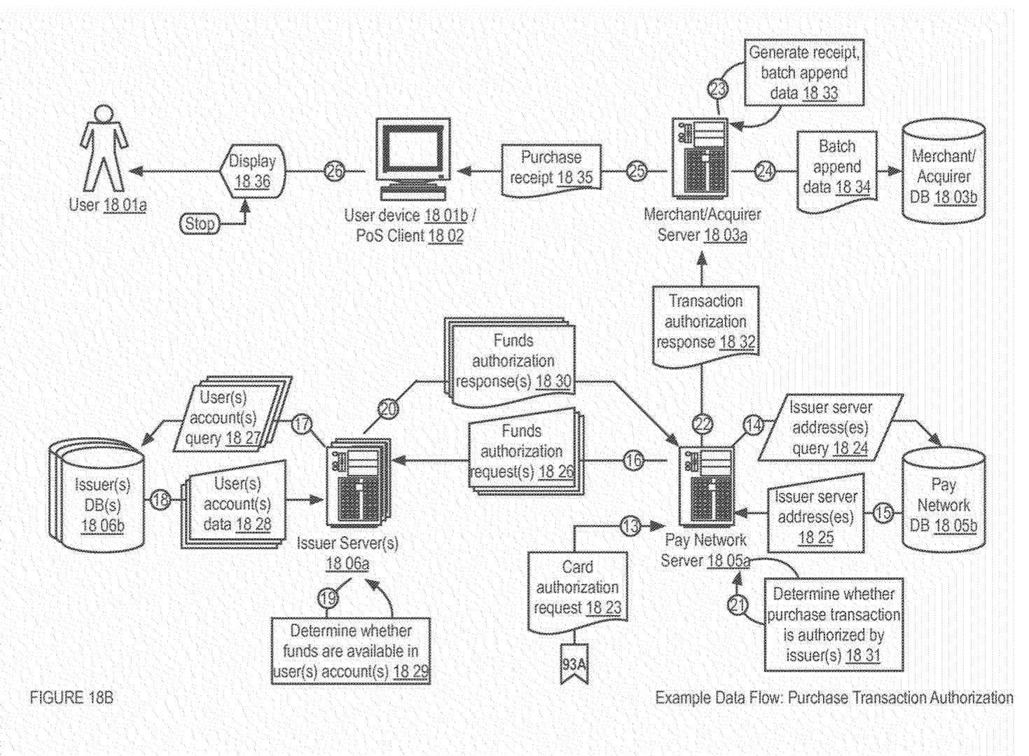

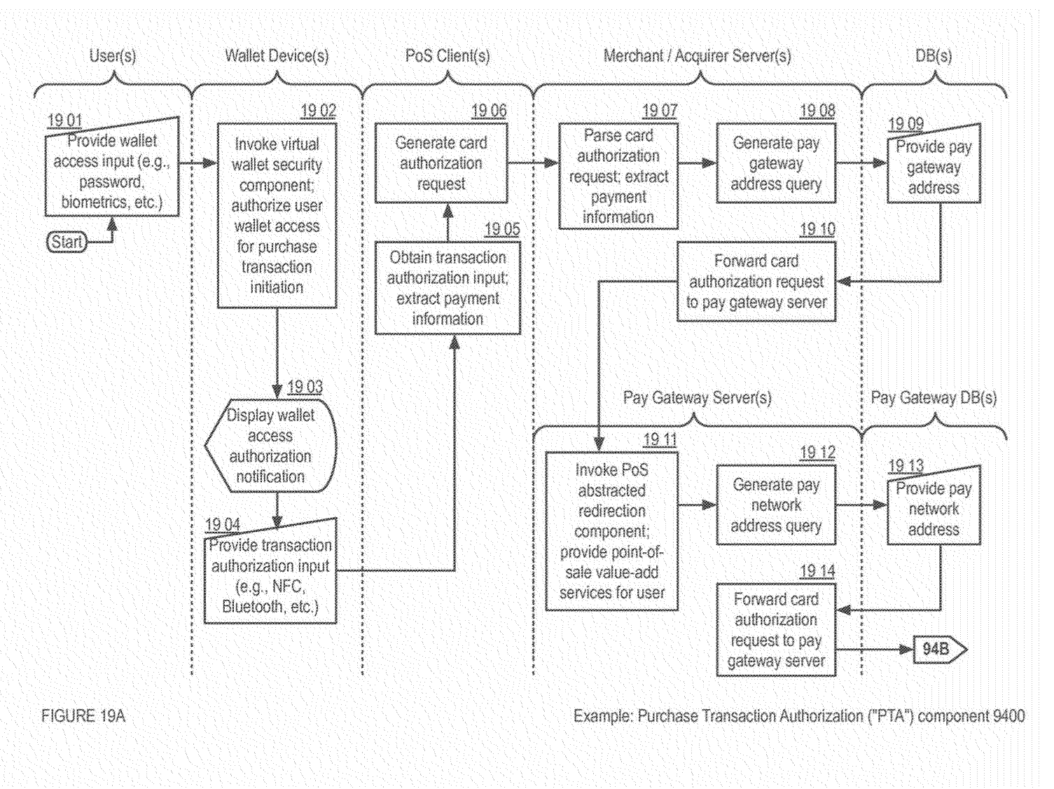

In some embodiments, in response to obtaining the product data, the merchant server may generate, e.g., 1616, checkout data to provide for the PoS client. In some embodiments, such checkout data, e.g., 1617, may be embodied, in part, in a HyperText Markup Language (“HTML”) page including data for display, such as product detail, product pricing, total pricing, tax information, shipping information, offers, discounts, rewards, value-added service information, etc., and input fields to provide payment information to process the purchase transaction, such as account holder name, account number, billing address, shipping address, tip amount, etc. In some embodiments, the checkout data may be embodied, in part, in a Quick Response (“QR”) code image that the PoS client can display, so that the user may capture the QR code using a user's device to obtain merchant and/or product data for generating a purchase transaction processing request. In some embodiments, a user alert mechanism may be built into the checkout data. For example, the merchant server may embed a URL specific to the transaction into the checkout data. In some embodiments, the alerts URL may further be embedded into optional level 3 data in card authorization requests, such as those discussed further below with reference to FIGS. 18-19. The URL may point to a webpage, data file, executable script, etc., stored on the merchant's server dedicated to the transaction that is the subject of the card authorization request. For example, the object pointed to by the URL may include details on the purchase transaction, e.g., products being purchased, purchase cost, time expiry, status of order processing, and/or the like. Thus, the merchant server may provide to the payment network the details of the transaction by passing the URL of the webpage to the payment network. In some embodiments, the payment network may provide notifications to the user, such as a payment receipt, transaction authorization confirmation message, shipping notification and/or the like. In such messages, the payment network may provide the URL to the user device. The user may navigate to the URL on the user's device to obtain alerts regarding the user's purchase, as well as other information such as offers, coupons, related products, rewards notifications, and/or the like. An example listing of a checkout data 1617, substantially in the form of XML-formatted data, is provided below:

```
<?XML version = “1.0” encoding = “UTF-8”?>
<checkout_data>
          <session_ID>4NFU4RG94</session_ID>
          <timestamp>2011-02-22 15:22:43</timestamp>
          <expiry_lapse>00:00:30</expiry_lapse>
          <transaction_cost>$34.78</transaction_cost>
          <alerts_URL>www.merchant.com/shopcarts.php?sessionID=
4NFU4RG94</alerts_URL>
          <!--optional data-->
          <user_ID>john.q.public@gmail.com</user_ID>
          <client_details>
              <client_IP>192.168.23.126</client_IP>
              <client_type>smartphone</client_type>
              <client_model>HTC Hero</client_model>
              <OS>Android 2.2</OS>
              <app_installed_flag>true</app_installed_flag>
          </client_details>
          <purchase_details>
              <num_products>1</num_products>
              <product>
                    <product_type>book</product_type>
                    <product_params>
                          <product_title>XML for dummies</product_title>
                          <ISBN>938-2-14-168710-0</ISBN>
                          <edition>2nd ed.</edition>
                          <cover>hardbound</cover>
                          <seller>bestbuybooks</seller>
                    </product_params>
                    <quantity>1</quantity>
              </product>
          </purchase_details>
          <offers_details>
              <num_offers>1</num_offers>
              <product>
                    <product_type>book</product_type>
                    <product_params>
                          <product_title>Here's more XML</product_title>
                          <ISBN>922-7-14-165720-1</ISBN>
                          <edition>1nd ed.</edition>
                          <cover>hardbound</cover>
                          <seller>digibooks</seller>
                    </product_params>
                    <quantity>1</quantity>
              </product>
          </offers_details>
          <secure_element>www.merchant.com/securedyn/0394733/
123.png</secure_element>
          <merchant_params>
              <merchant_id>3FBCR4INC</merchant_id>
              <merchant_name>Books & Things, Inc.</merchant_name>
              <merchant_auth_key>1NNF484MCP59CHB27365</merchant_auth_key>
          </merchant_params>
<checkout_data>
```

Upon obtaining the checkout data, e.g., 1617, the PoS client may render and display, e.g., 1618, the checkout data for the user.

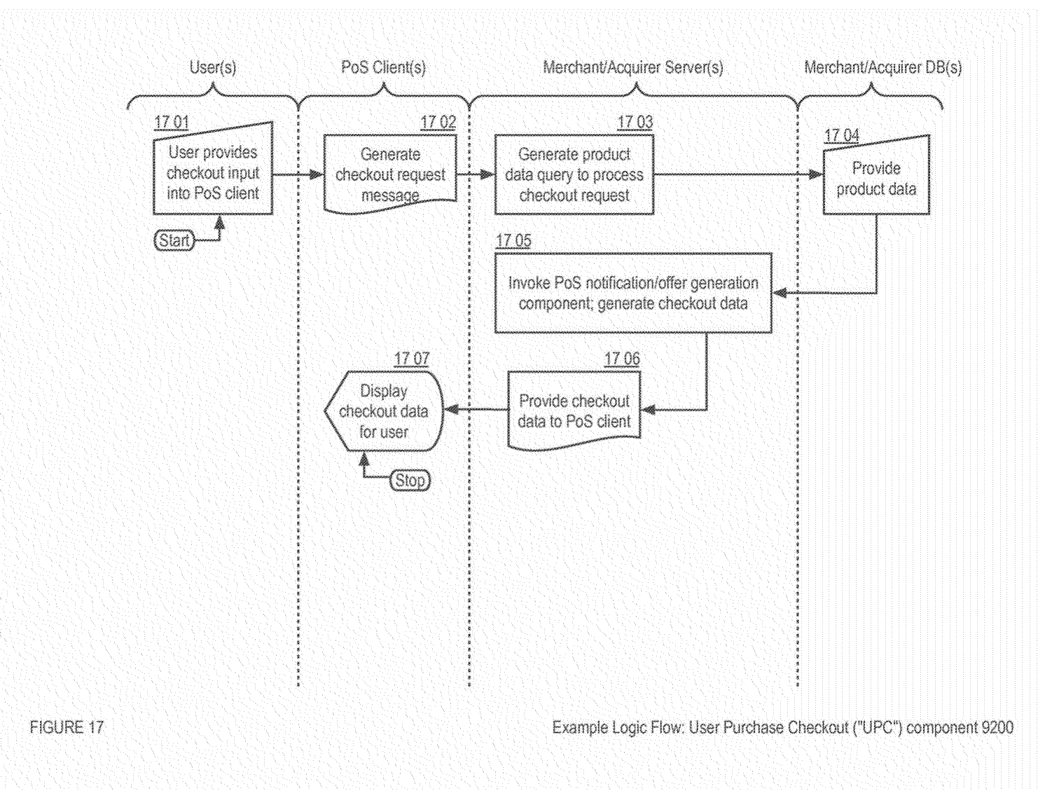

FIG. 17 shows a logic flow diagram illustrating example aspects of a user purchase checkout in some embodiments of the UVEMT, e.g., a User Purchase Checkout (“UPC”) component 1700. In some embodiments, a user may desire to purchase a product, service, offering, and/or the like (“product”), from a merchant via a merchant online site or in the merchant's store. The user may communicate with a merchant/acquirer (“merchant”) server via a PoS client. For example, the user may provide user input, e.g., 1701, into the client indicating the user's desire to purchase the product. The client may generate a checkout request, e.g., 1702, and provide the checkout request to the merchant server. In some embodiments, the merchant server may obtain the checkout request from the client, and extract the checkout detail (e.g., XML data) from the checkout request. For example, the merchant server may utilize a parser such as the example parsers described below in the discussion with reference to FIG. 22. Based on parsing the checkout request, the merchant server may extract product data (e.g., product identifiers), as well as available PoS client data, from the checkout request. In some embodiments, using the product data, the merchant server may query, e.g., 1703, a merchant/acquirer (“merchant”) database to obtain product data, e.g., 1704, such as product information, product pricing, sales tax, offers, discounts, rewards, and/or other information to process the purchase transaction and/or provide value-added services for the user. In some embodiments, in response to obtaining the product data, the merchant server may generate, e.g., 1705, checkout data to provide, e.g., 1706, for the PoS client. Upon obtaining the checkout data, the PoS client may render and display, e.g., 1707, the checkout data for the user.

FIGS. 18A-B show data flow diagrams illustrating an example purchase transaction authorization procedure in some embodiments of the UVEMT. With reference to FIG. 18A, in some embodiments, a user, e.g., 1801a, may wish to utilize a virtual wallet account to purchase a product, service, offering, and/or the like 7 (“product”), from a merchant via a merchant online site or in the merchant's store. The user may utilize a physical card, or a user wallet device, e.g., 1801b, to access the user's virtual wallet account. For example, the user wallet device may be a personal/laptop computer, cellular telephone, smartphone, tablet, eBook reader, netbook, gaming console, and/or the like. The user may provide a wallet access input, e.g., 1811 into the user wallet device. In various embodiments, the user input may include, but not be limited to: a single tap (e.g., a one-tap mobile app purchasing embodiment) of a touchscreen interface, keyboard entry, card swipe, activating a RFID/NFC enabled hardware device (e.g., electronic card having multiple accounts, smartphone, tablet, etc.) within the user device, mouse clicks, depressing buttons on a joystick/game console, voice commands, single/multi-touch gestures on a touch-sensitive interface, touching user interface elements on a touch-sensitive display, and/or the like. In some embodiments, the user wallet device may authenticate the user based on the user's wallet access input, and provide virtual wallet features for the user. In some embodiments, the user wallet device may invoke a component to ensure the security of the user's wallet.

In some embodiments, upon authenticating the user for access to virtual wallet features, the user wallet device may provide a transaction authorization input, e.g., 1814, to a point-of-sale (“PoS”) client, e.g., 1802. For example, the user wallet device may communicate with the PoS client via Bluetooth, Wi-Fi, cellular communication, one- or two-way near-field communication (“NFC”), and/or the like. In embodiments where the user utilizes a plastic card instead of the user wallet device, the user may swipe the plastic card at the PoS client to transfer information from the plastic card into the PoS client. For example, the PoS client may obtain, as transaction authorization input 1814, track 1 data from the user's plastic card (e.g., credit card, debit card, prepaid card, charge card, etc.), such as the example track 1 data provided below:

%B123456789012345\hat{ }PUBLIC/
J.Q.\hat{ }99011200000000000000**901******?* (wherein
‘123456789012345’
is the card number of ‘J.Q. Public’ and has a CVV number of 901.
‘990112’ is a service code, and *** represents decimal digits which
change randomly each time the card is used.)

In embodiments where the user utilizes a user wallet device, the user wallet device may provide payment information to the PoS client, formatted according to a data formatting protocol appropriate to the communication mechanism employed in the communication between the user wallet device and the PoS client. An example listing of transaction authorization input 1814, substantially in the form of XML-formatted data, is provided below:

```
<?XML version = “1.0” encoding = “UTF-8”?>
<transaction_authorization_input>
      <payment_data>
          <account>
              <charge_priority>1</charge_priority>
              <charge_ratio>40%</charge_ratio>
              <account_number>123456789012345
              </account_number>
              <account_name>John Q. Public</account_name>
              <bill_add>987 Green St #456, Chicago, IL
94652</bill_add>
              <ship_add>987 Green St #456, Chicago, IL
94652</ship_add>
              <CVV>123</CVV>
          </account>
          <account>
              <charge_priority>1</charge_priority>
              <charge_ratio>60%</charge_ratio>
              <account_number>234567890123456
              </account_number>
              <account_name>John Q. Public</account_name>
              <bill_add>987 Green St #456, Chicago, IL
94652</bill_add>
              <ship_add>987 Green St #456, Chicago, IL
94652</ship_add>
              <CVV>173</CVV>
          </account>
          <account>
              <charge_priority>2</charge_priority>
              <charge_ratio>100%</charge_ratio>
              <account_number>345678901234567
              </account_number>
              <account_name>John Q. Public</account_name>
              <bill_add>987 Green St #456, Chicago, IL
94652</bill_add>
              <ship_add>987 Green St #456, Chicago, IL
94652</ship_add>
              <CVV>695</CVV>
          </account>
      </payment_data>
      <!--optional data-->
      <timestamp>2011-02-22 15:22:43</timestamp>
      <expiry_lapse>00:00:30</expiry_lapse>
      <secure_key>0445329070598623487956543322</secure_key>
      <alerts_track_flag>TRUE</alerts_track_flag>
      <wallet_device_details>
          <device_IP>192.168.23.126</client_IP>
          <device_type>smartphone</client_type>
          <device_model>HTC Hero</client_model>
          <OS>Android 2.2</OS>
          <wallet_app_installed_flag>true
          </wallet_app_installed_flag>
      </wallet_device_details>
</transaction_authorization_input>
```

In some embodiments, the PoS client may generate a card authorization request, e.g., 1815, using the obtained transaction authorization input from the user wallet device, and/or product/checkout data (see, e.g., FIG. 16, 1615-1617). An example listing of a card authorization request 1815, substantially in the form of a HTTP(S) POST message including XML-formatted data, is provided below:

```
POST /authorizationrequests.php HTTP/1.1
Host: www.acquirer.com
Content-Type: Application/XML
Content-Length: 1306
<?XML version = “1.0” encoding = “UTF-8”?>
<card_authorization_request>
      <session_ID>4NFU4RG94</order_ID>
      <timestamp>2011-02-22 15:22:43</timestamp>
      <expiry>00:00:30</expiry>
      <alerts_URL>www.merchant.com/shopcarts.php?sessionID=AEBB4356</alerts
_URL>
      <!--optional data-->
      <user_ID>john.q.public@gmail.com</user_ID>
      <PoS_details>
          <PoS_IP>192.168.23.126</client_IP>
          <PoS_type>smartphone</client_type>
          <PoS_model>HTC Hero</client_model>
          <OS>Android 2.2</OS>
          <app_installed_flag>true</app_installed_flag>
      </PoS_details>
      <purchase_details>
          <num_products>1</num_products>
          <product>
              <product_type>book</product_type>
              <product_params>
                  <product_title>XML for dummies</product_title>
                  <ISBN>938-2-14-168710-0</ISBN>
                  <edition>2nd ed.</edition>
                  <cover>hardbound</cover>
                  <seller>bestbuybooks</seller>
              </product_params>
              <quantity>1</quantity>
            </product>
      </purchase_details>
      <merchant_params>
          <merchant_id>3FBCR4INC</merchant_id>
          <merchant_name>Books & Things, Inc.</merchant_name>
          <merchant_auth_key>1NNF484MCP59CHB27365</merchant_auth_key>
      </merchant_params>
      <account_params>
          <account_name>John Q. Public</account_name>
          <account_type>credit</account_type>
          <account_num>123456789012345</account_num>
          <billing_address>123 Green St., Norman, OK
98765</billing_address>
          <phone>123-456-7809</phone>
          <sign>/jqp/</sign>
          <confirm_type>email</confirm_type>
          <contact_info>john.q.public@gmail.com</contact_info>
      </account_params>
      <shipping_info>
          <shipping_adress>same as billing</shipping_address>
          <ship_type>expedited</ship_type>
          <ship_carrier>FedEx</ship_carrier>
          <ship_account>123-45-678</ship_account>
          <tracking_flag>true</tracking_flag>
          <sign_flag>false</sign_flag>
      </shipping_info>
</card_authorization_request>
```

In some embodiments, the card authorization request generated by the user device may include a minimum of information required to process the purchase transaction. For example, this may improve the efficiency of communicating the purchase transaction request, and may also advantageously improve the privacy protections provided to the user and/or merchant. For example, in some embodiments, the card authorization request may include at least a session ID for the user's shopping session with the merchant. The session ID may be utilized by any component and/or entity having the appropriate access authority to access a secure site on the merchant server to obtain alerts, reminders, and/or other data about the transaction(s) within that shopping session between the user and the merchant. In some embodiments, the PoS client may provide the generated card authorization request to the merchant server, e.g., 1816. The merchant server may forward the card authorization request to a pay gateway server, e.g., 1804a, for routing the card authorization request to the appropriate payment network for payment processing. For example, the pay gateway server may be able to select from payment networks, such as Visa, Mastercard, American Express, Paypal, etc., to process various types of transactions including, but not limited to: credit card, debit card, prepaid card, B2B and/or like transactions. In some embodiments, the merchant server may query a database, e.g., merchant/acquirer database 1803b, for a network address of the payment gateway server, for example by using a portion of a user payment card number, or a user ID (such as an email address) as a keyword for the database query. For example, the merchant server may issue PHP/SQL commands to query a database table (such as FIG. 22, Pay Gateways 2219h) for a URL of the pay gateway server. An example payment gateway address query 1817, substantially in the form of PHP/SQL commands, is provided below:

<?PHP
header(‘Content-Type: text/plain’);
mysql_connect(“254.93.179.112”,$DBserver,$password); // access
database server
mysql_select_db(“UVEMT_DB.SQL”); // select database table to search
//create query
$query = “SELECT paygate_id paygate_address paygate_URL
paygate_name FROM
PayGatewayTable WHERE card_num LIKE ‘%’ $cardnum”;
$result = mysql_query($query); // perform the search query
mysql_close(“UVEMT_DB.SQL”); // close database access
?>

In response, the merchant/acquirer database may provide the requested payment gateway address, e.g., 1818. The merchant server may forward the card authorization request to the pay gateway server using the provided address, e.g., 1819. In some embodiments, upon receiving the card authorization request from the merchant server, the pay gateway server may invoke a component to provide one or more services associated with purchase transaction authorization. For example, the pay gateway server may invoke components for fraud prevention, loyalty and/or rewards, and/or other services for which the user-merchant combination is authorized. In some embodiments, the pay gateway server may invoke a component to provide point-of-sale value-add services. The pay gateway server may forward the card authorization request to a pay network server, e.g., 1805a, for payment processing. For example, the pay gateway server may be able to select from payment networks, such as Visa, Mastercard, American Express, Paypal, etc., to process various types of transactions including, but not limited to: credit card, debit card, prepaid card, B2B and/or like transactions. In some embodiments, the pay gateway server may query a database, e.g., pay gateway database 1804b, for a network address of the payment network server, for example by using a portion of a user payment card number, or a user ID (such as an email address) as a keyword for the database query. For example, the pay gateway server may issue PHP/SQL commands to query a database table (such as FIG. 22, Pay Gateways 2219h) for a URL of the pay network server. An example payment network address query 1821, substantially in the form of PHP/SQL commands, is provided below:

<?PHP
header(‘Content-Type: text/plain’);
mysql_connect(“254.93.179.112”,$DBserver,$password); // access
database server
mysql_select_db(“UVEMT_DB.SQL”); // select database table to search
//create query
$query = “SELECT payNET_id payNET_address payNET_URL
payNET_name FROM
PayGatewayTable WHERE card_num LIKE ‘%’ $cardnum”;
$result = mysql_query($query); // perform the search query
mysql_close(“UVEMT_DB.SQL”); // close database access
?>

In response, the payment gateway database may provide the requested payment network address, e.g., 1822. The pay gateway server may forward the card authorization request to the pay network server using the provided address, e.g., 1823.

With reference to FIG. 18B, in some embodiments, the pay network server may process the transaction so as to transfer funds for the purchase into an account stored on an acquirer of the merchant. For example, the acquirer may be a financial institution maintaining an account of the merchant. For example, the proceeds of transactions processed by the merchant may be deposited into an account maintained by at a server of the acquirer.

In some embodiments, the pay network server may generate a query, e.g., 1824, for issuer server(s) corresponding to the user-selected payment options. For example, the user's account may be linked to one or more issuer financial institutions (“issuers”), such as banking institutions, which issued the account(s) for the user. For example, such accounts may include, but not be limited to: credit card, debit card, prepaid card, checking, savings, money market, certificates of deposit, stored (cash) value accounts and/or the like. Issuer server(s), e.g., 1806a, of the issuer(s) may maintain details of the user's account(s). In some embodiments, a database, e.g., pay network database 1805b, may store details of the issuer server(s) associated with the issuer(s). In some embodiments, the pay network server may query a database, e.g., pay network database 1805b, for a network address of the issuer(s) server(s), for example by using a portion of a user payment card number, or a user ID (such as an email address) as a keyword for the database query. For example, the merchant server may issue PHP/SQL commands to query a database table (such as FIG. 22, Issuers 2219f) for network address(es) of the issuer(s) server(s). An example issuer server address(es) query 1824, substantially in the form of PHP/SQL commands, is provided below:

<?PHP
header(‘Content-Type: text/plain’);
mysql_connect(“254.93.179.112”,$DBserver,$password); // access
database server
mysql_select_db(“UVEMT_DB.SQL”); // select database table to search
//create query
$query = “SELECT issuer_id issuer_address issuer_URL issuer_name
FROM
IssuersTable WHERE card_num LIKE ‘%’ $cardnum”;
$result = mysql_query($query); // perform the search query
mysql_close(“UVEMT_DB.SQL”); // close database access
?>

In response to obtaining the issuer server query, e.g., 1824, the pay network database may provide, e.g., 1825, the requested issuer server data to the pay network server. In some embodiments, the pay network server may utilize the issuer server data to generate funds authorization request(s), e.g., 1826, for each of the issuer server(s) selected based on the pre-defined payment settings associated with the user's virtual wallet, and/or the user's payment options input, and provide the funds authorization request(s) to the issuer server(s). In some embodiments, the funds authorization request(s) may include details such as, but not limited to: the costs to the user involved in the transaction, card account details of the user, user billing and/or shipping information, and/or the like. An example listing of a funds authorization request 1826, substantially in the form of a HTTP(S) POST message including XML-formatted data, is provided below:

```
POST /fundsauthorizationrequest.php HTTP/1.1
Host: www.issuer.com
Content-Type: Application/XML
Content-Length: 624
<?XML version = “1.0” encoding = “UTF-8”?>
<funds_authorization_request>
      <query_ID>VNEI39FK</query_ID>
      <timestamp>2011-02-22 15:22:44</timestamp>
      <transaction_cost>$22.61</transaction_cost>
      <account_params>
          <account_type>checking</account_type>
          <account_num>1234567890123456</account_num>
      </account_params>
      <!--optional parameters-->
      <purchase_summary>
          <num_products>1</num_products>
          <product>
              <product_summary>Book - XML for
dummies</product_summary>
              <product_quantity>1</product_quantity?
          </product>
      </purchase_summary>
      <merchant_params>
          <merchant_id>3FBCR4INC</merchant_id>
          <merchant_name>Books & Things, Inc.</merchant_name>
          <merchant_auth_key>1NNF484MCP59CHB27365
          </merchant_auth_key>
      </merchant_params>
</funds_authorization_request>
```

In some embodiments, an issuer server may parse the authorization request(s), and based on the request details may query a database, e.g., user profile database 1806b, for data associated with an account linked to the user. For example, the merchant server may issue PHP/SQL commands to query a database table (such as FIG. 22, Accounts 2219d) for user account(s) data. An example user account(s) query 1827, substantially in the form of PHP/SQL commands, is provided below:

<?PHP
header(‘Content-Type: text/plain’);
mysql_connect(“254.93.179.112”,$DBserver,$password); // access
database server
mysql_select_db(“UVEMT_DB.SQL”); // select database table to search
//create query
$query =
“SELECT issuer user_id user_name user_balance account_type FROM
AccountsTable WHERE account_num LIKE ‘%’ $accountnum”;
$result = mysql_query($query); // perform the search query
mysql_close(“UVEMT_DB.SQL”); // close database access
?>

In some embodiments, on obtaining the user account(s) data, e.g., 1828, the issuer server may determine whether the user can pay for the transaction using funds available in the account, 1829. For example, the issuer server may determine whether the user has a sufficient balance remaining in the account, sufficient credit associated with the account, and/or the like. Based on the determination, the issuer server(s) may provide a funds authorization response, e.g., 1830, to the pay network server. For example, the issuer server(s) may provide a HTTP(S) POST message similar to the examples above. In some embodiments, if at least one issuer server determines that the user cannot pay for the transaction using the funds available in the account, the pay network server may request payment options again from the user (e.g., by providing an authorization fail message to the user device and requesting the user device to provide new payment options), and re-attempt authorization for the purchase transaction. In some embodiments, if the number of failed authorization attempts exceeds a threshold, the pay network server may abort the authorization process, and provide an “authorization fail” message to the merchant server, user device and/or client.

In some embodiments, the pay network server may obtain the funds authorization response including a notification of successful authorization, and parse the message to extract authorization details. Upon determining that the user possesses sufficient funds for the transaction, e.g., 1831, the pay network server may invoke a component to provide value-add services for the user. In some embodiments, the pay gateway server may invoke a component to provide point-of-sale value-add services. In various embodiments, such value-add services may be provided at any point in the purchase transaction process, including before the pay gateway server(s) and/or pay network server(s) obtain verification from the issuer server(s) that the user has funds sufficient for the transaction to be processed, or prior to obtaining such verification.

In some embodiments, the pay network server may generate a transaction data record from the authorization request and/or authorization response, and store the details of the transaction and authorization relating to the transaction in a transactions database. For example, the pay network server may issue PHP/SQL commands to store the data to a database table (such as FIG. 22, Transactions 2219i). An example transaction store command, substantially in the form of PHP/SQL commands, is provided below:

<?PHP
header(‘Content-Type: text/plain’);
mysql_connect(″254.92.185.103”,$DBserver,$password); // access
database server
mysql_select(″UVEMT_DB.SQL″); // select database to append
mysql_query(“INSERT INTO TransactionsTable (PurchasesTable
(timestamp, purchase_summary_list, num_products,
product_summary, product_quantity, transaction_cost,
account_params_list, account_name, account_type,
account_num,
billing_addres, zipcode, phone, sign, merchant_params_list,
merchant_id, merchant_name, merchant_auth_key)
VALUES (time( ), $purchase_summary_list, $num_products,
$product_summary, $product_quantity, $transaction_cost,
$account_params_list, $account_name, $account_type,
$account_num, $billing_addres, $zipcode, $phone, $sign,
$merchant_params_list, $merchant_id, $merchant_name,
$merchant_auth_key)”); // add data to table in database
mysql_close(“UVEMT_DB.SQL”); // close connection to database
?>

In some embodiments, the pay network server may forward a transaction authorization response, e.g., 1832, to the user wallet device, PoS client, and/or merchant server. The merchant may obtain the transaction authorization response, and determine from it that the user possesses sufficient funds in the card account to conduct the transaction. The merchant server may add a record of the transaction for the user to a batch of transaction data relating to authorized transactions. For example, the merchant may append the XML data pertaining to the user transaction to an XML data file comprising XML data for transactions that have been authorized for various users, e.g., 1833, and store the XML data file, e.g., 1834, in a database, e.g., merchant database 404. For example, a batch XML data file may be structured similar to the example XML data structure template provided below:

```
<?XML version = “1.0” encoding = “UTF-8”?>
<merchant_data>
      <merchant_id>3FBCR4INC</merchant_id>
      <merchant_name>Books & Things, Inc.</merchant_name>
      <merchant_auth_key>1NNF484MCP59CHB27365
      </merchant_auth_key>
      <account_number>123456789</account_number>
</merchant_data>
<transaction_data>
      <transaction 1>
          ...
      </transaction 1>
      <transaction 2>
          ...
      </transaction 2>
          .
          .
          .
      <transaction n>
          ...
      </transaction n>
</transaction_data>
```

In some embodiments, the server may also generate a purchase receipt, e.g., 1833, and provide the purchase receipt to the client, e.g., 1835. The client may render and display, e.g., 1836, the purchase receipt for the user. In some embodiments, the user's wallet device may also provide a notification of successful authorization to the user. For example, the PoS client/user device may render a webpage, electronic message, text/SMS message, buffer a voicemail, emit a ring tone, and/or play an audio message, etc., and provide output including, but not limited to: sounds, music, audio, video, images, tactile feedback, vibration alerts (e.g., on vibration-capable client devices such as a smartphone etc.), and/or the like.

FIGS. 19A-B show logic flow diagrams illustrating example aspects of purchase transaction authorization in some embodiments of the UVEMT, e.g., a Purchase Transaction Authorization (“PTA”) component 1900. With reference to FIG. 19A, in some embodiments, a user may wish to utilize a virtual wallet account to purchase a product, service, offering, and/or the like (“product”), from a merchant via a merchant online site or in the merchant's store. The user may utilize a physical card, or a user wallet device to access the user's virtual wallet account. For example, the user wallet device may be a personal/laptop computer, cellular telephone, smartphone, tablet, eBook reader, netbook, gaming console, and/or the like. The user may provide a wallet access input, e.g., 1901, into the user wallet device. In various embodiments, the user input may include, but not be limited to: a single tap (e.g., a one-tap mobile app purchasing embodiment) of a touchscreen interface, keyboard entry, card swipe, activating a RFID/NFC enabled hardware device (e.g., electronic card having multiple accounts, smartphone, tablet, etc.) within the user device, mouse clicks, depressing buttons on a joystick/game console, voice commands, single/multi-touch gestures on a touch-sensitive interface, touching user interface elements on a touch-sensitive display, and/or the like. In some embodiments, the user wallet device may authenticate the user based on the user's wallet access input, and provide virtual wallet features for the user, e.g., 1902-1903. In some embodiments, the user wallet device may invoke a component to ensure the security of the user's wallet.

In some embodiments, upon authenticating the user for access to virtual wallet features, the user wallet device may provide a transaction authorization input, e.g., 1904, to a point-of-sale (“PoS”) client. For example, the user wallet device may communicate with the PoS client via Bluetooth, Wi-Fi, cellular communication, one- or two-way near-field communication (“NFC”), and/or the like. In embodiments where the user utilizes a plastic card instead of the user wallet device, the user may swipe the plastic card at the PoS client to transfer information from the plastic card into the PoS client. In embodiments where the user utilizes a user wallet device, the user wallet device may provide payment information to the PoS client, formatted according to a data formatting protocol appropriate to the communication mechanism employed in the communication between the user wallet device and the PoS client.

In some embodiments, the PoS client may obtain the transaction authorization input, and parse the input to extract payment information from the transaction authorization input, e.g., 1905. For example, the PoS client may utilize a parser, such as the example parsers provided below in the discussion with reference to FIG. 22. The PoS client may generate a card authorization request, e.g., 1906, using the obtained transaction authorization input from the user wallet device, and/or product/checkout data (see, e.g., FIG. 16, 1615-1617).

In some embodiments, the PoS client may provide the generated card authorization request to the merchant server. The merchant server may forward the card authorization request to a pay gateway server, for routing the card authorization request to the appropriate payment network for payment processing. For example, the pay gateway server may be able to select from payment networks, such as Visa, Mastercard, American Express, Paypal, etc., to process various types of transactions including, but not limited to: credit card, debit card, prepaid card, B2B and/or like transactions. In some embodiments, the merchant server may query a database, e.g., 1908, for a network address of the payment gateway server, for example by using a portion of a user payment card number, or a user ID (such as an email address) as a keyword for the database query. In response, the merchant/acquirer database may provide the requested payment gateway address, e.g., 1910. The merchant server may forward the card authorization request to the pay gateway server using the provided address. In some embodiments, upon receiving the card authorization request from the merchant server, the pay gateway server may invoke a component to provide one or more service associated with purchase transaction authorization, e.g., 1911. For example, the pay gateway server may invoke components for fraud prevention (see e.g., VerifyChat, FIG. 3E), loyalty and/or rewards, and/or other services for which the user-merchant combination is authorized. In some embodiments, the pay gateway server may invoke a component to provide point-of-sale value-add services.

The pay gateway server may forward the card authorization request to a pay network server for payment processing, e.g., 1914. For example, the pay gateway server may be able to select from payment networks, such as Visa, Mastercard, American Express, Paypal, etc., to process various types of transactions including, but not limited to: credit card, debit card, prepaid card, B2B and/or like transactions. In some embodiments, the pay gateway server may query a database, e.g., 1912, for a network address of the payment network server, for example by using a portion of a user payment card number, or a user ID (such as an email address) as a keyword for the database query. In response, the payment gateway database may provide the requested payment network address, e.g., 1913. The pay gateway server may forward the card authorization request to the pay network server using the provided address, e.g., 1914.

With reference to FIG. 19B, in some embodiments, the pay network server may process the transaction so as to transfer funds for the purchase into an account stored on an acquirer of the merchant. For example, the acquirer may be a financial institution maintaining an account of the merchant. For example, the proceeds of transactions processed by the merchant may be deposited into an account maintained by at a server of the acquirer. In some embodiments, the pay network server may generate a query, e.g., 1915, for issuer server(s) corresponding to the user-selected payment options. For example, the user's account may be linked to one or more issuer financial institutions (“issuers”), such as banking institutions, which issued the account(s) for the user. For example, such accounts may include, but not be limited to: credit card, debit card, prepaid card, checking, savings, money market, certificates of deposit, stored (cash) value accounts and/or the like. Issuer server(s) of the issuer(s) may maintain details of the user's account(s). In some embodiments, a database, e.g., a pay network database, may store details of the issuer server(s) associated with the issuer(s). In some embodiments, the pay network server may query a database, e.g., 1915, for a network address of the issuer(s) server(s), for example by using a portion of a user payment card number, or a user ID (such as an email address) as a keyword for the database query.

In response to obtaining the issuer server query, the pay network database may provide, e.g., 1916, the requested issuer server data to the pay network server. In some embodiments, the pay network server may utilize the issuer server data to generate funds authorization request(s), e.g., 1917, for each of the issuer server(s) selected based on the pre-defined payment settings associated with the user's virtual wallet, and/or the user's payment options input, and provide the funds authorization request(s) to the issuer server(s). In some embodiments, the funds authorization request(s) may include details such as, but not limited to: the costs to the user involved in the transaction, card account details of the user, user billing and/or shipping information, and/or the like. In some embodiments, an issuer server may parse the authorization request(s), e.g., 1918, and based on the request details may query a database, e.g., 1919, for data associated with an account linked to the user.

In some embodiments, on obtaining the user account(s) data, e.g., 1920, the issuer server may determine whether the user can pay for the transaction using funds available in the account, e.g., 1921. For example, the issuer server may determine whether the user has a sufficient balance remaining in the account, sufficient credit associated with the account, and/or the like. Based on the determination, the issuer server(s) may provide a funds authorization response, e.g., 1922, to the pay network server. In some embodiments, if at least one issuer server determines that the user cannot pay for the transaction using the funds available in the account, the pay network server may request payment options again from the user (e.g., by providing an authorization fail message to the user device and requesting the user device to provide new payment options), and re-attempt authorization for the purchase transaction. In some embodiments, if the number of failed authorization attempts exceeds a threshold, the pay network server may abort the authorization process, and provide an “authorization fail” message to the merchant server, user device and/or client.

In some embodiments, the pay network server may obtain the funds authorization response including a notification of successful authorization, and parse the message to extract authorization details. Upon determining that the user possesses sufficient funds for the transaction, e.g., 1923, the pay network server may invoke a component to provide value-add services for the user, e.g., 1923. In some embodiments, the pay gateway server may invoke a component to provide point-of-sale value-add services. In various embodiments, such value-add services may be provided at any point in the purchase transaction process, including before the pay gateway server(s) and/or pay network server(s) obtain verification from the issuer server(s) that the user has funds sufficient for the transaction to be processed, or prior to obtaining such verification.

In some embodiments, the pay network server may forward a transaction authorization response to the user wallet device, PoS client, and/or merchant server. The merchant may parse, e.g., 1924, the transaction authorization response, and determine from it that the user possesses sufficient funds in the card account to conduct the transaction, e.g., 1925, option “Yes.” The merchant server may add a record of the transaction for the user to a batch of transaction data relating to authorized transactions. For example, the merchant may append the XML data pertaining to the user transaction to an XML data file comprising XML data for transactions that have been authorized for various users, e.g., 1926, and store the XML data file, e.g., 1927, in a database. In some embodiments, the server may also generate a purchase receipt, e.g., 1928, and provide the purchase receipt to the client. The client may render and display, e.g., 1929, the purchase receipt for the user. In some embodiments, the user's wallet device may also provide a notification of successful authorization to the user. For example, the PoS client/user device may render a webpage, electronic message, text/SMS message, buffer a voicemail, emit a ring tone, and/or play an audio message, etc., and provide output including, but not limited to: sounds, music, audio, video, images, tactile feedback, vibration alerts (e.g., on vibration-capable client devices such as a smartphone etc.), and/or the like.

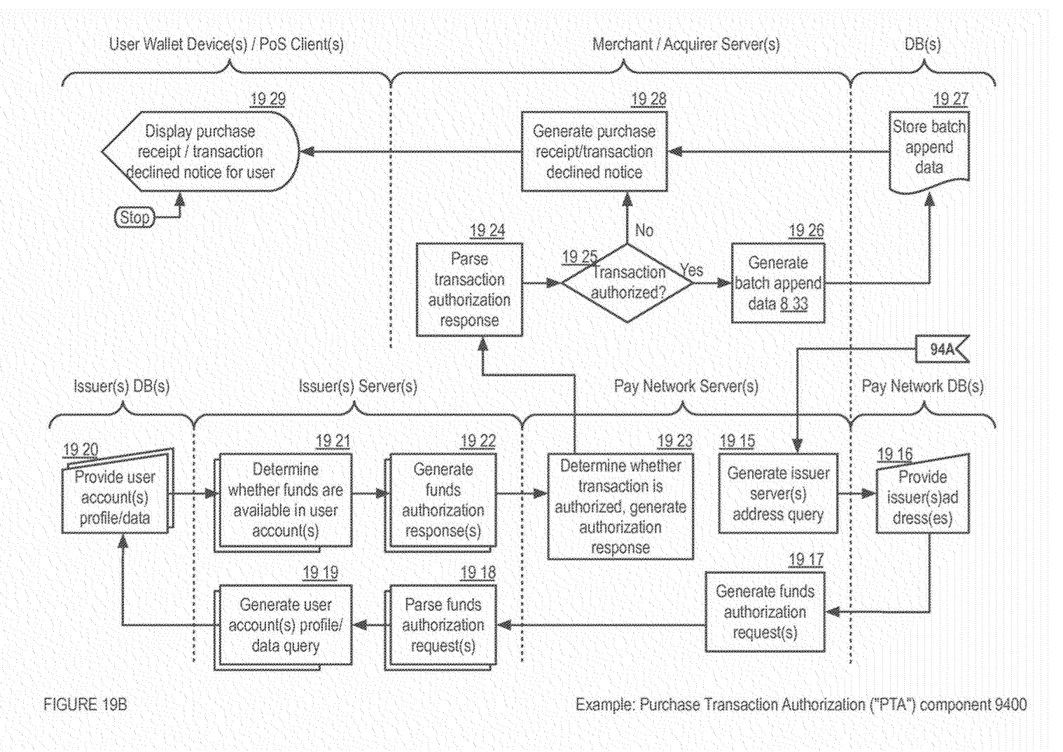

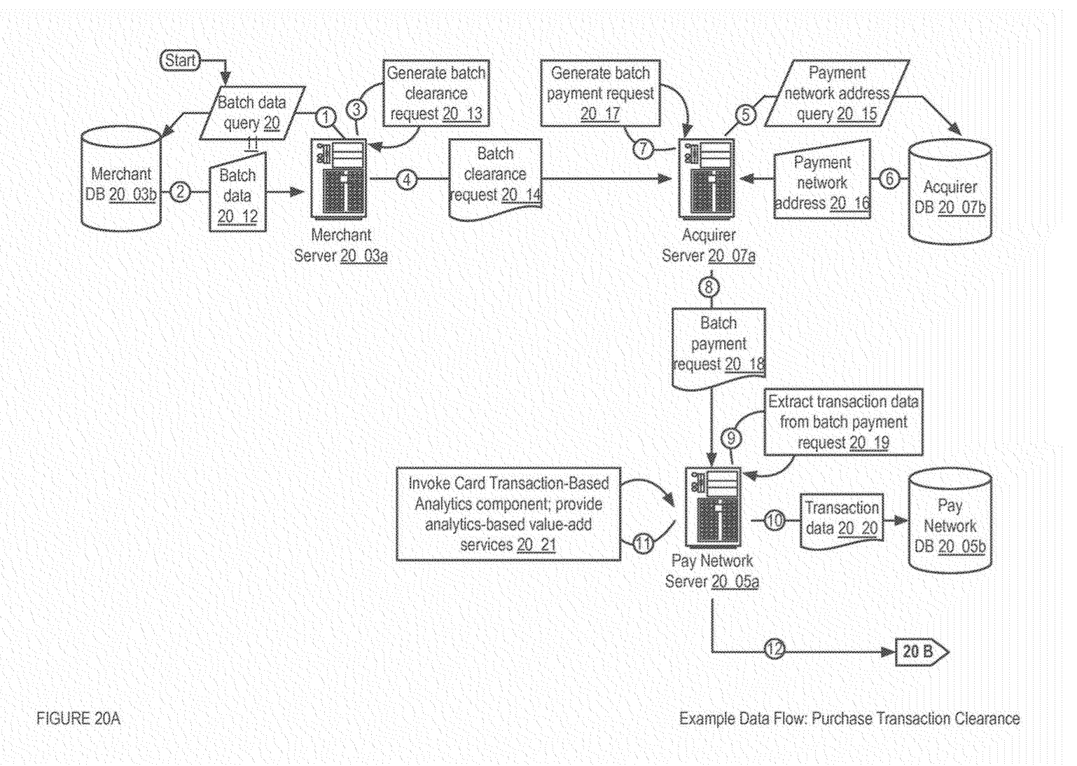

FIGS. 20A-B show data flow diagrams illustrating an example purchase transaction clearance procedure in some embodiments of the UVEMT. With reference to FIG. 20A, in some embodiments, a merchant server, e.g., 2003a, may initiate clearance of a batch of authorized transactions. For example, the merchant server may generate a batch data request, e.g., 2011, and provide the request, to a merchant database, e.g., 2003b. For example, the merchant server may utilize PHP/SQL commands similar to the examples provided above to query a relational database. In response to the batch data request, the database may provide the requested batch data, e.g., 2012. The server may generate a batch clearance request, e.g., 2013, using the batch data obtained from the database, and provide, e.g., 2014, the batch clearance request to an acquirer server, e.g., 2007a. For example, the merchant server may provide a HTTP(S) POST message including XML-formatted batch data in the message body for the acquirer server. The acquirer server may generate, e.g., 2015, a batch payment request using the obtained batch clearance request, and provide, e.g., 2018, the batch payment request to the pay network server, e.g., 2005a. The pay network server may parse the batch payment request, and extract the transaction data for each transaction stored in the batch payment request, e.g., 2019. The pay network server may store the transaction data, e.g., 2020, for each transaction in a database, e.g., pay network database 2005b. In some embodiments, the pay network server may invoke a component to provide value-add analytics services based on analysis of the transactions of the merchant for whom the UVEMT is clearing purchase transactions. Thus, in some embodiments, the pay network server may provide analytics-based value-added services for the merchant and/or the merchant's users.

With reference to FIG. 20B, in some embodiments, for each extracted transaction, the pay network server may query, e.g., 2023, a database, e.g., pay network database 2005b, for an address of an issuer server. For example, the pay network server may utilize PHP/SQL commands similar to the examples provided above. The pay network server may generate an individual payment request, e.g., 2025, for each transaction for which it has extracted transaction data, and provide the individual payment request, e.g., 2025, to the issuer server, e.g., 2006a. For example, the pay network server may provide an individual payment request to the issuer server(s) as a HTTP(S) POST message including XML-formatted data. An example listing of an individual payment request 2025, substantially in the form of a HTTP(S) POST message including XML-formatted data, is provided below:

```
POST /paymentrequest.php HTTP/1.1
Host: www.issuer.com
Content-Type: Application/XML
Content-Length: 788
<?XML version = “1.0” encoding = “UTF-8”?>
<pay_request>
      <request_ID>CNI4ICNW2</request_ID>
      <timestamp>2011-02-22 17:00:01</timestamp>
      <pay_amount>$34.78</pay_amount>
      <account_params>
          <account_name>John Q. Public</account_name>
          <account_type>credit</account_type>
          <account_num>123456789012345</account_num>
          <billing_address>123 Green St., Norman, OK
98765</billing_address>
          <phone>123-456-7809</phone>
          <sign>/jqp/</sign>
      </account_params>
      <merchant_params>
          <merchant_id>3FBCR4INC</merchant_id>
          <merchant_name>Books & Things, Inc.</merchant_name>
          <merchant_auth_key>1NNF484MCP59CHB27365
          </merchant_auth_key>
      </merchant_params>
      <purchase_summary>
          <num_products>1</num_products>
          <product>
              <product_summary>Book - XML for
dummies</product_summary>
              <product_quantity>1</product_quantity?
          </product>
      </purchase_summary>
</pay_request>
```

In some embodiments, the issuer server may generate a payment command, e.g., 2027. For example, the issuer server may issue a command to deduct funds from the user's account (or add a charge to the user's credit card account). The issuer server may issue a payment command, e.g., 2027, to a database storing the user's account information, e.g., user profile database 2006b. The issuer server may provide an individual payment confirmation, e.g., 2028, to the pay network server, which may forward, e.g., 2029, the funds transfer message to the acquirer server. An example listing of an individual payment confirmation 2028, substantially in the form of a HTTP(S) POST message including XML-formatted data, is provided below:

```
POST /clearance.php HTTP/1.1
Host: www.acquirer.com
Content-Type: Application/XML
Content-Length: 206
<?XML version = “1.0” encoding = “UTF-8”?>
<deposit_ack>
      <request_ID>CNI4ICNW2</request_ID>
      <clear_flag>true</clear_flag>
      <timestamp>2011-02-22 17:00:02</timestamp>
      <deposit_amount>$34.78</deposit_amount>
</deposit_ack>
```

In some embodiments, the acquirer server may parse the individual payment confirmation, and correlate the transaction (e.g., using the request_ID field in the example above) to the merchant. The acquirer server may then transfer the funds specified in the funds transfer message to an account of the merchant. For example, the acquirer server may query, e.g. 2030, an acquirer database 2007b for payment ledger and/or merchant account data, e.g., 2031. The acquirer server may utilize payment ledger and/or merchant account data from the acquirer database, along with the individual payment confirmation, to generate updated payment ledger and/or merchant account data, e.g., 2032. The acquirer server may then store, e.g., 2033, the updated payment ledger and/or merchant account data to the acquire database.

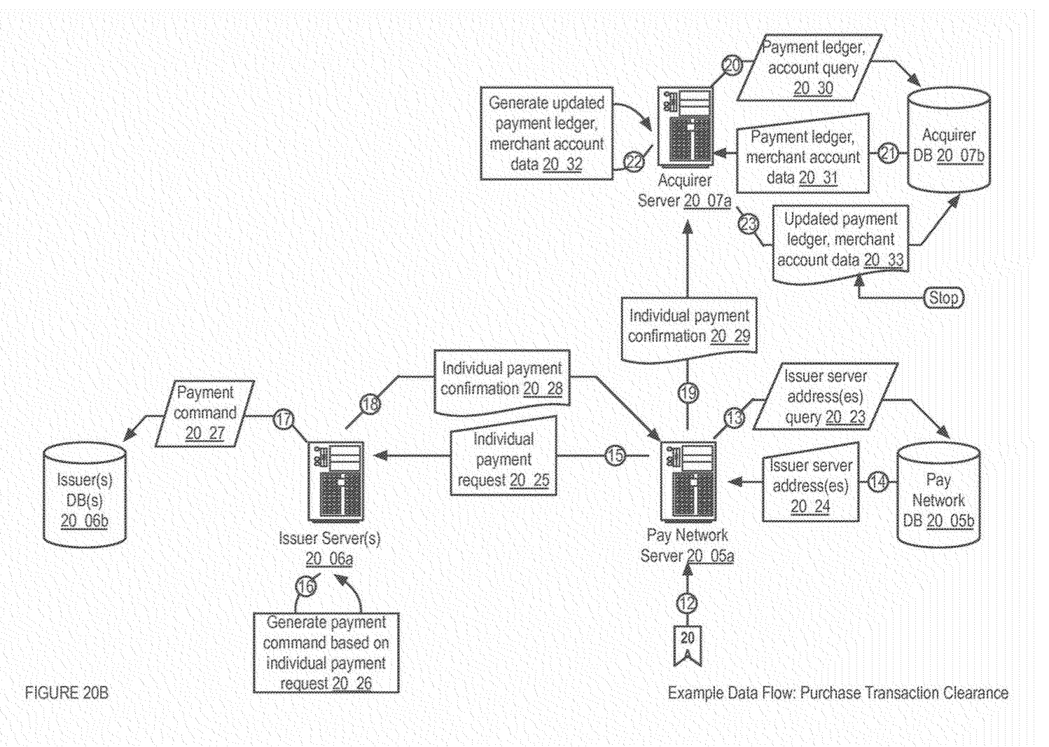

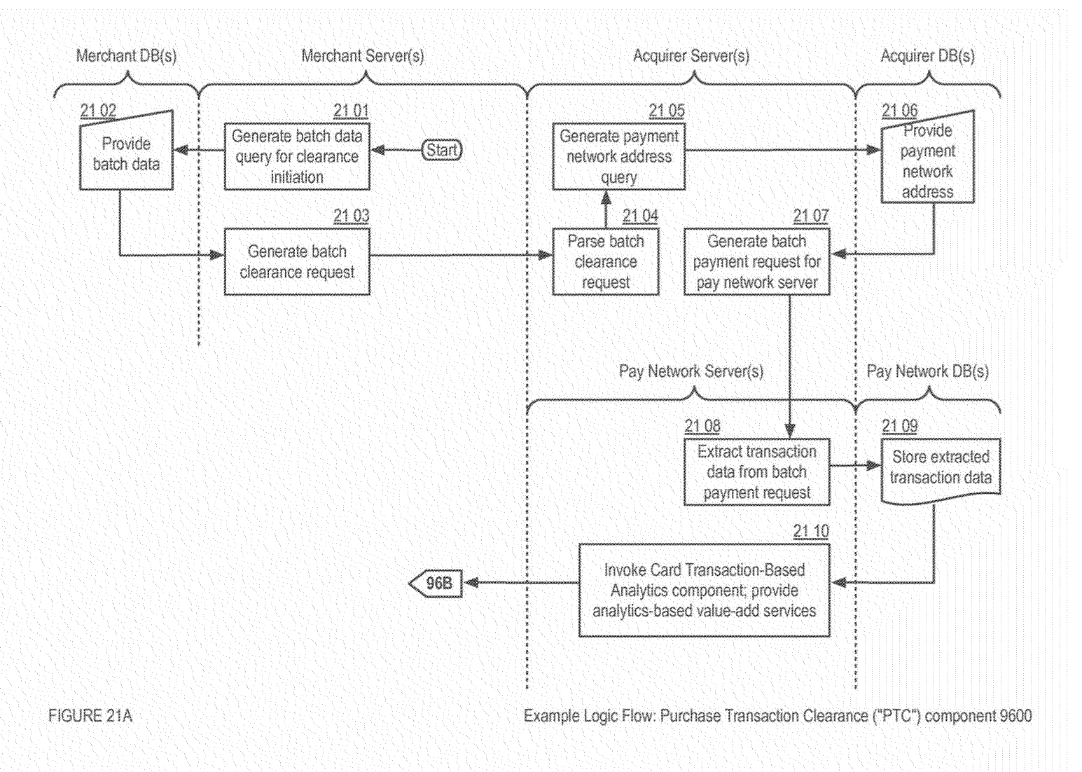

FIGS. 21A-B show logic flow diagrams illustrating example aspects of purchase transaction clearance in some embodiments of the UVEMT, e.g., a Purchase Transaction Clearance (“PTC”) component 2100. With reference to FIG. 21A, in some embodiments, a merchant server may initiate clearance of a batch of authorized transactions. For example, the merchant server may generate a batch data request, e.g., 2101, and provide the request to a merchant database. In response to the batch data request, the database may provide the requested batch data, e.g., 2102. The server may generate a batch clearance request, e.g., 2103, using the batch data obtained from the database, and provide the batch clearance request to an acquirer server. The acquirer server may parse, e.g., 2104, the obtained batch clearance request, and generate, e.g., 2107, a batch payment request using the obtained batch clearance request to provide, the batch payment request to a pay network server. For example, the acquirer server may query, e.g., 2105, an acquirer database for an address of a payment network server, and utilize the obtained address, e.g., 2106, to forward the generated batch payment request to the pay network server.

The pay network server may parse the batch payment request obtained from the acquirer server, and extract the transaction data for each transaction stored in the batch payment request, e.g., 2108. The pay network server may store the transaction data, e.g., 2109, for each transaction in a pay network database. In some embodiments, the pay network server may invoke a component, e.g., 2110, to provide analytics based on the transactions of the merchant for whom purchase transaction are being cleared.

With reference to FIG. 21B, in some embodiments, for each extracted transaction, the pay network server may query, e.g., 2111, a pay network database for an address of an issuer server. The pay network server may generate an individual payment request, e.g., 2113, for each transaction for which it has extracted transaction data, and provide the individual payment request to the issuer server. In some embodiments, the issuer server may parse the individual payment request, e.g., 2114, and generate a payment command, e.g., 2115, based on the parsed individual payment request. For example, the issuer server may issue a command to deduct funds from the user's account (or add a charge to the user's credit card account). The issuer server may issue a payment command, e.g., 2115, to a database storing the user's account information, e.g., a user profile database. The issuer server may provide an individual payment confirmation, e.g., 2117, to the pay network server, which may forward, e.g., 2118, the individual payment confirmation to the acquirer server.

In some embodiments, the acquirer server may parse the individual payment confirmation, and correlate the transaction (e.g., using the request_ID field in the example above) to the merchant. The acquirer server may then transfer the funds specified in the funds transfer message to an account of the merchant. For example, the acquirer server may query, e.g. 2119, an acquirer database for payment ledger and/or merchant account data, e.g., 2120. The acquirer server may utilize payment ledger and/or merchant account data from the acquirer database, along with the individual payment confirmation, to generate updated payment ledger and/or merchant account data, e.g., 2121. The acquirer server may then store, e.g., 2122, the updated payment ledger and/or merchant account data to the acquire database.

### UVEMT Controller

FIG. 22 shows a block diagram illustrating embodiments of a UVEMT controller. In this embodiment, the UVEMT controller 2201 may serve to aggregate, process, store, search, serve, identify, instruct, generate, match, and/or facilitate interactions with a computer through various technologies, and/or other related data.

Typically, users, which may be people and/or other systems, may engage information technology systems (e.g., computers) to facilitate information processing. In turn, computers employ processors to process information; such processors 2203 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 2229 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the UVEMT controller 2201 may be connected to and/or communicate with entities such as, but not limited to: one or more users from user input devices 2211; peripheral devices 2212; an optional cryptographic processor device 2228; and/or a communications network 2213.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The UVEMT controller 2201 may be based on computer systems that may comprise, but are not limited to, components such as: a computer systemization 2202 connected to memory 2229.

### Computer Systemization

A computer systemization 2202 may comprise a clock 2230, central processing unit (“CPU(s)” and/or “processor(s)” (these terms are used interchangeable throughout the disclosure unless noted to the contrary)) 2203, a memory 2229 (e.g., a read only memory (ROM) 2206, a random access memory (RAM) 2205, etc.), and/or an interface bus 2207, and most frequently, although not necessarily, are all interconnected and/or communicating through a system bus 2204 on one or more (mother)board(s) 2202 having conductive and/or otherwise transportive circuit pathways through which instructions (e.g., binary encoded signals) may travel to effectuate communications, operations, storage, etc. The computer systemization may be connected to a power source 2286; e.g., optionally the power source may be internal. Optionally, a cryptographic processor 2226 and/or transceivers (e.g., ICs) 2274 may be connected to the system bus. In another embodiment, the cryptographic processor and/or transceivers may be connected as either internal and/or external peripheral devices via the interface bus I/O. In turn, the transceivers may be connected to antenna(s) 2275, thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing UVEMT controller to determine its location)); Broadcom BCM4329FKUBG transceiver chip (e.g., providing 802.11n, Bluetooth 2.1+EDR, FM, etc.); a Broadcom BCM4750IUB8 receiver chip (e.g., GPS); an Infineon Technologies X-Gold 618-PMB9800 (e.g., providing 2G/3G HSDPA/HSUPA communications); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 2229 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the UVEMT controller and beyond through various interfaces. Should processing requirements dictate a greater amount speed and/or capacity, distributed processors (e.g., Distributed UVEMT), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the UVEMT may be achieved by implementing a microcontroller such as CAST's R8051XC2 microcontroller; Intel's MCS 51 (i.e., 8051 microcontroller); and/or the like. Also, to implement certain features of the UVEMT, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the UVEMT component collection (distributed or otherwise) and/or features may be implemented via the microprocessor and/or via embedded components; e.g., via ASIC, coprocessor, DSP, FPGA, and/or the like. Alternately, some implementations of the UVEMT may be implemented with embedded components that are configured and used to achieve a variety of features or signal processing.

Depending on the particular implementation, the embedded components may include software solutions, hardware solutions, and/or some combination of both hardware/software solutions. For example, UVEMT features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the UVEMT features. A hierarchy of programmable interconnects allow logic blocks to be interconnected as needed by the UVEMT system designer/administrator, somewhat like a one-chip programmable breadboard. An FPGA's logic blocks can be programmed to perform the operation of basic logic gates such as AND, and XOR, or more complex combinational operators such as decoders or mathematical operations. In most FPGAs, the logic blocks also include memory elements, which may be circuit flip-flops or more complete blocks of memory. In some circumstances, the UVEMT may be developed on regular FPGAs and then migrated into a fixed version that more resembles ASIC implementations. Alternate or coordinating implementations may migrate UVEMT controller features to a final ASIC instead of or in addition to FPGAs. Depending on the implementation all of the aforementioned embedded components and microprocessors may be considered the “CPU” and/or “processor” for the UVEMT.

### Power Source

The power source 2286 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 2286 is connected to at least one of the interconnected subsequent components of the UVEMT thereby providing an electric current to all subsequent components. In one example, the power source 2286 is connected to the system bus component 2204. In an alternative embodiment, an outside power source 2286 is provided through a connection across the I/O 2208 interface. For example, a USB and/or IEEE 1394 connection carries both data and power across the connection and is therefore a suitable source of power.

### Interface Adapters

Interface bus(ses) 2207 may accept, connect, and/or communicate to a number of interface adapters, conventionally although not necessarily in the form of adapter cards, such as but not limited to: input output interfaces (I/O) 2208, storage interfaces 2209, network interfaces 2210, and/or the like. Optionally, cryptographic processor interfaces 2227 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 2209 may accept, communicate, and/or connect to a number of storage devices such as, but not limited to: storage devices 2214, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 2210 may accept, communicate, and/or connect to a communications network 2213. Through a communications network 2213, the UVEMT controller is accessible through remote clients 2233b (e.g., computers with web browsers) by users 2233a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed UVEMT), architectures may similarly be employed to pool, load balance, and/or otherwise increase the communicative bandwidth required by the UVEMT controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 2210 may be used to engage with various communications network types 2213. For example, multiple network interfaces may be employed to allow for the communication over broadcast, multicast, and/or unicast networks.

Input Output interfaces (I/O) 2208 may accept, communicate, and/or connect to user input devices 2211, peripheral devices 2212, cryptographic processor devices 2228, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 2211 often are a type of peripheral device 512 (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 2212 may be connected and/or communicate to I/O and/or other facilities of the like such as network interfaces, storage interfaces, directly to the interface bus, system bus, the CPU, and/or the like. Peripheral devices may be external, internal and/or part of the UVEMT controller. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices 528), force-feedback devices (e.g., vibrating motors), network interfaces, printers, scanners, storage devices, transceivers (e.g., cellular, GPS, etc.), video devices (e.g., goggles, monitors, etc.), video sources, visors, and/or the like. Peripheral devices often include types of input devices (e.g., cameras).

It should be noted that although user input devices and peripheral devices may be employed, the UVEMT controller may be embodied as an embedded, dedicated, and/or monitor-less (i.e., headless) device, wherein access would be provided over a network interface connection.

Cryptographic units such as, but not limited to, microcontrollers, processors 2226, interfaces 2227, and/or devices 2228 may be attached, and/or communicate with the UVEMT controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other commercially available specialized cryptographic processors include: Broadcom's CryptoNetX and other Security Processors; nCipher's nShield; SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

### Memory

Generally, any mechanization and/or embodiment allowing a processor to affect the storage and/or retrieval of information is regarded as memory 2229. However, memory is a fungible technology and resource, thus, any number of memory embodiments may be employed in lieu of or in concert with one another. It is to be understood that the UVEMT controller and/or a computer systemization may employ various forms of memory 2229. For example, a computer systemization may be configured wherein the operation of on-chip CPU memory (e.g., registers), RAM, ROM, and any other storage devices are provided by a paper punch tape or paper punch card mechanism; however, such an embodiment would result in an extremely slow rate of operation. In a typical configuration, memory 2229 will include ROM 2206, RAM 2205, and a storage device 2214. A storage device 2214 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 2229 may contain a collection of program and/or database components and/or data such as, but not limited to: operating system component(s) 2215 (operating system); information server component(s) 2216 (information server); user interface component(s) 2217 (user interface); Web browser component(s) 2218 (Web browser); database(s) 2219; mail server component(s) 2221; mail client component(s) 2222; cryptographic server component(s) 2220 (cryptographic server); the UVEMT component(s) 2235; UPC Component 2241; PTA Component 2242, PTC Component 2243, CLGC-UVEMT Component 2244; GC-UVEMT Component 2245; SD-UVEMT Component 2246; EVD Component 2247; CE-UVEMT Component 2248; GCVEBO Component 2249; GCVEBI Component 2250; GCVEBOCP Component 2251, and/or the like (i.e., collectively a component collection). These components may be stored and accessed from the storage devices and/or from storage devices accessible through an interface bus. Although non-conventional program components such as those in the component collection, typically, are stored in a local storage device 2214, they may also be loaded and/or stored in memory such as: peripheral devices, RAM, remote storage facilities through a communications network, ROM, various forms of memory, and/or the like.

### Operating System

The operating system component 2215 is an executable program component facilitating the operation of the UVEMT controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the UVEMT controller to communicate with other entities through a communications network 2213. Various communication protocols may be used by the UVEMT controller as a subcarrier transport mechanism for interaction, such as, but not limited to: multicast, TCP/IP, UDP, unicast, and/or the like.

### Information Server

An information server component 2216 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective−) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the UVEMT controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the UVEMT database 2219, operating systems, other program components, user interfaces, Web browsers, and/or the like.

Access to the UVEMT database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the UVEMT. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the UVEMT as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 2217 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 2218 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly affect the obtaining and the provision of information to users, user agents, and/or the like from the UVEMT enabled nodes. The combined application may be nugatory on systems employing standard Web browsers.

### Mail Server

A mail server component 2221 is a stored program component that is executed by a CPU 2203. The mail server may be a conventional Internet mail server such as, but not limited to sendmail, Microsoft Exchange, and/or the like. The mail server may allow for the execution of program components through facilities such as ASP, ActiveX, (ANSI) (Objective−) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the UVEMT.

Access to the UVEMT mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 2222 is a stored program component that is executed by a CPU 2203. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 2220 is a stored program component that is executed by a CPU 2203, cryptographic processor 2226, cryptographic processor interface 2227, cryptographic processor device 2228, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the UVEMT may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the UVEMT component to engage in secure transactions if so desired. The cryptographic component facilitates the secure accessing of resources on the UVEMT and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The UVEMT Database

The UVEMT database component 2219 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases contain of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the UVEMT database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the UVEMT database is implemented as a data-structure, the use of the UVEMT database 2219 may be integrated into another component such as the UVEMT component 2235. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 2219 includes several tables 2219a-k. A Users table 2219a may include fields such as, but not limited to: user_id, ssn, dob, first_name, last_name, address, age, state, address_firstline, address_secondline, zipcode, application_id, application_type, exchange_preferences_list, exchange_preferences_values, devices_list, user_accounts_list, user_passwords_list, security_level, and/or the like. The Users table may support and/or track multiple entity accounts on a UVEMT. A Clients table 2219b includes fields such as, but not limited to: device_ID_list, device_name_list, device_type_list, hardware_configuration_list, software_apps_list, device_IP_list, device_MAC_list, device_preferences_list, media_resolution, media_type, media_format, GPS_enable, longitude_latitude, contact_method_preference, contact_information, language_preference, user_char list, and/or the like. An Exchanges table 2219c may include fields such as, but not limited to: user_id, currency_type, currency_id, currency_name, currency_float_flag, currency_exchange_restrictions, unit_currency_value, exchange_rate, exchange refresh_rate, baseline_rate, market_symbol, market_name, exchange_rate_startdate, exchange_rate_enddate, base_currency, and/or the like. A Merchants/provider table 2219d may include fields such as, but not limited to: provider_id, program_name, address_firstline, address_secondline, zipcode, application_id, application_type, exchange_preferences_list, exchange_preferences_values, devices_list, registered users_list, currency type and/or the like. A Banks/issuer table 2219e includes fields such as, but not limited to: bank_id, bank_bame, aba_number, routing_number, micr, branch_name, branch_code, address_first_line, address_secondline, zipcode, issuer_address, ip_address, mac_address, auth_key, port_num, security_settings_list, and/or the like. A rules and restrictions table 2219f includes fields such as, but not limited to: rules_ID, rulesrestriction_list, and/or the like. An accounts table 2219g includes fields such as, but not limited to: user_ID, program_ID, enrolled_status, points_balance, last_update_date, account_number, account_security_code, account_name, issuer_acquirer_flag, issuer_name, acquirer_name, account_address, routing_number, access_API_call, linked_wallets_list, and/or the like. An exchange rates table 2219h includes fields such as, but not limited to: program_ID, base_currency, exchangerate, date, and/or the like. A payment devices/cards table 2219i includes fields such as, but not limited to: user_ID, payment_device_type, payment_device_identifier, payment_device_securitycode, billing_address, bank_account_number, and/or the like. An analytics table 2219j includes fields such as, but not limited to: program_ID, user_ID, transaction_volume, time_period, and/or the like. A programs table 2219k includes fields such as, but not limited to program_ID, rules_ID, notallowedprogram_IDs, preferred_program_IDs, normal_exchnage_rate, preferred_exchange_rate, and/or the like. A Market Data table 22191 includes fields such as, but not limited to: market_data_feed_ID, asset_ID, asset_symbol, asset_name, spot_price, bid_price, ask_price, and/or the like; in one embodiment, the market data table is populated through a market data feed (e.g., Bloomberg's PhatPipe, Dun & Bradstreet, Reuter's Tib, Triarch, etc.), for example, through Microsoft's Active Template Library and Dealing Object Technology's real-time toolkit Rtt.Multi. An Acquirers table 2219m may include fields such as, but not limited to: merchant_ID, account_firstname, account_lastname, account_type, account_num, account_balance_list, billingaddress_line1, billingaddress_line2, billing_zipcode, billing_state, shipping_preferences, shippingaddress_line1, shippingaddress_line2, shipping_zipcode, shipping_state, and/or the like. A Pay Gateways table 2219n may include fields such as, but not limited to: gateway_ID, gateway_IP, gateway_MAC, gateway_secure_key, gateway_access_list, gateway API_call_list, gateway_services_list, and/or the like. A Transactions table 22190 may include fields such as, but not limited to: order_id, user_id, timestamp, transaction_cost, purchase_details_list, num_products, products_list, product_type, product_params_list, product_title, product_summary, quantity, user_id, client_id, client_ip, client_type, client_model, operating_system, os_version, app_installed_flag, user_id, account_firstname, account_lastname, account_type, account_num, account priority account_ratio, billingaddress_line1, billingaddress_line2, billing_zipcode, billing_state, shipping_preferences, shippingaddress_line1, shippingaddress_line2, shipping_zipcode, shipping_state, merchant_id, merchant_name, merchant_auth_key, and/or the like. A Batches table 2219p may include fields such as, but not limited to: batch_id, transaction_id_list, timestamp_list, cleared_flag_list, clearance_trigger_settings, and/or the like. A Ledgers table 2219q may include fields such as, but not limited to: request_id, timestamp, deposit_amount, batch_id, transaction_id, clear_flag, deposit_account, transaction_summary, payor_name, payor_account, and/or the like. A Products table 2219r may include fields such as, but not limited to: product_ID, product_title, product_attributes_list, product_price, tax_info_list, related_products_list, offers_list, discounts_list, rewards_list, merchants_list, merchant_availability_list, and/or the like. An Offers table 22195 may include fields such as, but not limited to: offer_ID, offer_title, offer_attributes_list, offer_price, offer_expiry, related_products_list, discounts_list, rewards_list, merchants_list, merchant_availability_list, and/or the like. An Apps table 2219t may include fields such as, but not limited to: app_ID, app_name, app_type, app_dependencies, and/or the like. A value card table 2219u may include fields such as, but not limited to: value_card_ID, value_amount, tracking_equivalent_amount, source_user_ID, destination_user_ID, current_user_ID, and/or the like. A broker table 2219v may include fields such as, but not limited to: broker_ID, broker_IP_address, broker_digital_certificate, broker_type, broker_currency_type, and/or the like.

In one embodiment, the UVEMT database may interact with other database systems. For example, employing a distributed database system, queries and data access by search UVEMT component may treat the combination of the UVEMT database, an integrated data security layer database as a single database entity.

In one embodiment, user programs may contain various user interface primitives, which may serve to update the UVEMT. Also, various accounts may require custom database tables depending upon the environments and the types of clients the UVEMT may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 2219a-1. The UVEMT may be configured to keep track of various settings, inputs, and parameters via database controllers.

The UVEMT database may communicate to and/or with other components in a component collection, including itself, and/or facilities of the like. Most frequently, the UVEMT database communicates with the UVEMT component, other program components, and/or the like. The database may contain, retain, and provide information regarding other nodes and data.

### The UVEMTs

The UVEMT component 2235 is a stored program component that is executed by a CPU. In one embodiment, the UVEMT component incorporates any and/or all combinations of the aspects of the UVEMT that was discussed in the previous figures. As such, the UVEMT affects accessing, obtaining and the provision of information, services, transactions, and/or the like across various communications networks.

The UVEMT transforms value equivalent exchange instructions via UVEMT components into cross-ecosystem currency exchanges, and/or the like. In one embodiment, the value transfer request inputs (see in the FIGURES, e.g., value transfer request 212, value transfer request 250, open loop gift card value transfer request 281, transfer confirmation 226, equivalent value transfer confirmation 266, acceptance confirmation 287, initiation of points/currency exchange 422, exchange confirmation 438, amount of source program points/currency to convert 430, etc.) inputs are transformed via UVEMT components CLGC-UVEMT 2244, GC-UVEMT 2245, SD-UVEMT 2246, EVD 2247, CE-UVEMT 2248 into currency exchange (see in the FIGURES, e.g., transfer request 214, confirmation message 228, balance transfer request 230, target gift card order 238, target gift card issue 240, transfer request 252, confirmation message 268, confirmation message 288, charge request 276, send charge request 290, authorization message 278, charge authorization 291, payment request message 442, payment confirmation 444, etc.) outputs. In another embodiment, inputs 24 (see in the FIGURES, e.g., wallet access input 1811, payment gateway address 1818, transaction authorization input 1814 and/or the like) etc., and transforms the inputs via various UVEMT components (e.g., UPC 2241, PTA 2242, PTC 2243, and/or the like), into outputs (see in the FIGURES, e.g., payment network address query 1821, pay network address query 1912, issuer(s) address(es) 1916, purchase receipt/transaction declined notice 1928, and/or the like).

In one embodiment, the value transfer request inputs (see in the FIGURES, e.g., value transfer request 2400, equivalent value transfer confirmation 2411, value transfer request 2404, equivalent value transfer 2414, value transfer request information 2100, gift card balance message(s) 2421, value transfer request information 2441, gift card balance message(s) 2441, incoming charge request 2459, selection of UVEMT option(s) and/or payment method 2484, etc.) inputs are transformed via UVEMT components GCVEBO, GCVEBI, GCVEBOCP, and UPC into currency exchange outputs (seen in the FIGURES, e.g., updated ledger balance(s) 2418, confirmation response 2436, complementary exchange response 2452, liquidation response 2453, charge authorization message 2470, hold clearance message 2469, checkout page with available payment option(s) 2483, etc., and/or the like).

The UVEMT component enabling access of information between nodes may be developed by employing standard development tools and languages such as, but not limited to: Apache components, Assembly, ActiveX, binary executables, (ANSI) (Objective−) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the UVEMT server employs a cryptographic server to encrypt and decrypt communications. The UVEMT component may communicate to and/or with other components in a component collection, including itself, and/or facilities of the like. Most frequently, the UVEMT component communicates with the UVEMT database, operating systems, other program components, and/or the like. The UVEMT may contain, communicate, generate, obtain, and/or provide program component, system, user, and/or data communications, requests, and/or responses.

### Distributed UVEMTs

The structure and/or operation of any of the UVEMT node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the UVEMT controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model 6 ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:
w3c-post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the UVEMT controller may be executing a PHP script implementing a Secure Sockets Layer (“SSL”) socket server via the information server, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

```
<?PHP
header(‘Content-Type: text/plain’);
// set ip address and port to listen to for incoming data
$address = ‘192.168.0.100’;
$port = 255;
// create a server-side SSL socket, listen for/accept incoming
communication
$sock = socket_create(AF_INET, SOCK_STREAM, 0);
socket_bind($sock, $address, $port) or die(‘Could not bind to address’);
socket_listen($sock);
$client = socket_accept($sock);
// read input data from client device in 1024 byte blocks until end of
message do {
      $input = “”;
      $input = socket_read($client, 1024);
      $data .= $input;
} while($input != “”);
// parse data to extract variables
$obj = json_decode($data, true);
// store input data in a database
mysql_connect(″201.408.185.132″,$DBserver,$password); // access
database server
mysql_select(″CLIENT_DB.SQL″); // select database to append
mysql_query(“INSERT INTO UserTable (transmission)
VALUES ($data)”); // add data to UserTable table in a CLIENT database
mysql_close(“CLIENT_DB.SQL”); // close connection to database
?>
```

Also, the following resources may be used to provide example embodiments regarding SOAP parser implementation:

http://www.xav.com/perl/site/lib/SOAP/Parser.html
http://publib.boulder.ibm.com/infocenter/tivihelp/v2r1/index.jsp?topic=
/com.ibm.IBMDI.doc/referenceguide295.htm

and other parser implementations:

http://publib.boulder.ibm.com/infocenter/tivihelp/v2r1/index.jsp?topic=
/com.ibm.IBMDI.doc/referenceguide259.htm

all of which are hereby expressly incorporated by reference.

As an example of the wide scope of the systems and methods disclosed herein, the systems and methods can be used with the embodiments disclosed in Appendix 1 of U.S. provisional patent application Ser. No. 61/808,180, filed Apr. 3, 2013 (“Provisional Application”). For example, the systems and methods disclosed herein can be used with a Pay with Points program (PwP) which will allow loyalty program participants to use their loyalty currency outside of their loyalty program to purchase goods, services, and other loyalty currency from participating partners, as described in Appendix 1 of the Provisional Application.

As another example of the wide scope of the systems and methods disclosed herein, the systems and methods can be used with the embodiments disclosed in Appendix 2 of U.S. provisional patent application Ser. No. 61/808,180, filed Apr. 3, 2013 (“Provisional Application”). For example, the systems and methods disclosed herein can be used as described in Appendix 2 of the Provisional Application as follows. Pay With Points (PwP) serves as an exchange for loyalty currencies and products and services. PwP can utilize Loyalty Currency Exchange Rates to convert a purchase into any currency (dollars, miles, points) between Partners thereby allowing a customer participating in a Rewards program to use their points to purchase goods and services from a Partner within the exchange. The goods and services can be in the form of merchandise or loyalty currency (points, miles, etc.). Example: exchanging points from one partner for airline miles from a related partner. Partners are categorized as Systems, Hosts and Merchants, and a Partner can serve in these roles simultaneously based on their individual/unique Relationships within the exchange, to the customer and to another Partner. Each Partner will have its own unique ID. A Host has the loyalty currency which will be used by the customer to purchase the goods and services being sold by the Merchant based on the contractually agreed upon parameters of the Relationship such as the Loyalty Currency Exchange Rate and Redemption Minimums. A System is an external platform that is permitted access to the REP to facilitate transactions between a Host and a Merchant. Once relationships between Merchants/Systems, Pay with Points and Hosts are defined, a series of web services will be transmitted between the Partners to facilitate exchange functions. The web services will use SSL/IP restricted security access between PwP and the partners. All fields will be sent from the Rep to System or Host or Merchant unless the field is specified as optional. A web service will be available to a System to retrieve the relationships that are accessible to the calling System. This request for the existing relationships is initiated from a System and transmitted to the Pay with Points (PwP) exchange platform. A relationship will consist of three partners, a Merchant, System and Host. Each partner will have an ID and description associated with them. Each Merchant will also have an associated acquirers BIN. The calling System's ID returns a list of active relationships established in the PwP platform between that System and other Merchants and Hosts.

As yet another example of the wide scope of the systems and methods disclosed herein, the systems and methods can be used with the embodiments disclosed in Appendix 3 of U.S. provisional patent application Ser. No. 61/808,180, filed Apr. 3, 2013 (“Provisional Application”). For example, the systems and methods disclosed herein can be used as described as follows in Appendix 3 of the Provisional Application. Global Concierge acts as a system, defined as an external platform that is permitted access to the Rewards Exchange Platform to facilitate transactions between a Host and a Merchant. Global Concierge may also fulfill both ‘System’ and ‘Merchant’ roles, as it provides assets available for purchase. All relationships will be defined at the Rewards Exchange Platform, and Global Concierge will use API calls relevant to those relationships, as documented by Pay With Points BRD and Pay With Points API documentation. This implementation of GC has one Merchant defined for any GC System-Merchant-Host relationships defined within the REP, and that GC is that sole Merchant acting as the merchant for Managed Assets made available through a concierge service. For example, GC would facilitate using cardholder's loyalty currency from any of these host programs for redemption of GC's assets available for purchase or to redeem host program loyalty currency for a card statement credit. Example Relationships:

| System | Merchant | Host |
|---|---|---|
| GC | GC | Extras |
| GC | GC | Hilton HHonors |
| GC | GC | United Mileage Plus |

In order to address various issues and advance the art, the entirety of this application for UNIVERSAL VALUE EXCHANGE MULTIPOINT TRANSACTIONS APPARATUSES, METHODS AND SYSTEMS (including the Cover Page, Title, Headings, Field, Background, Summary, Brief Description of the Drawings, Detailed Description, Claims, Abstract, Figures, Appendices, and otherwise) shows, by way of illustration, various embodiments in which the claimed innovations may be practiced. The advantages and features of the application are of a representative sample of embodiments only, and are not exhaustive and/or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations including the right to claim such innovations, file additional applications, continuations, continuations in part, divisions, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a UVEMT individual and/or enterprise user, database configuration and/or relational model, data type, data transmission and/or network framework, syntax structure, and/or the like, various embodiments of the UVEMT, may be implemented that enable a great deal of flexibility and customization. For example, aspects of the UVEMT may be adapted for exchanging securities, rights, obligations, debt, and/or the like. While various embodiments and discussions of the UVEMT have been directed to currency exchange, however, it is to be understood that the embodiments described herein may be readily configured and/or customized for a wide variety of other applications and/or implementations.

What is claimed is:

1. A universal value exchange multipoint transactions processor-implemented method to transform value equivalent exchange instructions into cross-ecosystem currency exchanges, comprising:
obtaining, using one or more data processors, a cross-ecosystem currency exchange instruction;
determining, using the one or more data processors, currency types based on parsing the cross-ecosystem currency exchange instruction;
determining, using the one or more data processors, multiple brokers based on parsing the cross-ecosystem currency exchange instruction;
determining, using the one or more data processors, exchange rates of the currency types;
obtaining, using the one or more data processors, currency exchange restrictions and conditions associated with the multiple brokers;
generating, using the one or more data processors, based on the currency exchange restrictions and conditions, currency exchange flow paths for currency transfer using the multiple brokers;
issuing, using the one or more data processors, currency transfer requests to the multiple brokers;
determining, using the one or more data processors, that the cross-ecosystem currency exchange has been completed;
determining, using the one or more data processors, a points redemption eligibility; and
effecting, using the one or more data processors, an adjustment of accounts associated with the issued currency transfer request to reflect the completed cross-ecosystem currency exchange.

2. The method of claim 1, wherein processing includes points being converted from traditional rewards programs into cash withdrawn from an ATM-linked account.

3. The method of claim 2, wherein the processing includes converting rewards points from an airline miles program into virtual currency that is to be utilized in an online social networking game.

4. The method of claim 2, wherein the processing includes converting virtual currency into currency usable to purchase stock on an electronic trading system.

5. The method of claim 1, wherein entities within the exchange network takes on different relationships or roles within an exchange network.

6. The method of claim 5, wherein the different relationships or roles include a points supplier becoming a buyer or a broker.

7. The method of claim 5, wherein the different relationships or roles include allowing a supplier of rewards points to also operate as a purchaser or broker of rewards points.

8. The method of claim 5, wherein the different relationships or roles include allowing a supplier of rewards points, either in a separate transaction or simultaneously, to also operate as a purchaser or broker of rewards points.

9. The method of claim 8, wherein the supplier of reward points who wishes to sell off, rebalance, or acquire other point suppliers' value equivalence sells and buys points.

10. The method of claim 8, wherein a user who has executed a cross-ecosystem currency exchange is permitted to perform a refund transaction.

11. The method of claim 8, wherein a user who has executed a cross-ecosystem currency exchange is permitted to perform a refund transaction through which an exchanged currency type may be converted back into the original source currency type.

12. The method of claim 11, wherein the user provides information including an account number corresponding to a credit card, debit card, gift card, or loyalty rewards card.

13. The method of claim 12, wherein the one or more data processors determines whether the account number is in a predetermined range of account numbers for which payment using points is authorized.

14. The method of claim 12, wherein the one or more data processors determines by referencing a lookup table whether the account number is in a predetermined range of account numbers for which payment using points is authorized.

15. The method of claim 14, wherein the lookup is performed utilizing the entire account number.

16. The method of claim 14, wherein the lookup is performed using a subset of the complete account number.

17. The method of claim 16, a progressive lookup-as-you-type operation is performed and provides interactive on-the-go feedback to the user.

18. The method of claim 17, wherein the one or more data processors use first the four digits of the account number in executing the lookup and performs additional subsequent lookups using additional digits in making a points redemption eligibility determination.

19. A processor implemented system of transforming value equivalent exchange instructions into cross-ecosystem currency exchanges, comprising:
a memory;
one or more data processors disposed in communication with said memory, and configured to process a plurality of processing instructions stored in said memory, wherein the one or more data processors process instructions to:
obtain, using one or more data processors, a cross-ecosystem currency exchange instruction;
determine, using the one or more data processors, currency types based on parsing the cross-ecosystem currency exchange instruction;
determine, using the one or more data processors, multiple brokers based on parsing the cross-ecosystem currency exchange instruction;
determine, using the one or more data processors, exchange rates of the currency types;
obtain, using the one or more data processors, currency exchange restrictions and conditions associated with the multiple brokers;
generate, using the one or more data processors, based on the currency exchange restrictions and conditions, currency exchange flow paths for currency transfer using the multiple brokers;
issue, using the one or more data processors, currency transfer requests to the multiple brokers;
determine, using the one or more data processors, that the cross-ecosystem currency exchange has been completed;
determine, using the one or more data processors, a points redemption eligibility; and
effect, using the one or more data processors, an adjustment of accounts associated with the issued currency transfer request to reflect the completed cross-ecosystem currency exchange.

20. A processor-readable non-transitory medium comprising instructions executable by one or more data processors in order to transform value equivalent exchange instructions into cross-ecosystem currency exchanges, said instructions being configured to:
obtain, using one or more data processors, a cross-ecosystem currency exchange instruction;
determine, using the one or more data processors, currency types based on parsing the cross-ecosystem currency exchange instruction;
determine, using the one or more data processors, multiple brokers based on parsing the cross-ecosystem currency exchange instruction;
determine, using the one or more data processors, exchange rates of the currency types;
obtain, using the one or more data processors, currency exchange restrictions and conditions associated with the multiple brokers;
generate, using the one or more data processors, based on the currency exchange restrictions and conditions, currency exchange flow paths for currency transfer using the multiple brokers;
issue, using the one or more data processors, currency transfer requests to the multiple brokers;
determine, using the one or more data processors, that the cross-ecosystem currency exchange has been completed;
determine, using the one or more data processors, a points redemption eligibility; and
effect, using the one or more data processors, an adjustment of accounts associated with the issued currency transfer request to reflect the completed cross-ecosystem currency exchange.
